(19) United States
(12) Patent Application Publication
(10) Pub. No.: US 2009/0055147 A1
(43) Pub. Date: Feb. 26, 2009

(54) CELL NETWORK ANALYSIS SYSTEM

(75) Inventors: Masato Miyake, Amagasaki-shi (JP); Tomohiro Yoshikawa, Amagasaki-shi (JP); Jun Miyake, Amagasaki-shi (JP)

Correspondence Address: SEED INTELLECTUAL PROPERTY LAW GROUP PLLC, 701 FIFTH AVE, SUITE 5400, SEATTLE, WA, 98104, US

(73) Assignees: National Inst. of Adv. Industrial Science and Tech, Chiyoda-ku (JP); CYOPATHFINDER, INC., Shinagawa-ku (JP)

(21) Appl. No.: 11/630,814

(22) PCT Filed: Jun. 24, 2005
(86) PCT No.: PCT/JP2005/011672

§ 371 Date: Aug. 27, 2008

(30) Foreign Application Priority Data
Jun. 25, 2004 (JP) 2004-189020

(51) Int. Cl. G06G 7/48

(52) U.S. Cl. 703/11

(57) ABSTRACT

A digital cell database and means for making network analysis using the database and actual data. A method for creating a database of digital cells and a device concerning the method are provided. A method for providing a service to reproduce an experiment according to a parameter to be analyzed on the basis of the results of an experiment on an actual cell using a digital cell by means of a computer system including a service requester and a service provider are also provided. The technique is solved by providing a support through which cells can be arranged in the same environment.

### TECHNICAL FIELD

The present invention is related to the field of cell analysis technologies. More specifically, the present invention describes a method for providing a network analysis technology using a digital cell, a system therefore, and data obtained thereby, as well as digital cell technologies.

The detailed description of the invention is provided as follows.

### BACKGROUND ART

The survival of organisms depends on their ability to perceive and respond to extracellular signals. At the molecular level, signals are perceived and transmitted through networks of interacting proteins or the like, that act cooperatively to maintain cellular homeostasis and regulate activities like growth, division and differentiation. Information transfer through biological signaling networks is mediated largely by protein-protein interactions that can assemble and disassemble dynamically in response to signals, creating transient circuits that link external events to specific internal outputs, such as changes in gene expression. Numerous strategies have been developed to map the protein-protein interactions that underlie these networks. These studies have collectively provided a wealth of data delineating genome-wide protein-protein interactions for Saccharomyces cervisiae and other organisms. While powerful, these approaches have provided only a partial picture and are likely to overlook many interactions that are context dependent, forming only in the presence of their appropriate signals.

The disruption of protein-protein interactions by either mutation or small-molecules can create biological fulcrums that enable small perturbations of a signaling network to elicit large changes in cellular phenotype. However, not all protein-protein interactions in a given signaling pathway are likely to possess this power. As such, complementary strategies that aim to identify regulatory protein-protein interactions by artificially introducing proteins or peptides into cells which compete with and titrate-out the endogenous regulatory interactions, thereby disrupting the normal circuits that connect external signals to cellular responses, are of interest. By combining this strategy with functional assays, such as the activation of a gene in response to a signal, screens for functional interference can be used to identify peptides that perturb regulatory protein-protein interactions. This strategy, often referred to as dominant-interfering or dominant-negative genetics, has been successfully employed in several model organisms where high-throughput screening methods are easily applied, and to a lesser extent in mammals, which have traditionally been less amenable to these types of screens. One advantage of dominant-negative strategies is that such strategies can pinpoint the functionally relevant protein-protein interaction “fulcrum points” and thereby expose the small number of nodes within the larger web of a protein network that are susceptible to functional modulation by external agents. As such, the results of such strategies can provide vital information about the regulatory components that define a particular pathway and can allow the elucidation of key protein-protein interactions suitable for targeting by drug screening programs.

The difficulty in transfecting cells or producing transgenic organisms hinders the progression of development of dominant-negative screening in mammals. To overcome this problem, high-efficiency retrovirus transfection has been developed. Although this retrovirus transfection is potent, it is necessary to produce DNA to be packaged into viral intermediates, and therefore, the applicability of this technique is limited. Alternatively, high-density transfection arrays or cell arrays are being developed, and the use thereof is proposed.

Rosetta Inpharmatics has proposed using cellular information as a cell profile in some patent applications (Japanese PCT National Phase Laid-Open Publication No.: 2003-505038; Japanese PCT National Phase Laid-Open Publication No.: 2003-505022; Japanese PCT National Phase Laid-Open Publication No.: 2002-533701 Japanese PCT National Phase Laid-Open Publication No.: 2002-533700 Japanese PCT National Phase Laid-Open Publication No.: 2002-533699; Japanese PCT National Phase Laid-Open Publication No.: 2002-528095; Japanese PCT National Phase Laid-Open Publication No.: 2002-526757; Japanese PCT National Phase Laid-Open Publication No.: 2002-518021; Japanese PCT National Phase Laid-Open Publication No.: 2002-518003; Japanese PCT National Phase Laid-Open Publication No.: 2002-514804; Japanese PCT National Phase Laid-Open Publication No.: 2002-514773; Japanese PCT National Phase Laid-Open Publication No.: 2002-514437). In such profile, information from separate cells is processed as a group of separate pieces of information, but not continuous information. Therefore, this technique is limited in that information analysis is not conducted on a single (the same) cell. Particularly, in this technique, analysis is conducted only at one specific time point before and after a certain change, and a series of temporal changes in a single point (gene) are not analyzed.

Recent advances in profiling techniques have led to accurate measurement of cellular components, and thus, profiling of cellular information (e.g., Schena et al., 1995, “Quantitative monitoring of gene expression patterns with a complementary DNA microarray”, Science 270:467-470; Lockhart et al., 1996, “Expression monitoring by hybridization to high-density oligonucleotide arrays”, Nature Biotechnology 14:1675-1680; Blanchard et al., 1996, “Sequence to array: Probing the genome's secrets”, Nature Biotechnology 14:1649; and U.S. Pat. No. 5,569,588). For organisms whose genome is entirely known, it is possible to analyze the transcripts of all genes in a cell. In the case of other organisms, for which the amount of known genomic information is increasing, a number of genes in a cell can be simultaneously monitored.

As array technology advances, arrays have also been utilized in the field of drug screening (e.g., Marton et al., “Drug target validation and identification of secondary drug target effects using Microarrays”, Nat. Med., 1998 November, 4(11):1293-301; and Gray et al., 1998, “Exploiting chemical libraries, structure, and genomics in the search for kinase inhibitors”, Science, 281:533-538). Analysis using profiles (e.g., U.S. Pat. No. 5,777,888) and clustering of profiles provides information about cell conditions, transplantation, target molecules and drug candidates, and/or relevant functions, efficacy and toxicity of drugs. These techniques can be used to determine a common profile which represents ideal drug activities and disease conditions. Comparing profiles assists in detecting diseases in patients at an early stage, and provides prediction of improved clinical outcomes for patients who have been diagnosed as having a disease.

However, to date, there has been no technique which can provide information about the same cell in the true sense. In the above-described techniques, data is obtained as average for a group of heterologous cells. Analyses and evaluations based on such data lack accuracy. Therefore, there is an increasing demand for a method of providing information at the cellular level.

Further, there is also a demand for development of technology for analyzing a network using such authentic data.

[patent literature 1]

Japanese PCT National Phase Laid Open Publication No. 2003-505038

[patent literature 2]

Japanese PCT National Phase Laid Open Publication 2003-505022

[patent literature 3]

Japanese PCT National Phase Laid Open Publication 2002-533701

[patent literature 4]

Japanese PCT National Phase Laid Open Publication 2002-533700

[patent literature 5]

Japanese PCT National Phase Laid-Open Publication 2002-533699

[patent literature 6]

Japanese PCT National Phase Laid Open Publication 2002-528095

[patent literature 7]

Japanese PCT National Phase Laid Open Publication 2002-526757

[patent literature 8]

Japanese PCT National Phase Laid Open Publication 2002-518021

[patent literature 9]

Japanese PCT National Phase Laid Open Publication 2002-518003

[patent literature 10]

Japanese PCT National Phase Laid Open Publication 2002-514804

[patent literature 11]

Japanese PCT National Phase Laid Open Publication 2002-514773

[patent literature 12]

Japanese PCT National Phase Laid Open Publication 2002-514437

[patent literature 13]

U.S. Pat. No. 5,569,588

[patent literature 14]

U.S. Pat. No. 5,777,888

[non-patent literature 1]

Schena et al., 1995, Quantitative monitoring of gene expression patterns with a complementary-DNA microarray, Science 270:467-470.

[non-patent literature 2]

Lockhart et al., 1996, Expression monitoring by hybridization to high-density oligonucleotide arrays, Nature Biotechnology 14:1675-1680

[non-patent literature 3]

Blanchard et al., 1996, Sequence to array: Probing the genome's secrets, Nature Biotechnology 14:1649

[non-patent literature 4]

Marton et al., 1998, Drug target validation and identification of secondary drug target effects using Microarrays, Nat. Med. 1998 November; 4(11):1293-301

[non-patent literature 5]

Gray et al., 1998, Exploiting chemical libraries, structures, and genomics in the search of forkinase inhibitors, Science 281:533-538

### SUMMARY OF THE INVENTION

### Problems to be Solved by the Invention

It is an object for the present invention to provide digital cell database and means for analyzing a cellular network using an actual data by means of such digital cell database.

The above identified problems have been solved by immobilizing a cell onto a substrate, monitoring a biological agent or a population thereof on or in a cell in a time-lapse manner to produce a profile data thereof, producing a database of digital cells by collecting the same, and forming a network thereof to summarize a variety of analysis.

The problem has also been solved by providing a substrate capable of placing a plurality of cells under a consistent environment. Such a substrate may be achieved by for example using a salt or an actin-acting substance, preferably both a salt and an actin-acting substance to immobilize a cell. Thus, it allowed collection of cellular profiles of the same type located in the same environment at the same time and under consistent conditions.

Accordingly, the present invention provides the following:

1. A method for producing a digital cell database, comprising the steps of:
a) obtaining a cell parameter specifying a cell of experimental interest;
b) obtaining an environment parameter specifying the environment under which the cell specified by the cell parameter is cultured;
c) obtaining a stimulus parameter specifying the stimulus to be given to the cell specified by the cell parameter;
d) obtaining a stimulus response result showing the response of the cell specified by the cell parameter to the stimulus specified by the stimulus parameter under the environment specified by the environment parameter;
e) producing an experimental data for the cell, by correlating the cell parameter, the environment parameter, the stimulus parameter and the stimulus response result;
f) optionally repeating steps a) through e) to produce at least one collection of experimental data for the cell, and to provide at least one collection of experimental data as a digital cell;
g) collecting the data of the digital cell to form a database.
   2. A method according to item 1, wherein the data relating to the cell is obtained by a method for producing profile data relating to a cell in a consistent environment, the method comprising the steps of:
a) locating a plurality of cells to a support which is capable of maintaining the cells in a consistent environment; and
b) monitoring a biological agent or a collection thereof on or in the cell to produce the profile data for the cell.
   3. A method according to item 1, wherein the environment parameters comprise a parameter indicating culture medium in which the cell is cultured, and a parameter showing the conditions of the culture medium.
   4. A method according to item 1, wherein the stimulus parameters comprise a parameter showing a reporter and a parameter showing a chemical stimulus.
   5. A method according to item 1, wherein said stimulus response result comprises the profile data for the cell obtained by monitoring a biological agent or a collection thereof on or in the cell over time.
   6. A method according to item 1, wherein the digital cell database is adapted to the format of a known database selected from the group consisting of KEGG, EMBL, GenBank and AfCS.
   7. A database produced by the method according to item 1.
   8. A database according to item 7, wherein the database has a data structure selected from the group consisting of those which have a continuous monitoring data of gene expression, and data of a cell caused in an identical chip obtained in a simultaneous and parallel manner.
   9. An apparatus for producing a digital cell database, comprising:
a) means for obtaining a cell parameter specifying a cell of experimental interest;
b) means for obtaining an environment parameter specifying the environment under which the cell specified by the cell parameter is cultured;
c) means for obtaining a stimulus parameter specifying a stimulus to be given to the cell specified by the cell parameter;
d) means for obtaining a stimulus response result showing the response of the cell specified by the cell parameter to the stimulus specified by the stimulus parameter under the environment specified by the environment parameter;
e) means for producing an experimental data for the cell, by correlating the cell parameter, the environment parameter, the stimulus parameter and the stimulus response result;
f) means for providing at least one collection of experimental data as a digital cell, by optionally repeating steps performed by steps conducted by the means a) through e) to produce at least one collection of experimental data for the cell; and
g) means for collecting data to form the digital cell database.
   10. A method for providing a service which reproduces an experimental result of an actual cell using a digital cell based on a target parameter for analysis by means of a computer system comprising a service requester and a service provider, comprising the steps of:
A) preparing a digital cell database having at least one digital cell stored thereon, wherein at least one digital cell is expressed as a collection of at least one experimental data of a cell of experimental interest, wherein each of the experimental data comprises a cell parameter specifying the cell, an environment parameter specifying an environment under which the cell specified by the cell parameter is cultured, a stimulus parameter specifying a stimulus to be given to the cell specified by the cell parameter, and a stimulus response result showing the response of the cell specified by the cell parameter to the stimulus specified by the stimulus parameter under the environment specified by the environment parameter;
B) receiving the target parameter for analysis to produce the cell parameter, the environment parameter and the stimulus parameter by the service requester thereby producing a request comprising the cell parameter, the environment parameter and the stimulus parameter;
C) providing the request to the service provider by the service requester;
D) searching the digital cell database in response to the request by the service provider to determine whether or not there is the stimulus response result relating to the cell parameter, the environment parameter and the stimulus parameter included in the request, in the database;
E) searching the digital cell database in response to the request by the service provider to determine whether or not there is a known database relating to the target parameter for analysis, and if present, obtain information relating to the known database relating to the target parameter for analysis;
F) providing the stimulus response result to the service requester by the service provider in association with the information relating to the known database, when it is determined that the stimulus response result relating to the cell parameter, the environment parameter and the stimulus parameter included in the request exists in the digital cell database, and when the information relating to the known database is obtained; and
G) presenting the information relating to the known database and the stimulus response result by the service requester.
   11. A method according to item 10, wherein the target parameter to be analyzed is selected from the group consisting of a disease, a drug and a gene nomenclature.
   12. A method according to item 10, wherein the known database is selected from the group consisting of pathway database, protein interaction database, protein interaction database, intermolecular interaction network database, genome database, protein database, cDNA database and cellular information database.
   13. A method according to item 10, wherein the information related to the known database is outputted in the order of intense relation to the target parameter for analysis.
   14. A method according to item 10, wherein the target parameter comprises a disease, and the information related the known database is outputted in a form of a list of a gene related to the disease, and a list of a drug related to the disease.
   15. A method according to item 10, further comprising the steps of:
conducting, by the service provider, a search for an intermolecular interaction network database and a pathway database as the known database after the target parameter for analysis is inputted, outputting a gene list having an intermolecular interaction and a gene list relating to the regulation of genes, and thereby designing a cellular assay experiment based on the gene list;
producing additional data relating to an additional digital cell based on the designed cellular assay by the service provider to produce a digital cell database with an update added to the digital cell database;
providing the service requester by the service provider with the stimulus response results relating to the information relating to a known database based on the updated digital cell database; and
displaying the information relating to the known database and the stimulus response result by the service requester.
   16. A method for providing a service for reproducing an experimental result of an actual cell using a digital cell based on the target parameter for analysis, by means of a computer system comprising a service requester and a plurality of service providers, comprising the steps of:
A) preparing a plurality of databases, each having at least one digital cell stored thereon, wherein the digital cell is expressed as a collection of at least one experimental data of a cell of experimental interest, wherein each of the experimental data comprises a cell parameter specifying the cell, an environment parameter specifying the environment under which the cell specified by the cell parameter is cultured, a stimulus parameter specifying a stimulus to be given to the cell specified by the cell parameter, and a stimulus response result showing the response of the cell specified by the cell parameter to the stimulus specified by the stimulus parameter under the environment specified by the environment parameter;
B) preparing a service registry which stores at least one service capable of being provided by the plurality of service providers;
C) receiving the target parameter for analysis to produce the cell parameter, the environment parameter and the stimulus parameter by the service requester thereby producing a request comprising the cell parameter, the environment parameter and the stimulus parameter;
D) searching the service registry in response to the request by the service requester to determine whether or not there is a service provider capable of providing a service for the request amongst the plurality of service providers;
E) providing the request to the service provider by the service requester when it is determined that a service provider capable of providing a service of the request amongst the plurality of service providers exists;
F) searching the database in response to the request by the service provider to determine whether or not there is the stimulus response result relating to the cell parameter, the environment parameter and the stimulus parameter included in the request in the database;
G) providing the request to the service requester by the service provider, when it is determined that there is a service provider capable of providing a known database relating to the target parameter for analysis included in the requests amongst a plurality of service providers,
H) searching, in response to the request by the service provider to determine whether or not there is a known database relating to the target parameter for analysis, and if present, obtain information relating to the known database relating to the target parameter for analysis;
I) providing the stimulus response result to the service requester by the service provider in association with the information relating to the known database, when it is determined that the stimulus response result relating to the cell parameter, the environment parameter, and the stimulus parameter exists in the digital cell database, and when the information relating to the known database is obtained; and
J) presenting the information relating to the known database and the stimulus response result by the service requester.
   17. A computer system for providing a service for reproducing an experimental result of an actual cell using a digital cell based on the target parameter for analysis, comprising:
a plurality of databases, each having at least one digital cell stored thereon, wherein the at least one digital cell is expressed as a collection of at least one experimental data of a cell of experimental interest, wherein each of the experimental data comprises a cell parameter specifying the cell, an environment parameter specifying the environment under which the cell specified by the cell parameter is cultured, a stimulus parameter specifying the stimulus to be given to the cell specified by the cell parameter, and a stimulus response result showing the response of the cell specified by the cell parameter to the stimulus specified by the stimulus parameter under the environment specified by the environment parameter; and a service requestor which requests a service desired by a user, wherein the service requestor comprises:
   means for receiving the cell parameter, the environment parameter and the stimulus parameter, and producing a request comprising the environment parameter and the stimulus parameter; and
   means for providing the request to the service provider;
wherein the service provider comprises:
   means for searching the digital cell database in response to the request, and determining whether or not the response result relating to the stimulus which correlates between the cell parameter, the environment parameter and the stimulus parameter is included in the request amongst the digital cell data base;
   means for searching for whether or not there is a known database related to the target parameter for analysis in response to the request, and if present, obtaining information related to the known database with respect to the target parameter for analysis; and
   means for providing the stimulus response result to the service requester by the service provider in association with the information relating to the known database, when it is determined that the stimulus response result relating to the cell parameter, the environment parameter, and the stimulus parameter exists in the digital cell database, and when the information relating to the known database is obtained;
wherein the service requestor comprises:
   means for presenting the information relating to the known database and the stimulus response result by the service requester.
      18. A computer system according to Item 17 wherein the service requester is a Web browser which the user operates, and the service provider is a Web server linked to the service requester via the Internet.
      19. A computer system according to Item 17, wherein the service requester provides the request to the service provider in a format described in XML language.
      20. A computer system according to Item 17, wherein the service provider provides the stimulus response result to the service requester in a format described in XML language.
      21. A computer system according to Item 17, wherein the target parameter to be analyzed is selected from the group consisting of a disease, a drug and a gene name.
      22. A computer system according to item 17, wherein the known database is selected from the group consisting of pathway database, protein interaction database, intermolecular interaction network database, genomic database, protein database, cDNA database and cellular information database.
      23. A computer system according to item 17, wherein the service provider stores at least one of the known database.
      24. A computer system according to item 17, wherein the service provider is connected to the known database via a network.
      25. A computer system according to item 17, wherein the information relating to the known database is outputted in the order of the intensity of relationship with the target parameter for analysis.
      26. A computer system according to item 17, wherein the target parameter to be analyzed comprises a disease, and the information relating to the known database is outputted in a form of a list selected from the group consisting of a list of gene nomenculature relating to the disease, and the list of drugs relating to the disease.
      27. A computer system according to item 17, wherein the service provider further comprises:
means for conducting a search for an intermolecular interaction network database and a pathway database as the known database after the target parameter for analysis is inputted, outputting a gene list having an intermolecular interaction and a gene list relating to the regulation of genes, and thereby designing a cellular assay experiment based on the gene list;
means for producing additional data relating to an additional digital cell based on the designed cellular assay to produce a digital cell database with an update added to the digital cell database; and
means for providing the service requester with the stimulus response results relating to the information relating to a known database based on the updated digital cell database.
   28. A computer system for providing a service for reproducing an experimental result of an actual cell using a digital cell based on the target parameter for analysis, by means of a computer system comprising a service requester and a plurality of service providers, comprising:
a plurality of service providers, each being constituted so as to be accessible to a database with at least one digital cell stored thereon, wherein the digital cell is expressed as a collection of at least one experimental data of a cell of experimental interest, wherein each of the experimental data comprises a cell parameter specifying the cell, an environment parameter specifying an environment under which the cell specified by the cell parameter is cultured, a stimulus parameter specifying a stimulus to be given to the cell specified by the cell parameter, and a stimulus response result showing the response of the cell specified by the cell parameter to the stimulus specified by the stimulus parameter under the environment specified by the environment parameter;
a service registry which stores at least one service capable of being provided by the plurality of service providers; and
a service requestor which requests a service desired by a user, wherein the service requester comprises:
   means for receiving the analysis of target parameter to produce the cell parameter, the environment parameter and the stimulus parameter thereby producing a request comprising the cell parameter, the environment parameter and the stimulus parameter;
   means for searching the service registry in response to the request by the service requester to determine whether or not there is a service provider capable of providing a service for the request amongst the plurality of service providers;
   means for providing the request to the service provider by the service requester when it is determined that a service provider capable of providing a service of the request amongst the plurality of service providers exists;
   means for providing the request to the service requester by the service provider, when it is determined that there is a service provider capable of providing a known database relating to the target parameter for analysis included in the requests amongst a plurality of service providers;
wherein each of the plurality of service provides comprises:
   means for searching, in response to the request to determine whether or not there is a known database relating to the target parameter for analysis, and if present, obtain information relating to the known database relating the target parameter for analysis;
   means for searching the database in response to the request to determine whether or not there is the stimulus response result relating to the cell parameter, the environment parameter and the stimulus parameter included in the request in the database;
   means for providing the stimulus response result to the service requester by the service provider in association with the information relating to the known database, when it is determined that the stimulus response result relating to the cell parameter, the environment parameter, and the stimulus parameter exists in the digital cell database, and when the information relating to the known database is obtained; and
wherein the service requestor further comprises:
   means for presenting the information relating to the known database and the stimulus response result by the service requester.
      29. A computer system according to item 28, wherein the service requestor is a web server connected to a web browser operated by the use via the Internet, and each of the plurality of service providers is a web server connected to the service requestor via the Internet.
      30. A computer system according to item 28, wherein the service requestor provides the service provider with the request described in the XML format.
      31. A computer system according to item 28, wherein the service provider provides the service requestor with the stimulus response result described in the XML format.
      32. A method for analyzing a biological system relating to a stimulus response, comprising the steps of:
A) providing a biological database comprising information relating to a biological system, input information database comprising information relating to a stimulus, and an output information database comprising information relating to a response of the biological system to the stimulus;
B) extracting a combination of an input data from the input information database and an output data from the output database;
C) calculating a clustering with respect to each of the input data and the output data; and
D) calculating the pattern of a stimulus and a response relating to a desired analysis target system to induce a biological system relating to the combination of a stimulus and a response corresponding thereto.
   33. A method according to item 32, wherein the biological system comprises a cell.
   34. A method according to item 32, wherein the biological database comprises a database of a digital cell.
   35. A method according to item 32, wherein the biological database comprises a component constituting the biological system, and the analysis calculates a component constituting the desired analysis target system.
   36. A method according to item 35, wherein the biological database is a cell, and the component constituting the biological system comprises a gene, and the analysis comprises the step of calculating a characteristic gene amongst the genes constituting the desired analysis target.
   37. A method according to item 35, wherein the biological database is a cell database, and the component constituting the biological system comprises a gene, an intermolecular interaction, regulation relationship and pathway thereof, and the analysis comprises the step of calculating a characteristic gene, intermolecular interaction, regulation relationship and pathway thereof amongst the genes constituting the desired analysis target.
   38. A method according to item 32, wherein the biological database, the input information database, and the output information database are provided by a digital cell, and the digital cell is provided by a digital cell database produced by a process of the steps of:
a) obtaining a cell parameter specifying a cell of experimental interest;
b) obtaining an environment parameter specifying an environment under which the cell specified by the cell parameter is cultured;
c) obtaining a stimulus parameter specifying the stimulus to be given to the cell specified by the cell parameter;
d) obtaining a stimulus response result showing the response of the cell specified by the cell parameter to the stimulus specified by the stimulus parameter under the environment specified by the environment parameter;
e) producing an experimental data for the cell, by correlating the cell parameter, the environment parameter, the stimulus parameter and the stimulus response result;
f) optionally repeating steps a) through e) to produce at least one collection of experimental data for the cell, and to provide at least one collection of experimental data as a digital cell;
g) collecting data of the digital-cell to produce a database.
   39. A method according to item 32, wherein the biological system is a cell, the output is outputted in a format selected from the group consisting of a differentiation state, a response to a foreign agent, cellular cycle, a proliferation state, an apoptosis state, a response to an environment change and an aging state.
   40. A method according to item 32, wherein the biological system is a cell, and the output is outputted in a format selected from the group consisting of a phenotype level, a gene expression level, a gene transcription level, a post-translational modification of a gene, a chemical present in a cell, an intracellular ion level, a cell size, a biochemical process level and a biophysical process level.
   41. A method according to item 32, wherein the biological system is a cell, and the output is outputted in a format selected from the group consisting of a gene expression level and a gene transcription level.
   42. A method according to item 32, wherein the biological system is a cell, and the analysis is conducted by means of change in sign (+/−) of a first-order differentiation of the time series data of the output.
   43. A method according to item 32, wherein the biological system is a cell, and the desired analysis target system is a cell related disease.
   44. A method according to item 32, wherein the biological system is a cell, and the desired analysis target system is a cell related disease, the component comprises a gene, and the analysis comprises the step of selecting a characteristic gene amongst the genes constituting the desired analysis target.
   45. A method according to item 32, wherein the biological system is a cell, and the desired analysis target system is a cell related disease, the component comprises a gene, and an intermolecular interaction, regulation relationship and pathway thereof, and the analysis comprises the step of selecting a characteristic gene, and the intermolecular interaction, regulation relationship and pathway thereof amongst the genes constituting the desired analysis target.
   46. A method according to item 32, wherein the biological system is a cell, and the response is selected from the group consisting of cell lethality, a change in cell morphology, a genetic promoter activity, an enzymatic activity, an ionic amount, an ionic localization, the amount of a biomolecule other than a protein, and the amount of a change in localization of a biomolecule other than a protein.
   47. A method according to item 32, wherein the biological system is a cell, and the cell is selected from the group consisting of a tissue derived from a normal cell, diseased cell and an established cell line.
   48. A method according to item 32, wherein the stimulus is selected from the group consisting of an inhibitor, an antisense oligonucleotide, an RNAi and an antibody.
   49. A method according to item 32, wherein the clustering comprises a clustering by the Ward method.
   50. A method according to item 32, wherein the clustering is determined by conducting a first-order processing wherein if a variable in the response is within a predetermined range, the variable is determined to be 0, if the variable is greater than the upper limit of the predetermined range, the variable is determined to be 1, and if the variable is lower than the lower limit of the predetermined range, the variable is determined to be −1; performing a second-order processing wherein if the value of the results of the first-order processing per member of each biological system coincides, then the member is determined to be 0, and otherwise the member is determined to be 1; and calculating a Euclidean space distance with respect to the results of the second-order-processing.
   51. A method according to item 50, wherein the predetermined range is a predetermined range of a change in the response.
   52. A method according to item 32, wherein the calculation based on the clustering further comprises the step of extracting a stimulus and response patterns which are capable of distinguishing a biological system similar to a desired analytical target system, and one different from the desired analytical target system.
   53. A method according to item 32, further comprising the step of extracting a stimulus capable of specifically distinguishing the desired analytical target system.
   54. A method according to item 32, comprising, in lieu of step D), the step of calculating a stimulus relating to the combination of a biological system and a response corresponding to the pattern of the biological system and a response relating to the desired stimulus.
   55. A method according to item 32, comprising, in lieu of step D), the step of calculating a response relating to the combination of a biological system and a stimulus corresponding to the pattern of the biological system and the stimulus relating to the desired stimulus.
   56. A system for analyzing a biological system relating to a stimulus response, comprising:
A) means for providing a biological database comprising information relating to a biological system, input information database comprising information relating to a stimulus, and an output information database comprising information relating to the response of the biological system to the stimulus;
B) means for extracting a combination of an input data from the input information database and an output data from the output database;
C) means for calculating a clustering with respect to each of the input data and the output data; and
D) means for calculating the pattern of a stimulus and a response relating to a desired analysis target system to induce a biological system relating to the combination of a stimulus and a response corresponding thereto.
   57. A system according to item 56, wherein the biological system comprises a cell.
   58. A system according to item 56, wherein the biological database comprises a digital cell database.
   59. A system according to item 56, wherein the biological database comprises a component constituting the biological system, and the analysis calculates a component constituting the desired analysis target system.
   60. A system according to item 59, wherein the biological database is a cell, and the components constituting the biological system comprise a gene, and the analysis comprises the step of calculating a characteristic gene amongst the genes constituting the desired analysis target.
   61. A system according to item 59, wherein the biological database is a cell database, and the components constituting the biological system comprise a gene, an intermolecular interaction, regulation relationship and pathway thereof, and the analysis comprises the step of calculating a characteristic gene, intermolecular interaction, regulation relationship and pathway thereof amongst the genes constituting the desired analysis target.
   62. A system according to item 56, wherein the biological database, the input information database, and the output information database are provided by a digital cell, and the digital cell is provided by a digital cell database produced by a process of the steps of:
a) obtaining a cell parameter specifying a cell of experimental interest;
b) obtaining an environment parameter specifying an environment under which the cell specified by the cell parameter is cultured;
c) obtaining a stimulus parameter specifying a stimulus to be given to the cell specified by the cell parameter;
d) obtaining a stimulus response result showing a result which the cell specified by the cell parameter responds to the stimulus specified by the stimulus parameter under the environment specified by the environment parameter;
e) producing an experimental data for the cell, by correlating the cell parameter, the environment parameter, the stimulus parameter and the stimulus response result;
f) optionally repeating steps a) through e) to produce at least one collection of experimental data for the cell, and to provide at least one collection of experimental data as a digital cell;
g) collecting data of the digital cell to produce a database.
   63. A system according to item 56, wherein the biological system is a cell, the output is outputted in a format selected from the group consisting of a differentiation state, a response to a foreign agent, cellular cycle, a proliferation state, an apoptosis state, a response to an environment change, and an aging state.
   64. A system according to item 56, wherein the biological system is a cell, and the output is outputted in a format selected from the group consisting of a phenotype level, a gene expression level, a gene transcription level, a post-translational modification of a gene, a chemical present in a cell, an intracellular ion level, a cell size, a biochemical process level, and a biophysical process level.
   65. A system according to item 56, wherein the biological system is a cell, and the output is outputted in a format selected from the group consisting of a gene expression level and a gene transcription level.
   66. A system according to item 56, wherein the biological system is a cell, and the analysis is conducted by means of change in sign (+/−) of a first-order differentiation of the time series data of the output.
   67. A system according to item 56, wherein the biological system is a cell, and the desired analysis target system is a disease related cell.
   68. A system according to item 56, wherein the biological system is a cell, and the desired analysis target system is a cell related disease, the component comprises a gene, and the analysis comprises the step of selecting a characteristic gene amongst the genes constituting the desired analysis target.
   69. A system according to item 56, wherein the biological system is a cell, and the desired analysis target system is a cell related disease, the component comprises a gene, and an intermolecular interaction, regulation relationship and pathway thereof, and the analysis comprises the step of selecting a characteristic gene, and the intermolecular interaction, regulation relationship and pathway thereof amongst the genes constituting the desired analysis target.
   70. A system according to item 56, wherein the biological system is a cell, and the response is selected from the group consisting of cell lethality, amount of a change in cell morphology, a genetic promoter activity, an enzymatic activity, an ionic amount, an ionic localization, the amount of a biomolecule other than a protein, and the amount of a change in localization of a biomolecule other than a protein.
   71. A system according to item 56, wherein the biological system is a cell, and the cell is selected from the group consisting of a tissue derived normal cell, a diseased cell and an established cell line.
   72. A system according to item 56, wherein the stimulus is selected from the group consisting of an inhibitor, an antisense oligonucleotide, an RNAi and an antibody.
   73. A system according to item 56, wherein the clustering comprises a clustering by the Ward method.
   74. A system according to item 56, wherein the clustering is determined by conducting a first-order processing wherein if a variable in the response is within a predetermined range, the variable is determined to be 0, if the variable is greater than the upper limit of the predetermined range, the variable is determined to be 1, and if the variable is lower than the lower limit of the predetermined range, the variable is determined to be −1; performing a second-order processing wherein if the value of the results of the first-order processing per member of each biological system coincides, then the member is determined to be 0, and otherwise the member is determined to be 1; and calculating a Euclidean space distance with respect to the results of the second-order processing.
   75. A system according to item 74, wherein the predetermined range is a predetermined range of a change in the response.
   76. A system according to item 56, wherein the calculation based on the clustering further comprises the step of extracting stimulus and response patterns which are capable of distinguishing a biological system similar to a desired analytical target system, and one different from the desired analytical target system.
   77. A system according to item 56, further comprising means for extracting a stimulus capable of specifically distinguishing the desired analytical target system.
   78. A system according to item 56, comprising, in lieu of means D), means for calculating a stimulus relating to the combination of a biological system and a response corresponding to the pattern of the biological system and a response relating to the desired stimulus.
   79. A system according to item 56, comprising, in lieu of means D), means for calculating a response relating to the combination of a biological system and a stimulus corresponding to the pattern of the biological system and the stimulus relating to the desired stimulus.
   80. A computer program for implementing to computer a method for analyzing a biological system relating to a stimulus response, the method comprising the steps of:
A) providing a biological database comprising information relating to a biological system, input information database comprising information relating to a stimulus, and an output information database comprising information relating to a response of the biological system to the stimulus;
B) extracting a combination of an input data from the input information database and an output data from the output database;
C) calculating a clustering with respect to each of the input data and the output data; and
D) calculating the pattern of a stimulus and a response relating to a desired analysis target system to induce a biological system relating to the combination of a stimulus and a response corresponding thereto; calculating a stimulus relating to the combination of a biological system and a response corresponding to the pattern of the biological system and a response relating to the desired stimulus; or calculating a response relating to the combination of a biological system and a stimulus corresponding to the pattern of the biological system and the stimulus relating to the desired stimulus.
   81. A computer-readable medium with a computer program stored thereon for implementing to computer a method for analyzing a biological system relating to a stimulus response, the method comprising the steps of:
A) providing a biological database comprising information relating to a biological system, input information database comprising information relating to a stimulus, and an output information database comprising information relating to a response of the biological system to the stimulus;
B) extracting a combination of an input data from the input information database and an output data from the output database;
C) calculating a clustering with respect to each of the input data and the output data; and
D) calculating the pattern of a stimulus and a response relating to a desired analysis target system to induce a biological system relating to the combination of a stimulus and a response corresponding thereto; calculating a stimulus relating to the combination of a biological system and a response corresponding to the pattern of the biological system and a response relating to the desired stimulus; or calculating a response relating to the combination of a biological system and a stimulus corresponding to the pattern of the biological system and the stimulus relating to the desired stimulus.

Hereinafter, the present invention will be described by way of preferred embodiments. It will be understood by those skilled in the art that the embodiments of the present invention can be appropriately made or carried out based on the description of the present specification and the accompanying drawings, and commonly used techniques well known in the art. The function and effect of the present invention can be easily recognized by those skilled in the art.

### EFFECTS OF THE INVENTION

The present invention provides a system and method for obtaining necessary cellular information based on a cell database as well as on data sequencing technology per se to design additional experiments. The present invention further provides a digital cell based on an actual raw data and use thereof, and network analysis technology. Furthermore, the present invention allows analysis in terms of response and stimuli of a biological system, which is a non-linear system, in an efficient manner by applying clustering technology in an opposite manner as conventionally used, thereby observing unexpectedly significant increase in analysis accuracy. This should be recognized to be significant effects in terms of cellular information, which is a target for pharmaceutical development, in particular, in an accurate manner.

Thus, the present invention allows examination and research of cellular network interactions on a computer as if an actual data is being produced. Such analysis allows applications for diagnosis, prevention, therapy and the like, and not only to medicine, but also to a variety of fields such as food, cosmetics, agriculture, environmental industries and the like. The present invention allows rapid and systematic education and research in the biotechnology field as raw experiments can be reproduced on a computer.

### BRIEF DESCRIPTION OF THE DRAWINGS

FIG. 1 shows the results of experiments in which various actin-like substances and HEK293 cells were used, where gelatin was used as a control. FIG. 1 shows the effect of each adhesion substance (HEK cell) with respect to transfection efficiency. The HEK cells were transfected with pEGFP-N1 using an Effectene reagent.

FIG. 2 shows exemplary transfection efficiencies when fibronectin fragments were used.

FIG. 3 shows exemplary transfection efficiencies when fibronectin fragments were used.

FIG. 4 shows a summary of the results presented in FIGS. 2 and 3.

FIG. 5 shows the results of an example in which transfection efficiency was studied for various cells.

FIG. 6 shows the results of transfection when various plates were used.

FIG. 7 shows the results of transfection when various plates were used at a fibronectin concentration of 0, 0.27, 0.53, 0.8, 1.07, and 1.33 (μg/μL).

FIG. 8 provides exemplary photographs showing cell adhesion profiles in the presence or absence of fibronectin.

FIG. 9 shows exemplary cross-sectional photographs of cell adhesion profiles in the presence or absence of fibronectin. Cross-sections of human mesenchymal stem cells (hMSC) were observed using a confocal laser scanning microscope. hMSC were stained with SYTO61 (blue fluorescence) and Texas red-X phalloidin (red fluorescence) and fixed with 4% PFA. Blue fluorescence (nuclei: SYT061) and red fluorescence (nuclei: Texas red-X phalloidin) were obtained using a confocal laser microscope (LSM510, Carl Zeiss Co., Ltd., pin hole size=1.0, image interval=0.4).

FIG. 10 shows transition of nuclear surface area. Relative nuclear surface area was determined by cross-sections of hMSC observed by confocal laser scanning microscopy. hMSC was fixed with 4% PFA.

FIG. 11 shows the results of an exemplary transfection experiment when a transfection array chip was constructed and used.

FIG. 12 shows exemplary contamination between each spot on an array.

FIG. 13 shows an experiment in which spatially-spaced DNA was taken into cells after the solid phase transfection of the present invention in Example 4.

FIG. 13A schematically shows a method for producing a solid phase transfection array (SPTA). This figure shows the methodology of a solid transfection.

FIG. 13B shows the results of a solid phase transfection. A HEK293 cell line was used to produce a SPTA. Green colored portions indicate transfected adherent cells. According to these results, the method of the present invention can be used to produce a group of cells separated spatially and transfected with different genes. As such, FIG. 13A-B, as a whole, depicts schematically the procedure of transfection (SPTA). FIG. 13A depicts the outlines of SPTA determination, and FIG. 13B depicts a result of SPTA using HEK293 cell strain. The bar indicates 3 mm.

FIG. 13C shows the difference between conventional liquid phase transfection and SPTA.

FIG. 14 shows the results of comparison of liquid phase transfection and SPTA.

FIG. 14A shows the results of experiments where 5 cell lines were measured with respect to GFP intensity/mm². Transfection efficiency was determined as fluorescence intensity per unit area.

FIG. 14B shows fluorescent images of cells expressing EGFP corresponding to the data presented in FIG. 14A. White circular regions therein were regions in which plasmid DNA was fixed. In other regions, cells were also fixed in solid phase, however, cells expressing EGFP were not observed. The white bar indicates 500 μm.

Fluorescent photographs of EGFP expressing cells corresponding to FIG. 14A are shown with respect to the five cell types per measured fluorescence/mm². White circles correspond to plasmid DNA printed regions. Outside these regions, cells express EGFP. Further, regions other than the printed regions are attached cells.

FIG. 14C shows an exemplary transfection method of the present invention.

FIG. 14D shows an exemplary transfection method of the present invention.

FIG. 15 shows the results of chip coating, wherein cross contamination was reduced.

FIG. 15 shows the results of liquid phase transfection and SPTA using HEK293 cells, HeLa cells, NIT3T3 cells (also referred to as “3T3”), HepG2 cells, and hMSCs. Transfection efficiency was determined by GFP intensity.

Transfection efficiency of hMSC depending on the N/P ratios is shown in FIG. 15A. In the case of liquid phase transfection (FIG. 15B, upper panel), hMSC cells were dead and in the case of SPTA, cell morphology was normal (FIG. 15B, lower panel).

FIG. 16 shows cross contamination between each spot. A nucleic acid mixture containing fibronectin having a predetermined concentration was fixed to a chip coated with APS or PLL (poly-L-lysine). Cell transfection was performed on the chip. Substantially no cross contamination was observed (upper and middle rows). In contrast, significant cross contamination of fixed nucleic acids was observed on an uncoated chip (lower row).

FIG. 16C shows a correlation relationship between the types of substances contained in a mixture used for fixation of nucleic acid and cell adhesion rate. The graph presented in FIG. 16 shows an increase in the proportion of adherent cells over time. A longer time is required for cell adhesion when the slope of the graph is shallow than when the slope of the graph is steep.

FIG. 16D is an enlargement of the graph presented in FIG. 16C.

FIG. 17 shows an exemplary configuration of the computer that was used to perform the method of the present invention.

FIG. 18 depicts an example of the mathematical analytic method of the present invention. Profiles of promoters shown in FIG. 18A (average of pNEFAT-d2EGFP/negative control) and FIG. 18B (average of pERE-d2EGFP/negative control) were obtained by measuring the fluorescent intensity thereof over time. These profiles have been normalized using the autologous fluorescence of either cells or medium. Thereafter, in order to compare the amplitude of the reporter expression fluctuations, an amplitude=5 or more (TH>=5) was determined to have a change in expression fluctuation state. Further, the induction of differentiation was divided into the following sections: early stage (0-17.5 hours), late stage (17.5-31.5 hours) and total stage (0-31.5 hours). Further, those observed with a variation in expression of an amplitude of 5 or more (TH>=5) were defined as (+) and those with an amplitude of less than 5 were defined as (−). Based on these definitions, the profiles of A and B were evaluated as shown in the lower tables of FIGS. 18A and 18B. When extracting reporter numbers, (A+B+ . . . n) were integrated with respect to n types of wave forms and the sum was divided by n to form the average wave form. Variations beyond the threshold were deemed as being “changed”.

FIG. 18B depicts another example of a mathematical analysis according to the present invention. When a reporter is extracted (A+B+ . . . n), n wave types are integrated, and the sum is divided by n to produce an average wave form, which was deemed as being a change of the variation above the threshold. The left hand panel of FIG. 18B depicts the integration of two reporter profiles and draws the average wave form in red or with solid squares. Those with 5 or more as a variation of the average profile were deemed to be expression variations for evaluation. As a result, evaluation can be conducted for variations of the two extracted reporters, as shown in the table herein.

FIG. 19 depicts exemplary plasmids containing promoters used in the present invention and an analysis according to the present invention. Seventeen types of transcriptional factors shown in the left hand panel of FIG. 19 were used as reporters under the conditions of osteoblast differentiation and maintenance of undifferentiated mesenchymal stem cells, and expression profiles thereof have been obtained over time (FIG. 19, right handed panel). From these seventeen transcriptional factors, profile numbers have been extracted and evaluated by the method as previously described in FIG. 18, taking the change in amplitude of the response profile of each transcriptional factor as a standard.

FIG. 20 depicts an example of mathematical analysis at the early stage of induction of differentiation. By changing the combination arbitrarily extracted in the early differentiation induction stage, results as shown in FIG. 20 have been obtained. Reporter numbers were extracted from the reporter group consisting of seventeen species, and calculated for the average profile according to the method shown in FIG. 18. Those having five or more variation widths are the results evaluated with the evaluation windows 0-31.5, 0-17.5 and 17.5-31.5. Each extraction condition has seventeen extraction patterns, except for where the seventeen extraction pattern has only one way of extraction. Amongst these combinations, FIG. 20 shows the ratio in which variation is found therein, including the table and graph therein. This analysis allows the confirmation of differentiation after fifteen hours although it is not possible to understand the very early stages of differentiation. The number of extraction where 100% change is found as a variation is eight or more in this instance.

FIG. 21 depicts an example of mathematical analytical results during the maintenance of the undifferentiated stage. Similar results have been obtained when a combination was arbitrarily extracted under conditions to maintain undifferentiation as shown in the graphs of FIG. 20. These results dramatically differ from those related to the induction of the differentiation stage, as shown in FIG. 20. Based on this comparison, it is believed that it is possible to determine whether a cell is moving in the direction of cell differentiation induction, or instead maintaining an undifferentiated state.

FIG. 22 schematically shows a cocktail party process.

FIG. 23 shows an exemplary construct of the gene transcription switch reporter used in the transfection plasmid of the present invention.

FIG. 24 shows exemplary construction of a set of transcription factor reporters.

FIG. 25 shows the results of exemplary assays using transcription factor reporters.

FIG. 26 shows an example of measurements of transcriptional activity in the bone differentiation process, taken in a time-series manner.

FIG. 27 shows an example of the oscillation phenomenon and phase analyses of transcriptional activity.

FIG. 28 shows a protocol of siRNA experiment.

FIG. 29A shows the results of siRNA experiments. The upper panel shows the results of hMSC, and the lower panel shows the results of HeLa cells. The numerals show the concentrations (μg/μL) of the siRNA used. The results obtained with the anti-GFP siRNA are shown on the left, and the right side shows the results with the scramble siRNAs.

FIG. 29B shows the effects of siRNA when solid transfection (PC12) was conducted on a collagen IV coating. FIG. 29B(A) shows PC12 cells cotransfected with EGFP vector and anti-EGFP siRNA. As shown, it was observed that only HcRed was colored, and green signals derived from pEGFP-N1 were suppressed. On the other hand, FIG. 29B(B) shows an example using scramble siRNA. As shown, green fluorescence was observed and thus the effects observed in FIG. 29B(A) are due to the effects of RNAi. Figures showing the relative fluorescence intensities in FIGS. 29B(A) and 29B(B), are summarized in FIG. 29B(C). The y axis indicates relative intensity. It can be seen that effects induced by EGFP were almost completely suppressed.

FIG. 29C depicts results and graphs summarizing the above. The left panel is a photograph comparing EGFP RNAi and scramble (mock) RNAi when changing the ratio of RNAi and pRNA. As shown, EGFP RNAi showed inhibitory effects, whereas scramble RNAi did not exert such effects. This is shown in the right panel, together with DsRed2. Experimental conditions were in accordance with those described herein. As a result, red (DsRed derived signal) and green (EGFP derived signal) were found to be proportional to the RNAi effect.

FIG. 29D depicts an exemplary chip used in the RNAi reporter. When using RNAi as input signals and cointroducing a gene product capable of transmitting signals such as EGF and the like together with a nucleic acid encoding a gene of interest (including a promoter), observation of such signal transmission as output allows the extraction of cell information.

FIG. 29E shows an exemplary experiment using a variety of reporters (pAP1-EGFP, pAP1(PMA)-EGFP, pCRE-EGFP, pE2F-EGFP, pERE-EGFP, pGAS-EGFP, pGRE-EGFP, pHSE-EGFP, pISRE-EGFP, pMyc-EGFP, pNFAT-EGFP, pNFkB-EGFP, PRARE-EGFP, pRb-EGFP, pSTST3-EGFP, pSRE-EGFP, pTRE-EGFP, pp 53-EGFP, pCREB-sensor, pIkB-sensor, pp 53-sensor, pCasapase3-sensor); the is-element sequence was purchased from Clontech using a plasmid vector produced by recombining a fluorescence protein gene therewith.

FIG. 30 shows changes in the profile when using tetracycline dependent promoters.

FIG. 31 shows expression when using tetracycline dependent promoters and tetracycline independent promoters.

FIG. 31B shows an exemplary result of analysis using a transfected microarray with respect to the effects of tyrosine kinase RNAi on neurons.

FIG. 31C depicts responses to retinoic acid (RA) and nerve growth factor (NGF) by a variety of tyrosine kinases. Percentage inhibition by siRNA is shown.

FIG. 31D depicts an example of a signaling pathway obtained as a result of the analysis.

FIG. 31E shows the results obtained by the above-mentioned analysis. It shows a general analysis of the tyrosine kinases responsible for human neuron differentiation. Classification is conducted by determining whether it is dopaminergic neuron, cholinergic neuron, or both, or neither. It can be concluded by the analysis that there is a high possibility that those tyrosine kinases relating to both types of neuron are involved in neuron projection formation.

FIG. 31F depicts an example of real-time monitoring of transcription regulation of apoptosis in a HeLa cell. The left handed panel shows the result over time, and the right handed panel shows the result of a signaling pathway based on the analysis thereof.

FIG. 32 depicts an example of a system configuration.

FIG. 33A depicts an example of a digital cell according to the present invention.

FIG. 33B depicts another example of a digital cell according to the present invention.

FIG. 34 depicts an example of a method for producing a digital cell according to the present invention.

FIG. 35 depicts an example of system 3501 computer configuration which provides a service for reproducing an experimental result obtained from an actual cell using the digital cell.

FIG. 36 depicts an example of procedures of a process which provides a service for reproducing an experimental result obtained from an actual cell using the digital cell.

FIG. 37 depicts an example of input interface for inputting cell parameters, environment parameters and stimulus parameters into service requester 3510.

FIG. 38 depicts an example of system 3801 computer configuration for providing a service for reproducing an experimental result from an actual cell using the digital cell.

FIG. 39 depicts an example of procedures of a process for providing a service for reproducing an experimental result from an actual cell using the digital cell.

FIG. 40 depicts an example of a method for producing a digital cell database of the present invention.

FIG. 41 depicts an example of computer system 4101 configuration which provides a service for reproducing an experiment based on an analysis of target parameters based on an experimental result from an actual cell using a digital cell database.

FIG. 42 depicts a typical example of a cellular network analysis according to the present invention. In FIG. 42, a disease name, a drug name, and a gene name are inputted, and the inputted values are optionally searched for pathway database, intermolecular interaction network database. These optionally allow output of a list of genes relating to those having the intermolecular interaction, and a list of genes relating to the regulation of these genes. Genomic database and RNAi database are optionally referred to, and a set of cellular assay experiments is designed. These allow use of provider catalog database such as reporter, RNAi and the like. After the design, orders to a transfection (TF) array and a printer are transmitted and transfection array is produced, and a cellular experiment is conducted. This is read by a transfection array reader, and data analysis and interpretation are conducted. Optionally, the data is feedbacked to the database, and outputted in an appropriate format. These include data such as, for example, a list of novel biomarker candidates, a list of pharmaceutical development target candidates, site of action for compounds, pathways and the like.

FIG. 43 depicts an example of procedures for providing a service for reproducing an experimental result to an actual cell using digital cells.

FIG. 44 depicts an example of input screen for inputting a cell parameter, an environment parameter, and a stimulus parameter into service requester 4410.

FIG. 45 depicts an example of computer system 4501 which provides a service for reproducing an experimental result to an actual cell using digital cells.

FIG. 46 depicts an example of procedures for providing a service for reproducing an experimental result to an actual cell using digital cells.

FIG. 47 depicts an example of cocktail genomic plan.

FIG. 48 depicts an example of an experimental system based on a network assisted cell. It allows application provision from cellular database production firm to science and technology research, pharmaceutical industry, diagnosis at a hospital, school education and the like from a cell system analysis apparatus.

FIG. 49 depicts results conducted by clustering analysis of RNAi assay panel analysis against four types of cells including U251, HepG2, MCF7 and HeLa cells.

FIG. 50 depicts the design of siRNA targeting in a cell specific manner. The table shown in upper panel of FIG. 50 depicts targeted cells in the left column, and target gene for actin downregulation in the right column. This was constructed based on the RNAi assay panel database which is a cell-based database as shown in the lower panel.

FIG. 51 depicts an example of functional analysis of tyrosine kinases in neuron differentiation pathway. In the present example, analyses were conducted based on human neuroblastoma SHSY5Y cell responses to retinoic acid (RA) and nerve growth factor (NGF).

FIG. 52 depicts an example of analysis of nerve differentiation and differentiation signals by means of NGF. FIG. 52A depicts scheme in which transfection array is used on SHSY5Y cells to analyze the function of NGF. FIG. 52B depicts an example in which differentiation induction efficiency of RA and that of NGF are plotted. FIG. 52C depicts a result in which kinases are analyzed with respect to the interrelationship there between, and those having higher inhibition efficiency of differentiation induction were outputted. FIG. 52D depicts a schematic drawing of a signal pathway in axon formation inhibition based on the interrelationship.

FIG. 53 depicts a flow chart analysis used in the system according to the present invention. The chart compares the digital cell database (2) and the digital cell database related to disease related cells (3).

FIG. 54 depicts a scheme of mass cell response data processing using clustering method by means of Ward method as exemplified in the present invention.

FIG. 55 (A-D; HeLa cell, U251 cell, HepG2 cell and MCF cell, respectively) depicts the average value of four experiments per data with respect to response data of cellular event reporter to siRNA, which was obtained by means of processing as depicted in FIG. 54. As used herein, upregulation, downregulation and stationary (unchanged) were identified. Upregulation and down regulation were determined as to whether a 20% increase or decrease compared to the standard (before change) was observed.

### DESCRIPTION OF SEQUENCE LISTING

SEQ ID NO.: 1: a nucleic acid sequence encoding fibronectin (human)

SEQ ID NO.: 2: an amino acid sequence of fibronectin (human)

SEQ ID NO.: 3: a nucleic acid sequence encoding vitronectin (mouse)

SEQ ID NO.: 4: an amino acid sequence of vitronectin (mouse)

SEQ ID NO.: 5: a nucleic acid sequence encoding laminin (mouse α-chain)

SEQ ID NO.: 6: an amino acid sequence of laminin (mouse α-chain)

SEQ ID NO.: 7: a nucleic acid sequence encoding laminin (mouse β-chain)

SEQ ID NO.: 8: an amino acid sequence of laminin (mouse β-chain)

SEQ ID NO.: 9: a nucleic acid sequence encoding laminin (mouse γ-chain)

SEQ ID NO.: 10: an amino acid sequence of laminin (mouse γ-chain)

SEQ ID NO.: 11: an amino acid sequence of fibronectin (bovine)

SEQ ID NO.: 12: siRNA used in the Examples

SEQ ID NO.: 13: mouse olfactory receptor 17 (heptanal-sensitive) nucleic acid (Genbank Accession No. AF106007)

SEQ ID NO.: 14: amino acid sequence of the protein encoded by the nucleic acid set forth in SEQ ID NO.: 13

SEQ ID NO: 15: nucleic acid encoding the murine olfactory receptor S1 (mc9/bc9-equi-sensitive) (Genbank Accession Number AF121972)

SEQ ID NO: 16: amino acid sequence of the protein encoded by the nucleic acid set forth in SEQ ID NO:

SEQ ID NO: 17: nucleic acid encoding the murine olfactory receptor S50 (cc9-sensitive) (Genbank Accession Number AF121980)

SEQ ID NO: 18: amino acid sequence of the protein encoded by the nucleic acid set forth in SEQ ID NO: 17

SEQ ID NO: 19: nucleic acid encoding the murine olfactory receptor S19 (mc9/mh9/bc9-equi-sensitive) (Genbank Accession Number AF121976)

SEQ ID NO: 20: amino acid sequence of the protein encoded by the nucleic acid set forth in SEQ ID NO: 19

SEQ ID NO: 21: nucleic acid encoding the murine OR23 (lyral-sensitive) (only coding region of Genbank Accession Number X92969).

SEQ ID NO: 22: amino acid sequence of the protein encoded by the nucleic acid set forth in SEQ ID NO: 21

SEQ ID NO: 23: nucleic acid encoding the murine olfactory receptor mOR-EV (vanillin-sensitive) (Genbank Accession Number AB061229)

SEQ ID NO: 24: amino acid sequence of the protein encoded by the nucleic acid set forth in SEQ ID NO: 23

SEQ ID NO: 25: nucleic acid encoding the murine olfactory receptor or 37a (Genbank Accession Number AJ133424)

SEQ ID NO: 26: amino acid sequence of the protein encoded by the nucleic acid set forth in SEQ ID NO: SEQ ID NO: 27: nucleic acid encoding the murine olfactory receptor C6 (Genbank Accession Number AF102523)

SEQ ID NO: 28: amino acid sequence of the protein encoded by the nucleic acid set forth in SEQ ID NO: 27

SEQ ID NO: 29: nucleic acid encoding the murine olfactory receptor F5 (Genbank Accession Number AF102531)

SEQ ID NO: 30: amino acid sequence of the protein encoded by the nucleic acid set forth in SEQ ID NO: 29

SEQ ID NO: 31: nucleic acid encoding the murine olfactory receptor S6 (Genbank Accession Number AF121974)

SEQ ID NO: 32: amino acid sequence of the protein encoded by the nucleic acid set forth in SEQ ID NO: 31

SEQ ID NO: 33: nucleic acid encoding the murine olfactory receptor S18 (Genbank Accession Number AF121975)

SEQ ID NO: 34: amino acid sequence of the protein encoded by the nucleic acid set forth in SEQ ID NO: 33

SEQ ID NO: 35: nucleic acid encoding the murine olfactory receptor S25 (Genbank Accession Number AF121977)

SEQ ID NO: 36: amino acid sequence of the protein encoded by the nucleic acid set forth in SEQ ID NO: SEQ ID NO: 37: nucleic acid encoding the murine olfactory receptor S46 (Genbank Accession Number AF121979)

SEQ ID NO: 38: amino acid sequence of the protein encoded by the nucleic acid set forth in SEQ ID NO: 37

SEQ ID NO: 39: nucleic acid encoding the a subunit of murine G-coupled protein (Genbank Accession Number M36778)

SEQ ID NO: 40: amino acid sequence of the protein encoded by the nucleic acid set forth in SEQ ID NO: 39

SEQ ID NO: 41: nucleic acid encoding the B subunit of murine G-coupled protein (Genbank Accession Number M87286)

SEQ ID NO: 42: amino acid sequence of the protein encoded by the nucleic acid set forth in SEQ ID NO: 41

SEQ ID NO: 43: nucleic acid encoding the y subunit of murine G-coupled protein (Genbank Accession Number U37527)

SEQ ID NO: 44: amino acid sequence of the protein encoded by the nucleic acid set forth in SEQ ID NO: 43

SEQ ID NO: 45: nucleic acid encoding the epidermal growth factor receptor (Genbank Accession Number BC023729)

SEQ ID NO: 46: amino acid sequence of the protein encoded by the nucleic acid set forth in SEQ ID NO: 45

SEQ ID NO: 47: the sequence of siRNA used in Example 9

SEQ ID NO: 48: the sequence of scrambled RNA used in Example 9

### BEST MODE FOR CARRYING OUT THE INVENTION

Hereinafter, the present invention will be described. It should be understood throughout the present specification that articles for a singular form (e.g., “a”, “an”, “the”, etc. in English) include the concept of their plurality unless otherwise mentioned. It should be also understood that the terms as used herein have definitions typically used in the art unless otherwise mentioned. Accordingly, unless otherwise defined, all technical and scientific terms used herein shall have the same meaning as generally understood by those skilled in the art to which the present invention pertains. If there is any inconsistency, the present specification precedes, including definitions.

### DEFINITION OF TERMS

Terms particularly used herein are defined as follows.

(System)

As used herein the term “system” refers to a collection of parts having functional association, for example, an existence separated and extracted from the circumstances as a target of analysis and discussion. Systems include, but are not limited to: for example, scientific systems (for example, physical systems, chemical systems, biological systems (for example, cells, tissues, organs, organisms and the like), geophysical systems, astronomical systems, and the like), social scientific systems (for example, company organization and the like), human scientific systems (for example, history, geography and the like), economic systems (for example, stock price, exchange and the like), machinery systems (for example, computers, apparatus and the like) and the like.

As used herein the term “scientific system” is interchangeably used with “natural scientific system” to refer to any system relating to science and technology (natural science and the like). Scientific systems include, but are not limited- to: for example, physical systems, chemical systems, biological systems, geophysical systems, astronomical systems, and the like.

As used herein the term “biological system” refers to any system relating to biology. Accordingly, biological systems include, but are not limited to: for example, biological organisms (bodies), organs, tissues (biological tissues), cells, cellular organelles (for example, chloroplasts, mitochondria, and the like), intracellular fractions, chromosomes, genomes, genetic clusters, and the like.

The term “cell” is herein used in its broadest sense in the art, referring to a structural unit of the tissue of a multicellular organism, which is capable of self replicating, has genetic information and a mechanism for expressing it, and is surrounded by a membrane structure which isolates the cell from the outside. Cells used herein may be either naturally-occurring cells or artificially modified cells (e.g., fusion cells, genetically modified cells, etc.), as long as the cell has a chemical receptor or is capable of having such a chemical receptor introduced therein. Examples of cell sources include, but are not limited to, a single-cell culture; the embryo, blood, or body tissue of normally-grown transgenic animals; a mixture of cells derived from normally-grown cell lines; and the like.

As used herein, the term “digital cell” refers to a collection of at least one experimental data on a cell of experimental interest. These experimental data correlate the experimental conditions and the experimental results of an example conducted from an actual cell. The digital cell is constituted such that once an experimental condition is given, the experimental result related to said experimental condition will be reproduced. The digital cell reflected by the present invention comprises any cell which is amenable to an experiment. It should be understood that the description with respect to all the (living) cells described herein can be applied to a digital cell according to the present invention, as long as such description is applicable to the digital cell.

Using digital cells of the present invention allows reproduction of an experimental result of an experiment conducted using an actual cell, in a computer system. As such, the present invention allow research institutes, educational organizations and individuals having no experimental facilities, to conduct education and advanced research relating to a cell. As a result, business entities in different fields will be able to start business in this field, which has not been possible to date.

Cells used herein may be derived from any organism (e.g., any unicellular organism (e.g., bacteria and yeast) or any multicellular organisms (e.g., animals (e.g., vertebrates and invertebrates), plants (e.g., monocotyledons and dicotyledons, etc.)). For example, cells used herein are derived from a vertebrate (e.g., Myxiniformes, Petronyzoniformes, Chondrichthyes, Osteichthyes, amphibian, reptilian, avian, mammalian, etc.), more preferably mammalian (e.g., monotremata, marsupialia, edentate, dermoptera, chiroptera, carnivore, insectivore, proboscidea, perissodactyla, artiodactyla, tubulidentata, pholidota, sirenia, cetacean, primates, rodentia, lagomorpha, etc.). In one embodiment, cells derived from primates (e.g., chimpanzee, Japanese monkey, human) are used. Particularly, without limitation, cells derived from a human are used. The above-described cells may be either stem cells or somatic cells. Also, the cells may be adherent cells, suspended cells, tissue forming cells, and mixtures thereof. The cells may be used for transplantation.

Any organ may be targeted by the present invention. A tissue or cell targeted by the present invention may be derived from any organ. As used herein, the term “organ” refers to a morphologically independent structure, localized to a particular portion of an individual organism, in which a certain function is performed. In multicellular organisms (e.g., animals, plants), an organ consists of several tissues spatially arranged in a particular manner, each tissue being composed of a number of cells. An example of such an organ includes an organ relating to the vascular system. In one embodiment, organs targeted by the present invention include, but are not limited to, skin, blood vessels, cornea, kidney, heart, liver, umbilical cord, intestine, nerve, lung, placenta, pancreas, brain, peripheral limbs, retina, and the like. As used herein, cells differentiated from a pluripotent cell of the present invention include, but are not limited to: epidermal cells, pancreatic parenchymal cells, pancreatic duct cells, hepatic cells, blood cells, cardiac muscle cells, skeletal muscle cells, osteoblasts, skeletal myoblasts, neurons, vascular endothelial cells, pigment cells, smooth muscle cells, fat cells, bone cells, cartilage cells, and the like.

As used herein, the term “tissue” refers to an aggregate of cells having substantially the same function and/or form in a multicellular organism. “Tissue” is typically an aggregate of cells of the same origin, but may be an aggregate of cells of different origins as long as the cells have the same function and/or form. Therefore, when stem cells of the present invention are used to regenerate tissue, the tissue may be composed of an aggregate of cells of two or more different origins. Typically, a tissue constitutes a part of an organ. Animal tissues are separated into epithelial tissue, connective tissue, muscular tissue, nervous tissue, and the like, on a morphological, functional, or developmental basis. Plant tissues are roughly separated into meristematic tissue and permanent tissue, according to the developmental stage of the cells constituting the tissue. Alternatively, tissues may be separated into single tissues and composite tissues according to the type of cells constituting the tissue. Thus, tissues are separated into various categories.

As used herein, the term “stem cell” refers to a cell capable of self replication and pluripotency. Typically, stem cells can regenerate an injured tissue. Stem cells used herein may be, but are not limited to, embryonic stem (ES) cells or tissue stem cells (also called tissular stem cells, tissue-specific stem cells, or somatic stem cells). A stem cell may be an artificially produced cell (e.g., fusion cells, reprogrammed cells, or the like used herein), as long as it has the above-described abilities. Embryonic stem cells are pluripotent stem cells derived from early embryos. An embryonic stem cell was first established in 1981, and has been applied to the production of knockout mice since 1989. In 1998, a human embryonic stem cell was established, which is currently becoming available for regenerative medicine. Tissue stem cells have a relatively limited level of differentiation, unlike embryonic stem cells. Tissue stem cells are present in tissues and have an undifferentiated intracellular structure. Tissue stem cells have a higher nucleus/cytoplasm ratio and have few intracellular organelles. Most tissue stem cells have pluripotency, a long cell cycle, and proliferative ability beyond the life of the individual. As used herein, stem cells may be embryonic stem cells or tissue stem cells.

Tissue stem cells are separated into categories of sites from which the cells are derived, such as the dermal system, the digestive system, the bone marrow system, the nervous system, and the like. Tissue stem cells in the dermal system include epidermal stem cells, hair follicle stem cells, and the like. Tissue stem cells in the digestive system include pancreatic (common) stem cells, liver stem cells, and the like. Tissue stem cells in the bone marrow system include hematopoietic stem cells, mesenchymal stem cells, and the like. Tissue stem cells in the nervous system include neural stem cells, retinal stem cells, and the like.

As used herein, the term “somatic cell” refers to any cell other than a germ cell, such as an egg, a sperm, or the like, which does not transfer its DNA to the next generation. Typically, somatic cells have limited or no pluripotency. Somatic cells used herein may be naturally-occurring or genetically modified.

The origin of a stem cell is categorized into the ectoderm, endoderm, or mesoderm. Stem cells of ectodermal origin are mostly present in the brain, including neural stem cells. Stem cells of endodermal origin are mostly present in bone marrow, including blood vessel stem cells, hematopoietic stem cells, mesenchymal stem cells, and the like. Stem cells of mesoderm origin are mostly present in organs, including liver stem cells, pancreatic stem cells, and the like. Somatic cells may be herein derived from any germ layer. Preferably, somatic cells, such as lymphocytes, spleen cells or testis-derived cells, may be used.

As used herein, the term “isolated” means that naturally accompanying material is at least reduced, or preferably substantially completely eliminated, in the normal environment. Therefore, the term “isolated cell” refers to a cell substantially free from other accompanying substances (e.g., other cells, proteins, nucleic acids, etc.) in the natural environment. The term isolated in relation to nucleic acids or polypeptides means that, for example, the nucleic acids or the polypeptides are substantially free from cellular substances or culture media when they are produced by recombinant DNA techniques; or precursory chemical substances or other chemical substances when they are chemically synthesized. Isolated nucleic acids are preferably free from sequences that naturally flank the nucleic acid within an organism from which the nucleic acid is derived (i.e., sequences positioned at the 5′ terminus and the 3′ terminus of the nucleic acid).

As used herein, the term “established” in relation to cells refers to a state of a cell in which a particular property (pluripotency) of the cell is maintained and the cell undergoes stable proliferation under culture conditions. Therefore, established stem cells maintain pluripotency.

As used herein, the term “differentiated cell” refers to a cell having a specialized function and form (e.g., muscle cells, neurons, etc.). Unlike stem cells, differentiated cells have no or little pluripotency. Examples of differentiated cells include epidermic cells, pancreatic parenchymal cells, pancreatic duct cells, hepatic cells, blood cells, cardiac muscle cells, skeletal muscle cells, osteoblasts, skeletal myoblasts, neurons, vascular endothelial cells, pigment cells, smooth muscle cells, fat cells, bone cells, cartilage cells, and the like.

As used herein, the term “state” refers to a condition concerning various parameters of a cell (e.g., cell cycle, response to an external factor, signal transduction, gene expression, gene transcription, etc.). Examples of such a state include, but are not limited to, differentiated states, undifferentiated states, responses to external factors, cell cycles, growth states, and the like.

As used herein, the terms “differentiation” or “cell differentiation” refers to a phenomenon where two or more types of cells having qualitative differences in form and/or function occur in a daughter cell population derived from the division of a single cell. Therefore, “differentiation” includes a process during which a population (family tree) of cells, which do not originally have a specific detectable feature, acquire a feature, such as the production of a specific protein, or the like. At present, cell differentiation is generally considered to be a state of a cell in which a specific group of genes in the genome are expressed. Cell differentiation can be identified by searching for intracellular or extracellular agents or conditions which elicit the above-described state of gene expression. Differentiated cells are stable in principle. Particularly, animal cells which have been differentiated once rarely re-differentiate into other types of cells.

As used herein, the term “pluripotency” refers to a nature of a cell, i.e., an ability to differentiate into one or more, preferably two or more, tissues or organs. Therefore, the terms “pluripotent” and “undifferentiated” are herein used interchangeably unless otherwise mentioned. Typically, the pluripotency of a cell is limited during development, and in an adult, cells constituting a tissue or organ rarely differentiate into different cells, that is, the pluripotency is usually lost. Particularly, epithelial cells resist altering into other types of epithelial cells. Such alteration typically occurs in pathological conditions, and is called metaplasia. However, mesenchymal cells tend to easily undergo metaplasia, i.e., alter to other mesenchymal cells, with relatively simple stimuli. Therefore, mesenchymal, cells have a high level of pluripotency. Embryonic stem cells have pluripotency. Tissue stem cells have pluripotency. Thus, the term “pluripotency” may include the concept of totipotency. An example of an in vitro assay for determining whether or not a cell has pluripotency, includes, but is not limited to, culturing under conditions for inducing the formation and differentiation of embryoid bodies. Examples of an in vivo assay for determining the presence or absence of pluripotency, include, but are not limited to, implantation of a cell into an immunodeficient mouse so as to form teratoma, injection of a cell into a blastocyst so as to form a chimeric embryo, implantation of a cell into a tissue of an organism (e.g., injection of a cell into ascites) so as to undergo proliferation, and the like. As used herein, one type of pluripotency is “totipotency”, which refers to the ability to be differentiated into all kinds of cells which constitute an organism. The idea of pluripotency encompasses totipotency. An example of a totipotent cell is a fertilized ovum. An ability to be differentiated into only one type of cell is called “unipotency”.

(Biochemistry and Molecular Biology)

As used herein, the term “agent” may refer to any substance or element as long as an intended object can be achieved (e.g., energy, such as ionizing radiation, radiation, light, acoustic waves, and the like). Examples of such a substance include, but are not limited to, proteins, polypeptides, oligopeptides, peptides, polynucleotides, oligonucleotides, nucleotides, nucleic acids (e.g., DNA such as cDNA, genomic DNA and the like, or RNA such as mRNA, RNAi and the like), polysaccharides, oligosaccharides, lipids, low molecular weight organic molecules (e.g., hormones, ligands, information transduction substances, low molecular weight organic molecules, molecules synthesized by combinatorial chemistry, low molecular weight molecules usable as medicaments (e.g., low molecular weight molecule ligands, etc.), etc.), and composite molecules thereof. External agents may be used singly or in combination. Examples of an agent specific to a polynucleotide include, but are not limited to, representatively, a polynucleotide having complementarity to the sequence of the polynucleotide with a predetermined sequence homology (e.g., 70% or more sequence identity), a polypeptide such as a transcriptional agent binding to a promoter region, and the like. Examples of an agent specific to a polypeptide include, but are not limited to, representatively, an antibody specifically directed to the polypeptide or derivatives or analogs thereof (e.g., single chain antibody), a specific ligand or receptor when the polypeptide is a receptor or ligand, a substrate when the polypeptide is an enzyme, and the like.

As used herein the term “biological agent” refers to an agent relating to a biological organism (for example, a cell). Preferably, an agent present in a cell in a normal state is referred to a biological agent. Such biological agents include, but are not limited to, for example: nucleic acid molecules, proteins, sugars, lipids, metabolites, low molecular weight molecules, and complexes thereof, and agents including time elements and the like. Alternatively, it should be understood that such biological agents include electric current, electric potential (such as membrane potential), pH, osmotic pressure and the like in the present invention. Useful biological agents as used herein include, for example, transcriptional controlling sequence (for example, promoters and the like), structural genes, and nucleic acids encoding the same. As used herein a “collection” of “biological agents” refer to a plurality of biological agents (of the same or different types). Preferably, the collection refers to biological agents which cooperate with each other.

As used herein, the term “gene” refers to an element defining a genetic trait. A gene is typically arranged in a given sequence-on a chromosome. A gene which defines the primary structure of a protein is called a structural gene. A gene which regulates the expression of a structural gene is called a regulatory gene (e.g., promoter). Genes herein include structural genes and regulatory genes unless otherwise specified. Recently, genomes have been analyzed and the entire sequence thereof per se has been determined. Although not all the functions thereof have been determined, there are sequences which do not encode proteins or RNA. Such a sequence is well known to have effects on genotype thereof. It is understood that such a sequence is included within the concept of the gene in the broadest sense. Therefore, the term “cyclin gene” typically includes the structural gene of cyclin and the promoter of cyclin. As used herein, “gene” may refer to “polynucleotide”, “oligonucleotide”, “nucleic acid”, and “nucleic acid molecule” and/or “protein”, “polypeptide”, “oligopeptide” and “peptide”. As used herein, “gene product” includes “polynucleotide”, “oligonucleotide”, “nucleic acid” and “nucleic acid molecule” and/or “protein”, “polypeptide”, “oligopeptide” and “peptide”, which are expressed by a gene. Those skilled in the art understand what a gene product is, according to the context.

As used herein, the term “homology” in relation to a sequence (e.g., a nucleic acid sequence, an amino acid sequence, etc.) refers to the level of identity between two or more gene sequences. Therefore, the greater the homology between two given genes, the greater the identity or similarity between their sequences. Whether or not two genes have homology is determined by comparing their sequences directly or by a hybridization method under stringent conditions. When two gene sequences are directly compared with each other, these genes have homology if the DNA sequences of the genes have representatively at least 50% identity, preferably at least 70% identity, more preferably at least 80%, 90%, 95%, 96%, 97%, 98%, or 99% identity with each other. As used herein, the term “similarity” in relation to a sequence (e.g., a nucleic acid sequence, an amino acid sequence, or the like) refers to the level of identity between two or more sequences when conservative substitution is regarded as positive (identical) in the above-described homology. Therefore, homology and similarity differ from each other in the presence of conservative substitutions. If no conservative substitutions are present, homology and similarity have the same value.

As used herein, the comparison of similarity, identity and homology of an amino acid sequence and a nucleotide sequence is calculated with FASTA, a tool for sequence analysis using default parameters.

The terms “protein”, “polypeptide”, “oligopeptide” and “peptide” as used herein have the same meaning and refer to an amino acid polymer having any length. This polymer may be a straight, branched or cyclic chain. An amino acid may be a naturally-occurring or non naturally-occurring amino acid, or a variant amino acid. The term may include those assembled into a composite of a plurality of polypeptide chains. The term also includes naturally-occurring or artificially modified amino acid polymers. Such modification includes, for example, disulfide bond formation, glycosylation, lipidation, acetylation, phosphorylation, or any other manipulation or modification (e.g., conjugation with a labeling moiety). This definition encompasses a polypeptide containing at least one amino acid analog (e.g., non naturally-occurring amino acid, etc.), a peptide-like compound (e.g., peptoid), and other variants known in the art, for example. Gene products, such as extracellular matrix proteins (e.g., fibronectin, etc.), are usually in the form of a polypeptide.

The terms “polynucleotide”, “oligonucleotide”, “nucleic acid molecule” and “nucleic acid” as used herein have the same meaning and refer to a nucleotide polymer having any length. This term also includes an “oligonucleotide derivative” or a “polynucleotide derivative”. An “oligonucleotide derivative” or a “polynucleotide derivative” includes a nucleotide derivative, or refers to an oligonucleotide or a polynucleotide having different linkages between nucleotides from typical linkages, which are interchangeably used. Examples of such oligonucleotides specifically include 2′-O-methyl-ribonucleotide, an oligonucleotide derivative in which a phosphodiester bond in an oligonucleotide is converted to a phosphorothioate bond, an oligonucleotide derivative in which a phosphodiester bond in an oligonucleotide is converted to a N3′-P5′ phosphoroamidate bond, an oligonucleotide derivative in which a ribose and a phosphodiester bond in an oligonucleotide are converted to a peptide-nucleic acid bond, an oligonucleotide derivative in which uracil in an oligonucleotide is substituted with C-5 propynyl uracil, an oligonucleotide derivative in which uracil in an oligonucleotide is substituted with C-5 thiazole uracil, an oligonucleotide derivative in which cytosine in an oligonucleotide is substituted with C-5 propynyl cytosine, an oligonucleotide derivative in which cytosine in an oligonucleotide is substituted with phenoxazine-modified cytosine, an oligonucleotide derivative in which ribose in DNA is substituted with 2′-O-propyl ribose, and an oligonucleotide derivative in which ribose is substituted with 2′-methoxyethoxy ribose. Unless otherwise indicated, a particular nucleic acid sequence also implicitly encompasses conservatively-modified variants thereof (e.g. degenerate codon substitutions) and complementary sequences as well as the sequence explicitly indicated. Specifically, degenerate codon substitutions may be produced by generating sequences in which the third position of one or more selected (or all) codons is substituted with mixed-base and/or deoxyinosine residues (Batzer et al., Nucleic Acid Res. 19:5081 (1991); Ohtsuka et al., J. Biol. Chem. 260:2605-2608 (1985); Rossolini et al., Mol. Cell. Probes 8:91-98(1994)). A gene encoding an extracellular matrix protein (e.g., fibronectin, etc.) or the like is usually in the form of a polynucleotide. A molecule to be transfected is in the form of a polynucleotide.

As used herein, the term “corresponding” amino acid or nucleic acid refers to an amino acid or nucleotide in a given polypeptide or polynucleotide molecule, which has, or is anticipated to have, a function similar to that of a predetermined amino acid or nucleotide in a polypeptide or polynucleotide as a reference for comparison. Particularly, in the case of enzyme molecules, the term refers to an amino acid which is present at a similar position in an active site and similarly contributes to catalytic activity. For example, in the case of a transcriptional controlling sequence of a polynucleotide, it may be a portion similar to that of a corresponding ortholog in the particular portion of the transcription controlling sequence.

As used herein, the term “corresponding” gene (e.g., a polypeptide or polynucleotide molecule) refers to a gene in a given species, which has, or is anticipated to have, a function similar to that of a predetermined gene in a species as a reference for comparison. When there is a plurality of genes having such a function, the term refers to a gene having the same evolutionary origin. Therefore, a gene corresponding to a given gene may be an ortholog of the given gene. Therefore, genes corresponding to mouse cyclin can be found in other animals. Such corresponding genes can be identified by techniques well known in the art. Therefore, for example, a corresponding gene in a given animal can be found by searching a sequence database of the animal (e.g., human, rat) using the sequence of a reference gene (e.g., mouse cyclin gene, etc.) as a query sequence.

As used herein, the term “fragment” with respect to a polypeptide or polynucleotide refers to a polypeptide or polynucleotide having a sequence length ranging from 1 to n−1 with respect to the full length of the reference polypeptide or polynucleotide (of length n). The length of the fragment can be appropriately changed depending on the purpose. For example, in the case of polypeptides, the lower limit of the length of the fragment includes 3, 4, 5, 6, 7, 8, 9, 10, 15, 20, 25, 30, 40, 50 or more amino acids. Lengths represented by integers which are not herein specified (e.g., 11 and the like) may be appropriate as a lower limit. For example, in the case of polynucleotides, the lower limit of the length of the fragment includes 5, 6, 7, 8, 9, 10, 15, 20, 25, 30, 40, 50, 75, 100 or more nucleotides. Lengths represented by integers which are not herein specified (e.g., 11 and the like) may be appropriate as a lower limit. As used herein, the length of polypeptides or polynucleotides can be represented by the number of amino acids or nucleic acids, respectively. However, the above-described numbers are not absolute. The above-described numbers as the upper or lower limit are intended to include some greater or smaller numbers (e.g., ±10%), as long as the same function is maintained. For this purpose, “about,” may be herein put ahead of the numbers. However, it should be understood that the interpretation of numbers is not affected by the presence or absence of “about” in the present specification.

As used herein, the term “biological activity” refers to activity possessed by an agent (e.g., a polynucleotide, a protein, etc.) within an organism, including activities exhibiting various functions (e.g., transcription promoting activity, etc.). For example, when a certain factor is an enzyme, the biological activity thereof includes its enzyme activity. In another example, when a certain factor is a ligand, the biological activity thereof includes the binding of the ligand to its corresponding receptor. The above-described biological activity can be measured by techniques well-known in the art.

As used herein, the term “polynucleotides hybridizing under stringent conditions” refers to conditions commonly used and well known in the art. Such polynucleotides can be obtained by conducting colony hybridization, plaque hybridization, Southern blot hybridization, or the like, using a polynucleotide selected from the polynucleotides of the present invention. Specifically, a filter on which DNA derived from a colony or plaque is immobilized is used to conduct hybridization at 65° C. in the presence of 0.7 to 1.0 M NaCl. Thereafter, a 0.1 to 2-fold concentration SSC (saline-sodium citrate) solution (1-fold concentration SSC solution containing 150 mM sodium chloride and 15 mM sodium citrate) is used to wash the filter at 65° C. Polynucleotides identified by this method are referred to as “polynucleotides hybridizing under stringent conditions”. Hybridization can be conducted in accordance with a method described in, for example, Molecular Cloning 2nd ed., Current Protocols in Molecular Biology, Supplement 1-38, DNA Cloning 1: Core Techniques, A Practical Approach, Second Edition, Oxford University Press (1995), and the like. Here, sequences hybridizing under stringent conditions exclude, preferably, sequences containing only A or T. “Hybridizable polynucleotide” refers to a polynucleotide which can hybridize to other polynucleotides under the above-described hybridization conditions. Specifically, the hybridizable polynucleotide includes at least a polynucleotide having a homology of at least 60% to the base sequence of DNA encoding a polypeptide having an amino acid sequence specifically herein disclosed, preferably a polynucleotide having a homology of at least 80%, and more preferably a polynucleotide having a homology of at least 95%.

As used herein, the term “salt” has the same meaning as that commonly understood by those skilled in the art, including both inorganic and organic salts. Salts are typically generated by neutralizing reactions between acids and bases. Salts include NaCl, K₂SO₄, and the like, which are generated by neutralization, and in addition, PbSO₄, ZnCl₂, and the like, which are generated by reactions between metals and acids. The latter salts may not be generated directly by neutralizing reactions, but may be regarded as a product of neutralizing reactions between acids and bases. Salts may be divided into the following categories: normal salts (salts without any H-groups from acids or without any OH-groups from bases, including, for example, NaCl, NH₄Cl, CH₃COONa, and Na₂CO₃), acid salts (salts with remaining H-groups from acids, including, for example, NaHCO₃, KHSO₄, and CaHPO₄), and basic salts (salts with remaining OH-groups from bases, including, for example, MgCl(OH) and CuCl(OH)). This classification is not very important in the present invention. Examples of preferable salts include salts constituting media (e.g., calcium chloride, sodium hydrogen phosphate, sodium hydrogen carbonate, sodium pyruvate, HEPES, sodium chloride, potassium chloride, magnesium sulfide, iron nitrate, amino acids, vitamins, etc.), salts constituting buffer (e.g., calcium chloride, magnesium chloride, sodium hydrogen phosphate, sodium chloride, etc.), and the like. These salts are preferable as they have a high affinity for cells and thus are more able to maintain cells in culture. These salts may be used singly or in combination. Preferably, these salts may be used in combination. This is because a combination of salts tends to have a higher affinity for cells. Therefore, a plurality of salts (e.g., calcium chloride, magnesium chloride, sodium hydrogen phosphate, and sodium chloride) is preferably contained in a medium, rather than only NaCl or the like. More preferably, all salts suitable for cell culture medium may be added to the medium. In another preferred embodiment, glucose may be added to medium.

As used herein the term “material” or “substance” is used in the broadest meaning as used in the art to refer to any thing that is positively or negatively charged.

As used herein, the term “positively charged substance” encompasses all substances having a positive charge. Such substances include cationic substances such as cationic polymers, cationic lipids and the like, but are not limited to these. Advantageously, such positively charged substances can form a complex. Such positively charged substances which can form a complex include, for example, substances having a certain molecular weight (for example, cationic polymers) and substances which can remain insoluble, that is, without being dissolved to a certain extent in a specific solvent such as water, an aqueous solution or the like (for example, cationic lipids), but are not limited to these. Preferable positively charged substances include, for example, polyethylene imine, poly-L-lysine, synthetic polypeptides, or derivatives thereof, but are not limited to these. Positively charged substances include, for example, biological molecules such as histone and synthetic polypeptides, but are not limited to these. The type of preferable positively charged substances changes in accordance with the type of negatively charged substances, which act as a complex partner to form complexes with the positively charged substances. It requires no specific creativity for those skilled in the art to select a preferable complex partner using technologies well known in the art. For selecting a preferable complex partner, various parameters are considered including, but not limited to, charge, molecular weight, hydrophobicity, hydrophilicity, properties of substituents, pH, temperature, salt concentration, pressure, and other physical and chemical parameters.

As used herein, the term “cationic polymer” refers to a polymer having a cationic functional group, and encompasses, for example, polyethylene imine, poly-L-lysine, synthetic polypeptides, and derivatives thereof, but is not limited to these.

As used herein, the term “cationic lipid” refers to a lipid having a cationic functional group, and encompasses, for example, phosphatidyl choline, phosphatidyl ethanol amine, phosphatidyl serine, and derivatives thereof, but is not limited to these.

Cationic functional groups include, for example, primary amines, secondary amines, and tertiary amines, but are not limited thereto.

As used herein, the term “negatively charged substance” encompasses all substances having a negative charge. Such substances include biological molecular polymers, anionic substances such as anionic lipids, and the like, but are not limited to these. Advantageously, such negatively charged substances can form a complex. Such negatively charged substances which can form a complex include, for example, substances having a certain molecular weight (for example, anionic polymers such as DNA) and substances which can remain insoluble, that is, without being dissolved to a certain extent in a specific solvent such as water, an aqueous solutions or the like (for example, anionic lipids), but are not limited to these. Preferable negatively charged substances include, for example, DNA, RNA, PNA, polypeptides, chemical compounds, and complexes thereof, but are not limited to these. Negatively charged substances include, for example, DNA, RNA, PNA, polypeptides, chemical compounds, and complexes thereof, but are not limited to these. The type of preferable negatively charged substances changes in accordance with the type of positively charged substances, which act as a complex partner to form complexes with the negatively charged substances. It requires no specific creativity for those skilled in the art to select a preferable complex partner using technologies well known in the art. For selecting a preferable complex partner, various parameters are considered as described above with regard to negatively charged substances.

As used herein, the term “anionic polymer” encompasses polymers having an anionic functional group, and includes, for example, DNA, RNA, PNA, polypeptides, chemical compounds, and complexes thereof, but is not limited to these.

As used herein, the term “anionic lipid” encompasses lipids having an anionic functional group, and include, for example, phosphatidic acid, phosphatidyl serine, but is not limited to these.

Anionic functional groups include, for example, carboxylic groups and phosphoric acid groups, but are not limited to these.

The type of charge of a target substance can be converted by adding a part of a substituent or the like having a positive charge or a negative charge to the target substance. In the case where a preferable complex partner has the same type of charge as that of the target substance, formation of a complex can be promoted by converting the type of charge of either the complex partner or the target substance.

As used herein, the term “complex” refers to two or more substances which directly or indirectly interact with each other and as a result, act as if they were one substance as a whole.

As used herein, the term “complex partner” used for a certain member forming a complex refers to another member interacting with the certain member directly or indirectly.

As used herein, the condition for forming a complex changes in accordance with the type of complex partner. Such a condition can be easily understood by those skilled in the art. Those skilled in the art can easily form a complex from any complex partners (for example, a positively charged substance and a negatively charged substance) using techniques well known in the art.

As used herein, when a complex of positively and negatively charged substances is used, either or both thereof may be identical to a biological agent.

As used herein, the term “immobilization” used for a solid-phase support refers to a state in which a substance as a subject of immobilization (e.g., a biological molecule) is held on the support for at least a certain time period, or an act-of placing the substance into such a state. As such, in the case where the condition is changed after the substance is immobilized on the solid-phase support (for example, the substance is immersed in another solvent), the substance may be released from the immobilization state.

As used herein, the term “cell affinity” refers to a property of a substance that when the substance is placed in an interactable state with a cell (e.g. germ cell, animal cell, yeast, plant cell) or an object containing a cell (e.g., tissue, organs, biological organisms), the substance does not have any adverse influence on the cell or the object containing the cell. Preferably, substances having cell affinity may be substances with which a cell interacts as a priority, but are not limited to these. According to the present invention, the substance to be immobilized (e.g., positively charged substances and/or negatively charged substances) preferably have cell affinity, but cell affinity is not absolutely necessary. It was unexpectedly found that when the substance to be immobilized has cell affinity, the cell affinity of the substance is maintained or improved when the substance is immobilized according to the present invention. In light of the past situation where a substance having cell affinity does not necessarily maintain its cell affinity when immobilized on a solid-phase support, the effect of the present invention is enormous.

As used herein, the term “probe” refers to a substance for use in searching, which is used in a biological experiment, such as in vitro and/or in vivo screening or the like, including, but not limited to, for example, a nucleic acid molecule having a specific base sequence or a peptide containing a specific amino acid sequence.

Examples of a nucleic acid molecule as a common probe include one having a nucleic acid sequence having a length of at least 8 contiguous nucleotides, which is homologous or complementary to the nucleic acid sequence of a gene of interest. Such a nucleic acid sequence may be preferably a nucleic acid sequence having a length of at least 9 contiguous nucleotides, more preferably a length of at least 10 contiguous nucleotides, and even more preferably a length of at least 11 contiguous nucleotides, a length of at least 12 contiguous nucleotides, a length of at least 13 contiguous nucleotides, a length of at least 14 contiguous nucleotides, a length of at least 15 contiguous nucleotides, a length of at least 20 contiguous nucleotides, a length of at least 25 contiguous nucleotides, a length of at least 30 contiguous nucleotides, a length of at least 40 contiguous nucleotides, or a length of at least 50 contiguous nucleotides. A nucleic acid sequence used as a probe includes a nucleic acid sequence having at least 70% homology to the above-described sequence, more preferably at least 80%, and even more preferably at least 90% or at least 95%.

As used herein, the term “search” indicates that a given nucleic acid sequence is utilized to find other nucleic acid base sequences having a specific function and/or property either electronically or biologically, or by using other methods. Examples of electronic searches include, but are not limited to, BLAST (Altschul et al., J. Mol. Biol. 215:403-410 (1990)), FASTA (Pearson & Lipman, Proc. Natl. Acad. Sci., USA 85:2444-2448 (1988)), the Smith and Waterman method (Smith and Waterman, J. Mol. Biol. 147:195-197 (1981)), and the Needleman and Wunsch method (Needleman and Wunsch, J. Mol. Biol. 48:443-453 (1970)), and the like. Examples of a biological search include, but are not limited to, a macroarray in which genomic DNA is attached to a nylon membrane or the like or a microarray (microassay) in which genomic DNA is attached to a glass plate under stringent hybridization conditions, PCR, in situ hybridization, and the like.

As used herein, the term “primer” refers to a substance required for the initiation of a reaction of a macromolecule compound to be synthesized, in a macromolecule synthesis enzymatic reaction. In a reaction for synthesizing a nucleic acid molecule, a nucleic acid molecule (e.g., DNA, RNA, or the like) which is complementary to part of a macromolecule compound to be synthesized may be used.

A nucleic acid molecule which is ordinarily used as a primer includes one that has a nucleic acid sequence having a length of at least 8 contiguous nucleotides, which is complementary to the nucleic acid sequence of a gene of interest. Such a nucleic acid sequence preferably has a length of at least 9 contiguous nucleotides, more preferably a length of at least 10 contiguous nucleotides, even more preferably a length of at least 11 contiguous nucleotides, a length of at least 12 contiguous nucleotides, a length of at least 13 contiguous nucleotides, a length of at least 14 contiguous nucleotides, a length of at least 15 contiguous nucleotides, a length of at least 16 contiguous nucleotides, a length of at least 17 contiguous nucleotides, a length of at least 18 contiguous nucleotides, a length of at least 19 contiguous nucleotides, a length of at least 20 contiguous nucleotides, a length of at least 25 contiguous nucleotides, a length of at least 30 contiguous nucleotides, a length of at least 40 contiguous nucleotides, and a length of at least 50 contiguous nucleotides. A nucleic acid sequence used as a primer includes a nucleic acid sequence having at least 70% homology to the above-described sequence, more preferably at least 80%, even more preferably at least 90%, and most preferably at least 95%. An appropriate sequence as a primer may vary depending on the property of the sequence to be synthesized (amplified). Those skilled in the art can design an appropriate primer depending on the sequence of interest. Such primer design is well known in the art and may be performed manually or using a computer program (e.g., LASERGENE, Primer Select, DNAStar).

As used herein, the term “epitope” refers to an antigenic determinant. Therefore, the term “epitope” includes a set of amino acid residues which are involved in recognition by a particular immunoglobulin, or in the context of T cells, those residues necessary for recognition by the T cell receptor proteins and/or Major Histocompatibility Complex (MHC) receptors. This term is also used interchangeably with “antigenic determinants or antigenic determinant site”. In the field of immunology, in vivo or in vitro, an epitope is the features of a molecule (e.g., primary, secondary and tertiary peptide structure, and charge) that form a site recognized by an immunoglobulin, T cell receptor or HLA molecule. An epitope including a peptide comprises 3 or more amino acids in a spatial conformation which is unique to the epitope. Generally, an epitope consists of at least 5 such amino acids, and more ordinarily, consists of at least 6, 7, 8, 9 or 10 such amino acids. The greater the length of an epitope, the more the similarity of the epitope to the original peptide, i.e., longer epitopes are generally preferable. This is not necessarily the case when the conformation is taken into account. Methods of determining the spatial conformation of amino acids are known in the art, and include, for example, X-ray crystallography and 2-dimensional nuclear magnetic resonance spectroscopy. Furthermore, the identification of epitopes in a given protein is readily accomplished using techniques well known in the art. See, also, Geysen et al., Proc. Natl. Acad. Sci. USA (1984) 81: 3998 (general method of rapidly synthesizing peptides to determine the location of immunogenic epitopes in a given antigen); U.S. Pat. No. 4,708,871 (procedures for identifying and chemically synthesizing epitopes of antigens); and Geysen et al., Molecular immunology (1986) 23: 709 (techniques for identifying peptides with high affinity for a given antibody). Antibodies that recognize the same epitope can be identified in a simple immunoassay. Thus, methods for determining epitopes including a peptide are well known in the art. Such an epitope can be determined using a well-known, common technique by those skilled in the art if the primary nucleic acid or amino acid sequence of the epitope is provided.

Therefore, an epitope including a peptide requires a sequence having a length of at least 3 amino acids, preferably at least 4 amino acids, more preferably at least 5 amino acids, at least 6 amino acids, at least 7 amino acids, at least 8 amino acids, at least 9 amino acids, at least 10 amino acids, at least 15 amino acids, at least 20 amino acids, and 25 amino acids. Epitopes may be linear or conformational.

As used herein, the term “agent binding specifically to” a certain nucleic acid molecule or polypeptide refers to an agent which has a level of binding to the nucleic acid molecule or polypeptide equal to or higher than a level of binding to other nucleic acid molecules or polypeptides. Examples of such an agent include, but are not limited to, when a target is a nucleic acid molecule, a nucleic acid molecule having a complementary sequence of a nucleic acid molecule of interest, a polypeptide capable of binding to a nucleic acid sequence of interest (e.g., a transcription agent, etc.), and the like, and when a target is a polypeptide, an antibody, a single chain antibody, either of a pair of a receptor and a ligand, either of a pair of an enzyme and a substrate, and the like.

As used herein, the term “antibody” encompasses polyclonal antibodies, monoclonal antibodies, human antibodies, humanized antibodies, polyfunctional antibodies, chimeric antibodies, and anti-idiotype antibodies, and fragments thereof (e.g., F(ab′)2 and Fab fragments), and other recombinant conjugates. These antibodies may be fused with an enzyme (e.g., alkaline phosphatase, horseradish peroxidase, α-galactosidase, and the like) via a covalent bond or by recombination.

As used herein, the term “monoclonal antibody” refers to an antibody composition having a group of homologous antibodies. This term is not limited by the production manner thereof. This term encompasses all immunoglobulin molecules and Fab molecules, F(ab′)2 fragments, Fv fragments, and other molecules having the immunological binding property of the original monoclonal antibody molecule. Methods for producing polyclonal antibodies and monoclonal antibodies are well known in the art, and will be more sufficiently described below.

Monoclonal antibodies are prepared by using standard techniques well known in the art (e.g., Kohler and Milstein, Nature (1975) 256:495) or a modification thereof (e.g., Buck et al. (1982) In Vitro 18:377). Representatively, a mouse or rat is immunized with a protein bound to a protein carrier, and boosted. Subsequently, the spleen (and optionally several large lymph nodes) is removed and dissociated into a single cell suspension. If desired, the spleen cells may be screened (after removal of nonspecifically adherent cells) by applying the cell suspension to a plate or well coated with a protein antigen. B-cells that express membrane-bound immunoglobulin specific for the antigen bind to the plate, and are not rinsed away with the rest of the suspension. Resulting B-cells, or all dissociated spleen cells, are then induced to fuse with myeloma cells to form hybridomas. The hybridomas are used to produce monoclonal antibodies.

As used herein, the term “antigen” refers to any substrate to which an antibody molecule may specifically bind. As used herein, the term “immunogen” refers to an antigen capable of initiating activation of the antigen-specific immune response of a lymphocyte.

In a given protein molecule, a given amino acid may be substituted with another amino acid in a structurally important region, such as a cationic region or a substrate molecule binding site, without a clear reduction or loss of interactive binding ability. A given biological function of a protein is defined by the interactive ability or other property of the protein. Therefore, a particular amino acid substitution may be performed in an amino acid sequence, or at the DNA sequence level, to produce a protein which maintains the original property after the substitution. Therefore, various modifications of peptides as disclosed herein and DNA encoding such peptides may be performed without clear losses of biological activity.

When the above-described modifications are designed, the hydrophobicity indices of amino acids may be taken into consideration. The hydrophobic amino acid indices play an important role in providing a protein with an interactive biological function, which is generally recognized in the art (Kyte, J. and Doolittle, R. F., J. Mol. Biol. 157(1):105-132, 1982). The hydrophobic property of an amino acid contributes to the secondary structure of a protein and then regulates interactions between the protein and other molecules (e.g., enzymes, substrates, receptors, DNA, antibodies, antigens, etc.). Each amino acid is given a hydrophobicity index based on the hydrophobicity and charge properties thereof as follows: isoleucine (+4.5); valine (+4.2); leucine (+3.8); phenylalanine (+2.8); cysteine/cystine (+2.5); methionine (+1.9); alanine (+1.8); glycine (−0.4); threonine (−0.7); serine (−0.8); tryptophan (−0.9); tyrosine (−1.3); proline (−1.6); histidine (−3.2); glutamic acid (−3.5); glutamine (−3.5); aspartic acid (−3.5); asparagine (−3.5); lysine (−3.9); and arginine (−4.5).

It is well known that if a given amino acid is substituted with another amino acid having a similar hydrophobicity index, the resultant protein may still have a biological function similar to that of the original protein (e.g., a protein having an equivalent enzymatic activity). For such an amino acid substitution, the hydrophobicity index is preferably within ±2, more preferably within ±1, and even more preferably within ±0.5. It is understood in the art that such an amino acid substitution based on hydrophobicity is efficient.

Hydrophilicity may also be considered for conservative substitution. As described in U.S. Pat. No. 4,554,101, amino acid residues are given the following hydrophilicity indices: arginine (+3.0); lysine (+3.0); aspartic acid (+3.0±1); glutamic acid (+3.0±1); serine (+0.3); asparagine (+0.2); glutamine (+0.2); glycine (0); threonine (−0.4); proline (−0.5±1); alanine (−0.5); histidine (−0.5); cysteine (−1.0); methionine (−1.3); valine (−1.5); leucine (−1.8); isoleucine (−1.8); tyrosine (−2.3); phenylalanine (−2.5); and tryptophan (−3.4). It is understood that an amino acid may be substituted with another amino acid which has a similar hydrophilicity index and can still provide a biological equivalent. For such an amino acid substitution, the hydrophilicity index is preferably within ±2, more preferably ±1, and even more preferably ±0.5.

(Profile and its Relevant Techniques)

As used herein, the term “profile” in relation to a cell refers to a set of measurements of the biological state of the cell. Particularly, the term “profile of a cell” refers to a set of discrete or continuous values obtained by quantitatively measuring a level of a “cellular component”. A level of a cellular component includes the expression level of a gene, the transcription level of a gene (the activity level of a transcription control sequence), the amount of mRNA encoding a specific gene, and the expression level of a protein in biological systems. The level of each cellular component, such as the expression level of mRNA and/or protein, is known to alter in response to drug treatments or cellular biological perturbations or vibrations. Therefore, the measurement of a plurality of “cellular components” generates a large amount of information about the effects of stimuli on the biological state of a cell. Therefore, the profile is more and more important in the analysis of cells. Mammalian cells contain about 30,000 or more cellular components. Therefore, the profile of an individual cell is usually complicated. A profile in a predetermined state of a biological system may often be measured after stimulating the biological system. Such stimulation is performed under experimental or environmental conditions associated with the biological system. Examples of a stimulus include exposure of a biological system to a drug candidate, introduction of an exogenous gene, passage of time, deletion of a gene from the system, alteration of culture conditions, and the like. The wide range measurement of cellular components (i.e., profiles of gene replication or transcription, protein expression, and response to stimuli) has a high level of utility including comparison and investigation of the effects of drugs, diagnosis of diseases, and optimization of drug administration to patients as well as investigation of cells. Further, profiles are useful for basic life science research. Such profile data may be produced and presented as data in a variety of formats. Such formats include, but are not limited to: a function between a numerical value and a period of time, a graphic format, a image format and the like. Accordingly, data relating to a profile may also be called “profile data” as used herein. Such data production may readily be carried out by using a computer. Coding of an appropriate program may also be carried out by using well known technology in the art.

In the cell analysis of the present application, as regards to information derived from a cell or a substance interacting with the cell, a variety of processes and means for detection may be used. Such process and means for detection include, but are not limited to: those using visual perception, optical microscopes, fluorescence microscopes, reading apparatus using a laser light source, surface plasmon resonance (SPR) imaging, electric signal, chemical and biochemical markers, or a combination thereof.

As used herein, the term “time-lapse profile” in relation to a certain cell refers to a profile which indicates time-lapse changes in a parameter relating to the cell. Examples of time-lapse profiles include, but are not limited to, a time-lapse profile of transcription levels, a time-lapse profile of expression levels (translation levels), a time-lapse profile of signal transduction, a time-lapse profile of neural potential, and the like. A time-lapse profile may be produced by continuously recording a certain parameter (e.g., a signal caused by a label associated with a transcription level). Time-lapse measurement may mean continuous measurement. Therefore, the term “time-lapse profile” as used herein may also be referred to as “continuous profile”.

As used herein the term “information” of a cell refers to those acting to direct an object as a whole by binding a number of elements present in the cell. A collection of information can be said to constitute a digital cell.

As used herein, the term “state” refers to a condition concerning various parameters of a cell (e.g., cell cycle, response to an external factor, signal transduction, gene expression, gene transcription, etc.). Examples of such a state include, but are not limited to, differentiated states, undifferentiated states, responses to external factors, cell cycles, growth states, and the like. The responsiveness or resistance of an organism of interest with respect to the following parameters of the, particularly, environment of the organism may be used herein as a measure of the state of the organism: temperature, humidity (e.g., absolute humidity, relative humidity, etc.), pH, salt concentration (e.g., the concentration of all salts or a particular salt), nutrients (e.g., the amount of carbohydrate, etc.), metals (e.g., the amount or concentration of all metals or a particular metal (e.g., a heavy metal, etc.)), gas (e.g., the amount of all gases or a particular gas), organic solvent (e.g., the amount of all organic solvents or a particular organic solvent (e.g., ethanol, etc.)), pressure (e.g., local or global pressure, etc.), atmospheric pressure, viscosity, flow rate (e.g., the flow rate of a medium in which an organism is present, etc.), light intensity (e.g., the quantity of light having a particular wavelength, etc.), light wavelength (e.g., visible light, ultraviolet light, infrared light, etc.), electromagnetic waves, radiation, gravity, tension, acoustic waves, organisms other than an organism of interest (e.g., parasites, pathogenic bacteria, etc.), chemicals (e.g., pharmaceuticals, etc.), antibiotics, naturally-occurring substances, metal stresses, physical stresses, and the like.

As used herein, the term “environment” (or “Umgebung” in German) in relation to an entity refers to a circumstance which surrounds the entity. In an environment, various components and quantities of state are recognized, which are called environmental factors. Examples of environmental factors include the above-described parameters. Environmental factors are typically roughly divided into non-biological environmental factors and biological environmental factors. Non-biological environmental factors (inorganic environment factors) may be divided into physical factors and chemical factors, or alternatively, climatic factors and soil factors. Various environmental factors do not always act on organisms independently, but may be associated with one another. Therefore, environment factors may be herein observed one by one or as a whole (a whole of various parameters). It has been believed that it was difficult to maintain such an environment in a consistent state. This is particularly the case since it has been difficult to maintain cells and to immobilize cells, and to introduce substances such as nucleic acids into a cell. The present invention has also solved at least one of these problems. As used herein the term “consistent environment” refers to substantially all of the circumstances surrounding a cell of interest. Accordingly, as long as a cell can grow or differentiate in a similar manner, such environments are deemed to be consistent environments. As used herein, a consistent environment refers to an environment where the parameters are the same except for a specific stimulus (for example, an external stimulus).

Examples of such an environment include at least one factor, as a parameter, selected from the group consisting of temperature, humidity, pH, salt concentration, nutrients, metal, gas, organic solvent, pressure, atmospheric pressure, viscosity, flow rate, light intensity, light wavelength, electromagnetic waves, radiation, gravity, tension, acoustic waves, organisms (e.g., parasites, etc.) other than the organism, chemical agents, antibiotics, natural substances, mental stress, and physical stress, and any combination thereof.

Examples of temperature include, but are not limited to, high temperature, low temperature, very high temperature (e.g., 95° C., etc.), very low temperature (e.g., −80° C., etc.), a wide range of temperature (e.g., 150 to −270° C., etc.), and the like.

Examples of humidity include, but are not limited to, a relative humidity of 100%, a relative humidity of 0%, an arbitrary point from 0% to 100%, and the like.

Examples of pH include, but are not limited to, an arbitrary point from 0 to 14, and the like.

Examples of salt concentration include, but are not limited to, a NaCl concentration (e.g., 3%, etc.), an arbitrary point of other salt concentrations from 0 to 100%, and the like.

Examples of nutrients include, but are not limited to, proteins, glucose, lipids, vitamins, inorganic salts, and the like.

Examples of metals include, but are not limited to, heavy metals (e.g., mercury, cadmium, etc.), lead, gold, uranium, silver, and the like.

Examples of gas include, but are not limited to, oxygen, nitrogen, carbon dioxide, carbon monoxide, and a mixture thereof, and the like.

Examples of organic solvents include, but are not limited to, ethanol, methanol, xylene, propanol, and the like.

Examples of pressure include, but are not limited to, an arbitrary point from 0 to 10 ton/cm², and the like.

Examples of atmospheric pressure include, but are not limited to, an arbitrary point from 0 to 100 atmospheric pressure, and the like.

Examples of viscosity include, but are not limited to the viscosity of any fluid (e.g., water, glycerol, etc.) or a mixture thereof, and the like.

Examples of flow rate include, but are not limited to an arbitrary point from 0 to the velocity of light.

Examples of light intensity include, but are not limited to, a point between darkness and the level of sunlight.

Examples of light wavelength include, but are not limited to visible light, ultraviolet light (UV-A, UV-B, UV-C, etc.), infrared light (far infrared light, near infrared light, etc.), and the like.

Examples of electromagnetic waves include ones having an arbitrary wavelength.

Examples of radiation include ones having an arbitrary intensity.

Examples of gravity include, but are not limited to, an arbitrary gravity on the Earth or an arbitrary point from zero gravity to the gravity on the Earth, or an arbitrary gravity greater than or equal to a gravity on the Earth.

Examples of tension include ones having an arbitrary strength.

Examples of acoustic waves include ones having an arbitrary intensity and wavelength.

Examples of organisms other than an organism of interest include, but are not limited to, parasites, pathogenic bacteria, insects, nematodes, and the like.

Examples of chemicals include, but are not limited to hydrochloric acid, sulfuric acid, sodium hydroxide, and the like.

Examples of antibiotics include, but are not limited to, penicillin, kanamycin, streptomycin, quinoline, and the like.

Examples of naturally-occurring substances include, but are not limited to, puffer toxin, snake venom, alkaloid, and the like.

Examples of mental stress include, but are not limited to starvation, population density, confined spaces, high places, and the like.

Examples of physical stress include, but are not limited to vibration, noise, electricity, impact, and the like.

As used herein when referring to a digital cell of the present invention, the environment is presented as an “environment parameter”. Such environment parameters include, but are not limited to, medium (type, composition), pH, temperature, moisture, CO₂ concentration, O₂ concentration, the presence or absence of an antibiotic, the presence or absence of a particular nutrient and the like.

As used herein the term “stimulant” refers to an acting agent which causes or induces expression or enhancement of a specific living action given to a cell from outside. Stimuli include, but are not limited to: a physical stimulus, a chemical stimulus, a biological stimulus, a biochemical stimulus, and the like. Physical stimuli include, but are not limited to: for example, light, electric waves, electric current, pressure, sound (vibration) and the like. Chemical stimuli include but are not limited to: for example, stimuli from chemicals such as antibiotics, nutrients, vitamins, metals, ions, acids, alkalis, salts, buffers and the like. Biological stimuli include, but are not limited to: for example, the existence of another organism such as the existence of a parasitic organism or the density of a cell population and the like. Biochemical stimuli include, but are not limited to the existence of cell signaling transduction agents, and the like.

As used herein, when the digital cell of the present invention is used, a stimulus is presented as a “stimulus parameter”. A stimulus parameter corresponding to those in response to any stimulus as described herein may be used. As used herein, it should be understood that the stimulus parameter includes agents for transducing a stimulus such as a reporter and the like. Such reporters include, but are not limited to: for example, on-off regulation of expression against an antibiotic, a transcription-controlling sequence, radioactivity, fluorophores and the like.

As used herein the term “response” to a stimulus refers to any response of a cell to a stimulus such as a change in cell morphology, change in metabolism, change in other cellular behaviors, change in signal transduction and the like. Therefore, for example, results of experiments using the digital cell of the present invention may be recorded as cell dynamics data. Alternatively, when using the above reporter, the result of such a response to the stimulus may be raw data of the reporter, or data transformed from the data of the reporter.

As used herein, the term “transcription control sequence” refers to a sequence which can regulate the transcription level of a gene. Such a sequence is at least two nucleotides in length. Examples of such a sequence include, but are not limited to, promoters, enhancers, silencers, terminators, sequences flanking other genomic structural genes, genomic sequences other than exons, sequences within exons, and the like. A transcription control sequence used herein is not related to a particular type. Rather, the important information about a transcription control sequence is a time-lapse fluctuation. Such fluctuation is referred to as a process (changes in a state of a cell). Therefore, such transcription control sequence may be herein arbitrarily selected. Such transcription control sequence may include those which are not conventionally used as markers. Preferably, a transcription control sequence has the ability to bind to a transcription factor.

As used herein, the term “transcription factor” refers to a factor which regulates the process of transcription of a gene. The term “transcription factor” mainly indicates a factor which regulates a transcription initiation reaction. Transcription factors are roughly divided into the following groups: basic transcription factors required for placing an RNA polymerase into a promoter region on DNA; and transcription regulatory factors which bind to cis-acting elements present upstream or downstream of a transcription region to regulate the synthesis initiation frequency of RNA.

Basic transcription factors are prepared depending on the type of RNA polymerase. A TATA-binding protein is believed to be common to all transcription systems. Although there are a number of types of transcription factors, a typical transcription factor consists of a portion structurally required for binding to DNA and a portion required for activating or suppressing transcription. Factors which have a DNA-binding portion and can bind to cis-acting elements are collectively referred to as trans-acting factors.

A portion required for activating or suppressing transcription is involved in interaction with other transcription factors or basic transcription factors. Such a portion is believed to play a role in regulating transcription via a structural change in DNA or a transcription initiating complex. Transcription regulatory factors are divided into several groups or families according to the structural properties of these portions, including factors which play an important role in the development or differentiation of a cell.

Examples of such transcription factors include, but are not limited to, STAT1, STAT2, STAT3, GAS, NFAT, Myc, AP1, CREB, NFκB, E2F, Rb, p53, RUNX1, RUNX2, RUNX3, Nkx-2, CF₂-II, Skn-1, SRY, HFH-2, Oct-1, Oct-3, Sox-5, HNF-3b, PPARγ, and the like.

As used herein, the term “terminator” refers to a sequence which is located downstream of a protein-encoding region of a gene and which is involved in the termination of transcription when DNA is transcribed into mRNA, and the addition of a poly-A sequence. It is known that a terminator contributes to the stability of mRNA, and has an influence on the level of gene expression.

As used herein, the term “promoter” refers to a base sequence which determines the initiation site of transcription of a gene and is a DNA region which directly regulates the frequency of transcription. Transcription is initiated by the binding of RNA polymerase to a promoter. The promoter region is usually located within about 2 kbp upstream of the first exon of a putative protein coding region. Therefore, it is possible to estimate a promoter region by predicting a protein coding region in a genomic base sequence using DNA analysis software. A putative promoter region is usually located upstream of a structural gene, but is dependent on the structural gene, i.e., a putative promoter region may be located downstream of a structural gene. Preferably, a putative promoter region is located within about 2 kbp upstream of the translation initiation site of the first exon. Such promoters include, but are not limited to constitutive promoters, specific promoters and inductive promoters and the like.

As used herein, the term “enhancer” refers to a sequence which is used so as to enhance the expression efficiency of a gene of interest. One or more enhancers may be used, or no enhancer may be used.

As used herein, the term “silencer” refers to a sequence having the function of suppressing and arresting the expression of a gene. Any silencer which has such a function may be herein used. No silencer may be used.

As used herein, the term “operably linked” indicates that a desired sequence is located such that expression (operation) thereof is under control of a transcription and translation regulatory sequences (e.g., a promoter, an enhancer, and the like) or a translation regulatory sequence. In order for a promoter to be operably linked to a gene, typically, the promoter is located immediately upstream of the gene. A promoter is not necessarily adjacent to a structural gene.

Sequences flanking other genome structural genes, genomic sequences other than exons, and sequences within exons may also be herein used. For example, in addition to the above-described sequences having specific names, structural gene-flanking sequences are thought to be involved in the control of transcription in terms of “processes”. Therefore, such flanking sequences are also included in transcription control sequences. Genomic sequences other than exons and sequences within exons are also expected to be involved in the control of transcription in terms of “processes”. Therefore, genomic sequences other than exons and sequences within exons are also included in transcription control sequences.

As used herein, the term “RNAi” is an abbreviation of RNA interference and refers to a phenomenon where an agent for causing RNAi, such as double-stranded RNA (also called dsRNA), is introduced into cells and mRNA homologous thereto is specifically degraded, so that the synthesis of gene products is suppressed, and techniques using the phenomenon. As used herein, RNAi may have the same meaning as that of an agent which causes RNAi.

As used herein, the term “an agent causing RNAi” refers to any agent capable of causing RNAi. As used herein, “an agent causing RNAi of a gene” indicates that the agent causes RNAi relating to the gene and that the effect of RNAi is achieved (e.g., suppression of expression of the gene, and the like). Examples of such an agent causing RNAi include, but are not limited to, a sequence having at least about 70% homology to the nucleic acid sequence of a target gene or a sequence hybridizable thereto under stringent conditions, RNA containing a double-stranded portion having a length of at least 10 nucleotides or variants thereof. Here, this agent may be preferably DNA containing a 3′ protruding end, and more preferably the 3′ protruding end has a length of 2 or more nucleotides (e.g., 2-4 nucleotides in length).

Though not wishing to be bound by any theory, a mechanism which causes RNAi is considered to be as follows. When a molecule which causes RNAi, such as dsRNA, is introduced into a cell, an RNaseIII-like nuclease having a helicase domain (called dicer) cleaves the molecule at about 20 base pair intervals from the 3′ terminus in the presence of ATP in the case where the RNA is relatively long (e.g., 40 or more base pairs). As used herein, the term “siRNA” is an abbreviation of short interfering RNA and refers to short double-stranded RNA of 10 or more base pairs which are artificially chemically synthesized or biochemically synthesized, synthesized by an organism, or produced by double-stranded RNA of about 40 or more base pairs being degraded within the organism. siRNA typically has a structure comprising 5′-phosphate and 3′-OH, where the 3′ terminus projects by about 2 bases. A specific protein is bound to siRNA to form RISC(RNA-induced-silencing-complex). This complex recognizes and binds to mRNA having the same sequence as that of siRNA and cleaves mRNA at the middle of siRNA due to RNaseIII-like enzymatic activity. It is preferable that the relationship between the sequence of siRNA and the sequence of mRNA to be cleaved as a target is a 100% match. However, base mutations at a site away from the middle of siRNA do not completely inhibit the cleavage activity of RNAi, leaving partial activity, while base mutations in the middle of siRNA have a larger influence and the mRNA cleavage activity by RNAi is considerably lowered. As such, only mRNA having a mutation can be specifically degraded. Specifically, siRNA having a mutation located in the middle thereof is synthesized and is introduced into a cell. Therefore, in the present invention, siRNA per se, as well as an agent capable of producing siRNA (e.g., representatively dsRNA of about 40 or more base pairs) can be used as an agent capable of eliciting RNAi.

Also, though not wishing to be bound by any theory, apart from the above-described pathway, the antisense strand of siRNA binds to mRNA and siRNA functions as a primer for RNA-dependent RNA polymerase (RdRP), so that dsRNA is synthesized. This dsRNA is a substrate for a dicer again, leading to production of new siRNA. It is intended that such a reaction is amplified. Therefore, in the present invention, siRNA per se, as well as an agent capable of producing siRNA are useful. In fact, in insects and the like, for example, 35 dsRNA molecules can substantially completely degrade 1,000 or more copies of intracellular mRNA, and therefore, it will be understood that siRNA per se, as well as an agent capable of producing siRNA, is useful.

In the present invention, double-stranded RNA having a length of about 20 bases (e.g., representatively about 21 to 23 bases) or less than about 20 bases, called siRNA, can be used. Expression of siRNA in cells can suppress expression of a pathogenic gene targeted by the siRNA. Therefore, siRNA can be used for the treatment, prophylaxis, prognosis, and the like of diseases.

The siRNA of the present invention may be in any form as long as it can elicit RNAi.

In another embodiment, an agent capable of causing RNAi may have a short hairpin structure having a sticky portion at the 3′ terminus (shRNA; short hairpin RNA). As used herein, the term “shRNA” refers to a molecule of about 20 or more base pairs in which a single-stranded RNA partially contains a palindromic base sequence and forms a double-strand structure therein (i.e., a hairpin structure). shRNA can be artificially chemically synthesized. Alternatively, shRNA can be produced by linking sense and antisense strands of a DNA sequence in reverse directions and synthesizing RNA in vitro with T7 RNA polymerase using the DNA as a template. Though not wishing to be bound by any theory, it should be understood that after shRNA is introduced into a cell, the shRNA is degraded in the cell to a length of about 20 bases (e.g., representatively 21, 22, 23 bases), and causes RNAi as with siRNA, leading to the treatment effect of the present invention. It should be understood that such effect is exhibited in a wide range of organisms, such as insects, plants, animals (including mammals), and the like. Thus, shRNA elicits RNAi as with siRNA and therefore can be used as an effective component of the present invention. shRNA may preferably have a 3′ protruding end. The length of the double-stranded portion is not particularly limited, but is preferably about 10 or more nucleotides, and more preferably about 20 or more nucleotides. Here, the 3′ protruding end may be preferably DNA, more preferably DNA of at least 2 nucleotides in length, and even more preferably DNA of 2-4 nucleotides in length.

The agent capable of causing RNAi used in the present invention may be artificially synthesized (chemically or biochemically) or naturally occurring. There is substantially no difference between these agents in terms of the effect of the present invention. A chemically synthesized agent is preferably purified by liquid chromatography or the like.

An agent capable of causing RNAi used in the present invention can be produced in vitro. In this synthesis system, T7 RNA polymerase and T7 promoter are used to synthesize antisense and sense RNAs from template DNA. These RNAs are annealed and thereafter introduced into a cell. In this case, RNAi is caused via the above-described mechanism, thereby achieving the effect of the present invention. Here, for example, the introduction of RNA into cell can be carried out using a calcium phosphate method.

Another example of an agent capable of causing RNAi according to the present invention is a single-stranded nucleic acid hybridizable to mRNA, or all nucleic acid analogs thereof. Such agents are useful for the method and composition of the present invention.

As used herein, the term “time-lapse” means any action or phenomenon that is related to the passage of time.

As used herein, the term “monitor” refers to the measurement of a state of a cell using at least one parameter as a measure (e.g., a labeling signal attributed to transcription, etc.). Preferably, monitoring is performed using a device, such as a detector, a measuring instrument, or the like. More preferably, such device is connected to a computer for recording and/or processing data. Monitoring may comprise the step of obtaining image data of a solid phase support (e.g., an array, a plate, etc.).

As used herein, the term “real time” means that a certain state is substantially simultaneously displayed in another form (e.g., as an image on a display or a graph with processed data). In such a case, the “real time” lags behind an actual event by the time required for data processing. Such a time lag is included in the scope of “real time” if it is substantially negligible. Such time lag may be typically within 10 seconds, and preferably within 1 second, without limitation. A time lag exceeding 10 seconds may be included in the scope of “real time”.

As used herein, the determination of a state of a cell can be performed using various methods. Examples of such methods include, but are not limited to, mathematical processing (e.g., signal processing, multivariate analysis, etc.), empirical processing, phase changes, and the like.

As used herein, the term “difference” refers to a result of mathematical processing in which a value of a control profile (e.g., without a stimulus) is subtracted from a certain profile.

As used herein, the term “phase” in relation to a time-lapse profile refers to a result of a determination of whether the profile is positive or negative with respect to a reference point (typically 0), which is expressed with + or −, and also refers to analysis based on such a result.

As used herein, the term “correlate” or “correlation” in relation to a profile (e.g., a time-lapse profile, etc.) and a state of a cell refers to an act of associating the profile or particular information about changes, with the state of the cell. A relationship between them is referred to as “correlation” or a “correlation relationship”. Conventionally, it was substantially impossible to associate a profile (e.g., a time-lapse profile, etc.) with a state of a cell. No relationship between them was known. The present invention has an advantageous effect of performing such a correlation.

As used herein, correlation can be performed by associating at least one profile (e.g., a time-lapse profile, etc.) or changes therein, with a state of a cell, a tissue, an organ or an organism (e.g., drug resistance, etc.). For example, a profile (e.g., a time-lapse profile, etc.) or changes therein is quantitatively or qualitatively associated with at least one parameter indicating a state of a cell. A small number of profiles (e.g., time-lapse profile, etc.) may be used for correlation, as long as the correlation can be performed, typically including, without limitation, 1, preferably 2, and more preferably 3. The present invention demonstrates that at least 2, preferably at least 3, profiles (e.g., a time-lapse profile, etc.) are sufficient for specifying substantially all cells. Such an effect could not be expected by conventional profiling or assays which use point observation, and can be said to be realized by the present invention. At least one profile (e.g., a time-lapse profile, etc.) may be subjected to mathematical processing by utilizing a matrix to associate the profile with a state of a cell. In one preferred embodiment, at least 8 profiles (e.g., a time-lapse profile, etc.) may be advantageously used. By observing increases or decreases in 8 profiles, 256 results can be theoretically obtained, based on which about 300 types of cells constituting an organism can be substantially distinguished from one another. In this context, it may be more advantageous to use at least 9 or 10 structures as profiles. On the other hand, by using the technology of the present invention, it is possible to substantially understand the state of a cell, merely by selecting any single biological agent and obtaining the profile data thereof.

Examples of a specific method for correlation include, but are not limited to, signal processing (e.g., wavelet analysis, etc.), multivariate analysis (e.g., cluster analysis, etc.), and the like.

Correlation may be performed in advance or may be performed at the time of determination of cells using a control.

As used herein, the term “external factor” in relation to a cell refers to a factor which is not usually present in the cell (e.g., a substance, energy, etc.). As used herein, the term “factor” may refer to any substance or element as long as an intended object can be achieved (e.g., energy, such as ionizing radiation, radiation, light, acoustic waves, and the like). Examples of such a substance include, but are not limited to, proteins, polypeptides, oligopeptides, peptides, polynucleotides, oligonucleotides, nucleotides, nucleic acids (e.g., DNA such as cDNA, genomic DNA and the like, or RNA such as mRNA, RNAi and the like), polysaccharides, oligosaccharides, lipids, low molecular weight organic molecules (e.g., hormones, ligands, information transduction substances, low molecular weight organic molecules, molecules synthesized by combinatorial chemistry, low molecular weight molecules usable as medicaments (e.g., low molecular weight molecule ligands, etc.), etc.), and composite molecules thereof. External factors may be used singly or in combination. Examples of an external factor as used herein include, but are not limited to, temperature changes, humidity changes, electromagnetic wave, potential difference, visible light, infrared light, ultraviolet light, X-rays, chemical substances, pressure, gravity changes, gas partial pressure, osmotic pressure, and the like. In one embodiment, an external factor may be a biological molecule or a chemically synthesized substance.

As used herein, the term “biological molecule” refers to molecules relating to an organism and aggregations thereof. As used herein, the term “biological” or “organism” refers to a biological organism, including, but being not limited to, an animal, a plant, a fungus, a virus, and the like. Biological molecules include molecules extracted from an organism and aggregations thereof, though the present invention but are not limited to this. Any molecule capable of affecting an organism and aggregations thereof fall within the definition of a biological molecule. Therefore, low molecular weight molecules (e.g., low molecular weight molecule ligands, etc.), capable of being used as medicaments fall within the definition of a biological molecule as long as the effect on an organism is intended. Examples of such a biological molecule include, but are not limited to, proteins, polypeptides, oligopeptides, peptides, polynucleotides, oligonucleotides, nucleotides, nucleic acids (e.g., DNA such as cDNA and genomic DNA; RNA such as mRNA), polysaccharides, oligosaccharides, lipids, low molecular weight molecules (e.g., hormones, ligands, information transmitting substances, low molecular weight organic molecules, etc.), and composite molecules thereof and aggregations thereof (e.g., glycolipids, glycoproteins, lipoproteins, etc.), and the like. A biological molecule may include a cell itself or a portion of tissue as long as it is intended to be introduced into a cell. Typically, a biological molecule may be a nucleic acid, a protein, a lipid, a sugar, a proteolipid, a lipoprotein, a glycoprotein, a proteoglycan, or the like. Preferably, a biological molecule may include a nucleic acid (DNA or RNA) or a protein. In another preferred embodiment, the biological molecule is a nucleic acid (e.g., genomic DNA or cDNA, or DNA synthesized by PCR or the like). In another preferred embodiment, the biological molecule may be a protein. Preferably, such a biological molecule may be a hormone or a cytokine.

As used herein, the term “chemically synthesized substance” or “chemical” refers to any substance which may be synthesized by using typical chemical techniques. Such synthesis techniques are well known in the art. Those skilled in the art can produce chemically synthesized substances by combining such techniques as appropriate.

The term “cytokine” is used herein in the broadest sense in the art and refers to a physiologically active substance which is produced by a cell and acts on the same or a different cell. Cytokines are generally proteins or polypeptides having the function of controlling an immune response, regulating the endocrine system, regulating the nervous system, acting against a tumor, acting against a virus, regulating cell growth, regulating cell differentiation, or the like. Cytokines are used herein in the form of a protein or a nucleic acid or in other forms. In actual practice, cytokines are typically proteins. The terms “growth factor” refers to a substance which promotes or controls cell growth. Growth factors are also called “proliferation factors” or “development factors”. Growth factors may be added to cell or tissue culture medium, substituting for serum macromolecules. It has been revealed that a number of growth factors have a function of controlling differentiation in addition to the function of promoting cell growth. Examples of cytokines representatively include, but are not limited to, interleukins, chemokines, hematopoietic factors (e.g., colony stimulating factors), tumor necrosis factor, and interferons. Representative examples of growth factors include, but are not limited to, platelet-derived growth factor (PDGF), epidermal growth factor (EGF), fibroblast growth factor (FGF), hepatocyte growth factor (HGF), endothelial cell growth factor (VEGF), cardiotrophin, and the like, which have proliferative activity.

The term “hormone” is herein used in its broadest sense in the art, referring to a physiological organic compound which is produced in a particular organ or cell of an animal or plant, and has a physiological effect on an organ apart from the site producing the compound. Examples of such an hormone include, but are not limited to, growth hormones, sex hormones, thyroid hormones, and the like. The scope of hormones may overlap partially with that of cytokines.

As used herein, the term “actin-like substance” refers to a substance which interacts directly or indirectly with actin within cells to alter the form or state of actin. Examples of such a substance include, but are not limited to, extracellular matrix proteins (e.g., fibronectin, vitronectin, laminin, etc.), and the like. Such actin-like substances include substances identified by the following assays. As used herein, interaction with actin is evaluated by visualizing actin with an actin staining reagent (Molecular Probes, Texas Red-X phalloidin) or the like, followed by microscopic inspection to observe and determine actin aggregation, actin reconstruction or an improvement in cellular outgrowth rate. Such evaluation may be performed quantitatively or qualitatively. Actin-like substances are herein utilized so as to increase transfection efficiency. An actin-like substance used herein is derived from any organism, including, for example, mammals, such as human, mouse, bovine, and the like.

As used herein, the terms “cell adhesion agent”, “cell adhesion molecule”, “adhesion agent” and “adhesion molecule” are used interchangeably to refer to a molecule capable of mediating the joining of two or more cells (cell adhesion) or adhesion between a substrate and a cell. In general, cell adhesion molecules are divided into two groups: molecules involved in cell-cell adhesion (e.g., intercellular adhesion) are defined as cell-cell adhesion molecules, while molecules involved in cell-extracellular matrix adhesion (e.g., cell-substrate adhesion) are classified as cell-substrate adhesion molecules. For a method of the present invention, either type of molecule is useful and can be effectively used. Therefore, cell adhesion molecules herein include a substrate protein and a cellular protein (e.g., integrin, etc.) involved in cell-substrate adhesion. A molecule other than a protein can fall within the concept of a cell adhesion molecule as long as it can mediate cell adhesion.

For cell-cell adhesion, cadherin, a number of molecules belonging in an immunoglobulin superfamily (NCAM, L1, ICAM, fasciclin II, III, etc.), selectin, and the like are known to connect cell membranes via a specific molecular interaction.

On the other hand, a major cell adhesion molecule functioning for cell-substrate adhesion is integrin, which recognizes and binds to various proteins contained in extracellular matrices. These cell adhesion molecules are all located on cell membranes and can be regarded as a type of receptor (cell adhesion receptor). Therefore, receptors present on cell membranes can also be used in the method of the present invention. Examples of such a receptor include, but are not limited to, α-integrin, β-integrin, CD44, syndecan, aggrecan, and the like. Techniques for cell adhesion are well known as described above and as described in, for example, “Saibogaimatorikkusu-Rinsho—[Extracellular matrix—Clinical Applications—], Medical Review.

It can be determined whether or not a certain molecule is a cell adhesion molecule, by an assay, such as biochemical quantification (an SDS-PAGE method, a labeled-collagen method, etc.), immunological quantification (an enzyme antibody method, a fluorescent antibody method, an immunohistological study, etc.), a PCR method, a hybridization method, or the like, in which a positive reaction is detected. Examples of such a cell adhesion molecule include, but are not limited to, collagen, integrin, fibronectin, laminin, vitronectin, fibrinogen, immunoglobulin superfamily members (e.g., CD2, CD4, CD8, ICM1, ICAM2, VCAM1), selectin, cadherin, and the like. Most of these cell adhesion molecules transmit an auxiliary signal for cell activation into a cell due to intercellular interaction as well as cell adhesion. It can be determined whether or not such an auxiliary signal can be transmitted into a cell, by an assay, such as biochemical quantification (an SDS-PAGE method, a labeled-collagen method, etc.), immunological quantification (an enzyme antibody method, a fluorescent antibody method, an immunohistological study, etc.), a PCR method, a hybridization method, or the like, in which a positive reaction is detected.

Examples of cell adhesion molecules include, but are not limited to, immunoglobulin superfamily molecules (LFA-3, ICAM-1, CD2, CD4, CD8, ICM1, ICAM2, VCAM1, etc.); integrin family molecules (LFA-1, Mac-1, gpIIbIIIa, p150, p95, VLA1, VLA2, VLA3, VLA4, VLA5, VLA6, etc.); selectin family molecules (L-selectin, E-selectin, P-selectin, etc.), and the like.

As used herein, the term “extracellular matrix protein” refers to a protein constituting an “extracellular matrix”. As used herein, the term “extracellular matrix” (ECM) is also called “extracellular substrate” and has the same meaning as commonly used in the art, and refers to a substance existing between somatic cells no matter whether the cells are epithelial cells or non-epithelial cells. Extracellular matrices are involved in supporting tissue as well as in internal environmental structures essential for survival of all somatic cells. Extracellular matrices are generally produced from connective tissue cells. Some extracellular matrices are secreted from cells possessing basal membrane, such as epithelial cells or endothelial cells. Extracellular matrices are roughly divided into fibrous components and matrices filling there between. Fibrous components include collagen fibers and elastin fibers. A basic component of matrices is glycosaminoglycan (acidic mucopolysaccharide), most of which is bound to non-collagenous protein to form a polymer of a proteoglycan (acidic mucopolysaccharide-protein complex). In addition, matrices include glycoproteins, such as laminin of basal membrane, microfibrils around elastin fibers, fibers, fibronectins on cell surfaces, and the like. Specifically differentiated tissue has the same basic structure. For example, in hyaline cartilage, chondroblasts characteristically produce a large amount of cartilage matrices including proteoglycans. In bones, osteoblasts produce bone matrices which cause calcification. Examples of extracellular matrices for use in the present invention include, but are not limited to, collagen, elastin, proteoglycan, glycosaminoglycan, fibronectin, laminin, elastic fiber, collagen fiber, and the like.

As used herein, the term “receptor” refers to a molecule which is present on cells, within nuclei, or the like, and is capable of binding to an extracellular or intracellular agent wherein the binding mediates signal transduction. Receptors are typically in the form of proteins. The binding partner of a receptor is usually referred to as a ligand.

As used herein, the term “agonist” refers to an agent which binds to the receptor of a certain biologically acting substance (e.g., ligand, etc.), and has the same or similar function as the function of the substance.

As used herein, the term “antagonist” refers to a factor which competitively binds to the receptor of a certain biologically acting substance (ligand), and does not produce a physiological action via the receptor. Antagonists include antagonist drugs, blockers, inhibitors, and the like.

(Devices and Solid Phase Supports)

As used herein, the term “device” refers to a part which can constitute the whole or a portion of an apparatus, and comprises a support (preferably, a solid phase support) and a target substance carried thereon. Examples of such a device include, but are not limited to, chips, arrays, microtiter plates, cell culture plates, Petri dishes, films, beads, and the like.

As used herein, the term “support” refers to a material which can fix a substance, such as a biological molecule. Such a support may be made from any fixing material which has a capability of binding to a biological molecule as used herein via covalent or noncovalent bonds, or which may be induced to have such a capability.

Examples of materials used for supports include any material capable of forming a solid surface, such as, without limitation, glass, silica, silicon, ceramics, silicon dioxide, plastics, metals (including alloys), naturally-occurring and synthetic polymers (e.g., polystyrene, cellulose, chitosan, dextran, and nylon), and the like. A support may be formed of layers made of a plurality of materials. For example, a support may be made of an inorganic insulating material, such as glass, quartz glass, alumina, sapphire, forsterite, silicon oxide, silicon carbide, silicon nitride, or the like. A support may be made of an organic material, such as polyethylene, ethylene, polypropylene, polyisobutylene, polyethylene terephthalate, unsaturated polyester, fluorine-containing resin, polyvinyl chloride, polyvinylidene chloride, polyvinyl acetate, polyvinyl alcohol, polyvinyl acetal, acrylic resin, polyacrylonitrile, polystyrene, acetal resin, polycarbonate, polyamide, phenol resin, urea resin, epoxy resin, melamine resin, styrene-acrylonitrile copolymer, acrylonitrile-butadiene-styrene copolymer, silicone resin, polyphenylene oxide, polysulfone, and the like. Also in the present invention, nitrocellulose film, nylon film, PVDF film, or the like, which are used in blotting, may be used as a material for a support. When a material constituting a support is in the solid phase, such as a support is herein particularly referred to as a “solid phase support”. A solid phase support may be herein in the form of a plate, a microwell plate, a chip, a glass slide, a film, beads, a metal (surface), or the like. A support may be uncoated or may be coated.

As used herein, the term “liquid phase” has the same meanings as are commonly understood by those skilled in the art, typically referring to a state in solution.

As used herein, the term “solid phase” has the same meanings as are commonly understood by those skilled in the art, typically referring to a solid state. As used herein, liquid and solid may be collectively referred to as a “fluid”.

As used herein, the term “substrate” refers to a material (preferably, solid) which is used to construct a chip or array according to the present invention. Therefore, substrates are included in the concept of plates. Such a substrate may be made from any solid material which has a capability of binding to a biological molecule as used herein via covalent or noncovalent bonds, or which may be induced to have such a capability.

Examples of materials used for plates and substrates include any material capable of forming a solid surface, such as, without limitation, glass, silica, silicon, ceramics, silicon dioxide, plastics, metals (including alloys), naturally-occurring and synthetic polymers (e.g., polystyrene, cellulose, chitosan, dextran, and nylon), and the like. A support may be formed of layers made of a plurality of materials. For example, a support may be made of an inorganic insulating material, such as glass, quartz glass, alumina, sapphire, forsterite, silicon oxide, silicon carbide, silicon nitride, or the like. A support may be made of an organic material, such as polyethylene, ethylene, polypropylene, polyisobutylene, polyethylene terephthalate, unsaturated polyester, fluorine-containing resin, polyvinyl chloride, polyvinylidene chloride, polyvinyl acetate, polyvinyl alcohol, polyvinyl acetal, acrylic resin, polyacrylonitrile, polystyrene, acetal resin, polycarbonate, polyamide, phenol resin, urea resin, epoxy resin, melamine resin, styrene-acrylonitrile copolymer, acrylonitrile-butadiene-styrene copolymer, silicone resin, polyphenylene oxide, polysulfone, and the like. A material preferable as a substrate varies depending on various parameters such as a measuring device, and can be selected from the above-described various materials as appropriate by those skilled in the art. For transfection arrays, glass slides are preferable. Preferably, such a substrate may be coated with a substance or have a coating.

As used herein, the term “coating” in relation to a solid phase support or substrate refers to an act of forming a film of a material on a surface of the solid phase support or substrate, and also refers to a film itself. Coating is performed for various purposes, such as, for example, improvement in the quality of a solid phase support and substrate (e.g., elongation of life span, improvement in resistance to hostile environment, such as resistance to acids, etc.), an improvement in affinity to a substance integrated with a solid phase support or substrate, and the like. Various materials may be used for such coating, including, without limitation, biological substances (e.g., DNA, RNA, protein, lipid, etc.), polymers (e.g., poly-L-lysine, MAS (available from Matsunami Glass, Kishiwada, Japan), and hydrophobic fluorine resin), silane (APS (e.g., γ-aminopropyl silane, etc.)), metals (e.g., gold, etc.), in addition to the above-described solid phase support and substrate. The selection of such materials is within the technical scope of those skilled in the art and thus can be performed using techniques well known in the art. In one preferred embodiment, such a coating may be advantageously made of poly-L-lysine, silane (e.g., epoxy silane or mercaptosilane, APS (γ-aminopropyl silane), etc.), MAS, hydrophobic fluorine resin, a metal (e.g., gold, etc.). Such a material may be preferably a substance suitable for cells or objects containing cells (e.g., organisms, organs, etc.).

As used herein, the terms “chip” or “microchip” are used interchangeably to refer to a micro-integrated circuit which has versatile functions and constitutes a portion of a system. Examples of a chip include, but are not limited to, DNA chips, protein chips, and the like.

As used herein, the term “array” refers to a substrate (e.g., a chip, etc.) which has a pattern of a composition containing at least one (e.g., 1000 or more, etc.) target substance (e.g., DNA, proteins, transfection mixtures, etc.), which are arrayed. Among arrays, patterned substrates having a small size (e.g., 10×10 mm, etc.) are particularly referred to as microarrays. The terms “microarray” and “array” are used interchangeably. Therefore, a patterned substrate having a larger size than that which is described above may be referred to as a microarray. For example, an array comprises a set of desired transfection mixtures fixed to a solid phase surface or a film thereof. An array preferably comprises at least 10² antibodies of the same or different types, more preferably at least 10³, even more preferably at least 10⁴, and still even more preferably at least 10⁵. These antibodies are placed on a surface of up to 125×80 mm, more preferably 10×10 mm. An array includes, but is not limited to, a 96-well microtiter plate, a 384-well microtiter plate, a microtiter plate the size of a glass slide, and the like. A composition to be fixed may contain one or a plurality of types of target substances. Such a number of target substance types may be in the range of from one to the number of spots, including, without limitation, about 10, about 100, about 500, and about 1,000.

As described above, any number of target substances (e.g., proteins, such as antibodies) may be provided on a solid phase surface or film, typically including no more than 10⁸ biological molecules per substrate, in another embodiment no more than 10⁷ biological molecules, no more than 10⁶ biological molecules, no more than 10⁵ biological molecules, no more than 10⁴ biological molecules, no more than 10³ biological molecules, or no more than 10² biological molecules. A composition containing more than 10⁸ biological molecule target substances may be provided on a substrate. In these cases, the size of a substrate is preferably small. Particularly, the size of a spot of a composition containing target substances (e.g., proteins such as antibodies) may be as small as the size of a single biological molecule (e.g., 1 to 2 nm order). In some cases, the minimum area of a substrate may be determined based on the number of biological molecules on a substrate. A composition containing target substances, which are intended to be introduced into cells, are herein typically arrayed on and fixed via covalent bonds or physical interaction to a substrate in the form of spots having a size of 0.01 mm to 10 mm.

“Spots” of biological molecules may be provided on an array. As used herein, the term “spot” refers to a certain set of compositions containing target substances. As used herein, the term “spotting” refers to an act of preparing a spot of a composition containing a certain target substance on a substrate or plate. Spotting may be performed by any method, for example, pipetting or the like, or alternatively, by using an automatic device. These methods are well known in the art.

As used herein, the term “address” refers to a unique position on a substrate, which may be distinguished from other unique positions. Addresses are appropriately associated with spots. Addresses can have any distinguishable shape such that substances at each address may be distinguished from substances at other addresses (e.g., optically). A shape defining an address may be, for example, without limitation, a circle, an ellipse, a square, a rectangle, or an irregular shape. Therefore, the term “address” is used to indicate an abstract concept, while the term “spot” is used to indicate a specific concept. Unless it is necessary to distinguish them from each other, the terms “address” and “spot” may be herein used interchangeably.

The size of each address particularly depends on the size of the substrate, the number of addresses on the substrate, the amount of a target substances and/or available reagents contained in a composition, the size of microparticles, and the level of resolution required for any method used for the array. The size of each address may be, for example, in the range of from 1-2 nm to several centimeters, though the address may have any size suited to an array.

The spatial arrangement and shape which define an address are designed so that the microarray is suited to a particular application. Addresses may be densely arranged or sparsely distributed, or subgrouped into a desired pattern appropriate for a particular type of material to be analyzed.

Microarrays are widely reviewed in, for example, “Genomu Kino Kenkyu Purotokoru [Genomic Function Research Protocol] (Jikken Igaku Bessatsu [Special Issue of Experimental Medicine], Posuto Genomu Jidai no Jikken Koza 1 [Lecture 1 on Experimentation in Post-genome Era), “Genomu Ikagaku to korekarano Genomu Iryo [Genome Medical Science and Futuristic Genome Therapy (Jikken Igaku Zokan [Special Issue of Experimental Medicine]), and the like.

A vast amount of data can be obtained from a microarray. Therefore, data analysis software is important for facilitating correspondence between clones and spots, data analysis, and the like. Such software may be attached to various detection systems (e.g., Ermolaeva O. et al., (1998) Nat. Genet., 20: 19-23). The format of such a database includes, for example, GATC (genetic analysis technology consortium) proposed by Affymetrix.

Micromachining for arrays is described in, for example, Campbell, S. A. (1996), “The Science and Engineering of Microelectronic Fabrication”, Oxford University Press; Zaut, P. V. (1996), “Micromicroarray Fabrication: a Practical Guide to Semiconductor Processing”, Semiconductor Services; Madou, M. J. (1997), “Fundamentals of Microfabrication”, CRC1 5 Press; Rai-Choudhury, P. (1997), “Handbook of Microlithography, Micromachining, & Microfabrication: Microlithography”; and the like, portions related thereto of which are herein incorporated by reference.

### Detection

In cell analysis or determination in the present invention, various detection methods and means can be used as long as they can be used to detect information attributed to a cell or a substance interacting therewith. Examples of such detection methods and means include, but are not limited to, visual inspection, optical microscopes, confocal microscopes, reading devices using a laser light source, surface plasmon resonance (SPR) imaging, electric signals, chemical or biochemical markers, which may be used singly or in combination. Examples of such a detecting device include, but are not limited to, fluorescence analyzing devices, spectrophotometers, scintillation counters, CCD, luminometers, and the like. Any means capable of detecting a biological molecule may be used.

As used herein, the term “marker” refers to a biological agent for indicating a level or frequency of a substance or state of interest. Examples of such a marker include, but are not limited to, nucleic acids encoding a gene, gene products, metabolic products, receptors, ligands, antibodies, and the like.

Therefore, as used herein, the term “marker” in relation to a state of a cell refers to an agent (e.g., ligands, antibodies, complementary nucleic acids, etc.) interacting with intracellular factors indicating the state of the cell (e.g., nucleic acids encoding a gene, gene products (e.g., mRNA, proteins, post-transcriptionally modified proteins, etc.), metabolic products, receptors, etc.) in addition to transcription control factors. In the present invention, such a marker may be used to produce a time-lapse profile which is in turn analyzed. Such a marker may preferably interact with a factor of interest. As used herein, the term “specificity” in relation to a marker refers to its property to interact with a molecule of interest to a significantly higher extent than with similar molecules. Such a marker is herein preferably present within cells or may be present outside cells.

As used herein, the term “label” refers to a factor which distinguishes a molecule or substance of interest from others (e.g., substances, energy, electromagnetic waves, etc.). Examples of labeling methods include, but are not limited to, RI (radioisotope) methods, fluorescence methods, biotinylation methods, chemoluminescence methods, and the like. When the above-described nucleic acid fragments and complementary oligonucleotides are labeled by fluorescence methods, fluorescent substances having different fluorescence emission maximum wavelengths are used for labeling. The difference between each fluorescence emission maximum wavelength may be preferably 10 nm or more. Any fluorescent substance which can bind to a base portion of a nucleic acid may be used, preferably including a cyanine dye (e.g., Cy3 and Cy5 in the Cy Dye™ series, etc.), a rhodamine 6G reagent, N-acetoxy-N2-acetyl amino fluorine (AAF), AAIF (iodine derivative of AAF), and the like. Examples of fluorescent substances having a difference in fluorescence emission maximum wavelength of 10 nm or more include a combination of Cy5 and a rhodamine 6G reagent, a combination of Cy3 and fluorescein, a combination of a rhodamine 6G reagent and fluorescein, and the like. In the present invention, such a label can be used to alter a sample of interest so that the sample can be detected by detecting means. Such alteration is known in the art. Those skilled in the art can perform such alteration using a method appropriate for labeling a sample of interest.

As used herein, the term “interaction” refers to, without limitation, hydrophobic interactions, hydrophilic interactions, hydrogen bonds, Van der Waals forces, ionic interactions, nonionic interactions, electrostatic interactions, and the like.

As used herein, the term “interaction level” in relation to interaction between two substances (e.g., cells, etc.) refers to the extent or frequency of interaction between the two substances. Such an interaction level can be measured by methods well known in the art. For example, the number of cells which are fixed and actually perform an interaction is counted directly or indirectly (e.g., the intensity of reflected light), for example, without limitation, by using an optical microscope, a fluorescence microscope, a phase-contrast microscope, or the like, or alternatively by staining cells with a marker, an antibody, a fluorescent label or the like specific thereto and measuring the intensity thereof. Such a level can be displayed directly from a marker or indirectly via a label. Based on the measured value of such a level, the number or frequency of genes, which are actually transcribed or expressed in a certain spot, can be calculated.

### Presentation and Display

As used herein, the terms “display” and “presentation” are used interchangeably to refer to an act of providing a profile obtained by a method of the present invention, or information derived therefrom, directly or indirectly, or in an information-processed form. Examples of such displayed forms include, but are not limited to, various methods, such as graphs, photographs, tables, animations, and the like. Such techniques are described in, for example, METHODS IN CELL BIOLOGY, VOL. 56, ed. 1998, pp:185-215, A High-Resolution Multimode Digital Microscope System (Sluder & Wolf, Salmon), which discusses application software for automating a microscope and controlling a camera and the design of a hardware device comprising an automated optical microscope, a camera, and a Z-axis focusing device, which can be used herein. Image acquisition by a camera is described in detail in, for example, Inoue and Spring, Video Microscopy, 2d. Edition, 1997, which is herein incorporated by reference.

Real time display can also be performed using techniques well known in the art. For example, after all images are obtained and stored in a semi-permanent memory, or substantially at the same time as when an image is obtained, images can be processed with appropriate application software to obtain processed data. For example, data may be processed by a method for playing back a sequence of images without interruption, a method for displaying images in real time, or a method for displaying images as a “movie” showing irradiating light as changes or continuation on a focal plane.

In another embodiment, application software for measurement and presentation typically includes software for setting conditions for applying stimuli or conditions for recording detected signals. With such a measurement and presentation application, a computer can have means for applying a stimulus to cells and means for processing signals detected from cells, and in addition, can control an optically observing means (a SIT camera and an image filing device) and/or a cell culturing means.

By inputting conditions for stimulation on a parameter setting screen using a keyboard, a touch panel, a mouse, or the like, it is possible to set the desired complex conditions for stimulation. In addition, various conditions, such as a temperature for cell culture, pH, and the like, can be set using a keyboard, a mouse, or the like.

A display screen displays a time-lapse profile detected from a cell or information derived therefrom in real time or after recording. In addition, another recorded profile or information derived therefrom a cell can be displayed while being superimposed with a microscopic image of the cell. In addition to recorded information, measurement parameters in recording (stimulation conditions, recording conditions, display conditions, process conditions, various conditions for cells, temperature, pH, etc.) can be displayed in real time. The present invention may be equipped with a function of issuing an alarm when a temperature or pH departs from the tolerable range.

On a data analysis screen, it is possible to set conditions for various mathematical analyses, such as Fourier transformation, cluster analysis, FFT analysis, coherence analysis, correlation analysis, and the like. The present invention may be equipped with a function for temporarily displaying a profile, a function for displaying topography, or the like. The results of these analyses can be displayed while being superimposed with microscopic images stored in a recording medium.

### Gene Introduction

Any technique may be used herein for introducing a nucleic acid molecule into cells, including, for example, transformation, transduction, transfection, and the like. In the present invention, transfection is preferable.

As used herein, the term “transfection” refers to the act of performing gene introduction or transfection by culturing cells with genomic DNA, plasmid DNA, viral DNA, viral RNA or the like in a substantially naked form (excluding viral particles), or adding such a genetic material into cell suspension to allow the cells to incorporate the genetic material. A gene introduced by transfection is typically expressed by cells in a temporary manner or may be expressed in a permanent manner.

Such a nucleic acid molecule introduction technique is well known in the art and commonly used, and is described in, for example, Ausubel F. A. et al., editors, (1988), Current Protocols in Molecular Biology, Wiley, New York, N.Y.; Sambrook J. et al. (1987) Molecular Cloning: A Laboratory Manual, 2nd Ed. and its 3rd Ed., Cold Spring Harbor Laboratory Press, Cold Spring Harbor, N.Y.; Special issue, Jikken Igaku [Experimental Medicine] “Experimental Methods for Gene introduction & Expression Analysis”, Yodosha, 1997; and the like. Gene introduction can be confirmed by method as described herein, such as Northern blotting analysis and Western blotting analysis, or other well-known, common or routine techniques.

When a gene is mentioned herein, the term “Vector” or “recombinant vector” refers to a vector transferring a polynucleotide sequence of interest to a target cell. Such a vector is capable of self-replication or incorporation into a chromosome in a host cell (e.g., a differences or distances between samples are used to form clusters. In a certain embodiment, a distance used is a Euclidean distance in multi-dimensional space:

$$I ( x , y ) = {\{ {\sum }_{i} {( {X}_{i} - {Y}_{i} )}^{2} \}}^{1 / 2} \qquad ( 1 )$$

where (x, y) represents a distance between gene X and gene Y (or any other cellular components X and Y (e.g., transcription control sequences)); Xᵢ and Yᵢ represent gene expression in response to i stimuli. Euclidean distances may be squared and then multiplied by a weighting, which is increased with an increase in the distance. Alternatively, a distance reference may be, for example, a distance between transcription control sequences X and Y, or a Manhattan distance represented by:

$$I ( x , y ) = {\sum }_{i} \vert {X}_{i} - {Y}_{i} \vert$$

where Xᵢ and Yᵢ represent responses of transcription control sequences or gene expression when i stimuli are applied. Several other definitions of distance include Chebyshev distance, power distance, and mismatch rate. When dimensional data can be categorized without modification, a mismatch rate defined as I(x, y)=(the number of Xᵢ≠Yᵢ)/i may be used in a method of the present invention. Such a method is particularly useful in terms of cellular responses. Another useful definition of distance is I=1−r where r is a correlation coefficient of response vectors X and Y, e.g., a normalized inner product X·Y/|X∥Y|. Specifically, an inner product X·Y is defined by:

$$X \cdot Y = {\sum }_{i} {X}_{i} \times {Y}_{i}$$

prokaryotic cell, yeast, an animal cell, a plant cell, an insect cell, an individual animal, and an individual plant, etc.), and contains a promoter at a site suitable for transcription of a polynucleotide of the present invention. A vector suitable for performing cloning is referred to as a “cloning vector”. Such a cloning vector ordinarily contains a multiple cloning site containing a plurality of restriction sites. Restriction enzyme sites and multiple cloning sites as described above are well known in the art and can be used as appropriate by those skilled in the art depending on the purpose in accordance with publications described herein (e.g., Sambrook et al., supra).

As used herein, the term “expression vector” refers to a nucleic acid sequence comprising a structural gene and a promoter for regulating expression thereof, and in addition, various regulatory elements in a state that allows them to operate within host cells. The regulatory elements may include, preferably, terminators, selectable markers such as drug-resistance genes, and enhancers.

Examples of “recombinant vectors” for prokaryotid cells include, but are not limited to, pcDNA3(+), pBluescript-SK(+/−), pGEM-T, pEF-BOS, pEGFP, pHAT, pUC18, pFT-DEST™42GATEWAY (Invitrogen), and the like.

Examples of “recombinant vectors” for animal cells include, but are not limited to, pcDNAI/Amp, pcDNAI, pCDM8 (all commercially available from Funakoshi), pAGE107 [Japanese Laid-Open Publication No. 3-229 (Invitrogen), pAGE103 [J. Biochem., 101, 1307 (1987)], pAMo, pAMoA [J. Biol. Chem., 268, 22782-22787 (1993)], a retrovirus expression vector based on a murine stem cell virus (MSCV), pEF-BOS, pEGFP, and the like.

Examples of recombinant vectors for plant cells include, but are not limited to, pPCVICEn4HPT, pCGN1548, pCGN1549, pBI221, pBI121, and the like.

Any of the above-described methods for introducing DNA into cells can be used as a vector introduction method, including, for example, transfection, transduction, transformation, and the like (e.g., a calcium phosphate method, a liposome method, a DEAE dextran method, an electroporation method, a particle gun (gene gun) method, and the like), a lipofection method, a spheroplast method (Proc. Natl. Acad. Sci. USA, 84, 1929 (1978)), a lithium acetate method (J. Bacteriol., 153, 163 (1983); and Proc. Natl. Acad. Sci. USA, 75, 1929 (1978)), and the like.

As used herein, the term “operably linked” indicates that a desired sequence is located such that expression (operation) thereof is under control of a transcription and translation regulatory sequence (e.g., a promoter, an enhancer, and the like) or a translation regulatory sequence. In order for a promoter to be operably linked to a gene, typically, the promoter is located immediately upstream of the gene. A promoter is not necessarily adjacent to a structural gene.

As used herein, the term “gene introduction reagent” refers to a reagent which is used in a gene introduction method so as to enhance introduction efficiency. Examples of such a gene introduction reagent include, but are not limited to, cationic polymers, cationic lipids, polyamine-based reagents, polyimine-based reagents, calcium phosphate, and the like. Specific examples of a reagent used in transfection include reagents available from various sources, such as, without limitation, Effectene Transfection Reagent (cat. no. 301425, Qiagen, CA), TransFast™ Transfection Reagent (E2431, Promega, WI), Tfx™-20 Reagent (E2391, Promega, WI), SuperFect Transfection Reagent (301305, Qiagen, CA), PolyFect Transfection Reagent (301105, Qiagen, CA), LipofectAMINE 2000 Reagent (11668-019, Invitrogen corporation, CA), JetPEI (×4) conc. (101-30, Polyplus-transfection, France) and ExGen 500 (R0511, Fermentas Inc., MD), and the like.

Gene expression (e.g., mRNA expression, polypeptide expression) may be “detected” or “quantified” by an appropriate method, including mRNA measurement and immunological measurement methods. Examples of molecular biological measurement methods include Northern blotting methods, dot blotting methods, PCR methods, and the like. Examples of immunological measurement methods include ELISA methods, RIA methods, fluorescent antibody methods, Western blotting methods, immunohistological staining methods, and the like, where a microtiter plate may be used. Examples of quantification methods include ELISA methods, RIA methods, and the like. A gene analysis method using an array (e.g., a DNA array, a protein array, etc.) may be used. The DNA array is widely reviewed in Saibo-Kogaku [Cell Engineering], special issue, “DNA Microarray and Up-to-date PCR Method”, edited by Shujun-sha. The protein array is described in detail in Nat. Genet. 2002 December; 32 Suppl:526-32. Examples of methods for analyzing gene expression include, but are not limited to, RT-PCR methods, RACE methods, SSCP methods, immunoprecipitation methods, two-hybrid systems, in vitro translation methods, and the like, in addition to the above-described techniques. Other analysis methods are described in, for example, “Genome Analysis Experimental Method, Yusuke Nakamura's Lab-Manual, edited by Yusuke Nakamura, Yodosha (2002), and the like. All of the above-described publications are herein incorporated by reference.

As used herein, the term “expression level” refers to the amount of a polypeptide or mRNA expressed in a subject cell. The term “expression level” includes the level of protein expression of a polypeptide evaluated by any appropriate method using an antibody, including immunological measurement methods (e.g., an ELISA method, an RIA method, a fluorescent antibody method, a Western blotting method, an immunohistological staining method, and the like, or the mRNA level of expression of a polypeptide evaluated by any appropriate method, including molecular biological measurement methods (e.g., a Northern blotting method, a dot blotting method, a PCR method, and the like). The term “change in expression level” refers to an increase or decrease in protein or mRNA expression levels of a polypeptide evaluated by an appropriate method including the above-described immunological measurement methods or molecular biological measurement methods.

### Screening

As used herein, the term “screening” refers to selection of a target, such as an organism, a substance, or the like, a given specific property of interest from a population containing a number of elements using a specific operation/evaluation method. For screening, an agent (e.g., an antibody), a polypeptide or a nucleic acid molecule of the present invention can be used.

As used herein, screening by utilizing an immunological reaction is also referred to as “immunophenotyping”. In this case, an antibody or a single chain antibody may be used for immunophenotyping a cell line and a biological sample. A transcription or translation product of a gene may be useful as a cell specific marker, or more particularly, a cell marker which is distinctively expressed in various stages in differentiation and/or maturation of a specific cell type. A monoclonal antibody directed to a specific epitope, or a combination of epitopes allows the screening for a cell population expressing a marker. Various techniques employ monoclonal antibodies to screen for a cell population expressing a marker. Examples of such techniques include, but are not limited to, magnetic separation using magnetic beads coated with antibodies, “panning” using antibodies attached to a solid matrix (i.e., a plate), flow cytometry, and the like (e.g., U.S. Pat. No. 5,985,660; and Morrison et al., Cell, 96:737-49 (1999)).

These techniques may be used to screen cell populations containing undifferentiated cells, which can grow and/or differentiate as seen in human umbilical cord blood or which are treated and modified into an undifferentiated state (e.g., embryonic stem cells, tissue stem cells, etc.).

### Diagnosis

As used herein, the term “diagnosis” refers to the act of identifying various parameters associated with a disease, a disorder, a condition, or the like of a subject and determining a current state of the disease, the disorder, the condition, or the like. The method, device, or system of the present invention can be used to analyze a sugar chain structure, a drug resistance level, or the like. Such information can be used to select parameters, such as a disease, a disorder, a condition, and a prescription or method for treatment or preventative method for a subject.

The diagnosis method of the present invention can use, in principle, a sample which is derived from the body of a subject. Therefore, it is possible for someone which is not a medical practitioner, such as a medical doctor, to deal with such a sample. The present invention is industrially useful.

### Therapy

As used herein, the term “therapy” refers to the act of preventing the progression of a disease or a disorder, preferably by maintaining the current state of a disease or a disorder, more preferably by alleviating a disease or a disorder, and more preferably by extinguishing a disease or a disorder.

As used herein, the term “subject” refers to an organism which is subjected to the treatment of the present invention. A subject is also referred to as a “patient”. A patient or subject may preferably be a human.

As used herein, the term “cause” or “pathogen” in relation to a disease, a disorder or a condition of a subject refers to an agent associated with the disease, the disorder or the condition (also collectively referred to as a “lesion”, or “disease damage” in plants), including, without limitation, a causative or pathogenic substance (i.e., pathogenic agent), a disease agent, a disease cell, a pathogenic virus, and the like.

The disease targeted by the present invention may be any disease associated with a pathogenic gene. Examples of such a disease include, but are not limited to, cancer, infectious diseases due to viruses or bacteria, allergy, hypertension, hyperlipemia, diabetes, cardiac diseases, cerebral infarction, dementia, obesity, arteriosclerosis, infertility, mental and nervous diseases, cataract, progeria, hypersensitivity to ultraviolet radiation, and the like.

A disorder targeted by the present invention may be any disorder associated with a pathogenic gene.

Examples of such a disease, disorder or condition include, but are not limited to, circulatory diseases (anemia (e.g., aplastic anemia (particularly, severe aplastic anemia), renal anemia, cancerous anemia, secondary anemia, refractory anemia, etc.), cancer or tumors (e.g., leukemia, multiple myeloma), etc.); neurological diseases (dementia, cerebral stroke and sequels thereof, cerebral tumor, spinal injury, etc.); immunological diseases. (T-cell deficiency syndrome, leukemia, etc.); motor organ and the skeletal system diseases (fracture, osteoporosis, luxation of joints, subluxation, sprain, ligament injury, osteoarthritis, osteosarcoma, Ewing's sarcoma, osteogenesis imperfecta, osteochondrodysplasia, etc.); dermatologic diseases (atrichia, melanoma, cutis malignant lympoma, hemangiosarcoma, histiocytosis, hydroa, pustulosis, dermatitis, eczema, etc.); endocrinologic diseases (hypothalamus/hypophysis diseases, thyroid gland diseases, accessory thyroid gland (parathyroid) diseases, adrenal cortex/medulla diseases, saccharometabolism abnormality, lipid metabolism abnormality, protein metabolism abnormality, nucleic acid metabolism abnormality, inherent metabolic disorders (phenylketonuria, galactosemia, homocystinuria, maple syrup urine disease), analbuminemia, lack of ascorbic acid synthetic ability, hyperbilirubinemia, hyperbilirubinuria, kallikrein deficiency, mast cell deficiency, diabetes insipidus, vasopressin secretion abnormality, dwarfism, Wolman's disease (acid lipase deficiency, mucopolysaccharidosis VI, etc.); respiratory diseases (pulmonary diseases (e.g., pneumonia, lung cancer, etc.), bronchial diseases, lung cancer, bronchial cancer, etc.); alimentary diseases (esophageal diseases (e.g., esophagial cancer, etc.), stomach/duodenum diseases (e.g., stomach cancer, duodenum cancer, etc.), small intestine diseases/large intestine diseases (e.g., polyps of the colon, colon cancer, rectal cancer, etc.), bile duct diseases, liver diseases (e.g., liver cirrhosis, hepatitis (A, B, C, D, E, etc.), fulminant hepatitis, chronic hepatitis, primary liver cancer, alcoholic liver disorders, drug induced liver disorders, etc.), pancreatic diseases (acute pancreatitis, chronic pancreatitis, pancreas cancer, cystic pancreas diseases, etc.), peritoneum/abdominal wall/diaphragm diseases (hernia, etc.), Hirschsprung's disease, etc.); urinary diseases (kidney diseases (e.g., renal failure, primary glomerulus diseases, renovascular disorders, tubular function abnormality, interstitial kidney diseases, kidney disorders due to systemic diseases, kidney cancer, etc.), bladder diseases (e.g., cystitis, bladder cancer, etc.); genital diseases (male genital organ diseases (e.g., male sterility, prostatomegaly, prostate cancer, testicular cancer, etc.), female genital organ diseases (e.g., female sterility, ovary function disorders, hysteromyoma, adenomyosis uteri, uterine cancer, endometriosis, ovarian cancer, villosity diseases, etc.), etc); circulatory diseases (heart failure, angina pectoris, myocardial infarct, arrhythmia, valvulitis, cardiac muscle/pericardium diseases, congenital heart diseases (e.g., atrial septal defect, arterial canal patency, tetralogy of Fallot, etc.), artery diseases (e.g., arteriosclerosis, aneurysm), vein diseases (e.g., phlebeurysm, etc.), lymphoduct diseases (e.g., lymphedema, etc.), etc.); and the like.

As used herein, the term “cancer” refers to a malignant tumor which has a high level of atypism, grows faster than normal cells, tends to disruptively invade surrounding tissue or metastasize to new body sites or a condition characterized by the presence of such a malignant tumor. In the present invention, cancer includes, without limitation, solid cancer and hematological cancer.

As used herein, the term “solid cancer” refers to a cancer having a solid shape in contrast to hematological cancer, such as leukemia and the like. Examples of such a solid cancer include, but are not limited to, breast cancer, liver cancer, stomach cancer, lung cancer, head and neck cancer, uterocervical cancer, prostate cancer, retinoblastoma, malignant lymphoma, esophagus cancer, brain tumor, osteoncus, and the like.

As used herein, the term “cancer therapy” encompasses administration of an anticancer agent (e.g., a chemotherapeutic agent, radiation therapy, etc.) or surgical therapy, such as surgical excision and the like.

Chemotherapeutic agents used herein are well known in the art and are described in, for example, Shigeru Tsukagoshi et al. editors, “Kogan zai Manuaru [Manual of Anticancer agents]”, 2nd ed., ChugaiIgacku sha; Pharmacology; and Lippincott Williams & Wilkins, Inc. Examples of such chemotherapeutic agents are described below: 1) alkylating agents which alkylate cell components, such as DNA, protein, and the like, to produce cytotoxicity (e.g., cyclophosphamide, busulfan, thiotepa, dacarbazine, etc.); 2) antimetabolites which mainly inhibit synthesis of nucleic acids (e.g., antifolics (methotrexate, etc.), antipurines (6-mercaptopurine, etc.), antipyrimidines (fluorourasil (5-FU), etc.); 3) DNA topoisomerase inhibitors (e.g., camptothecin and etoposide, each of which inhibits topoisomerases I and II)); 4) tubulin agents which inhibit formation of microtubules and suppress cell division (vinblastine, vincristine, etc.); 5) platinum compounds which bind to DNA and proteins to exhibit cytotoxicity (cisplatin, carboplatin, etc.); 6) anticancer antibiotics which bind to DNA to inhibit synthesis of DNA and RNA (adriamycin, dactinomycin, mitomycin C, bleomycin, etc.); 7) hormone agents which are applicable to hormone-dependent cancer, such as breast cancer, uterus cancer, prostate cancer, and the like (e.g., tamoxifen, leuprorelin (LH-RH), etc.); 8) biological formulations (asparaginase effective for asparagine requiring blood malignant tumor, interferon exhibiting direct antitumor action and indirect action by immunopotentiation, etc.); 9) immunostimulants which exhibit capability of immune response, indirectly leading to antitumor activity (e.g., rentinan which is a polysaccharide derived from shiitake mushroom, bestatin which is a peptide derived from a microorganism, etc.).

An “anticancer agent” used herein selectively suppresses the growth of cancerous (tumor) cells, and includes both pharmaceutical agents and radiation therapy. Such an anticancer agent is well known in the art and described in, for example, Shigeru Tsukagoshi et al. editors, “Kogan zai Manuaru [Manual of Anticancer agents]”, 2nd ed., ChugaiIgaku sha; Pharmacology; and Lippincott Williams & Wilkins, Inc.

As used herein, the term “radiation therapy” refers to a therapy for diseases using ionizing radiation or radioactive substances. Representative examples of radiation therapy include, but are not limited to, X-ray therapy, γ-ray therapy, electron beam therapy, proton beam therapy, heavy particle beam therapy, neutron capture therapy, and the like. For example, heavy particle beam therapy is preferable. However, heavy particle beam therapy requires a large-size device and is not generally used. The above-described radiation therapies are well known in the art and are described in, for example, Sho Kei Zen, “Hoshasenkensa to Chiryo no Kiso: Hoshasen Chiryo to Shugakuteki Chiryo [Basics of Radiation Examination and Therapies: Radiation Therapy and Incentive Therapy]”, (Shiga Medical School, Radiation): Total digestive system care, Vol. 6, No. 6, Pages 79-89, 6-7 (2002.02). For drug resistance to be identified in the present invention, chemotherapies are typically considered. However, resistance to radiation therapy is also associated with time-lapse profiles. Therefore, radiation therapy is herein encompassed by the concept of pharmaceutical agents.

As used herein, the term “pharmaceutically acceptable carrier” refers to a material for use in production of a medicament, an animal drug or an agricultural chemical, which does not have an adverse effect on an effective component. Examples of such a pharmaceutically acceptable carrier include, but are not limited to, antioxidants, preservatives, colorants, flavoring agents, diluents, emulsifiers, suspending agents, solvents, fillers, bulking agents, buffers, delivery vehicles, excipients, agricultural or pharmaceutical adjuvants, and the like.

The type and amount of a pharmaceutical agent used in a treatment method of the present invention can be easily determined, by those skilled in the art based on information obtained by a method of the present invention (e.g., information about the level of drug resistance, etc.) and with reference to the purpose of use, a target disease (type, severity, and the like), the patient's age, weight, sex, and case history, the form or type of the cell, and the like. The frequency of the treatment method of the present invention-applied to a subject (or patient) is also determined by those skilled in the art with respect to the purpose of use, target disease (type, severity, and the like), the patient's age, weight, sex, and case history, the progression of therapy, and the like. Examples of the frequency include once per day to several months (e.g., once per week to once per month). Preferably, administration is performed once per week to once per month with reference to the progression of therapy.

As used herein, the term “instructions” refers to a description of a tailor made therapy of the present invention for a person who performs administration, such as a medical doctor, a patient, or the like. Instructions state when to administer a medicament of the present invention, such as immediately after or before radiation therapy (e.g., within 24 hours, etc.). The instructions are prepared in accordance with a format defined by an authority of a country in which the present invention is practiced (e.g., Health, Labor and Welfare Ministry in Japan, Food and Drug Administration (FDA) in the U.S., and the like), explicitly describing that the instructions are approved by the authority. The instructions are so-called package insert and are typically provided in paper media. The instructions are not so limited and may be provided in the form of electronic media (e.g., web sites, electronic mails, and the like provided on the internet).

In therapy of the present invention, two or more pharmaceutical agents may be used as required. When two or more pharmaceutical agents are used, these agents may have similar properties or may be derived from similar origins, or alternatively, may have different properties or may be derived from different origins. The method of the present invention can be used to obtain information about the drug resistance level of a method for administering two or more pharmaceutical agents.

Also, in the present invention, gene therapy can be performed based on the resultant information about drug resistance. As used herein, the term “gene therapy” refers to a therapy in which a nucleic acid, which has been expressed or can be expressed, is administered into a subject. In such an embodiment of the present invention, a protein encoded by a nucleic acid is produced to mediate a therapeutic effect.

In the present invention, it will be understood by those skilled in the art that if the result of analysis of a certain specific time-lapse profile is correlated with a state of a cell in a similar organism (e.g., mouse with respect to human, etc.), the result of the analysis of a corresponding time-lapse profile can be correlated with a state of a cell. This feature is supported by, for example, Dobutsu Baiyo Saibo Manuaru [Animal Culture Cell Manual], Seno, ed., Kyoritsu Shuppan, 1993, which is herein incorporated by reference.

Any methods for gene therapy available in the art may be used in accordance with the present invention. Illustrative methods will be described below.

Methods for gene therapy are generally reviewed in, for example, Goldspiel et al., Clinical Pharmacy 12: 488-505 (1993); Wu and Wu, Biotherapy 3: 87-95 (1991); Tolstoshev, Ann. Rev. Pharmacol. Toxicol., 32: 573-596 (1993); Mulligan, Science 260: 926-932 (1993); Morgan and Anderson, Ann. Rev. Biochem., 62: 191-217 (1993); and May, TIBTECH 11(5): 155-215 (1993). Commonly known recombinant DNA techniques used in gene therapy are described in, for example, Ausubel et al. (ed.), Current Protocols in Molecular Biology, John Wiley & Sons, NY (1993); and Kriegler, Gene Transfer and Expression, A Laboratory Manual, Stockton Press, NY (1990).

### Basic Techniques

Techniques used herein are within the technical scope of the present invention unless otherwise specified. These techniques are commonly used in the fields of fluidics, micromachining, organic chemistry, biochemistry, genetic engineering, molecular biology, microbiology, genetics, and their relevant fields. The techniques are well described in documents described below and the documents mentioned herein elsewhere.

Microfabrication is described in, for example, Campbell, S. A. (1996), “The Science and Engineering of Microelectronic Fabrication”, Oxford University Press; Zaut, P. V. (1996), “Micromicroarray Fabrication: a Practical Guide to Semiconductor Processing”, Semiconductor Services; Madou, M. J. (1997), “Fundamentals of Microfabrication”, CRC15 Press; Rai-Choudhury, P. (1997), “Handbook of Microlithography, Micromachining, & Microfabrication: Microlithography”. Relevant portions (or possibly the entirety) of each of these publications are herein incorporated by reference.

Molecular biology techniques, biochemistry techniques, and microbiology techniques used herein are well known and commonly used in the art, and are described in, for example, Sambrook J. et al. (1989), “Molecular Cloning: A Laboratory Manual”, Cold Spring Harbor and its 3rd Ed. (2001); Ausubel, F. M. (1987), “Current Protocols in Molecular Biology”, Greene Pub. Associates and Wiley-Interscience; Ausubel, F. M. (1989), “Short Protocols in Molecular Biology: A Compendium of Methods from Current Protocols in Molecular Biology”, Greene Pub. Associates and Wiley-Interscience; Innis, M. A. (1990), “PCR Protocols: A Guide to Methods and Applications”, Academic Press; Ausubel, F. M. (1992), “Short Protocols in Molecular Biology: A Compendium of Methods from Current Protocols in Molecular Biology”, Greene Pub. Associates; Ausubel, F. M. (1995), “Short Protocols in Molecular Biology: A Compendium of Methods from Current Protocols in Molecular Biology”, Greene Pub. Associates; Innis, M. A. et al. (1995), “PCR Strategies”, Academic Press; Ausubel, F. M. (1999), “Short Protocols in Molecular Biology: A Compendium of Methods from Current Protocols in Molecular Biology”, Wiley, and annual updates; Sninsky, J. J. et al. (1999), “PCR Applications: Protocols for Functional Genomics”, Academic Press; Special issue, Jikken Igaku [Experimental Medicine] “Idenshi Donyu & Hatsugenkaiseki Jikkenho [Experimental Method for Gene introduction & Expression Analysis]”, Yodosha, 1997; and the like. Relevant portions (or possibly the entirety) of each of these publications are herein incorporated by reference.

DNA synthesis techniques and nucleic acid chemistry for producing artificially synthesized genes are described in, for example, Gait, M. J. (1985), “Oligonucleotide Synthesis: A Practical Approach”, IRL Press; Gait, M. J. (1990), “Oligonucleotide Synthesis: A Practical Approach”, IRL Press; Eckstein, F. (1991), “Oligonucleotides and Analogues: A Practical Approach”, IRL Press; Adams, R. L. et al. (1992), “The Biochemistry of the Nucleic Acids”, Chapman & Hall; Shabarova, Z. et al. (1994), “Advanced Organic Chemistry of Nucleic Acids”, Weinheim; Blackburn, G. M. et al. (1996), “Nucleic Acids in Chemistry and Biology”, Oxford University Press; Hermanson, G. T. (1996), “Bioconjugate Techniques”, Academic Press; and the like. Relevant portions (or possibly the entirety) of each of these publications are herein incorporated by reference.

### Analysis of Co-Regulation of Genes

Mathematical processes used herein can be performed by using well-known techniques described in, for example, Kazuyuki Shimizu, “Seimei Sisutemu Kaiseki notameno Sugaku [Mathematics for Analyzing Biological Systems]”, Corona sha, 1999; and the like. Among these techniques, representative analysis techniques will be described below.

In one embodiment, such a mathematical process may be regression analysis. Examples of regression analysis include, but are not limited to, linear regression (e.g., simple regression analysis, multiple regression analysis, robust estimation, etc.), nonlinear estimation, and the like.

In simple regression analysis, n sets of data (x₁, y₁) to (xₙ, yₙ) are fitted to yᵢ=axᵢ+b+eᵢ (i=1, 2, . . . , n) where a and b are model parameters, and eᵢ represents a deviation or an error from the straight line. The parameters a and b are typically determined so that the mean of a sum of squares of the distance between a data point and the straight line is minimal. In this case, the rms of the distance is partially differentiated to produce simultaneous linear equations. These equations are solved for a and b which minimize the square errors. Such values are called least square estimates.

Next, a regression line is calculated based on the value obtained by subtracting the mean of all data values from each data value. A regression line represented by:

ASᵢXᵢ+B=SYᵢ

is assumed. Further, it is assumed that B=0. The mean (xₐᵥₑ, yₐᵥₑ) of (xᵢ, yᵢ) (i=1, 2, . . . , n) is calculated, and the variance of x (sₓₓ) and the covariance of x and y (s_{xy}) are calculated. The above-described regression line can be represented by:

y−yₐᵥₑ=(x_{xy}/sₓₓ)(x−xₐᵥₑ).

The correlation coefficient r_{xy} is represented by:

r_{xy}=s_{xy}/√(s_{xy}s_{yy}).

In this case, the relationship Seᵢ²/n=s_{yy}(1−r_{xy}²) is satisfied. Therefore, as |r_{xy}| approaches 1, the error is decreased, which means that data can be satisfactorily represented by the regression line.

In another embodiment, multiple regression analysis is used. In this technique, y is not a single independent variable, and is considered to be a function of two or more variables, e.g., is represented by:

y=a₀+a₁x₁+a₂x₂+ . . . +aₙxₙ.

This equation is called a multiple regression equation. a₀ and the like are called (partial) regression coefficients. In multiple regression analysis, a least square method is used and normal equations are solved to obtain least square estimates. Evaluation can be performed as with single regression analysis.

In another embodiment, robust estimation is used. The least square method is based on the premise that measurement values are not biased and measurement errors have a normal distribution, and models have no approximation error. In actual situations, however, there may be errors in measurement. In robust estimation, unreliable data is detected and separated as outliers from the great majority of data which are reliable, or is subjected to a statistical process. Such a robust estimation may be utilized herein.

Nonlinear estimation may also be used herein. With nonlinear estimation, it is possible to represent a nonlinear model as vector equations which are in turn solved.

Other mathematical processes used herein include principal component analysis, which utilizes two-dimensional data principal component analysis, multi-dimensional data principal component analysis, singular value decomposition, and generalized inverse matrix. Alternatively, canonical correlation analysis, factor analysis, discrimination analysis, cluster analysis, and the like may be used herein.

(Gene Set Classification by Cluster Analysis)

For a number of applications, it may be desirable to obtain a set of reference transcription control sequences which are cooperatively controlled under a wide range of conditions. An embodiment for identifying such a set of reference transcription control sequences is, for example, a clustering algorithm, which is reviewed in, for example, Fukunaga, 1990, “Statistical Pattern Recognition”, 2nd ed., Academic Press, San Diego; Anderberg, 1973, “Cluster Analysis for Applications”, Academic Press: New York; Everitt, 1974, “Cluster Analysis”, London: Heinemann Educ. Books; Hartigan, 1975, “Clustering Algorithms”, New York: Wiley; and Sneath and Sokal, 1973, “Numerical Taxonomy”, Freeman.

A set of transcription control sequences can also be defined based on a transcription control mechanism. Transcription control sequences having a transcription factor binding site for the same or similar sequences in a regulatory region are likely to be cooperatively regulated. In a certain embodiment, the regulatory regions of transcription control sequences of interest are compared with one another using multiple alignment analysis, so that a possible common transcription factor binding site can be determined (Stormo and Hartzell, 1989, “Identifying protein binding sites from unaligned DNA fragments”, Proc. Natl. Acad. Sci., 86: 1183-1187; Hertz and Stormo, 1995, “Identification of consensus patterns in unaligned DNA and protein sequences: a large-deviation statistical basis for penalizing gaps”, Proc. of 3rd Intl. Conf. on Bioinformatics and Genome Research, Lim and Cantor, ed., World Scientific Publishing Co., Ltd. Singapore, pp. 201-216).

It may be desirable to obtain a set of basic transcription control sequences which are cooperatively regulated under various conditions. With such a set, the method of the present invention can satisfactorily and efficiently carry out a determination based on profiles. A preferable embodiment for identifying such a set of basic transcription control sequences includes a clustering algorithm.

In an embodiment using cluster analysis, the transcription levels of a number of transcription control sequences can be monitored while applying various stimuli to biological samples. A table of data containing measurements of the transcription levels of transcription control sequences is used in cluster analysis. In order to obtain a set of basic transcription control sequences containing transcription control sequences which simultaneously vary under various conditions, typically at least two, preferably at least 3, more preferably at least 10, even more preferably more than 50, and most preferably more than 100 stimuli or conditions are used. Cluster analysis is performed for a table of data having m×k dimensions where m is the total number of conditions or stimuli and k is the number of transcription control sequences to be measured.

A number of clustering algorithms are useful for clustering analysis. In clustering algorithms,

Also, |X|=(X·X)^{1/2} and |Y|=(Y·Y)^{1/2} (3).

Most preferably, a distance reference is suited to a biological problem in order to identify cellular components (e.g., transcription control sequences, etc.) which are simultaneously changed and/or simultaneously regulated. For example, in a particularly preferred embodiment, a distance reference is I=1−r having a correlation coefficient containing a weighted inner product of genes X and Y. Specifically, in such a preferred embodiment, r_{η} is defined by:

$$r = \frac{{\sum }_{i} \frac{{X}_{i} {Y}_{i}}{{σ}_{i}^{( X )} {σ}_{i}^{( Y )}}}{{[ {\sum }_{i} {( \frac{{X}_{i}}{{σ}_{i}^{( X )}} )}^{2} {( \frac{{Y}_{i}}{{σ}_{i}^{( Y )}} )}^{2} ]}^{1 / 2}} \qquad ( 4 )$$

where σᵢ^{(X)} and σᵢ^{(Y)} represent standard errors in measurement of genes X and Y in experiment i.

The above-described normalized and weighted inner products (correlation coefficients) are constrained between values +1 (two response vectors are completely correlated, i.e., the two vectors are essentially the same) and −1 (two response vectors are not correlated or do not have the same orientation (i.e., opposing orientations)). These correlation coefficients are particularly preferable in an embodiment of the present invention which tries to detect a set or cluster of cellular components (e.g., transcription control sequences, etc.) having the same sign or response.

In another embodiment, it is preferable to identify a set or cluster of cellular components (e.g., transcription control sequences, etc.) which simultaneously regulate the same biological response or pathway or are involved in such regulation, or have similar or non-correlated responses. In such an embodiment, it is preferable to use the absolute value of either the above-described normalized or weighted inner product, i.e., |r| as a correlation coefficient.

In another embodiment, the relationship between cellular components (e.g., transcription control sequences, etc.), which are simultaneously regulated and/or simultaneously changed, are more complex, e.g., a number of biological pathways (e.g., signal transduction pathways, etc.) are involved with the same cellular component (e.g., a transcription control sequence, etc.) so that different results may be obtained. In such an embodiment, it is preferable to use a correlation coefficient r=r^{(change)} which can identify cellular components (other transcription control sequences as controls which are not involved in change) which are simultaneously changed and/or simultaneously regulated. A correlation coefficient represented by expression (5) is particularly useful for the above-described embodiment:

$$r = \frac{{\sum }_{i} \vert \frac{{X}_{i}}{{σ}_{i}^{( X )}} \vert \vert \frac{{Y}_{i}}{{σ}_{i}^{( Y )}} \vert}{{[ {\sum }_{i} {( \frac{{X}_{i}}{{σ}_{i}^{( X )}} )}^{2} {( \frac{{Y}_{i}}{{σ}_{i}^{( Y )}} )}^{2} ]}^{1 / 2}}$$

Various cluster linkage methods are useful in the method of the present invention.

Examples of such a technique include a simple linkage method, a nearest neighbor method, and the like. In these techniques, a distance between the two closest samples is measured. Alternatively, in a complete linkage method, which may be herein used, a maximum distance between two samples in different clusters is measured. This technique is particularly useful when genes or other cellular components naturally form separate “clumps”.

Alternatively, the mean of non-weighted pairs is used to define the mean distance of all sample pairs in two different clusters. This technique is also useful in clustering genes or other cellular components which naturally form separate “clumps”. Finally, a weighted pair mean technique is also available. This technique is the same as a non-weighted pair mean technique, except that in the former, the size of each cluster is used as a weight. This technique is particularly useful in an embodiment in which it is suspected that the size of a cluster of transcription control sequences or the like varies considerably (Sneath and Sokal, 1973, “Numerical taxonomy”, San Francisco: W.H. Freeman & Co.). Other cluster linkage methods, such as, for example, non-weighted and weighted pair group centroid and Ward's method, are also useful in several embodiments of the present invention. See, for example, Ward, 1963, J. Am. Stat. Assn., 58: 236; and Hartigan, 1975, “Clustering algorithms”, New York: Wiley.

In a certain preferred embodiment, cluster analysis can be performed using a well-known hclust technique (e.g., see a well-known procedure in “hclust” available from Program S-Plus, MathSoft, Inc., Cambridge, Mass.).

According to the present invention, it was found that even if the versatility of stimuli to a clustering set is increased, a state of a cell can be substantially elucidated by analyzing typically at least two, preferably at least 3, profiles using a method of the present invention. Stimulation conditions include treatment with a pharmaceutical agent in different concentrations, different measurement times after treatment, response to genetic mutations in various genes, a combination of treatment of a pharmaceutical agent and mutation, and changes in growth conditions (temperature, density, calcium concentration, etc.).

As used herein, the term “significantly different” in relation to two statistics means that the two statistics are different from each other with a statistical significance. In an embodiment of the present invention, data of a set of experiments assessing the responses of cellular components can be randomized by the Monte Carlo method to define an objective test.

In a certain embodiment, an objective test can be defined by the following technique. pₖᵢ represents a response of a component k in experiment i. Π₍ᵢ₎ represents a random permutation of the indices of experiments. Next, P_{kΠ(i)} is calculated for a number of different random permutations (about 100 to 1,000). For each branch of the original tree and each permutation:

(1) hierarchical clustering is performed using the same algorithm as that which has been used for the original data which is not permutated (in this case, “hclust”); and

(2) an improvement f in classification in total variance about the center of clusters when transition is made from one cluster to two clusters;

f=1−ΣDₖ⁽¹⁾/ΣDₖ⁽²⁾ (6)

where Dₖ is the square of the distance reference (mean) of component k with respect to the center of a cluster to which component k belongs. Superscript 1 or 2 indicates the center of all branches or the center of the more preferable cluster of the two subclusters. The distance function D used in this clustering technique has a considerable degree of freedom. In these examples, D=1-r, where r is a correlation coefficient of one response with respect to another response of a component appearing in a set of experiments (or of the mean cluster response).

Specifically, an objective statistical test can be preferably used to determine the statistical reliability of grouping any clustering methods or algorithms. Preferably, similar tests can be applied to both hierarchical and nonhierarchical clustering methods. The compactness of a cluster is quantitatively defined as, for example, the mean of squares of the distances of elements in the cluster from the “mean of the cluster”, or more preferably, the inverse of the mean of squares of the distances of elements from the mean of the cluster. The mean of a specific cluster is generally defined as the mean of response vectors of all elements in the cluster. However, in a specific embodiment (e.g., the definition of the mean of the cluster is doubtful), for example, the absolute values of normalized or weighted inner products are used to evaluate the distance function of a clustering algorithm (i.e., I=1−|r|). Typically, the above-described definition of the mean may raise a problem in an embodiment in which response vectors have opposing directions so that the mean of the cluster as defined above is zero. Therefore, in such an embodiment, a different definition is preferably selected for the compactness of a cluster, for example, without limitation, the mean of squares of the distances of all pairs of elements in a cluster. Alternatively, the compactness of a cluster may be defined as the mean of distances between each element (e.g., a cellular component) of a cluster and another element of the cluster (or more preferably the inverse of the mean distance).

Other definitions, which may be used in statistical techniques used in the present invention, are obvious to those skilled in the art.

In another embodiment, a profile of the present invention can be analyzed using signal processing techniques. In these signal processing techniques, a correlation function is defined, a correlation coefficient is calculated, an autocorrelation function and a cross-correlation function are defined, and these functions are weighted where the sum of the weights is equal to 1. Thereby, moving averages can be obtained.

In signal processing, it is important to consider a time domain and a frequency domain. Rhythm often plays an important role in dynamic characteristic analysis for natural phenomena, particularly life and organisms. If a certain time function f(t) satisfies the following condition, the function is called a periodic function:

f(t)=f(t+T).

At time 0, the function takes a value of f(0). The function takes a value of f(0) at time T again after taking various values after time 0. Such a function is called a periodic function. Such a function includes a sine wave. T is called a period. The function has one cycle per time T. Alternatively, this feature may be represented by 1/T which means the number of cycles per unit time (cycles/time) without loss of the information. The concept represented by the number of cycles per unit time is called frequency. If the frequency is represented by f, f is represented by:

f=1/T.

Thus, the frequency is an inverse of the time. The time is dealt in a time domain, while the frequency is dealt in a frequency domain. The frequency may be represented in an electrical engineering manner. For example, the frequency is represented by angular measure where one period corresponds to 360° or 2π radians. In this case, f (cycles/sec) is converted to 2πf (radians/sec), which is generally represented by ω(=2πf) and is called angular frequency.

Now, a sine wave is compared with a cosine wave. The cosine wave is obtained by translating the sine wave by 90° or π/2 radians. The sine wave may be represented by the delayed cosine wave. This time delay is called phase. For example, when a pure cosine wave has a phase of 0, a sine wave has a phase of 90°. When a sine wave is added to a cosine wave, the amplitude of the resultant wave is increased by a factor of √2 and the phase is π/4.

In such analysis, Fourier series and frequency analysis may be available. In addition, Fourier transformation, discrete Fourier transformation, and power spectrum may be available. In Fourier expansion, techniques, such as wavelet transformation and the like, may be available. These techniques are well known in the art and are described in, for example, Yukio Shimizu, “Seimei Sisutemu Kaiseki notameno Sugaku [Mathematics for analyzing life systems]”, Corona sha, (1999); and Yasuhiro Ishikawa, “Rinsho Igaku notameno Ueburetto Kaiseki [Wavelet analysis for clinical medicine]”, Igaku Shuppan.

### DESCRIPTION OF PREFERRED EMBODIMENTS

Hereinafter, the present invention will be described by way of embodiments. The embodiments described below are provided only for illustrative purposes. Accordingly, the scope of the present invention is not limited by the embodiments except as by the appended claims.

In one aspect, the present invention provides a method for representing a state of a cell. The method comprises the steps of: a) obtaining a time-lapse profile of the cell by time-lapse monitoring of the state of a cell associated with at least one biological agent selected from biological agents derived from the cell; and b) presenting the time-lapse profile. For example, the profile of the intensity of a signal obtained by monitoring is subjected to interval differentiation, thereby obtaining a function of changes which can be in turn displayed. In this case, preferably, for example a constitutive promoter or the like, which is assumed to be changed, can be used as a reference to obtain a difference, thereby obtaining a time-lapse profile. The present invention is not limited to this.

The profiles may be displayed using any method, for example, they may be visually displayed using a display device (e.g., an x axis showing time while the y axis shows signal intensity), or alternatively, may be displayed as a table of numerical values. Alternatively, signal intensity may be displayed as optical intensity. Furthermore, profiles may be presented by means of sound.

Preferably, cells are fixed to a solid phase support (e.g., an array, a plate, a microtiter plate, etc.) when they are monitored. Such fixation can be carried out using techniques known in the art or techniques as described herein. Fixation or immobilization of a cell allows systematic investigation thereof.

In a preferred embodiment, such a time-lapse profile may be presented in real time. The real time presentation may contain a time lag to some extent if it is performed substantially in real time. A tolerable time lag is, for example, 10 seconds at maximum, and more preferably 1 second at maximum, though the tolerable time lag depends on the required level of real time (simultaneity).

In another aspect, the present invention provides a method for determining a state of a cell. Such determination of the cellular state is achieved by monitoring changes in a transcriptional state of a transcription control factor, which are not conventionally observed. Therefore, the method of the present invention for determining the cellular state allows the determination of various states which cannot be conventionally observed. Such a method comprises the steps of: a) obtaining a time-lapse profile of the cell by time-lapse monitoring of a transcriptional state associated with at least one biological agent selected from a biological agent group derived from the cell; and b) determining the state of the cell based on the time-lapse profile of the transcription level.

Preferably, cells are fixed to a solid phase support (e.g., an array, a plate, a microtiter plate, etc.) when they are monitored. Such fixation can be carried out using techniques known in the art or techniques as described herein.

In a preferred embodiment, advantageously, the cellular state determination method of the present invention may further comprise correlating the time-lapse profile with the state of the cell before obtaining the time-lapse profile. Alternatively, such correlation information may be provided from known information. Such a correlating step may be performed at every determining step or correlation information may be stored in a database and used as required.

In a preferred embodiment, the transcription control sequence may be, without limitation, a promoter, an enhancer, a silencer, another flanking sequence of a structural gene in a genome, and a genomic sequence other than exons. A promoter is preferable. This is because the transcription level can be directly measured, and the state of transcription thus directly reflects the state of a cell. In a particular embodiment, the transcription control sequences may include constitutive promoters, specific promoters, inducible promoters, and the like.

In certain embodiments, any promoter may be used. The present invention is characterized in that any type of promoter can be used. According to the method of the present invention, profiles can be analyzed from a viewpoint of “procession”. Therefore, it is possible to determine a state of a cell using any promoter or any set of promoters. Such determination cannot be achieved by conventional techniques. The present invention is highly useful since the present invention achieves what cannot be achieved by conventional techniques.

In a preferred embodiment, at least two biological agents (for example, transcriptional control sequence) are monitored. By observing at least two biological agents, 80% of the states of a cell can be typically identified. More preferably, at least 3 biological agents are monitored. By observing at least three biological agents, at least 90% of the states of a cell can be typically identified. In a most preferred embodiment, at least 8 biological agents are monitored. By observing at least 8 biological agents, substantially all of the states of a cell can be typically identified. Thus, although any biological agents are selected, substantially all of the states of a cell can be determined by selecting and monitoring a small number of biological agents, as described above. This feature has not been conventionally expected. The method of the present invention is simpler, more precise and more accurate than conventional determination methods in which observation is made at time points and resultant data is statistically processed as heterologous groups.

Therefore, the determination method of the present invention preferably further comprises arbitrarily selecting at least one biological agent from a biological agent group before monitoring. An important feature of the present invention is such that a biological agent, which does not exhibit specificity when investigated from point to point, can be used. Further, the present invention allows accurate reflection of the resultant data to the state of a cell of interest, since data are linearly measured under a consistent environment. Such accurate data cannot be obtained by means of conventional technology.

In a preferred embodiment, such a time-lapse profile obtained in the present invention may be presented in real time. Alternatively, in the present invention, data may be obtained in a real time manner. As used herein, the term “real time” means that the real time presentation may contain a time lag to some extent if it is performed substantially in real time. A tolerable time lag is, for example, 10 seconds at maximum, and more preferably 1 second at maximum, though the tolerable time lag depends on the required level of real time (simultaneity). For example, the level of real time may be preferably 30 seconds at maximum, or even longer in the case of, for example, therapies required for real time diagnosis.

In a particular preferable embodiment, states determined by the cellular state determination method of the present invention includes, for example, differentiated states, undifferentiated states, cellular responses to external factors, cell cycles, growth states, and the like. More specifically, such a state includes, for example, without limitation, a response of a cancer cell to an anticancer agent, drug resistance, a response to a biological clock, a differentiated state of a stem cell (e.g., a mesenchymal stem cell, a neural stem cell, etc.), an undifferentiated state of a purified stem cell (e.g., an embryonic stem cell, etc.), a change in cellular morphology, a state of cellular migration, intracellular localization of a molecule, production of a secreted substance, and the like.

Therefore, in a preferred embodiment, a cell assessed by the cellular state determination method of the present invention includes, for example, without limitation, a stem cell or a somatic cell, or a mixture thereof. Alternatively, such a cell includes an adherent cell, a suspended cell, a tissue forming cell, and a mixture thereof.

In a preferred embodiment, the cellular state determination method of the present invention may be performed upon a cell fixed on a substrate which is a solid phase support. In such a case, the solid phase support is called a chip. When cells are arrayed on the substrate, the substrate is also called an array.

In a particularly preferred embodiment of the cellular state determination method of the present invention, advantageously, when a biological agent (for example, a transcription control sequence) used for determination is a nucleic acid molecule, such a nucleic acid molecule may be operably linked to a reporter gene sequence and may be transfected into a cell. In this case, the transcription level of the transcription control sequence can be measured as a signal from the reporter gene.

Such transfection may be performed in the solid phase or in the liquid phase. For transfection, a technique for increasing the efficiency of introduction of a target substance into a cell may be used. In the present invention, a target substance (e.g., DNA, RNA, a polypeptide, a sugar chain, or a composite substance thereof, etc.), which cannot be substantially introduced into cells under typical conditions, is presented (preferably, contacted) along with an actin-like substance, such as fibronectin, to a cell, thereby making it possible to efficiency introduce the target substance into cells. Therefore, the transfection method comprises the steps of: A) providing a target substance (i.e., DNA comprising a transcription control sequence) and B) providing an actin-like substance (e.g., fibronectin), wherein the order of steps of A) and B) is not particularly limited, and C) contacting the target substance and the actin-like substance with the cell. The target substance and the actin-like substance may be provided together or separately. The actin-like acting substance may be used as described in detail above for the composition of the present invention for increasing the efficiency of introduction of a target substance into a cell. Such a technique can be carried out by those skilled in the art as based on the present specification. Therefore, the actin-like substance may be used in a manner which is described in detail above for the composition of the present invention for increasing the introduction efficiency of a target substance into a cell. Preferably, the actin-like acting substance may be an extracellular matrix protein (e.g., fibronectin, vitronectin, laminin, etc.) or a variant thereof. More preferably, fibronectin, a variant or fragment thereof may be used.

In one embodiment, a transcription control sequence used in the present invention may be capable of binding to a transcription factor. Examples of such a transcription factor include, but are not limited to, ISRE, RARE, STAT3, GAS, NFAT, MIC, AP1, SRE, GRE, CRE, NFκB, ERE, TRE, E2F, Rb, p53, and the like. These transcription factors are commercially available from BD Biosciences Clonetech, CA, USA. ISRE is related to STAT1/2. RARE is related to retinoic acid. STAT3 is related to the control of differentiation. GRE is related to the metabolism of sugar. CRE is related to cAMP. TRE is related to thyroid hormone. E2F is related to cell cycle. p53 is related to G1 check point. Therefore, such information can be used to determine a state of a cell.

In a preferred embodiment, the determination step of b) of the present invention comprises comparing the phases of the time-lapse profiles. Phases can be calculated by those skilled in the art using general techniques as described herein above and techniques described in the examples below.

In another preferred embodiment, the determination step of b) of the present invention comprises calculating a difference between the time-lapse profile of the cell and a control profile. The difference can be calculated by those skilled in the art using general techniques as described herein above and techniques described in Examples below.

In another preferred embodiment, the determination step of b) of the present invention comprises a mathematical process selected from the group consisting of signal processing and multivariate analysis. Such a mathematical process can be easily carried out by those skilled in the art based on the description of the present specification.

In another aspect, the present invention provides a method for correlating an external factor with a cellular response to the external factor. The method comprises the steps of: a) exposing a plurality of cells to an external factor on a support capable of retaining the cells in a consistent environment; b) monitoring a transcriptional state relating to at least one of a transcriptional factor group present on or within the cells over time to generate profile data for the cells; and c) correlating the external factor with the profile.

Any external factor to be correlated in the present invention may be used. Such an external factor is preferably directly or indirectly applicable to a cell. A method for applying such an external factor is well known in the art, depending on the type of external factor used. When a substance is used, the substance is dissolved into a solvent, and the resultant solution is added to a medium containing a cell.

The correlation method of the present invention may utilize the production method of profiles as described hereinabove.

A variety of methods can be provided for correlating a foreign agent to a profile in the method of correlation of the present invention. In brief, profiles obtained when a foreign agent is applied to a cell, are patternized, and if there is little difference between the patternized profiles, it can be inferred that the particular foreign agent has been applied to the cells.

Preferably, a cell may be monitored in an immobilized state to a solid support such as an array, a plate, a microtiterplate and the like. Such a method for immobilization can be conducted based on any known methodology in the art or the methods described herein.

In a preferred embodiment, a correlation method of the present invention may further comprise using at least two external factors to obtain a profile for each external factor. In certain embodiments, at least three, or at least four, more preferably at least ten such foreign agents may be used but the present invention is not limited thereto.

More preferably, the correlation step may further comprise dividing at least two profiles into categories and classifying the external factors corresponding to the respective profiles into the categories. Such categorization may be readily conducted by those skilled in the art based on the description of the present specification. Such categorization or classification allows correlation and identification of an unknown foreign agent by means of the method of the present invention.

In a preferred embodiment, a transcription control sequence used in the present invention may be, without limitation, a promoter, an enhancer, a silencer, other flanking sequences of structural genes in genomes, and genomic sequences other than exons. A promoter is preferable, since the transcription level can be directly measured.

In a particular embodiment, transcription control sequences used in the present invention may be constitutive promoters, specific promoters, inducible promoters, and the like. The present invention is characterized in that any type of promoter can be used.

According to the method of the present invention, profiles can be analyzed from a viewpoint of “process” or “procession”. Therefore, it is possible to determine a state of a cell by using any promoter or any set of promoters. Such determination cannot be achieved by conventional techniques. The present invention is highly useful since the present invention achieves what cannot be achieved by conventional techniques.

In a preferred embodiment, at least two transcription control sequences are monitored. By observing at least two transcription control sequences, at least 80% of the states of a cell can be typically identified. More preferably, at least 3 transcription control sequences are monitored. By observing at least three transcription control sequences, at least 90% of the states of a cell can be typically identified. In a most preferred embodiment, at least 8 transcription control sequences are monitored. By observing at least 8 transcription control sequences, substantially all of the states of a cell can be typically identified. Thus, although any transcription control sequences are selected, substantially all of the states of a cell can be determined by selecting and monitoring a small number of transcription control sequences as described above. This feature has not been conventionally expected. The method of the present invention is simpler, more precise and more accurate than conventional determination methods in which observation is made at time points and resultant data is statistically processed as heterologous groups.

Therefore, the determination method of the present invention preferably further comprises arbitrarily selecting at least one transcription control sequence from a group of transcription control sequences before monitoring. An important feature of the present invention is such that a transcription control sequence, which does not exhibit specificity when investigated from point to point, can be used.

In a preferred embodiment, such a time-lapse profile may be presented in real time. The real time presentation may contain a time lag to some extent if it is performed substantially in real time. A tolerable time lag is, for example, 10 seconds at maximum, and more preferably 1 second at maximum, though the tolerable time lag depends on the required level of real time (simultaneity). For example, in the case of environment measurement requiring real time identification of external factors, the tolerable time lag may be, for example, 1 sec at maximum, 0.1 sec at maximum, or the like. Alternatively, after data is stored on a storage medium at real time, profiles may be presented corresponding to the data based on the stored data, with some time lag.

In a preferred embodiment, in the correlation step of c) of the present invention, the phase of the time-lapse profile may be used as information about the time-lapse profile in order to correlate the external factor with the time-lapse profile. The phase is represented by plus or minus depending on the signal intensity at a certain time. Even using such a simplified method, a cell or an external factor can be identified, thus demonstrating the precision of the method of the present invention.

Preferably, in the method of the present invention, cells are advantageously cultured on an array. This is because a number of cells can be simultaneously observed. Preferably, when a cell is immobilized on a solid support such as an array, a salt may be used.

In a preferred embodiment, the step of monitoring the transcription level over time may comprise obtaining image data from the array. This is because image data can be subjected to visual inspection and a human (particularly, a person skilled in the art, such as a medical practitioner or the like) can easily examine image data with his/her eyes.

In a preferred embodiment of the present invention, the step of correlating the external factor with the time-lapse profile may comprise distinguishing the phases of the time-lapse profiles. As described above, phase is a simple parameter, and its information processing is simple. Thus, cells can be well identified by such simple information processing.

In a preferred embodiment, examples of an external factor to be identified by the method of the present invention include, but are not limited to, a temperature change, a humidity change, an electromagnetic wave, a potential difference, visible light, infrared light, ultraviolet light, X-ray, a chemical substance, a pressure, a gravity change, a gas partial pressure, an osmotic pressure, and the like. These factors cannot be satisfactorily identified by conventional methods. By using the cell determination method of the present invention which places an importance on “procession”, an influence of a factor on a cell can be well examined.

In a particularly preferred embodiment, an external factor to be identified by the method of the present invention may be a chemical substance. Examples of such a chemical substance include, but are not limited to, biological molecules, chemical compound, media, and the like.

Examples of biological molecules include, but are not limited to, nucleic acids, proteins, lipids, sugars, proteolipids, lipoproteins, glycoproteins, proteoglycans, and the like. These biological molecules are known to have an influence on organisms. Unknown biological molecules are also highly likely to have an influence on organisms and are considered to be important targets for study.

Particularly preferably, hormones, cytokines, cell adhesion factors, extracellular matrices, receptor agonists, receptor antagonists, and the like, which are expected to have an influence on cells, are used as biological molecules to be investigated.

In another aspect, the present invention provides a method for inferring an unidentified external factor given to a cell based on a time-lapse profile of the cell. The method comprises the steps of: a) exposing the cell to a plurality of known external factors; b) obtaining a time-lapse profile of the cell for each known external factor by time-lapse monitoring of the transcription level associated with at least one biological agent selected from the group consisting of biological agents derived from the cell; c) correlating the known external factors with the respective time-lapse profiles; d) exposing the cell to the unidentified external factor; e) obtaining a time-lapse profile of the unidentified external factor by time-lapse monitoring of the transcription level of the selected biological agent; f) determining a profile corresponding to the time-lapse profile obtained in the step of e) from the time-lapse profiles obtained in the step of b); and g) determining that the unidentified external factor is the known external factor corresponding to the profile determined in the step of f).

In the method of the present invention, the step of exposing a cell to external factors can be performed as described above herein or as illustrated in the examples described below. The step of obtaining a time-lapse profile can be performed as described above herein or as illustrated in the examples described below. The correlation step can be performed as described above herein or as illustrated in the examples described below. After information about all known external factors has been obtained, an unidentified external factor is similarly monitored. These pieces of information are compared to determine whether or not the unidentified external factor is a known one. If the profile of an unidentified factor fully matches the profile of a known factor, these two factors can be determined as being identical. Also, if the profile of an unidentified factor substantially matches the profile of a known factor, these two factors can be determined to be identical. Such determination depends on the information quantity and quality of the known external factor. Such determination can be easily carried out by those skilled in the art considering various elements.

In another aspect, the present invention provides a method for inferring an unidentified external factor given to a cell based on a time-lapse profile of the cell. The method comprises: a) providing data relating to a correlation relationship between known external factors and time-lapse profiles of the cell in response to the known external factors, in relation to at least one promoter selected from promoters present in the cell; b) exposing the cell to the unidentified external factor; c) obtaining a time-lapse profile of the cell by time-lapse monitoring of a transcription level associated with the selected promoter; d) determining a profile corresponding to the time-lapse profile obtained in the step of c) from the time-lapse profiles obtained in the step of a); and e) determining that the unidentified external factor is the known external factor corresponding to the profile determined in the step of d).

Exposure to external factors, profile generation, correlation, and the like can be carried out using techniques as described herein above or as illustrated in the examples below.

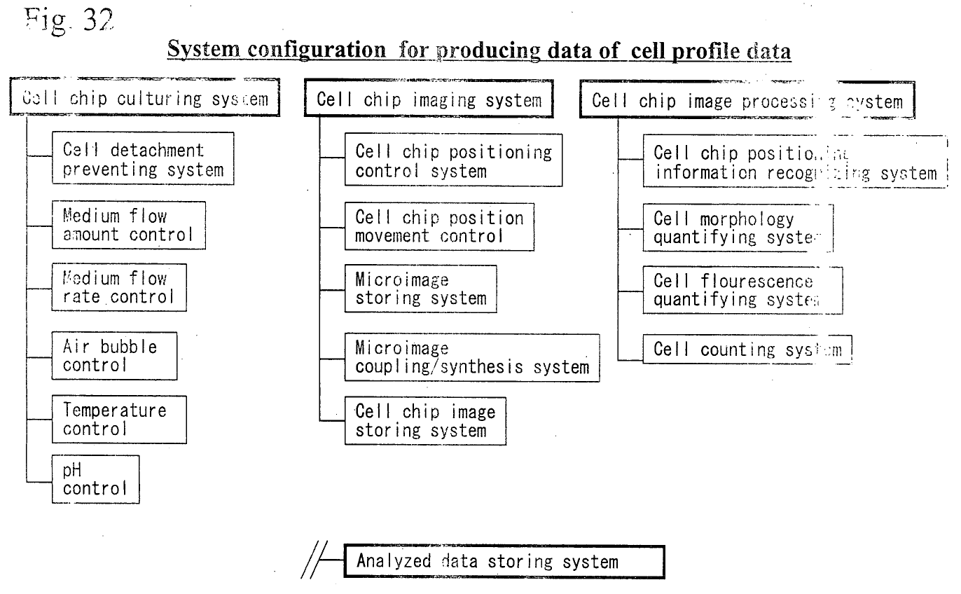

In another aspect, the present invention provides a system for presenting a state of a cell. The system comprises: a) means for obtaining a time-lapse profile of the cell by time-lapse monitoring of a transcription level associated with at least one transcription control sequence selected from the group consisting of transcription control sequences derived from the cell; and b) means for presenting the time-lapse profile. An exemplary system configuration is presented in FIG. 32.

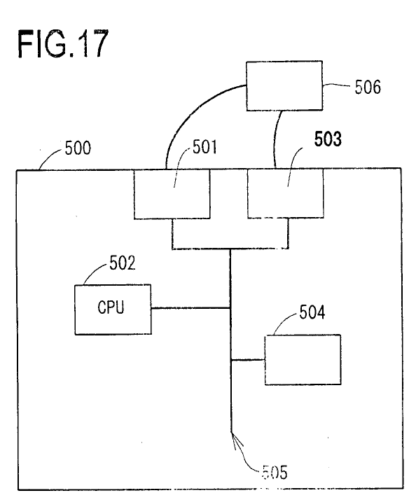

A configuration of a computer or system for implementing the cellular state presenting method of the present invention is shown in FIG. 17. FIG. 17 shows an exemplary configuration of a computer 500 for executing the cellular state presenting method of the present invention. An exemplary system configuration is presented in FIG. 32.

The computer 500 comprises an input section 501, a CPU 502, an output section 503, a memory 504, and a bus 505. The input section 501, the CPU 502, the output section 503, and the memory 504 are connected via a bus 505. The input section 501 and the output section 503 are connected to an I/O device 506.

An outline of a process for presenting a state of a cell, which is executed by the computer 500, will be described below.

A program for executing the cellular state presenting method (hereinafter referred to as a “cellular state presenting program”) is stored in, for example, the memory 502. Alternatively, each component of the cellular state presenting program may be stored in any type of recording medium, such as a floppy disk, MO, CD-ROM, CD-R, DVD-ROM, or the like separately or together. Alternatively, the program may be stored in an application server. The cellular state presenting program stored in such a recording medium is loaded via the I/O device 506 (e.g., a disk drive, a network (e.g., the Internet)) to the memory 504 of the computer 500. The CPU 502 executes the cellular state presenting program, so that the computer 500 functions as a device for performing the cellular state presenting method of the present invention.

Information about a cell or the like is inputted via the input section 501 as well as profile data obtained. Known information may be inputted as appropriate.

The CPU 502 generates display data based on the information about profile data and cells through the input section 501, and stores the display data into the memory 504. Thereafter, the CPU 502 may store the information in the memory 504. Thereafter, the output section 503 outputs a cellular state selected by the CPU 502 as display data. The output data is outputted through the I/O device 506.

In another aspect, the present invention provides a system for determining a state of a cell. The system comprises: a) means for obtaining a time-lapse profile of the cell by time-lapse monitoring of a transcription level associated with at least one biological agent selected from the group consisting of biological agents derived from the cell; and b) means for determining the state of the cell based on the time-lapse profile. An exemplary system configuration is presented in FIG. 32.

A configuration of a computer or system for implementing the cellular state determining method of the present invention is shown in FIG. 17. FIG. 17 shows an exemplary configuration of a computer 500 for executing the cellular state determining method of the present invention. An exemplary system configuration is presented in FIG. 32.

The computer 500 comprises an input section 501, a CPU 502, an output section 503, a memory 504, and a bus 505. The input section 501, the CPU 502, the output section 503, and the memory 504 are connected via a bus 505. The input section 501 and the output section 503 are connected to an I/O device 506.

An outline of a process for determining a state of a cell, which is executed by the computer 500, will be described below.

The program for executing the cellular state determining method (hereinafter referred to as a “cellular state determining program”) is stored in, for example, the memory 502. Alternatively, each component of the cellular state determining program may be stored in any type of recording medium, such as a floppy disk, MO, CD-ROM, CD-R, DVD-ROM, or the like, separately or together. Alternatively, the program may be stored in an application server. The cellular state determining program stored in such a recording medium is loaded via the I/O device 506 (e.g., a disk drive, a network (e.g., the Internet)) to the memory 504 of the computer 500. The CPU 502 executes the cellular state presenting program, so that the computer 500 functions as a device for performing the cellular state determining method of the present invention.

Information about a cell or the like is inputted via the input section 501, as well as profile data obtained. Known information may be inputted as appropriate.

The CPU 502 determines the state of a cell based on the information about profile data and cells as inputted through the input section 501, generates the results as determination result data, and stores the determination result data in the memory 504. Thereafter, the CPU 502 may store the information in the memory 504. Thereafter, the output section 503 outputs a cellular state selected by the CPU 502 as a result data. The output data is outputted through the I/O device 506.

In another aspect, the present invention provides a system for correlating an external factor with a response of a cell to the external factor. The system comprises: a) means for exposing the cell to the external factor; b) means for obtaining a time-lapse profile of the cell by time-lapse monitoring of a transcription level associated with at least one promoter selected from the group consisting of promoters derived from the cell; and c) means for correlating the external factor with the time-lapse profile. Such a system can be implemented using a computer as in the above-described systems. An exemplary system configuration is presented in FIG. 32.

In another aspect, the present invention provides a system for inferring an unidentified external factor given to a cell based on a time-lapse profile. The system comprising: a) means for exposing the cell to a plurality of known external factors; b) means for obtaining a time-lapse profile of the cell for each known external factors by time-lapse monitoring of a transcription level associated with at least one biological agent selected from the group consisting of biological agents derived from the cell; c) means for correlating the known external factors with the respective time-lapse profiles; d) means for exposing the cell to the unidentified external factor; e) means for obtaining a time-lapse profile of the unidentified external factor by time-lapse monitoring of the transcription level of the selected transcription control sequence; f) means for determining a profile corresponding to the time-lapse profile obtained in the means of e) from the time-lapse profiles obtained in the means of b); and g) means for determining that the unidentified external factor is the known external factor corresponding to the profile determined in the means of f). Such a system can be implemented using a computer as with the above-described systems. An exemplary system configuration is presented in FIG. 32.

In another aspect, the present invention provides a system for inferring an unidentified external factor given to a cell based on a time-lapse profile, comprising: a) means for providing data relating to a correlation relationship between known external factors and time-lapse profiles of the cell in response to the known external factors, in relation to at least one biological agent selected from biological agents present in the cell; b) means for exposing the cell to the unidentified external factor; c) means for obtaining a time-lapse profile of the cell by time-lapse monitoring of a transcription level associated with the selected transcription control sequence; d) means for determining a profile corresponding to the time-lapse profile obtained in the means of c) from the time-lapse profiles obtained in the means of a); and e) determining that the unidentified external factor is the known external factor corresponding to the profile determined in the means of d). Such a system can be implemented using a computer as with the above-described systems. An exemplary system configuration is presented in —FIG. 32.

When the present invention is provided in the form of a system as described above, each constituent element thereof can be implemented as in the detailed or preferred embodiments of the method of the present invention. Preferred embodiments of such a system can be easily selected by those skilled in the art and can be made or carried out by those skilled in the art based on the present specification. An exemplary system configuration is presented in FIG. 32.

In another aspect, the present invention provides a computer recordable recording medium recording a program for executing a process for presenting a state of a cell to a computer. The recording medium records at least a program for executing the procedures of: a) obtaining a time-lapse profile of the cell by time-lapse monitoring of a transcription level associated with at least one biological agent selected from the group consisting of biological agents derived from the cell; and b) presenting the time-lapse profile.

In another aspect, the present invention provides a computer recordable recording medium recording a program for executing a process for determining a state of a cell to a computer. The recording medium records at least a program for executing the procedures of: a) obtaining a time-lapse profile of the cell by time-lapse monitoring of a transcription level associated with at least one biological agent selected from the group consisting of biological agents derived from the cell; and b) determining the state of the cell based on the time-lapse profile of the transcription level.

In another aspect, the present invention provides a computer recordable recording medium recording a program for executing a process for correlating an external factor with a response of a cell to the external factor. The recording medium records at least a program for executing the procedures of: a) exposing the cell to the external factor; b) obtaining a time-lapse profile of the cell by time-lapse monitoring of a transcription level associated with at least one transcription control factor selected from the group consisting of transcription control factors derived from the cell; and c) correlating the external factor with the time-lapse profile.

In another aspect, the present invention provides a computer recordable recording medium recording a program for executing a process for inferring an unidentified external factor given to a cell based on a time-lapse profile. The recording medium records at least a program for executing the procedures of: a) exposing the cell to a plurality of known external factors; b) obtaining a time-lapse profile of the cell for each known external factor by time-lapse monitoring of a transcription level associated with at least one transcription control factor selected from the group consisting of transcription control factors derived from the cell; c) correlating the known external factors with the respective time-lapse profiles; d) exposing the cell to the unidentified external factor; e) obtaining a time-lapse profile of the unidentified external factor by time-lapse monitoring of the transcription level of the selected transcription control sequence; f) determining a profile corresponding to the time-lapse profile obtained in the procedure of e) from the time-lapse profiles obtained in the procedure of b); and g) determining that the unidentified external factor is the known external factor corresponding to the profile determined in the procedure of f).

In another aspect, the present invention provides a computer recordable recording medium recording a program for executing a process for inferring an unidentified external factor given to a cell based on a time-lapse profile. The recording medium records at least a program for executing the procedures of: a) providing data relating to a correlation relationship between known external factors and time-lapse profiles of the cell in response to the known external factors, in relation to at least one transcription control sequence selected from transcription control sequences present in the cell; b) exposing the cell to the unidentified external factor; c) obtaining a time-lapse profile of the cell by time-lapse monitoring of a transcription level associated with the selected transcription control sequence; d) determining a profile corresponding to the time-lapse profile obtained in the procedure of c) from the time-lapse profiles obtained in the procedure of a); and e) determining that the unidentified external factor is the known external factor corresponding to the profile determined in the procedure of d).

When the present invention is provided in the form of a recording medium as described above, each constituent element thereof can be implemented as with the detailed or preferred embodiments of the method of the present invention. Preferred embodiments of such a recording medium can be easily selected by those skilled in the art and can be made or carried out by those skilled in the art based on the present specification.

In another aspect, the present invention provides a program for executing a process for presenting a state of a cell to a computer. The program executes the procedures of: a) obtaining a time-lapse profile of the cell by time-lapse monitoring of a transcription level associated with at least one biological agent selected from the group consisting of biological agents derived from the cell; and b) presenting the time-lapse profile.

In another aspect, the present invention provides a program for executing a process for determining a state of a cell to a computer. The program executes the procedures of: a) obtaining a time-lapse profile of the cell by time-lapse monitoring of a transcription level associated with at least one biological agent selected from the group consisting of biological agents derived from the cell; and b) determining the state of the cell based on the time-lapse profile of the transcription level.

In another aspect, the present invention provides a program for executing a process for correlating an external factor with a response of a cell to the external factor. The program executes the procedures of: a) exposing the cell to the external factor; b) obtaining a time-lapse profile of the cell by time-lapse monitoring of a transcription level associated with at least one transcription control factor selected from the group consisting of transcription control factors derived from the cell; and c) correlating the external factor with the time-lapse profile. Techniques implementing such procedures are well known in the art, and an appropriated program therefore may be produced by those skilled in the art depending on the purpose thereof.

In another aspect, the present invention provides a program for executing a process for inferring an unidentified external factor given to a cell based on a time-lapse profile. The program executes the procedures of: a) exposing the cell to a plurality of known external factors; b) obtaining a time-lapse profile of the cell for each known external factor by time-lapse monitoring of a transcription level associated with at least one transcription control factor selected from the group consisting of transcription control factors derived from the cell; c) correlating the known external factors with the respective time-lapse profiles; d) exposing the cell to the unidentified external factor; e) obtaining a time-lapse profile of the unidentified external factor by time-lapse monitoring of the transcription level of the selected transcription control sequence; f) determining a profile corresponding to the time-lapse profile obtained in the procedure of e) from the time-lapse profiles obtained in the procedure of b); and g) determining that the unidentified external factor is the known external factor corresponding to the profile determined in the procedure of f).

In another aspect, the present invention provides a program for executing a process for inferring an unidentified external factor given to a cell based on a time-lapse profile. The program executes the procedures of: a) providing data relating to a correlation relationship between known external factors and time-lapse profiles of the cell in response to the known external factors, in relation to at least one transcription control sequence selected from transcription control sequences present in the cell; b) exposing the cell to the unidentified external factor; c) obtaining a time-lapse profile of the cell by time-lapse monitoring of a transcription level associated with the selected transcription control sequence; d) determining a profile corresponding to the time-lapse profile obtained in the procedure of c) from the time-lapse profiles obtained in the procedure of a); and e) determining that the unidentified external factor is the known external factor corresponding to the profile determined in the procedure of d).

When the present invention is provided in the form of a program as described above, each constituent element thereof can be implemented as with the detailed or preferred embodiments of the method of the present invention. Preferred embodiments of such a program can be easily selected by those skilled in the art and can be made or carried out by those skilled in the art based on the present specification. Description formats of such a program are well known to those skilled in the art and include, for example, the C+ language, and the like.

In another aspect, the present invention provides a method and system for diagnosing a subject. The diagnosis method comprises the steps of: a) obtaining a time-lapse profile of the cell by time-lapse monitoring of a transcription level associated with at least one transcription control sequence selected from the group consisting of transcription control sequences derived from the cell; b) determining the state of the cell based on the time-lapse profile of the transcription level; and c) determining a condition, disorder or disease of a subject based on the state of the cell. The diagnosis method is provided in the form of a system, the system of the present invention comprises: a) means for obtaining a time-lapse profile of the cell by time-lapse monitoring of a transcription level associated with at least one transcription control sequence selected from the group consisting of transcription control sequences derived from the cell; b) means for determining the state of the cell based on the time-lapse profile of the transcription level; and c) means for determining a condition, disorder or disease of a subject based on the state of the cell. The present invention is applicable to tailor-made diagnoses and therapies, such as drug resistance, selection of appropriate anticancer agents, selection of appropriate transplant cells, and the like. Preferably, the diagnosis method of the present invention may be provided as a therapeutic or preventative method comprising the step of treating a subject with a therapy or preventative method selected based on the result of diagnosis. In another preferred embodiment, the diagnosis system of the present invention may be provided as a therapeutic or preventative system comprising means for treating a subject with a therapy or preventative method, selected based on the result of diagnosis. An exemplary system configuration is shown in FIG. 32.

The configuration of a computer or system for implementing the diagnosis method and system of the present invention is shown in FIG. 17. FIG. 17 shows an exemplary configuration of a computer 500 for executing the cellular state determining method of the present invention. An exemplary system configuration is shown in FIG. 32.

The computer 500 comprises an input section 501, a CPU 502, an output section 503, a memory 504, and a bus 505. The input section 501, the CPU 502, the output section 503, and the memory 504 are connected via a bus 505. The input section 501 and the output section 503 are connected to an I/O device 506.

An outline of a correlation process, which is executed by the computer 500, will be described below.

A program for executing the correlation method and/or selection of treatment or preventative method (hereinafter referred to as a “correlation program and a selection program”, respectively) is stored in, for example, the memory 502. Alternatively, the correlation program and the selection program may be stored in any type of recording medium, such as a floppy disk, MO, CD-ROM, CD-R, DVD-ROM, or the like, separately or together. Alternatively, the programs may be stored in an application server. The correlation program and the selection program stored in such a recording medium are loaded via the I/O device 506 (e.g., a disk drive, a network (e.g., the Internet)) to the memory 504 of the computer 500. The CPU 502 executes the correlation program and the selection program, so that the computer 500 functions as a device for performing the correlation method and the selection method of the present invention.

The result of analysis of a time-lapse profile (e.g., phase, etc.) and information about a cell or the like are inputted via the input section 501. Secondary information about a condition, disorder or disease to be correlated with a time-lapse profile and information about treatment and/or preventative methods may be inputted as required.

The CPU 502 correlates information about a time-lapse profile with a state of a cell or a condition, disorder or disease of a subject and a preventative or therapeutic method as required, based on the information inputted through the input section 501, and stores correlation data into the memory 504. Thereafter, the CPU 502 may store the information in the memory 504. Thereafter, the output section 503 outputs information about a state of a cell or a condition, disorder or disease of a subject and a preventative or therapeutic method as required, which has been selected by the CPU 502 as diagnostic information. The output data is outputted through the I/O device 506.

(Generation of Data)

In one aspect, the present invention provides a method for generating profile data of information of a cell. The method comprises the steps of: a) providing and fixing the cell to a support; and b) monitoring a biological agent or an aggregation of biological agents on or within the cell over time to generate data on the profile of the cell. In this aspect, the present invention is characterized in that the cell is fixed to substantially the same site on the support so that information can be continuously (e.g., in a time-lapse manner, etc.) obtained from the same cell. Thereby, it is possible to monitor a biological agent and an aggregation of biological agents over time. Time-lapse monitoring makes it possible to obtain a profile of a cell and construct a digital cell. To fix a cell to a support, a fixing agent, such as a salt or the like, may be used in the present invention. A combination of a salt, a complex of a positively charged substance and a negatively charged substance, and a cell may fix the cell to the support. Any salt may be used in the present invention. Examples of such a salt include, but are not limited to, calcium chloride, sodium hydrogen phosphate, sodium hydrogen carbonate, sodium pyruvate, HEPES, sodium chloride, potassium chloride, magnesium sulfide, iron nitrate, amino acids, vitamins, and the like. Examples of the above-described combination of a positively charged substance and a negatively charged substance include, but are not limited to, complexes of a negatively charged substance selected from the group consisting of DNA, RNA, PNA, a polypeptide, a chemical compound, and a complex thereof and a positively charged substance selected from the group consisting of a cationic polymer, a cationic lipid, a cationic polyamino acid, and a complex thereof. In a preferred embodiment of the present invention, a biological agent of interest may be a nucleic acid molecule or a molecule derived from such a nucleic acid molecule. This is because most nucleic acid molecules carry genetic information, from which cellular information can be obtained.

In another aspect, the present invention relates to data obtained by a method comprising the steps of: a) providing and fixing the cell to a support; and b) monitoring a biological agent or an aggregation of biological agents on or within the cell over time to generate data of the profile of the cell. Such data is obtained by the method which is not conventionally available, and is thus per se novel. Therefore, the present invention provides a recording medium storing such data.

In another aspect, the present invention relates to a method for generating profile data of information of a plurality of cells in a consistent environment. The method comprises the steps of: a) providing a plurality of cells on a support which can maintain a consistent environment; and b) monitoring a biological agent or an aggregation of biological agents on or within the cells over time to generate profile data for the cells. In this aspect, the present invention is characterized in that profile data or information for a plurality of cells in a consistent environment can be obtained. Techniques for providing such an environment are also within the scope of the present invention. To provide a consistent environment for a plurality of cells, a fixing agent, such as a salt or the like, may be used for the support in the present invention. A combination of a salt, a complex of a positively charged substance and a negatively charged substance, and cells may fix the cells to the support. Any salt may be used in the present invention. Examples of such a salt include, but are not limited to, calcium chloride, sodium hydrogen phosphate, sodium hydrogen carbonate, sodium pyruvate, HEPES, sodium chloride, potassium chloride, magnesium sulfide, iron nitrate, amino acids, vitamins, and the like. Examples of the above-described combination of a positively charged substance and a negatively charged substance include, but are not limited to, complexes of a negatively charged substance selected from the group consisting of DNA, RNA, PNA, a polypeptide, a chemical compound, and a complex thereof and a positively charged substance selected from the group consisting of a cationic polymer, a cationic lipid, a cationic polyamino acid and a complex thereof. In a preferred embodiment of the present invention, a biological agent of interest may be a nucleic acid molecule or a molecule derived from such a nucleic acid molecule. This is because most nucleic acid molecules carry genetic information, from which cellular information can be obtained.

In a preferred embodiment, an actin-like acting substance is preferably provided to the cells in the method of the present invention. The actin-like acting substance acts on actin within the cells to deform the internal cytoskeleton to facilitate the introduction of an external factor into the cells. The presence of such an actin-like acting substance makes it possible to investigate the influence of an external factor of interest in or on the cells.

In one embodiment, a biological agent targeted by the present invention is at least one factor selected from the group consisting of nucleic acids, proteins, sugar chains, lipids, low molecular weight molecules, and composite molecules thereof.

In a preferred embodiment, cells targeted by the present invention are preferably cultured for a certain period of time without stimulation before monitoring. This procedure is performed for the purpose of synchronizing the target cells. The period of time required for synchronization is, for example, advantageously at least one day, more preferably at least two days, even more preferably at least 3 days, and still even more preferably at least 5 days. It should be noted that as the period of time for culture is increased, the necessity of maintaining the culture conditions increases. In the synchronization procedure, the same medium is preferably supplied to cells. Therefore, the culture medium is preferably consistent or at least changed in a consistent manner. To achieve this, a means for causing convection in the medium may be preferably provided and used.

In a more preferred embodiment, a biological agent provided to a cell in the present invention may comprise a nucleic acid molecule encoding a gene. The nucleic acid molecule encoding a gene is preferably transfected into a cell. Preferably, such a biological agent may be provided along with a transfection reagent (gene introduction reagent). More preferably, the nucleic acid molecule encoding a gene may be provided to a cell along with a gene introduction reagent and an actin-like acting substance. In this case, the cell is preferably provided with a complex of a salt, a positively charged substance, and a negatively charged substance (in this case, a nucleic acid molecule and a gene introduction reagent). Thus, the cell and the target molecule are fixed on a support. In addition, this technique makes it possible to allow biological agents (e.g., nucleic acid molecules) to be separately introduced into cells without a partition. As substantially no partition is used, a plurality of cells can be monitored in a substantially consistent environment. Further, different biological agents can be introduced into a cell, thereby making it possible to obtain a profile of a state of the cell affected by the biological agents. Such a profile can be stored as data. Such data may be stored in a certain standard format, and therefore, can be reproduced and compared. Thus, the present invention has an effect which is not achieved by conventional biological assays. Such data, once obtained and stored in such a standard format, can be extracted and used for various purposes and a number of times. For example, researchers can perform “virtual experiments” to conduct various analyses under the same conditions while taking into consideration differences in a substantially infinite number of parameters. In addition, since virtual experiments and the results thereof are stored in a raw data format, undergraduate and graduate students, who otherwise spend most of their school life doing laboratory work, can receive education in data analysis in the true sense. The above-described cellular profile data can be easily standardized, thereby making it possible to do research based on data which may have been obtained by experiments under the same conditions worldwide. Such data may be distributed in a standardized form. Such a standardized form may be readable to typical computers (e.g., computers having a commonly available OS, such as Windows, Mac, UNIX, LINUX, or the like). Data produced in the present invention may include generated cellular profile data, information about experimental conditions used in data generation, information about cells, information about environments, and the like.

In a preferred embodiment, a profile targeted by the present invention may include a profile of gene expression, a profile of an apoptotic signal, a profile of a stress signal, a profile of the localization of a molecule (preferably, the molecule is labeled with a fluorescent, phosphorescent, or radioactive substance, or a combination thereof), a profile of changes in cellular morphology, a profile of a promoter, a profile of a promoter dependent on a specific pharmaceutical agent (e.g., antibiotics, ligands, toxins, nutrients, vitamins, hormones, cytokines, etc.), a profile of an intermolecular interaction, and the like. In an embodiment in which the present invention targets a profile of a promoter dependent on a specific pharmaceutical agent, it is preferable that the present invention may further comprise administering the specific pharmaceutical agent.

In a preferred embodiment, the present invention may further comprise providing an external stimulus to the cell. Such an external stimulus may or may not be a biological agent. The external factor may be any factor and includes, without limitation, substances or other elements (e.g., energy, such as ionizing radiation, radiation, light, acoustic waves, and the like).

In one embodiment, an external factor used in the present invention may be RNAi. RNAi can be used to substantially suppress an arbitrary gene. It is possible to produce RNAi for all existing genes and investigate the effect of RNAi on the genes. RNAi can be created by techniques well known in the art.

In another embodiment, an external factor of the present invention may comprise a chemical substance which does not exist in organisms. By providing such a chemical substance which does not exist in organisms, it is possible to collect a variety of information. Once collected, such data can be reused. Therefore, assuming that a chemical substance which does not exist in organisms is not substantially available, if data can be obtained once for such a chemical substance in accordance with the present invention, research can continue without worrying about the availability of such a chemical substance.

In one embodiment, an external factor targeted by the present invention may comprise a ligand to a cellular receptor. By analyzing a ligand, it is possible to study various signal transduction pathways. Therefore, in such a case, a profile obtained according to the present invention may be a profile of receptor-ligand interactions.

In a preferred embodiment of the present invention, a profile of cellular morphology may be obtained. In this case, a method of the present invention may further comprise applying a stimulus to a cell which may be selected from the group consisting of overexpression of a gene, underexpression of a gene, knock down of a gene, addition of an external factor, and a change in an environment.

In a preferred embodiment, a profile obtained according to the present invention may be a profile of interactions between molecules present within a cell. Such intermolecular interactions include, but is not limited to, interactions between molecules present in a signal transduction pathway, interactions between a receptor and a ligand, interactions between a transcription factor and a transcription factor sequence, and the like.

In another preferred embodiment, a profile obtained according to the present invention may be a profile of interactions between molecules present in a cell. In this case, a method of the present invention may further comprise observing a cell using a technique selected from the group consisting of a two-hybrid method, FRET, and BRET. The two-hybrid method detects intermolecular interaction within a cell. Specifically, this technique is described in, for example, Protein-Protein Interactions, A MOLECULAR CLONING MANUAL, Edited by Erica Golemis, Cold Spring Habor Laboratory Press, Cold Spring Harbor, N.Y. (this document also describes FRET). FRET is a technique for detecting inter- or intra-molecular resonance energy shift as a fluorescent wavelength, and is described in, for example, Protein-Protein Interactions (supra); and Miyawaki A., Visualization of the spatial and temporal dynamics of intracellular signaling, Dev. Cell, 2003 March; 4(3):295-305. BRET is an intermolecular interaction assay system and is described in, for example, Boute N., The use of resonance energy transfer in high-throughput screening: BRET versus FRET, Trends Pharmacol Sci., 2002 August; 23(8):351-4.

In a preferred embodiment, cells targeted by the present invention are preferably arranged on a support in a pattern of an array. In this case, preferably, a plurality of cells targeted by the present invention may be spaced at intervals of 10 cm at maximum, more preferably 1 cm at maximum, even more preferably 1 mm at maximum, and most preferably 0.1 mm at maximum. The cells need to be spaced at minimum intervals. Such intervals may be preferably set so that substantially no interaction occurs.

In one embodiment, a profile obtained according to the present invention may or may not be obtained in real time. A real time profile may be advantageous. When simultaneity is important, it is important to obtain a profile in real time. Alternatively, when a profile is intended to be stored, the profile is not necessarily obtained in real time.

In an additional embodiment, the present invention further comprises fixing a cell to a solid phase support. In this case, the cell is fixed to the solid phase support along with a salt, a complex, an actin-like acting substance, or the like.

In one embodiment, data generated according to the present invention may contain information about a profile. In a preferred embodiment, data generated according to the present invention may contain information about conditions for monitoring, information about a cellular state, information about an external factor, information about an environment, and the like.

In a preferred embodiment, at least two biological agents may be preferably monitored in the present invention, more preferably at least 3 biological agents, and even more preferably at least 8 biological agents. Alternatively, all biological agents in a certain specific category (e.g., all olfactory receptors, all gustatory receptors, etc.) may be preferably monitored.

Alternatively, in another preferred embodiment, the present invention may further comprise arbitrarily selecting the above-described biological agents.

In a preferred embodiment, a cell targeted by the present invention may be selected from the group consisting of stem cells and somatic cells.

In one embodiment, a support used in the present invention is preferably a solid phase support. This is because cells are easily fixed to such a support. Such a solid phase support may be made of any material known in the art. The support may be in the form of a substrate or board.

In one embodiment of the present invention, the above-described biological agent may be a nucleic acid and the above-described cell may be transfected with the nucleic acid. By transfecting the cell with the nucleic acid, the influence of the nucleic acid on the cell can be collected in real time or in a standardized storable format into data or a profile. This cannot be achieved by conventional techniques. In a preferred embodiment, transfection may be performed in solid phase or in liquid phase. More preferably, transfection may be advantageously performed in solid phase. This is because data collection and standardization or normalization can be more easily carried out.

In a preferred embodiment of the present invention, a profile may be subjected to a process selected from the group consisting of phase comparison, calculation of a difference from a control profile, signal processing, and multivariate analysis. Data processed in such a manner may fall within the scope of the present invention.

In another aspect, the present invention provides a method for presenting profile data of information of a plurality of cells in the same environment. The method comprises the steps of: a) providing a plurality of cells on a support capable of retaining the cells in the same environment; b) monitoring a biological agent or an aggregation of biological agents on or within the cells over time to generate profile data of the cells; and c) presenting the data.

The above-described support capable of retaining a plurality of cells in the same environment can be achieved as described elsewhere herein. The step of generating data can be performed as described elsewhere herein. The step of presenting data can be performed as described elsewhere herein. Examples of a method of performing such presentation include, but are not limited to, techniques of using various sensory means, such as visual means, auditory means, olfactory means, tactile means, gustatory means, and the like. Preferably, a visually presenting means may be used. Such visual means includes, without limitation, a computer display and the like.

Preferably, in the presentation method of the present invention, presentation may be performed in real time. Alternatively, stored data may be called and presentation may be delayed. When presentation should be performed in real time, data signals may be transferred directly to, for example, a display.

In another aspect, the present invention provides a method for determining states of cells in the same environment. The method comprises the steps of: a) providing a plurality of cells on a support capable of retaining the cells in the same environment; b) monitoring a biological agent or an aggregation of biological agents on or within the cells over time to generate profile data of the dells; and c) determining the states of the cells based on the data.

The above-described support capable of retaining a plurality of cells in the same environment can be achieved as described elsewhere herein. The step of generating data can be performed as described elsewhere herein. The step of determining the states of the cells may be performed by correlating the generated data with information about the cells, or comparing the generated data with standard data. In this case, the data may be statistically processed.

Therefore, in a certain embodiment, the present invention may further comprise correlating a profile obtained according to the present invention to a state of a cell before obtaining the time-lapse profile. To perform determination smoothly, the cells targeted by the present invention may advantageously include cells whose states are known. It is possible to hold data of cells whose states are known, determination can be quickly performed by comparing data between the known cell and unknown cells.

In determination, at least two biological agents are preferably present. In this case, the plurality of biological agents may belong to heterologous categories (e.g., proteins and nucleic acids, etc.) or homologous categories.

Preferably, the present invention may further comprise arbitrarily selecting a biological agent. Any biological agent can be selected and used to characterize a state of a cell to some extent, and in some cases, identification is possible. Thus, the present invention has an effect which cannot be expected from conventional techniques.

In the determination method of the present invention, data may be preferably generated in real time. When data is generated in real time, an unknown substance or state of an unknown cell may be determined in real time.

In the determination method of the present invention, examples of a state of a target cell include, but are not limited to, differentiated state, undifferentiated state, cellular responses to external factors, cell cycles, growth states, and the like.

A cell targeted by the present invention may be either a stem cell or a somatic cell. Any somatic cell may be used. A cell may be selected by those skilled in the art, depending on the purpose of use of the cell.

A solid phase support used in the determination method of the present invention may comprise substrate. In the present invention, such a substrate can be used as a part of a computer system, so that determination can be automated. An exemplary configuration of such a system is shown in FIG. 32.

In a preferred embodiment, in the determination method of the present invention, the biological agent may be a nucleic acid molecule, and the cell is transfected with the nucleic acid molecule. Transfection may be performed on a solid phase support using any material, but preferably a gene introduction agent, more preferably a salt, an actin acting substance, or the like. Transfection may be performed in solid phase or in liquid phase, and preferably in solid phase.

In a determination method of the present invention, a target biological agent may be capable of binding to another biological agent. By investigating a biological agent having such a property, a network mechanism in a cell may be elucidated.

In a determination method of the present invention, the determination step may comprise a mathematical process selected from the group consisting of comparison of phases of profiles, collection of differences from a control profile, signal processing, and multivariate analysis. Such processing techniques are well known in the art and described in detail herein.

In another aspect, the present invention provides a method for correlating an external factor with a cellular response to the external factor. The method comprises the steps of: a) exposing a plurality of cells to an external factor on a support capable of retaining the cells in the same environment; b) monitoring a biological agent or an aggregation of biological agents on or within the cells over time to generate profile data of the cells; and c) correlating the external factor with the profile. Exposure of the cells to the external factor may be achieved by placing the cells and the external factor into an environment in which the cells are contacted with the external factor. For example, when the cells are fixed on the support, the external factor is added to the support to achieve exposure. Techniques for generating and correlating data are also well known in the art, and may be used singly or in combination. Preferably, statistical processes are performed to generate statistically significant data and information.

In a preferred embodiment, in the correlation method of the present invention, the cells may be fixed on the support. Since the cells are fixed, data can be easily standardized, so that data can be significantly efficiently processed.

In a preferred embodiment, the correlation method of the present invention may further comprise using at least two external factors to obtain a profile for each external factor. Techniques for obtaining such a profile are well described herein.

More preferably, the correlation step may further comprise dividing at least two profiles into categories and classifying the external factors corresponding to the respective profiles into the categories. By categorization, data can be processed in a more standardized manner.

In a preferred embodiment, the profile obtained by the present invention may be presented in real time. When data is intended to be stored, data may not be particularly presented in real time.

In a preferred embodiment, a cell used in the present invention may be cultured on an array. In such a case, therefore, the cell is preferably covered with medium. Any medium which is commonly used for cells may be used.

In a preferred embodiment of the present invention, the step of monitoring a profile may comprise obtaining image data from the array. Particularly, when a profile contains visual information (e.g., emission of fluorescence due to gene expression), the profile can be obtained by capturing image data.

In a correlation method of the present invention, the step of correlating an external factor with a profile may comprise distinguishing phases of the profile. Distinguishing phases of the profile can be achieved only after the present invention provides time-lapse profiles obtained in the same environment.

An external factor targeted by the present invention may be selected from the group consisting of a temperature change, a humidity change, an electromagnetic wave, a potential difference, visible light, infrared light, ultraviolet light, X-ray, a chemical substance, a pressure, a gravity change, a gas partial pressure, and an osmotic pressure. Preferably, the chemical substance may be a biological molecule, a chemical compound, or a medium. Examples of such a biological molecule include, but are not limited to, nucleic acid molecules, proteins, lipids, sugars, proteolipids, lipoproteins, glycoproteins, proteoglycans, and the like. Such a biological molecule may also be, for example, a hormone, a cytokine, a cell adhesion factor, an extracellular matrix, or the like. Alternatively, the chemical substance may be either a receptor agonist or antagonist.

In another aspect, the present invention relates to a method for identifying an unidentified external factor given to a cell from a profile of the cell. The method comprises the steps of: a) exposing a cell to a plurality of known external factors on a support capable of retaining the cell in the same environment; b) monitoring a biological agent or an aggregation of biological agents on or within the cell over time to generate a profile of the cell for each of the known external factor and generate profile data of the cell; c) correlating each of the known external factors with each of the profiles; d) exposing the cell to an unidentified external factor; e) monitoring a biological agent or an aggregation of biological agents on or within the cell exposed to the external factors over time to obtain a profile of the cell with respect to the unidentified external factor; f) determining, from the profiles obtained in the step of b), a profile corresponding to the profile obtained the step of e); and g) determining that the unidentified external factor is the known external factor corresponding to the profile determined in the step of f). Techniques for exposure to external factors, data generation, correlation, exposure to unidentified external factors, and the like are described elsewhere herein and can be selected as appropriate depending on the purpose of those skilled in the art taking such descriptions into consideration.

In another aspect, the present invention provides a method for identifying an unidentified external factor given to a cell from a profile of the cell. The method comprises the steps of: a) providing data relating to a correlation relationship between known external factors and profiles of the cell in response to the known external factors, in relation to a biological agent or an aggregation of biological agents on or within the cell; b) exposing the cell to the unidentified external factor; c) monitoring the biological agent or the aggregation of the biological agents on or within the cell to obtain a profile of the cell; d) determining, from the profiles provided in the step of a), a profile corresponding to the profile obtained in the step of c); and e) determining that the unidentified external factor is the known external factor corresponding to the profile determined in the step of d). Techniques for exposure to external factors, data generation, correlation, exposure to unidentified external factors, and the like are described elsewhere herein and can be selected as appropriate depending on the purpose by those skilled in the art taking such descriptions into consideration.

In another aspect, the present invention provides a method for obtaining a profile relating to information of a plurality of cells in the same environment. The method comprises the steps of: a) providing a plurality of cells on a support capable of retaining the cells in the same environment; and b) monitoring a biological agent or an aggregation of biological agents on or within the cell over time to generate a profile of the cells. Techniques for exposure to external factors, data generation, correlation, exposure to unidentified external factors, and the like are described elsewhere herein and can be selected as appropriate depending on the purpose by those skilled in the art taking such descriptions into consideration.

In another aspect, the present invention relates to a recording medium in which data generated by a method for generating cellular profile data of the present invention is stored. Data may be stored in any format. Any recording medium may be used. Examples of such a recording medium include, but are not limited to, CD-ROMs, flexible disks, CD-Rs, CD-RWs, MOs, mini disks, DVD-ROMs, DVD-Rs, memory sticks, hard disks, and the like. The present invention also relates to a transmission medium in which data generated by a method for generating cellular profile data of the present invention is stored. Examples of such a transmission medium include, but are not limited to, networks, such as intranets, the Internet, and the like.

A recording medium or transmission medium of the present invention may further contain data relating to at least one piece of information selected from the group consisting of information about conditions for the monitoring step, information about the profile, information about the cellular state, and information about the biological agent. Data relating to such information may be stored while being linked to one another. Preferably, the data may be advantageously standardized. Standardized data can be distributed on general distribution pathways. The above-described linkage may be constructed for each cell or for each biological agent, or for both.

In another aspect, the present invention relates to data generated by a method for generating cellular profile data of the present invention. Such data cannot be generated by conventional techniques and is thus novel.

In another aspect, the present invention provides a system for generating profile data of information of a plurality of cells in the same environment. The system comprises: a) a support capable of retaining a plurality of cells in the same environment; b) means for monitoring a biological factor or an aggregation of biological factors on or within the cells over time; and c) means for generating profile data of the cells from a signal obtained from the monitoring means. The support capable of retaining cells in the same environment can be made by those skilled in the art using a technique first provided by the present invention. Such a technique is attributed to the finding that cells are fixed and arrayed without a partition. Examples of the monitoring means include, but are not limited to, microscopes (e.g., optical microscopes, fluorescence microscopes, phase-contrast microscopes, etc.), electron microscopes, scanners, naked eyes, infrared cameras, confocal/nonconfocal microscopes, CCD cameras, and the like. An exemplary configuration of such a system is shown in FIG. 32.

In a system of the present invention, the system may not necessarily contain cells from the start, but preferably may contain cells which are advantageously fixed on a support. In such a case, fixation is preferably standardized. In addition, the cells are fixed and spaced, for example, without limitation, at intervals of 1 mm or the like.

In a preferred embodiment, at least one substance selected from the group consisting of salts and actin-acting substances may be preferably adhered to the support. By adhering cells to the support with a salt or an actin-acting substance, or preferably with both, fixation of the cells and/or introduction of a substance into the cells can be enhanced.

Examples of the monitoring means used in the system of the present invention include, but are not limited to, optical microscopes, fluorescence microscopes, phase-contrast microscopes, reading devices using a laser source, means using surface plasmon resonance (SPR) imaging, electric signals, chemical or biochemical markers singly or in combination, radiation, confocal microscopes, nonconfocal microscopes, differential interference microscopes, stereoscopic microscopes, video monitors, infrared cameras, and the like. Preferably, a scanner (e.g., a scanner for scanning a surface of a substrate using a white light source or laser) may be used. The reason a scanner is preferable is that fluorescence can efficiently transmit excited energy and microscopic technology can be easily applied. Further, measurement can be advantageously performed without significant cell damage. An exemplary configuration of such a system is shown in FIG. 32.

In another aspect, the present invention provides a system for presenting a profile of information of a plurality of cells in the same environment. The system comprises: a) a support capable of retaining a plurality of cells in the same environment; b) means for monitoring a biological factor or an aggregation of biological factors on or within the cells over time; c) means for generating profile data of the cells from a signal obtained from the monitoring means; and d) means for presenting the data. The support, the monitoring means, and the data generating means can be made as described elsewhere herein. The means for presenting data can be achieved by techniques well known in the art. Examples of such a data presenting means include, but are not limited to, computer displays, loudspeakers, and the like. An exemplary configuration of such a system is shown in FIG. 32.

The presentation system of the present invention may further comprise a plurality of cells, in which the cells are preferably fixed to the support. In such a case, at least one substance selected from the group consisting of salts and actin acting substances may be preferably adhered to the support. By adhering cells to the support with a salt or an actin acting substance, or preferably with both, fixation of the cells and/or introduction of a substance into the cells can be enhanced.

Any monitoring means may be used. Examples of the monitoring means include, but are not limited to, optical microscopes; fluorescence microscopes; phase microscopes; reading devices using a laser source; means using surface plasmon resonance (SPR) imaging, electric signals, chemical or biochemical markers singly or in combination; and the like.

Any data presenting means may be used, including, without limitation, displays, loudspeakers, and the like.

In another aspect, the present invention provides a system for determining a state of a cell. The system comprises: a) a support capable of retaining a plurality of cells in the same environment; b) means for monitoring a biological factor or an aggregation of biological factors on or within the cells over time; c) means for generating data from a signal obtained by the monitoring means; and d) means for extrapolating the state of the cell from the data. The support, the monitoring means, and the data generating means can be made by those skilled in the art as described elsewhere herein. The means for extrapolating a state of a cell from data may be produced and used by techniques well known in the art. For example, measured data can be compared with standard data for known cells to achieve extrapolation. A device storing a program for such extrapolation or a computer capable of executing such a program may be used as the extrapolation means. An exemplary configuration of such a system is shown in FIG. 32.

In another aspect, the present invention provides a system for correlating an external factor with responses of cells to the external factor. The system comprises: a) a support capable of retaining a plurality of cells in the same environment; b) means for exposing the cell to the external factor; c) means for monitoring a biological factor or an aggregation of biological factors on or within the cells over time; d) generating profile data of the cells from a signal from the monitoring means; and e) means for correlating the external factor with the profile. The support, the monitoring means, and the data generating means can be made by those skilled in the art as described elsewhere herein. The means for exposing the cells to the external factor can be designed and carried out as appropriate by those skilled in the art depending on the properties of the external factor. The correlation means can employ a recording medium storing a program for correlation or a computer capable of executing such a program. Preferably, a system of the present invention comprises a plurality of cells. An exemplary configuration of such a system is shown in FIG. 32.

In another aspect, the present invention provides a system for identifying an unidentified external factor given to a cell based on a profile of the cell. The system comprises: a) a support capable of retaining a plurality of cells in the same environment; b) means for exposing the cell to known external factor; c) means for monitoring a biological factor or an aggregation of biological factors on or within the cells over time; d) means for obtaining a profile of the cell with respect to each of the known external factors to generate profile data of the cell; e) means for correlating each of the known external factors with each profile; f) means for exposing the cell to the unidentified external factor; g) means for comparing the profiles of the known external factors obtained by the means of d) with the profile of the unidentified external factor to determine a profile of the unidentified external factor from the profiles of the known external factors, wherein the determined unidentified external factor is the known external factor corresponding to the determined profile. The support, the exposure means, the monitoring means, the data generating means, and the correlation means, and the other exposure means can be made and carried out as appropriate by those skilled in the art as described elsewhere herein. The means for determining a corresponding profile can also be made and carried out by utilizing a recording medium storing a program capable of executing such a determination process and a computer capable of executing such a program. Preferably, a system of the present invention comprises a plurality of cells. An exemplary configuration of such a system is shown in FIG. 32.

In another aspect, the present invention provides a system for identifying an unidentified external factor given to a cell based on a profile of the cell. The system comprises: a) a recording medium storing providing data relating to a correlation relationship between known external factors and profiles of the cell in response to the known external factors, in relation to a biological factor or an aggregation of biological factors on or within the cell; b) means for exposing the cell to the unidentified external factor; c) a support capable of retaining a plurality of cells in the same environment; d) means for monitoring a biological factor or an aggregation of biological factors on or within the cells over time; e) means for obtaining a profile of the cell from a signal obtained by the monitoring means; f) means for determining, from the profiles stored in the recording medium of a), a profile corresponding to the profile obtained with respect to the unidentified external factor, wherein the determined unidentified external factor is the known external factor corresponding to the determined profile. The support, the exposure means, the monitoring means, the data generating means, and the correlation means, and the other exposure means can be made and carried out as appropriate by those skilled in the art as described elsewhere herein. The means for determining a corresponding profile can also be made and carried out by utilizing a recording medium storing a program capable of executing such a determination process and a computer capable of executing such a program. Preferably, a system of the present invention comprises a plurality of cells. An exemplary configuration of such a system is shown in FIG. 32.

In another aspect, the present invention relates to a support capable of maintaining the same environment for a plurality of cells. Such a support was first provided by the present invention. By utilizing such a support, a plurality of cells can be analyzed in the same environment.

Preferably, cells are arranged on a support in the form of an array, allowing standardized analysis to be achieved. In this case, the support may preferably comprise a salt or an actin acting substance. More preferably, the support may advantageously comprise a complex of a positively charged substance and a negatively charged substance. This is because cells can be easily fixed to the support. Actin-acting substances are preferable when analysis is conducted within the cells, since the actin acting substances increase the efficiency of introduction of external factors into cells. Therefore, in a preferred embodiment of the present invention, the support may comprise a salt and an actin-acting substance, and more preferably may comprise a complex of a positively charged substance and a negatively charged substance.

A support of the present invention is characterized in that cells may be provided and spaced at intervals of 1 mm. In the case of such intervals, it is not conventionally possible to provide an environment without a partition. Therefore, the present invention has a remarkable effect and practicability or applicability or utility.

In a preferred embodiment, a support of the present invention may comprise a cell fixed thereto. In a more preferred embodiment, a support of the present invention may comprise a biological factor fixed thereto.

In a preferred embodiment, at least two biological factors may be fixed to the support. Such biological factors may be factors selected from the group consisting of nucleic acid molecules, proteins, sugars, lipids, metabolites, low molecular weight molecules, and complexes thereof, and factors containing physical elements and/or temporal elements.

In a more preferred embodiment, a cell and a biological factor may be fixed to a support of the present invention in a mixed manner. The biological factor and the cell may be provided so that they can interact with each other. Such interaction may vary depending on the biological factor. According to the properties of the biological factor, those skilled in the art can understand how the biological factor interacts with the cell and where the biological factor is positioned so as to interact with the cell.

In a preferred embodiment, a salt, a complex of a positively charged substance and a negatively charged substance, and an actin-acting substance are fixed along with a cell and a biological factor the support of the present invention.

In a more preferred embodiment, a salt, a complex of a positively charged substance and a negatively charged substance, and an actin acting substance are fixed along with a cell and a biological factor the support of the present invention in the form of an array. With such a structure, a cell chip capable of generating the profile data of a cell can be provided. The support has a structure in which a salt, a complex of a positively charged substance and a negatively charged substance, and an actin-acting substance are fixed along with a cell and a biological factor in the form of an array. Such a support is also called a “transfection array”.

Examples of a salt used in the support of the present invention include, but are not limited to, calcium chloride, sodium hydrogen phosphate, sodium hydrogen carbonate, sodium pyruvate, HEPES, sodium chloride, potassium chloride, magnesium sulfide, iron nitrate, amino acids, vitamins, and the like. A preferable salt is, for example, without limitation, sodium chloride or the like.

Examples of a gene introduction agent used in the support of the present invention include, but are not limited to, cationic polymers, cationic lipids, polyamine-based reagents, polyimine-based reagents, calcium phosphate, oligofectamin, and oligofectors and the like. Preferably the gene introduction reagents used may be preferably, but are not limited to lipofectamines, oligofectamines and oligofectors.

Examples of an, actin acting substance used in the support of the present invention include, but are not limited to, fibronectin, laminin, vitronectin, and the like. A preferable actin acting substance is, for example, without limitation, fibronectin.

Examples of a nucleic acid molecule used in the support of the present invention include, but are not limited to, nucleic acid molecules comprising transcription control sequences (e.g., promoters, enhancers, etc.), gene coding sequences, genomic sequences containing untranslated regions, nucleic acid sequences encoded by the genome of a host (a fluorescent protein gene, E. coli/yeast self-replication origins, a GAL4 domain, etc.), and the like. Preferable nucleic acid molecules include, but are not limited to, transcription control sequences (e.g., promoters, enhancers, etc.), gene coding sequences, genomic sequences containing untranslated regions, and the like.

Examples of a cell used in the support of the present invention include, but are not limited to, stem cells, established cell lines, primary culture cells, insect cells, bacterial cells, and the like. Preferable cells include, but are not limited to, stem cells, established cell lines, primary culture cells, and the like.

Examples of a material for a support of the present invention include, but are not limited to, glass, silica, plastics, and the like. Preferable materials include, but are not limited to, the above-described materials with coating.

In another aspect, the present invention provides a method for producing a support comprising a plurality of cells fixed thereto and capable of maintaining the same environment for the cells. The method comprises the steps of: A) providing the support; and B) fixing the cells via a salt and a complex of a positively charged substance and a negatively charged substance onto the support. The step of providing a support may be achieved by obtaining a commercially available support or molding a support material. A support material may be prepared by mixing starting materials for the material as required. The fixing step can be carried out by using techniques known in the art. Examples of such fixing techniques include, but are not limited to, an ink jet printing technique, a pin array technique, a stamping technique, and the like. These techniques are well known and can be performed as appropriate by those skilled in the art.

In a preferred embodiment, the fixing step in the present invention may comprise fixing a mixture of the salt, the complex of a gene introduction agent and an actin acting substance (positively charged substances) and a nucleic acid molecule (a negatively charged substance), and the cell in the form of an array. Such a fixing step may be achieved by printing techniques.

In another aspect, the present invention provides a device for producing a support comprising a plurality of cells fixed thereto and capable of maintaining the same environment for the cells. The device comprises: A) means for providing the support; and B) means for fixing the cells via a salt and a complex of a positively charged substance and a negatively charged substance onto the support. The support may be obtained using means that can perform the above-described methods. Examples of such means include, but are not limited to, a support molding means, a material formulating means (e.g., a mixing means), and the like. The molding means can employ techniques well known in the art. The fixing means may comprise a printing means. As such a printing means, commercially available ink jet printers can be used.

(Digital Cell)

As used herein the term “digital cell” refers to a collection of at least one experimental data corresponding to a cell of experimental interest. Such experimental data is a correlation between the conditions used for the experiments conducted to an actual cell in the real world, and the experimental results thereof. The digital cell is composed such that when an experimental condition is given, an experimental result relating to the experimental condition will be reproduced.

By using the digital cell, experimental results conducted on an actual cell can be reproduced on a computer system. This allows institutions or individuals having no experimental facilities to conduct most recent studies relating to a cell. As a result, it allows introduction of business entities having different disciplines from that of the present technical art, which could not been achieved prior to the disclosure date of the present invention.

FIG. 33A depicts an example of a digital cell structure data. This example represents a digital cell by a collection of three experimental data A1, A2 and A3 relating to cell A.

Each of experimental data A1, A2 and A3, comprises cell parameter, environment parameter and stimulus parameter as parameters indicating experimental conditions, and stimulus response result as an experimental result.

As used herein, the cell parameter specifies a cell of experimental interest. The environment parameter specifies an environment under which the cell specified by the cell parameter is cultured. The stimulus parameter specifies a stimulus given to the cell specified by the cell parameter. The stimulus response result shows the response of the cell specified by the cell parameter to the stimulus specified by the stimulus parameter under the environment specified by the environment parameter.

Experimental data A1 shows that cell A was cultured in a medium called “DMEM”, under the culture condition of pH “7”, temperature “37” degree Celcius, CO₂ concentration “5” %, and a stimulus consisting of a reporter called “Tet-OFF CMV EGF” or “MCV EGFP” and a chemical stimulus (agent) “Doxycycene” was given thereto to obtain a stimulus response result. The stimulus response result is represented by “cell dynamic data 1” and “reporter measurement data 1”.

Experimental data A2 shows that cell A was cultured in a medium called “DMEM”, under the culture condition, of pH “7”, temperature “37” degree Celsius, CO₂ concentration “5” %, and a stimulus consisting of a reporter called “c-fos” and a chemical stimulus (agent) “PSC833” was given thereto to obtain a stimulus response result. The stimulus response result is represented by “cell dynamic data 2” and “reporter measurement data 2”.

Experimental data A3 shows that cell A was cultured in a medium called “DMEM”, under the culture condition of pH “5”, temperature “39” degree Celsius, CO₂ concentration “4” %, and a stimulus consisting of a reporter called “CREB” and a chemical stimulus (agent) “Vindecine” was given thereto to obtain a stimulus response result. The stimulus response result is represented by “cell dynamic data 3” and “reporter measurement data 3”.

As such, parameters indicating experimental conditions (a cell parameter, an environment parameter and a stimulus parameter) and a stimulus response result showing an experimental result are correlated. Such correlation and data correlated thereby are called experimental data. The digital cell is provided as a collection of at least one experimental data on a cell of experimental interest.

FIG. 33B shows another example of a digital cell structure data. This example shows layered structure of the data structure shown in FIG. 33A. As such, layering the structure of the data structure of the digital cell allows expression of the same content with less data than the data structure shown in FIG. 33A.

In the examples of FIGS. 33A and 33B, correlation has been presented by a unidirectional link (arrows in the Figures) between the parameter showing the experimental conditions and experimental results. However, methods of such correlation are not limited thereto. Any methods of such correlation may be used herein.

(Production of a Digital Cell)

FIG. 34 shows an example of digital cell production process procedures. These procedures are implemented by any type of computers.

Step S3401: Cell parameter specifying a cell of experimental interest is obtained. The cell parameter can be obtained by, for example, receiving cell parameter inputted by a user by using a computer. Alternatively, data outputted from an experimental apparatus may be obtained by collecting or analyzing the same in an automatic manner by using a computer.

Step S3402: Environment parameter specifying environment under which the cell specified by the cell parameter is cultured, is obtained. The environment parameter is obtained by receiving, by a computer, environment parameter inputted by a user, for example. Alternatively, the environment parameter may be obtained by automatically collecting or analyzing data outputted from an experimental apparatus (for example, sensors measuring experimental environment and the like) and the like, by a computer. Such an environment parameter may comprise, for example, a parameter representing medium for culturing a cell and a parameter representing conditions for such culture. Parameter of such culturing conditions includes for example, pH, temperature, CO₂ concentration of the medium, and the like.

Step S3403: Stimulus parameter specifying stimulus to be given to a cell specified by the cell parameter. Stimulus parameter is obtained by, for example, receiving, by a computer, a stimulus parameter inputted by a user. Alternatively, stimulus parameter may be obtained by automatically collecting or analyzing, by a computer, data outputted by an experimental apparatus. Such a stimulus parameter may comprise, for example, a parameter representing a reporter and a parameter representing a chemical stimulus.

Step S3404: Stimulus response result showing the result in response to a stimulus specified of a cell specified by the cell parameter by the stimulus parameter under the environment specified by the environment parameter is obtained. The stimulus response result is obtained by automatically collecting or analyzing data outputted from an experimental apparatus such as monitoring apparatus for monitoring the course of experiments.

Step S3405: The cell parameter, the environment parameter, the stimulus parameter and the stimulus response result are correlated with each other. This correlation allows production of an experimental data against a cell of experimental interest. Such a correlation is conducted by linking in a single direction shown in FIG. 33A. However, methods of such a correlation are not limited so.

Step S3406: Steps S3401 through S3405 are repeated as necessary. This allows production of at least one experimental data against a cell of experimental interest. The collection of at least one experimental data is provided as a digital cell.

The computer implementing the process for producing a digital cell, functions as an apparatus or device for producing a digital cell. The digital cell produced is stored on, for example, a database which can be accessed by the computer.

As such, provision of a digital cell of a collection of at least one experimental data, is only possible by the present invention by providing and developing technologies for locating a plurality of cells on a substrate under the same environment. Conventionally, in the prior art, it was not possible to maintain a plurality of cells under the same environment, and thus the experimental conditions have not been reliable, and thus no significance is found for accumulating these experimental data. As such, the “production of a digital cell” is a real advanced technology which is feasible for the first time through the technology innovation of the present invention.

(Provision of Services for Reproducing Experimental Results from an Actual Cell)

FIG. 35 depicts an example of a configuration of computer system 3501 which provides a service reproducing an experimental result obtained using an actual cell using the digital cell.

Computer system 3501 comprises service requester 3510 requesting a service desired by a user, and service provider 3520 providing the desired service in response to the request.

Computer system 3501 may comprise a plurality of service requesters 3510.

Service provider 3520 is configured so as to be capable of accessing database 3522 with at least one digital cell stored thereon. Database structure of the digital cell stored on database 3522 is shown in, for example, FIGS. 33A and 33B. Database 3522 may be provided inside service provider 3520, or may be located outside service provider 3520.

Service provider 3520 may be configured so as to be capable of accessing a plurality of databases stored thereon with respect to at least one digital cell.

Service requester 3510 and service provider 3520 may independently be any type of computer.

Service requester 3510 and service provider 3520 are connected to each other via network 3530. Network 3530 may be any type of network, but in view of feasibility of connection or cost, most preferably, the network is the Internet.

When network 3530 is the Internet, service requester 3510 may be a Web browser operated by a user, and service provider 3520 may be a Web server connected to service requester via the Internet. Such configuration allows worldwide users to easily access the service provider 3520.

FIG. 36 depicts an example of procedures for providing a service of reproducing an experimental result from an actual cell using a digital cell. This process may be implemented by cooperating service requester 3510 and service provider 3520.

Step S3601: Service requester 3510 receives cell and environment parameters and produces a request comprising the cell parameter, the environment parameter and the stimulus parameter. The request is described in, for example, XML.

Step S3602: Service request 3510 provides the request to service provider 3520.

Step S3603: Service provider 3520 searches for database 3522 in response to the request, to determine whether or not there is a stimulus response result relating to the cell parameter, the environment parameter and the stimulus parameter included in the requested database 3522.

Step S3604: when determined that there is a stimulus response result relating to the cell parameter, the environment parameter and the stimulus parameter included in the database 3522, service provider 3520 provides service requester 3510 with the stimulus response result. The stimulus response result is described in, for example, XML.

Step S3605: Service requester 3510 displays the stimulus response result provided by service provider 3520.

If determined there is no stimulus response result relating to the cell parameter, the environment parameter and the stimulus parameter included in the requested database 3522, service provider 3520 provides service requester 3510 with a result of “no hit”, for example.

Procedures as shown in FIG. 36 may be processed in a single computer. For example, a single computer program in a single computer may be used for implementing the procedures of steps S3601 through S3605 as shown in FIG. 36. In this case, such a single computer functions as an apparatus having combined functions of service requester 3510 and service provider 3520.

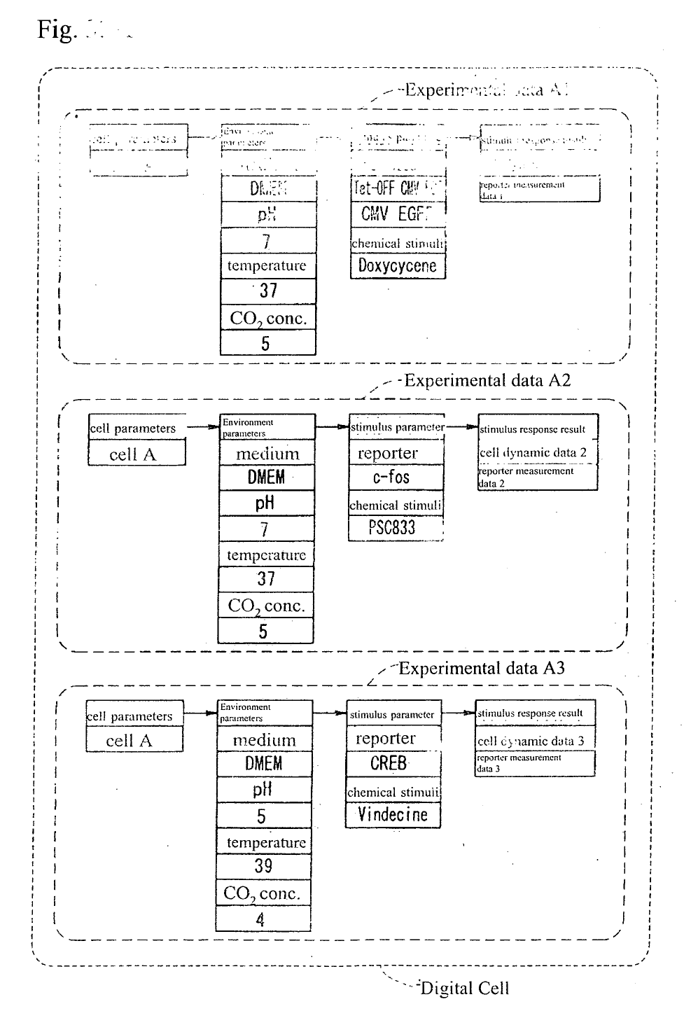

FIG. 37 depicts an example of input interface for inputting a cell parameter, an environment parameter and a stimulus parameter to service 3510. In this example, these parameters are inputted by inputting these parameters as text by a user into a desired region.

Any number of methods may be employed as a method for inputting these parameters into service requester 3510. For example, these parameters may be inputted by choosing these parameters from a menu (such as, pull-down menu, pop-up menu and the like) by a user.

Service requester 3510 may employ any embodiment for displaying the stimulus response result. For example, service requester 3510 may display the stimulus response result on a display screen, or may output the stimulus response result to a printer. Service requester 3510 may display the stimulus response result using a still image or display the stimulus response result using a movie display.

The stimulus response result may include profile data of a cell obtained by monitoring a biological agent or a collection thereof on or in a cell over time.

In such a case, for example, the profile data of a cell shown in FIG. 19 may be displayed by service requester 3510 as the stimulus response result.

As such, according to computer system 3510, it is now possible to provide a service for reproducing an experimental result from an actual cell using the digital cell. As such, it is now possible to conduct an advanced search relating to a cell even by a research organization or an individual without experimental facilities.

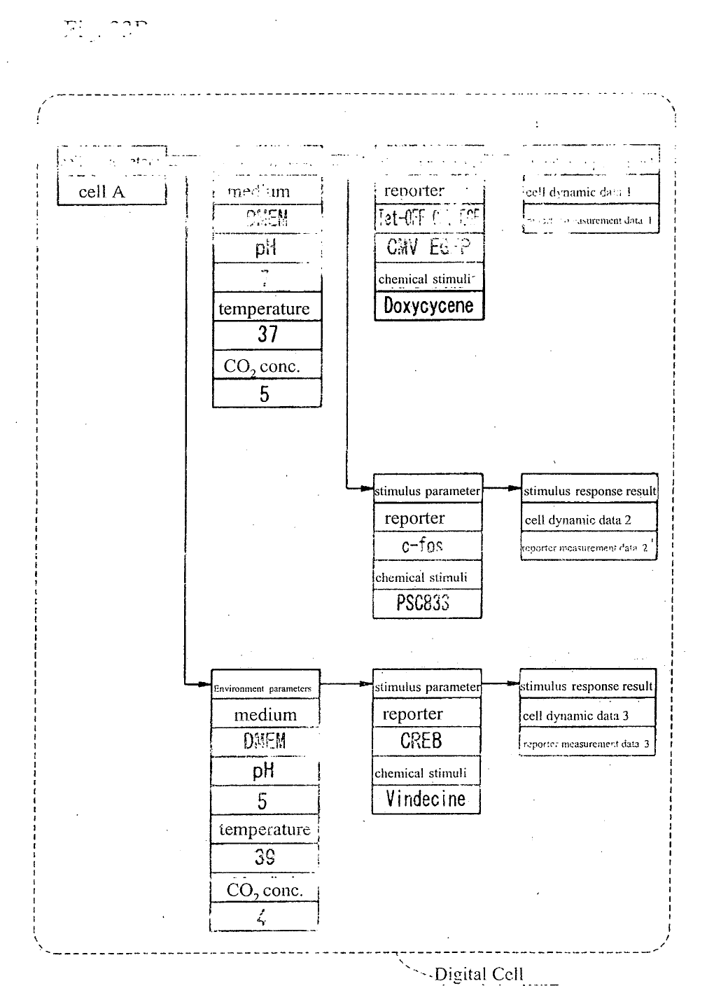

FIG. 38 depicts an example of computer system 3801 configuration providing a service for reproducing an experimental result from an actual cell using the digital cell.

Computer system 3801 comprises service requester 3810 requesting a service desired by a user; a plurality of service providers 3820₁ 3820_{N}; and service registry 3840 with registration of at least one service which can be provided by a plurality of service providers 3820₁3820_{N}, wherein N is any integer of two or more.

Computer system 3801 may include a plurality of service requesters 3810. Service provider 3820₁ is configured so as to be capable of accessing database 3822ᵢ at least one digital cell stored thereon. Data structure of a digital cell stored on database 3822ᵢ is shown in FIGS. 33A and 33B. Database 3822ᵢ may be provided by service provider 3820ᵢ or outside service provider 3820, wherein i=1, 2, N.

Service provider 3820ᵢ may be configured to be capable of accessing to a plurality of database with at least one digital cell each stored thereon.

Service registry 3840 is configured to be capable of accessing to database 3842 with data stored thereon representing services being capable of being provided by service providers 3820ᵢ to 3820_{N}. Database 3842 may be provided in service registry or outside service registry 3840. Storing data representing services on database 3842 allows registration of services to service registry 3840. Formats of data stored on database 3842 are preferably pre-normalized. Storage of data to database 3842 may be handled manually by a firm managing service registry 3840 or by transmitting data from service providers 3820ᵢ to 3820_{N} via network 3830 to service registry 3840.

Each service requester 3810, service provider 3820 to 3820_{N} and service registry 3840 may be any type of computer.

Each of service providers 3820ᵢ to 3820_{N} is preferably conducted by any organizations, firms or any other corporation possessing experimental facilities which conduct research on an actual cell. Each of service requester 3810 and service registry 3840 is preferably conducted by any of organizations, firms or any other corporation (for example, an association for promoting digital cell) managing provision of services for reproducing experimental results from an actual cell using the digital cell. Further, in order to secure quality of services registered to service registry 3840, it is preferable to oblige such an organization which manages service providers 3820ᵢ to 3820_{N} to satisfy a predetermined standard.

Service requester 3810, service provider 3820ᵢ to 3820_{N} and service registry 3840 are connected via network 3830. Network 3830 is of any type but most preferably, in view of ease of connection and cost, the Internet.

When network 3830 is the Internet, service requester 3810 may be a Web server connected to a Web browser operated by a user via the Internet. Each of 3820₁ 3820_{N} may be a Web server connected to service requester 3810 via the Internet. In this case, service requester 3810 functions as portal or Website interrelaying a Web browser operated by a user to a Web server of service provider 3820ᵢ. This configuration allows easy access to service providers 3820ᵢ to 3820_{N} by users all over the world. It is now possible for worldwide research institutes and/or firms to participate in business providing services for reproducing experimental results from an actual cell using a digital cell.

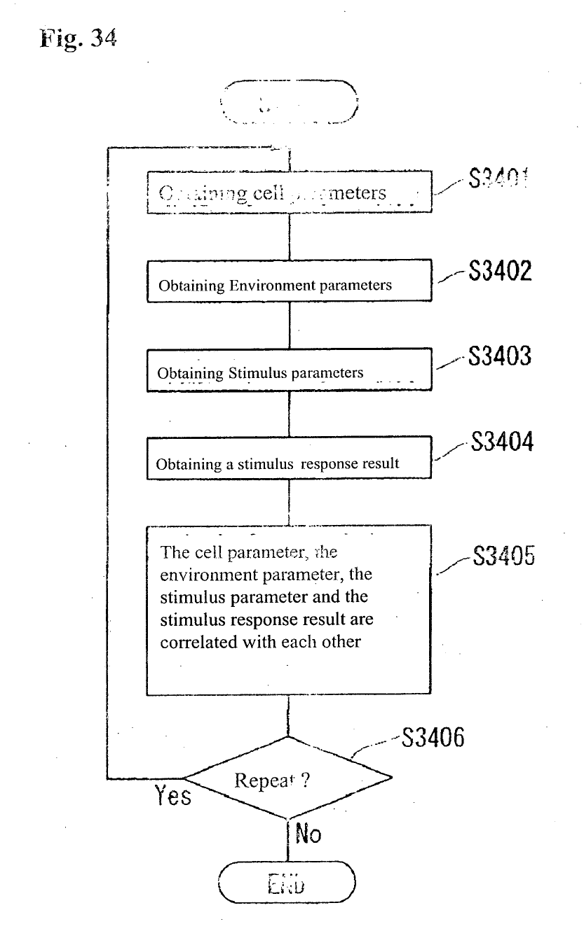

FIG. 39 depicts an example of procedures of process for providing a service of reproducing an experimental result from an actual cell using the digital cell. This procedure is implemented by cooperating service requester 3810 and service providers 3820ᵢ to 3820_{N}.

Step S3910: Service requester 3810 receives a cell parameter, an environment parameter, and a stimulus parameter, and produces a request comprising such a cell parameter, an environment parameter, and a stimulus parameter. Such a request is described in, for example, XML.

Step S3902: Service requester 3810 searches service registry 3840 responding to the request, and determines whether or not there is a service provider 3820ᵢ which can provide a service for the requester amongst service providers 3820ᵢ to 3820_{N}, wherein i is any integer of 1 to N.

Service providers 3820ᵢ to 3820_{N} may employ any type of method for registering services which can be provided by service providers 3820ᵢ to 3820_{N} on service registry 3840. For example, when service provider 3820₁ is capable of providing a service for reproducing an experimental result from cell A, then cell parameters specifying cell A and addresses (for example, URL and the like) specifying the locations of service provider 3820₁ may be stored in database 3842. For example, if service provider 3820₂ can provide services of reproducing cells B and C, then cell parameters specifying cell A and addresses (for example, URL and the like) specifying the locations of service provider 3820₂ may be stored in database 3842. Alternatively, when service provider can provide service for reproducing experimental results satisfying specific experimental conditions from cell D, then parameters such as environment parameters and stimulus parameters specifying the experimental conditions and addresses (for example, URL and the like) specifying the locations of service provider 3820₃ may be stored on database 3842.

Step S3903: If there is a service provider 3820ᵢ which can provide service for the requester, amongst service providers 3820ᵢ to 3820_{N}, such service requester 3810 provides service provider 3820ᵢ with the request. The location of service provider 3820ᵢ may be specified by referring to database 3842 of service registry 3840.

Step S3904: service provider 3820ᵢ searches database 3822ᵢ in response to the request, and determines whether or not the stimulus response result relating to the cell parameter, the environment parameter and the stimulus parameter exist in database 3822ᵢ.

Step S3905: If determined that there is a stimulus response result relating to the cell parameter, the environment parameter and the stimulus parameter included in the request in database 3822ᵢ, service provider 3820ᵢ provides service requester 3810 with the stimulus response result. The stimulus response result is described in, for example, XML.

Step S3906: service requester 3810 displays stimulus response result provided by service provider 3820ᵢ.

If determined that there is no stimulus response result relating to the requested cell parameter, environment parameter and stimulus parameter contained in database 3822ᵢ, service provider 3820ᵢ will provide service requester 3810 with, for example, the result of “no hit”.

As described above, any number of methodologies may be employed as a method for inputting a cell parameter, an environment parameter and a stimulus parameter to service requester 3810, and any forms may be employed for displaying stimulus response result by service requester 3810.

As such, according to computer system 3810, it is possible to provide service for reproducing an experimental result from an actual cell using the digital cell. This allows research institutes or individual having no advanced experimental facilities to conduct research activities relating to a cell. Further, according to computer system 3801, registration of services provided by the plurality of service providers 3820ᵢ to 3820_{N}, renders the opportunity for worldwide research institutes and/or firms to participate in business providing services for reproducing experimental results from an actual cell using a digital cell.

### Digital Cell Database

As used herein, the term “database” refers to a collection of data or a system, in which data is collected and a variety of items (parameters) can be used for conducting search.

As used herein the term “digital cell database” refers to database in which data relating to a digital cell is stored. Such database may be provided in a variety of formats. In an embodiment, a known database format may be used. Such a known database format includes, but is not limited to, for example, KEGG, EMBL, GenBank and AfCS, and the like.

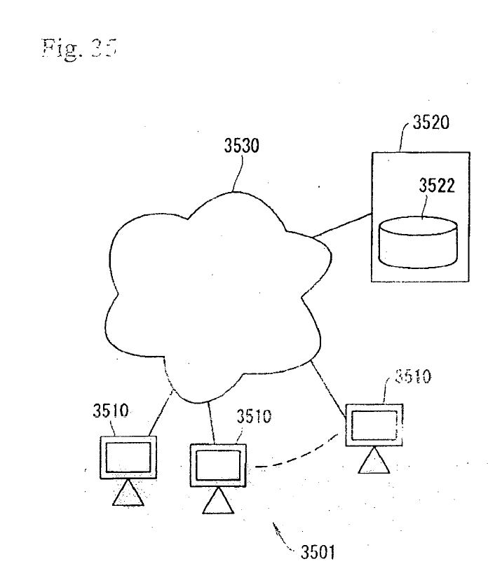

In one aspect, the present invention provides a method for producing database of a digital cell. The present method comprises the steps of: a) obtaining a cell parameter specifying a cell of experimental interest; b) obtaining an environment parameter specifying an environment under which the cell specified by the cell parameter is cultured; c) obtaining a stimulus parameter specifying a stimulus to be given to the cell specified by the cell parameter; d) obtaining a stimulus response result showing the response of the cell specified by the cell parameter to the stimulus specified by the stimulus parameter under the environment specified by the environment parameter; e) producing an experimental data for the cell, by correlating the cell parameter, the environment parameter, the stimulus parameter and the stimulus response result; f) optionally repeating steps a) through e) to produce at least one collection of experimental data for the cell, and to provide at least one collection of experimental data as a digital cell; g) collecting the data of the digital cell to form a database. Such embodiments in which such a step is conducted may employ any embodiments specifically described herein above (with respect to “Digital Cell”) up to the step of collecting database. Schematic figure thereof is depicted in FIG. 40. Storing onto a database may be conducted by means of any of well known technology in the art.

FIG. 40 shows an example of the procedure for producing a digital cell. This procedure may be implemented by any type of computer.

Step S4001: The Cell parameter specifying a cell of experimental interest is obtained. Cell parameter can be obtained by, for example, receiving cell parameter inputted by a user into a computer. Alternatively, data outputted from an experimental apparatus may be obtained by collecting or analyzing the same in an automatic manner by a computer to obtain cell parameters.

Step S4002: Environment parameters specifying an environment under which the cell specified by the cell parameter is cultured, is obtained. The environment parameter is obtained by receiving, by a computer, the environment parameter inputted by a user, for example. Alternatively, the environment parameter may be obtained by automatically collecting or analyzing data outputted from an experimental apparatus (for example, sensors measuring experimental environment and the like) and the like, by a computer. Such an environment parameter may comprise, for example, a parameter representing a medium for culturing a cell and a parameter representing conditions for such culture. Parameters for such culture conditions include for example, pH, temperature, CO₂ concentration of the medium, and the like.

Step S4003: Stimulus parameter specifying a stimulus to be given to a cell specified by the cell parameter. A stimulus parameter is obtained by, for example, receiving, by a computer, a stimulus parameter inputted by a user. Alternatively, a stimulus parameter may be obtained by automatically collecting or analyzing, by a computer, data outputted by an experimental apparatus. Such a stimulus parameter may comprise, for example, a parameter representing a reporter and a parameter representing a chemical stimulus.

Step S4004: A stimulus response result showing the result in response to a stimulus by the stimulus parameter, by a cell specified by the cell parameter under the environment specified by the environment parameter, is obtained. The stimulus response result is obtained by automatically collecting or analyzing data outputted from an experimental apparatus such as monitoring apparatus for monitoring the course of experiments.

Step S4005: The cell parameter, the environment parameter, the stimulus parameter and the stimulus response result are correlated with each other. This correlation allows production of an experimental data for a cell of experimental interest. Such a correlation is conducted by linking in a single direction shown in FIG. 33A. However, correlating methods are not limited to such.

Step S4006: Steps S4001 through S4005 are repeated as necessary. This allows production of at least one experimental data for a cell of experimental interest. The collection of at least one experimental data is provided as a digital cell.

Step 4007: as a result of Step 4006, data produced up to Step 4006 are stored on a database. A collection of at least one experimental data is provided as a digital cell.

The computer implementing the process for producing a digital cell database, functions as an apparatus or device for producing a digital cell. The digital cell database produced is stored in, for example, a database which can be accessed by the computer.

As such, provision of a digital cell database of a collection of at least one experimental data, is only possible by the present invention by providing and developing technologies for locating a plurality of cells on a substrate under a consistent environment. Conventionally, in the prior art, it was not possible to maintain a plurality of cells under a consistent environment, and thus the experimental conditions were not reliable, and thus no significance was found when accumulating experimental data between experiments. As such, the “production of a digital cell database” is a real advance in technology which is feasible for the first time through the technological innovation of the present invention.

In one embodiment, the data relating to a cell used in generating a digital cell database is produced by the following method for generating profile data of information from a cell comprising the steps of: a) providing and fixing the cell to a support; and b) monitoring a biological agent or an aggregation of biological agents on or within the cell over time to generate data on the profile of the cell. Such a method is described elsewhere herein and any preferable embodiments may be employed in the present invention.

In a preferable embodiment, an environment parameter used in the present invention comprises a parameter indicating medium for culturing the cell, and that indicating the conditions of the medium.

In another preferable embodiment, the stimulus parameter used in the present invention comprises a parameter indicating a reporter, and a parameter indicating a chemical stimulus.

In still another preferable embodiment, stimulus response result used in the present invention comprises profile data of the cell obtained by monitoring a biological agent on or in the cell or a collection thereof in a time-lapse manner.

In one embodiment, the database of the digital cell used herein is adapted to a format of a known database such as KEGG, EMBL, GenBank and AfCS, and the like.

In another aspect, the present invention provides a database produced by the digital cell database production method according to the present invention. Such a database provides a novel and non-obvious product, in terms of that the data indicating an actual experimental result is stored.

In a preferable embodiment, the database of the present invention has a data structure selected from the group consisting of having continuous monitoring data of the gene expression, and simultaneous and parallel data of cell change on the same chip obtained thereon.

In another aspect, the present invention provides an apparatus for producing a database of a digital cell, comprising: a) means for obtaining a cell parameter specifying a cell of experimental interest; b) means for obtaining an environment parameter specifying an environment under which the cell specified by the cell parameter is cultured; c) means for obtaining a stimulus parameter specifying a stimulus to be given to the cell specified by the cell parameter; d) means for obtaining a stimulus response result showing the response of the cell specified by the cell parameter to the stimulus specified by the stimulus parameter under the environment specified by the environment parameter; e) means for producing an experimental data for the cell, by correlating the cell parameter, the environment parameter, the stimulus parameter and the stimulus response result; f) means for providing at least one collection of experimental data as a digital cell, by optionally repeating steps performed by steps conducted by the means a) through e) to produce at least one collection of experimental data for the cell; and g) means for collecting the data of the digital cell to form a database. With respect to the means other than collecting data, examples described herein may be employed. Means for collecting data may employ any means known in the art. Such apparatus and means used therefore are described herein elsewhere and any preferable embodiments may also be employed.

(Provision for a System and a Method for Analyzing Cellular Network Using Experimental Results from an Actual Cell)

In one aspect, the present invention provides a method for providing a service which reproduces an experimental result of an actual cell using a digital cell based on an analysis target parameter by means of a computer system comprising a service requester and a service provider. The present method comprises the steps of: A) preparing a digital cell database having at least one digital cell stored thereon, wherein at least one digital cell is expressed as a collection of at least one experimental data of a cell of experimental interest, wherein each experimental data comprises a cell parameter specifying the cell, an environment parameter specifying an environment under which the cell specified by the cell parameter is culture, a stimulus parameter specifying a stimulus to be given to the cell specified by the cell parameter, and a stimulus response result showing showing the response of the cell specified by the cell parameter to the stimulus specified by the stimulus parameter under the environment specified by the environment parameter; B) receiving the analysis of target parameters to produce the cell parameter, the environment parameter and the stimulus parameter by the service requester thereby producing a request comprising the cell parameter, the environment parameter and the stimulus parameter; C) providing the request to the service provider by the service requester; D) searching the digital cell database in response to the request by the service provider to determine whether or not there is the stimulus response result relating to the cell parameter, the environment parameter and the stimulus parameter included in the request, in the database; E) searching the digital cell database in response to the request by the service provider to determine whether or not there is a known database relating to the analysis of target parameters, and if present, obtaining information relating to the known database relating to the target parameter for analysis; F) providing the stimulus response result to the service requester by the service provider in association with the information relating to the known database, when it is determined that the stimulus response result relating to the cell parameter, the environment parameter and the stimulus parameter included in the request exists in the digital cell database, and when the information relating to the known database is obtained; and G) presenting the information relating to the known database and the stimulus response result by the service requester. As used herein, those skilled in the art may select an appropriate known database in response to a request in an appropriate manner, and the setting for the selection thereof may be conducted by a service requester and/or service provider.

As used herein the term “analysis of target parameter” refers to a parameter of analysis interest in a cellular network analysis technology of the present invention, and for example, includes, but is not limited to: for example, the state of a cell or a biological organism such as a disease, a drug, a gene nomenclature, network pathway, interaction and the like.

Known databases usable in the present invention include but are not limited to: pathway database, protein interaction database, intermolecular interaction network database, genome database, protein database, cDNA database, cell information database and the like.

As used herein the term “pathway database” refers to those collecting data with respect to cell signaling transduction. Such databases include, but are not limited to: for example, database such as KEGG, Signaling Gataway, Cell signaling database, signaling pathway database, CNSDB and the like.

As used herein the term “protein interaction database” refers to database related to interaction between proteins (for example, functions, origin, interaction level, related information and the like). Such databases include, but are not limited to: for example, ExPASy, GPCRDB, NCBI database, PROW, PDB, SwissProt, PIR and the like.

As used herein the term “molecular interaction network database” refers to a database relating to interaction between molecules (for example, functions, origin, homology, related information and the like). Such databases include, but are not limited to: for example database such as OMIM, KEGG, NCBI database, Path Calling database and the like.

As used herein the term “genome database” refers to database relating to genome (for example, sequences, functions, origin, homology, related information and the like). Such databases include but are not limited to: for example, database such as GenBank, EMBL, DDBJ and the like.

As used herein the term “protein database” refers to database relating to protein (for example, sequences, function, origin, homology, related information and the like). Such databases include but are not limited to: for example, databases such as SwissProt, ExPASy, GPCRDB, NCBI database, PROW, PDB, PIR and the like. Protein database may include protein structure database (for example, protein data bank (PDB)).

As used herein the term “cDNA database” refers to database relating to cDNA (for example, sequences, functions, origin, homology, related information and the like). Such databases include but are not limited to, for example, GenBank, EMBL, DDBJ and the like.

As used herein the term “cell information database” refers to database relating to cellular information. Such databases include, but are not limited to, for example, the Signaling Gateway (AfCS) and the like.

In addition, available known databases include but are not limited to, for example, SCOP (three-dimensional structure classification), CATH (three-dimensional structure classification), PROSITE (sequence family and motif), Pfam (sequence family and motifs), LIGAND (compounds and chemical reactions), AAindex (compounds and chemical reactions), TAXONOMY (biological species classification), COG (ortholog gene classification) and the like. It is understood that these may be used solely or in combination with a plurality thereof. Optionally, it is understood that data and information produced by means of network analysis of the present invention is feedbacked to the known database, and the database may be updated.

Analytical tools usable herein include the following:

Database search: WAIS-KW[DISC], SFgate-KW[DDBJ], getentry—ID [DDBJ], PubMed: Medline—KW [NBCI], Entrez-KW/ID [NBCI]

Homology search: BLAST [GenomeNET], FASTA [GenomeNET], Smith and Waterman [DISC]

sequence search: DNA→AA [EBI], PROSCAN[NIH], NNPP[LBNL], Signal Scan[NIH], SSPN[BDGP], Genie [USCS/LBNL], ORF Finder [NCBI], clustalW [GenomeNET], TFSEARCH[AIST], TFBINF, MOTIF[GenomeNET], pI/Mw [ExPASy]

Restriction enzyme mapping: WWWtacg, WebCutter PCR: Primer selection, Primer3, Oligo Calculator, Tm, Web Primer—PCR & Sequencing, CODEHOP

Second-oder structure prediction: PredictProtein, TMpred, SOSUI

Sequence alignment: BOXSHADE, ReadSeq [NIH-J]

Other tools: Codon Usage—CUTG[DISC], PSORT

The following databases may also be used: NCBI Site Map, genome net WWW server, DISC (DNA Information and Stock Center), LiMB, Restriction Enzyme Database, Biochemical Pathways (enzyme database which is linked to metabolism map), INTERNATIONAL UNION OF BIOCHEMISTRY AND MOLECULAR BIOLOGY (IUBMB: nomenclature of enzymes, molecular biology, biochemistry terms or symbols and the like), The Protein Kinase Resource, culture biology world data center, ATCC, JCRB cell bank, JCRB gene bank, RIKEN gene bank, Agriculture and Fishery (Norinsuisan) DNA bank, Entrez, NCBI PubMed, Chemfinder, CAS, Tokkyo Joho Teikyo Service (patent information service), PATOLIS, ESPACENET, Delphion patent information and the like.

In one embodiment, known information used in the present invention is outputted in accordance with the strength of relevancy of the analysis of target parameters. Examples of such output list include, but are not limited to, for example, lists of candidates for novel biomarkers, lists of candidates for novel drug target, lists of sites of reactions for compounds, lists of pathway and the like.

In another embodiment, analyzed target parameters used in the present invention comprises diseases, and the information relating to the known database is outputted in a form of lists selected from the group consisting of lists of gene nomenclature relating to the disease, and the lists of medicaments relating to the disease. Such lists of candidates for drug targets are those which cannot be produced according to conventional methods. Outputted lists according to the present invention reflect actual experimental results, and thus the fact that the results are reliable is a remarkable feature of the present invention.

In a preferable embodiment, the present invention further comprises the steps of: conducting, by the service provider, a search for a intermolecular interaction network database and a pathway database as the known database after the analysis of target parameters is inputted, outputting a gene list having intermolecular interaction and a gene list relating to the regulation of the genes, and thereby designing a cellular assay experiment based on the gene list; producing additional data relating to an additional digital cell based on the designed cellular assay by the service provider to produce a digital cell database with an update added to the digital cell database; providing the service requester by the service provider with the stimulus response result relating to the information relating to a known database based on the updated digital cell database; and displaying the information relating to the known database and the stimulus response result by the service requester.

FIG. 41 depicts an example of computer system 4101 configuration which provides a service reproducing an experimental result obtained from an actual cell using the digital cell.

Computer system 4101 comprises service requester 4110 requesting a service desired by a user, and service provider 4120 providing the desired service in response to the request.

Computer system 4101 may comprise a plurality of service requesters 4110.

Service provider 4120 is configured so as to be capable of accessing database 4122 with at least one digital cell stored thereon. A database structure of the digital cell stored on database 4122 is shown in, for example, FIGS. 33A and 33B. Database 4122 may be provided inside service provider 4120, or may be located outside service provider 4120.

Service provider 4120 may be configured so as to be capable of accessing a plurality of databases stored thereon with respect to at least one digital cell.

Service requester 4110 and service provider 4120 may independently be any type of computer.

Service requester 4110 and service provider 4120 are connected to each other via network 4130. Network 4130 may be any type of network, but in view of feasibility of connection or cost, most preferably, the network is the Internet.

When network 4130 is the Internet, service requester 4110 may be a Web browser operated by a user, and service provider 4120 may be a Web server connected to the service requester via the Internet. Such a configuration allows an easy access to service provider 4120 to worldwide users.

Network 4130 is connected to known database 4140 (for example, GenBank and the like). This allows collection, and provision of information from a known database, and analysis of related information.

FIG. 42 represents an example of a typical network analysis.

FIG. 43 depicts an example of process for providing a service for reproducing an experimental result from an actual cell using a digital cell. This process may be implemented by cooperating service requester 4110 and service provider 4120.

Step S4301: Service requester 4110 receives cell and environment parameters and produces request comprising the cell parameter, the environment parameter and the stimulus parameter. The request is described in, for example, XML.

Step S4302: Service requester 4110 provides the request to service provider 4120.

Step S4303: Service provider 4120 searches for database 4122 in response to the request, to determine whether or not there is a stimulus response result relating to the cell parameter, the environment parameter and the stimulus parameter included in the requested database 4122.

Step S4303A: Service provider 4120 responds to the requests (including analysis target parameter) to conduct search on a known database 4140, and thereby extracting information relating to the request within database 4140.

Step S4303B: Service provider 4120 correlates the information extracted from S4303A with stimulus response result.

Step S4304: when it is determined that there is a stimulus response result relating to the cell parameter, the environment parameter and the stimulus parameter included in database 4122, service provider 4120 provides service requester 4110 with the stimulus response result. The stimulus response result is described in, for example, XML.

Step S4305: Service requester 4110 displays the stimulus response result provided by service provider 4120.

If it is determined that there is no stimulus response result relating to the cell parameter, the environment parameter and the stimulus parameter included in the requested in database 4122, service provider 4120 provides service requester 4110 with a result of “no hit”, for example.

Procedures as shown in FIG. 43 may be processed by a single computer. For example, a single computer program in a single computer may be used for implementing the procedures of steps S4301 through S4305 shown in FIG. 43. In this case, such a single computer functions as an apparatus having the combined functions of service requester 4110 and service provider 4120.

FIG. 44 depicts an example of an input interface for inputting a cell parameter, an environment parameter and a stimulus parameter to service 4110. In this example, these parameters are inputted by inputting these parameters as text by a user into a desired region.

Any methods may be employed as a method for inputting these parameters into service requester 4110. For example, these parameters may be inputted by choosing these parameters from a menu (such as, pull-down menu, pop-up menu and the like) by a user.

Service requester 4110 may employ any embodiment for displaying the stimulus response result. For example, service requester 4110 may display the stimulus response result on a display screen, or may output the stimulus response result to a printer. Service requester 4110 may display the stimulus response result using a still image or display the stimulus response result using movie display.

The stimulus response result may include profile data of a cell obtained by monitoring a biological agent or a collection thereof on or in a cell over time. In such a case, for example, the profile data of a cell shown in FIG. 19 may be displayed by service requester 4110 as the stimulus response result.

As such, according to computer system 4110, it is now possible to provide a service of reproducing an experimental result from an actual cell using the digital cell. As such, it is possible to conduct an advanced search relating to a cell even by a research organization or an individual without experimental facilities.

FIG. 45 depicts an example of configurations of computer system 4501 for providing a service of reproducing an experimental result from an actual cell using the digital cell.

Computer system 4501 comprises service requester 4510 requesting a service desired by a user; a plurality of service providers 4520₁ 4520_{N}; and service registry 4540 with registration of at least one service which can be provided by a plurality of service providers 4520₁4520_{N}, wherein N is any integer of two or more.

Computer system 4501 may include a plurality of service requesters 4510.

Service provider 4520ᵢ is configured so as to be capable of accessing database 4522, at least one digital cell stored thereon. A data structure of a digital cell stored on database 4522ᵢ is as shown in FIGS. 33A and 33B. Database 4522ᵢ may be provided in service provider 4520ᵢ or outside service provider 4520, wherein i=1, 2, N.

Service provider 4520ᵢ may be configured to be capable of accessing a plurality of databases with at least one digital cell each stored thereon.

Service registry 4540 is configured to be capable of accessing database 4542 with data stored thereon representing services being capable of being provided by service providers 4520ᵢ to 4520_{N}. Database 4542 may be provided in service registry or outside service registry 4540. Storing data representing services on database 4542 allows registration of services to service registry 4540. Formats of data stored on database 4542 are preferably pre-normalized. Storage of data to database 4542 may be performed manually by a firm managing service registry 4540 or by transmitting data from service providers 4520ᵢ to 4520_{N} via network 4530 to service registry 4540.

Each service requester 4510, service provider 4520, to 4520_{N} and service registry 4540 may be any type of computer.

Each of service providers 4520ᵢ to 4520_{N} is preferably conducted by research carried out by any of organizations, firms or any other corporation possessing experimental facilities which conducts research on an actual cell. Each of service requester 4510 and service registry 4540 is preferably conducted by any of organizations, firms or any other corporation (for example, an association for promoting digital cells) managing provision of services of reproducing experimental results from an actual cell using the digital cell. Further, in order to secure the quality of services registered to service registry 4540, it is preferable to oblige such an organization which manages service providers 4520ᵢ to 4520_{N} to satisfy a predetermined standard.

Service requester 4510, service provider 4520ᵢ to 4520_{N} and service registry 4540 are connected via network 4530. Network 4530 is of any type but most preferably, in view of ease of connection and cost, is the Internet.

When network 4530 is the Internet, service requester 4510 may be a Web server connected to a Web browser operated by a user via the Internet. Each of 4520, 4520_{N} may be a Web server connected to service requester 4510 via the Internet. In this case, service requester 4510 functions as portal or Website interrelaying to a Web browser operated by a user and a Web server of service provider 4520ᵢ. This configuration allows allows easy access to service providers 4520ᵢ to 4520_{N} by users all over the world. Thus, it is now possible for research institutes and/or firms all over the world to participate in the business providing services for reproducing experimental results from an actual cell using a digital cell.

Network 4530 is connected to a known database 4560 (for example, GenBank and the like). This allows collection and provision of information from a known database, and analysis relating to related information.

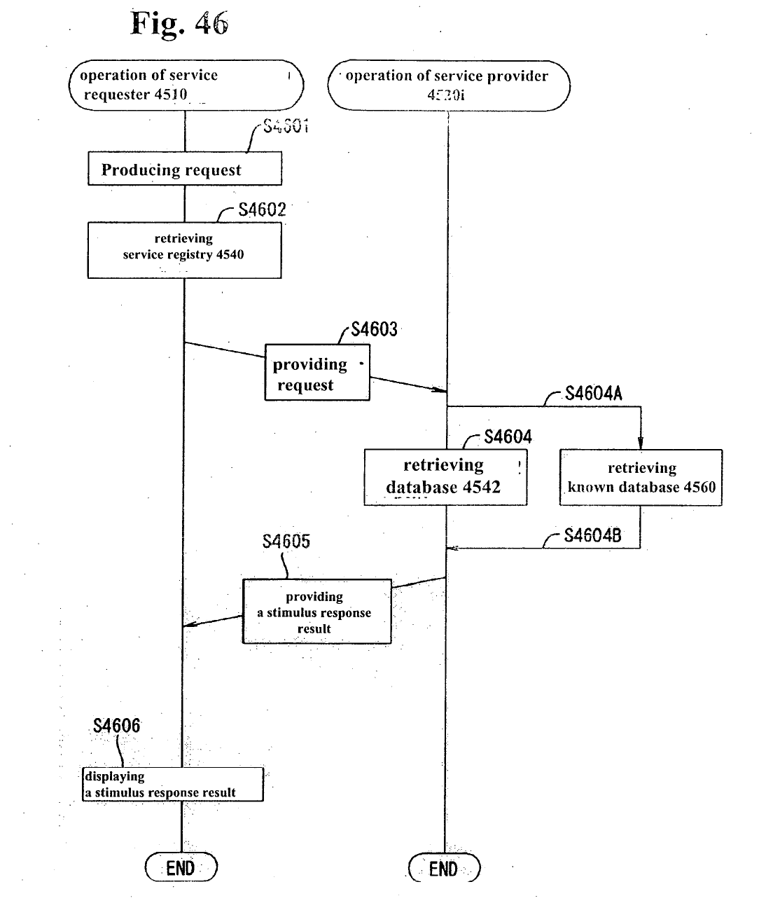

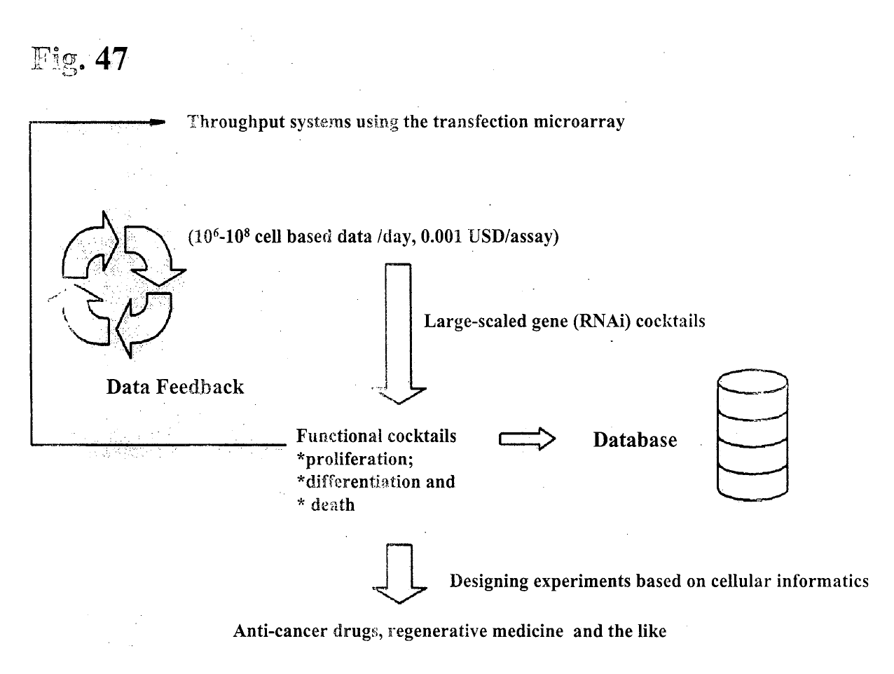

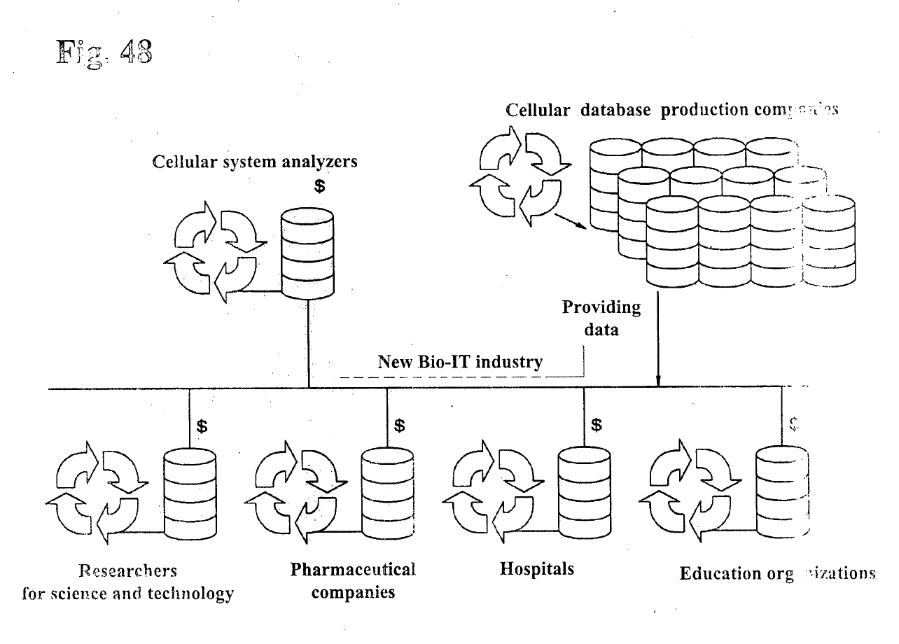

FIG. 46 depicts an example of a process for providing a service for reproducing an experimental result from an actual cell using the digital cell. This procedure is implemented by cooperating service requester 4510 and service providers 4520ᵢ with 4520_{N}.

Step S4610: Service requester 4510 receives a cell parameter, an environment parameter, and a stimulus parameter, and produces a request comprising such a cell parameter, an environment parameter, and a stimulus parameter. Such a request is described in, for example, XML.

Step S4602: Service requester 4510 searches service registry 4540 responding to the request, and determines whether or not there is a service provider 4520ᵢ which can provide a service of the requester amongst service provides 4520ᵢ to 4520_{N}, wherein i is any integer of 1 to N.

Service providers 4520ᵢ to 4520_{N} may employ any type of method to register services that can be provided by service providers 4520ᵢ to 4520_{N} on service registry 4540. For example, when service provider 4520₁ is capable of providing a service of reproducing an experimental result against cell A, then cell parameters specifying cell A and addresses (for example, URL and the like) specifying the locations of service provider 4520₁ may be stored on database 4542. For example, if service provider 4520₂ can provide services of reproducing cells B and C, then cell parameters specifying cell A and addresses (for example, URL and the like) specifying the locations of service provider 4520₂ may be stored on database 4542. Alternatively, when service provider 4520₃ can provide the service of reproducing experimental results satisfying specific experimental conditions against cell D, then parameters such as environment parameters and stimulus parameters specifying the experimental conditions and addresses (for example, a URL and the like) specifying the locations of service provider 4520₃ may be stored on database 4542.

Step S4603: If there is a service provider 4520ᵢ which can provide a service of the requester, amongst service providers 4520ᵢ to 4520_{N}, such service requester 4510 provides service provider 4520ᵢ with the request. The location of service provider 4520ᵢ may be specified by referring to database 4542 of service registry 4540.

Step S4604: service provider 4520ᵢ searches database 4522ᵢ in response to the request, and determines whether or not there exists the stimulus response result relating to the cell parameter, the environment parameter and the stimulus parameter included in the request in database 4522ᵢ.

Step S4605: If determined that there is a stimulus response result relating to the cell parameter, the environment parameter and the stimulus parameter included in the request in database 4522ᵢ, service provider 4520ᵢ provides service requester 4510 with the stimulus response result. The stimulus response result is described in, for example, XML.

Step S4606: service requester 4510 displays stimulus response result provided by service provider 4520ᵢ.

If determined that there is no stimulus response result relating to the cell parameter, environment parameter and stimulus parameter contained in the request in database 4522ᵢ, service provider 4520ᵢ will provide service requester 4510 with, for example, the result of “no hit”.

As described above, any number of methodologies may be employed as a method for inputting a cell parameter, an environment parameter and a stimulus parameter to service requester 4510, and further any forms may be employed as a form of displaying stimulus response result by service requester 4510.

As such, according to computer system 4510, it is possible to provide a service of reproducing an experimental result from an actual cell using the digital cell. This allows research institutes or individual having no experimental facilities to perform advanced research activities relating to a cell. Further, according to computer system 4501, registration of services capable of being provided by a plurality of service providers 4520ᵢ to 4520_{N}, provides opportunities to participate in the business of providing the service for reproducing experimental results from an actual cell using the digital cell to research organizations or firms all over the world.

In another aspect, the present invention provides a method for providing a service for reproducing an experimental result of an actual cell using a digital cell based on the analysis of target parameters, by means of a computer system comprising a service requester and a plurality of service providers. The subject method comprises the steps of: A) preparing a plurality of databases, each having at least one digital cell stored thereon, wherein at least one digital cell is expressed as a collection of at least one experimental data of a cell of experimental interest, wherein each experimental data comprises a cell parameter specifying the cell, an environment parameter specifying an environment under which the cell specified by the cell parameter is culture, a stimulus parameter specifying a stimulus to be given to the cell specified by the cell parameter, and a stimulus response result showing the response of the cell specified by the cell parameter to the stimulus specified by the stimulus parameter under the environment specified by the environment parameter; B) preparing a service registry which stores at least one service capable of being provided by the plurality of service providers; C) receiving the target parameter for analysis to produce the cell parameter, the environment parameter and the stimulus parameter by the service requester thereby producing a request comprising the cell parameter, the environment parameter and the stimulus parameter; D) searching the service registry in response to the request by the service requester to determine whether or not there is a service provider capable of providing a service for the request amongst the plurality of service providers; E) providing the request to the service provider by the service requester when it is determined that a service provider capable of providing a service of the request amongst the plurality of service providers exists; F) searching the database in response to the request by the service provider to determine whether or not there is the stimulus response result relating to the cell parameter, the environment parameter and the stimulus parameter included in the request in the database; G) providing the request to the service requester by the service provider, when it is determined that there is a service provider capable of providing a known database relating to the analysis of target parameters included in the requests amongst the plurality of service providers; H) searching, in response to the request by the service provider to determine whether or not there is a known database relating to target parameter for analysis, and if present, obtain information relating to the known database relating to the target parameter for analysis; I) providing the stimulus response result to the service requester by the service provider in association with the information relating to the known database, when it is determined that the stimulus response result relating to the cell parameter, the environment parameter, and the stimulus parameter exists in the digital cell database, and when the information relating to the known database is obtained; and J) presenting the information relating to the known database and the stimulus response result by the service requester. A method for practicing the present method is specifically described elsewhere herein.

In another aspect, the present invention provides computer system for providing a service for reproducing an experimental result of an actual cell using a digital cell based on an analysis target parameter. The subject system comprises: a plurality of databases, each having at least one digital cell stored thereon, wherein the at least one digital cell is expressed as a collection of at least one experimental data of a cell of experimental interest, wherein each of the at least one experimental data comprises a cell parameter specifying the cell, an environment parameter specifying an environment under which the cell specified by the cell parameter is culture, a stimulus parameter specifying a stimulus to be given to the cell specified by the cell parameter, and a stimulus a stimulus response result showing the response of the cell specified by the cell parameters to the stimulus specified by the stimulus parameters under the environment specified by the environment parameters; and a service requestor which requests a service desired by a user, wherein the service requestor comprises: means for receiving the cell parameter, the environment parameter and the stimulus parameter, and producing a request comprising the environment parameter and the stimulus parameter; and means for providing the request to the service provider; wherein the service provider comprises: means for searching the digital cell database in response to the request, and determining whether or not a response result relating to the stimulus which correlates between the cell parameter, the environment parameter and the stimulus parameter included in the request amongst the digital cell data base; means for searching for whether or not there is a known database related to the analysis of target parameters in response to the request, and if exists, obtaining information related to the known database with respect to the target parameter for analysis; and means for providing the stimulus response result to the service requester by the service provider in association with the information relating to the known database, when it is determined that the stimulus response result relating to the cell parameter, the environment parameter, and the stimulus parameter exists in the digital cell database, and when the information relating to the known database is obtained; wherein the service requester comprises: means for presenting the information relating to the known database and the stimulus response result by the service requester. Methods for implementing the subject system are specifically described herein above.

In one embodiment, the service requester is a Web browser operated by the user, and the service provider is a Web server linked to the service requester via the Internet.

In another embodiment, the service requester provides the request to the service provider in a format described in XML language.

In another embodiment, the service provider provides the stimulus response result to the service requester in a format described in XML language.

In another embodiment, the target parameter analyzed is selected from the group consisting of a disease, a drug and a gene name.

In another embodiment, the known database is selected from the group consisting of pathway database, protein interaction database, intermolecular interaction network database, genomic database, protein database, cDNA database and cellular information database.

In another embodiment, the service provider stores at least one of the known databases.

In another embodiment, the service provider is connected to the known database via a network.

In another embodiment, the information relating to the known database is outputted in the order of the intensity of relationship with the target parameter for analysis.

In another embodiment, the target parameter comprises a disease, and the information relating to the known database is outputted in a form of a list selected from the group consisting of a list of gene nomenclature relating to the disease, and the list of drugs relating to the disease.

In another preferable embodiment, the service provider further comprises: means for conducting a search for a intermolecular interaction network database and a pathway database as the known database after the analysis target parameter is inputted, outputting a gene list having intermolecular interaction and a gene list relating to the regulation of the genes, and thereby designing a cellular assay experiment based on the gene list; means for producing additional data relating to an additional digital cell based on the designed cellular assay to produce a digital cell database with an update added to the digital cell database; and means for providing the service requester with the stimulus response result related to the information relating to a known database based on the updated digital cell database.

In another aspect, the present invention provides a computer system for providing a service for reproducing an experimental result of an actual cell using a digital cell based on an analysis target parameter, by means of a computer system comprising a service requester and a plurality of service providers. The subject computer system comprises a plurality of service providers, each being constituted so as to be accessible to a database with at least one digital cell stored thereon, wherein the at least one digital cell is expressed as a collection of at least one experimental data of a cell of experimental interest, wherein each experimental data comprises a cell parameter specifying the cell, an environment parameter specifying an environment under which the cell specified by the cell parameter is culture, a stimulus parameter specifying a stimulus to be given to the cell specified by the cell parameter, and a stimulus response result showing the response of the cell specified by the cell parameter to the stimulus specified by the stimulus parameter under the environment specified by the environment parameter; a service registry which stores at least one service capable of being provided by the plurality of service providers; and a service requestor which requests a service desired by a user, wherein the service requestor comprises: means for receiving the target parameter for analysis to produce the cell parameter, the environment parameter and the stimulus parameter thereby producing a request comprising the cell parameter, the environment parameter and the stimulus parameter; means for searching in the service registry the response to the request by the service requester to determine whether or not there is a service provider capable of providing a service for the request amongst the plurality of service providers; means for providing the request to the service provider by the service requester when it is determined that a service provider capable of providing a service of the request amongst the plurality of service providers exists; means for providing the request to the service requester by the service provider, when it is determined that there is a service provider capable of providing a known database relating to the analysis of target parameters included in the requests amongst a plurality of service providers; wherein each of the plurality of service provides comprises: means for searching in response to the request to determine whether or not there is a known database relating to the target parameter for analysis, and if present, obtain information relating to the known database relating to target parameter for analysis; means for searching the database in response to the request to determine whether or not there is the stimulus response result relating to the cell parameter, the environment parameter and the stimulus parameter included in the request in the database; means for providing the stimulus response result to the service requester by the service provider in association with the information relating to the known database, when it is determined that the stimulus response result relating to the cell parameter, the environment parameter, and the stimulus parameter exists in the digital cell database, and when the information relating to the known database is obtained; and wherein the service requestor further comprises: means for presenting the information relating to the known database and the stimulus response result by the service requester. Embodiments to carry out the system are specifically described hereinabove.

In one embodiment, the service requestor is a web server connected to a web browser operated via the Internet, and each of the plurality of service providers is a web server connected to the service requestor via the Internet.

In another embodiment, the service requestor provides the service provider with the request described in the XML format.

In another embodiment, the service provider provides the service requestor with the stimulus response result described in the XML format.

In one aspect, the present invention provides a method for analyzing a biological system relating to a stimulus response. The present method comprises the steps of: A) providing a biological database comprising information relating to a biological system, input information database comprising information relating to a stimulus, and an output information database comprising information relating to a response of the biological system to the stimulus; B) extracting a combination of an input data from the input information database and an output data from the output database; C) calculating a clustering with respect to each of the input data and the output data; and D) calculating the pattern of a stimulus and a response relating to a desired analysis target system to induce a biological system relating to the combination of a stimulus and a response corresponding thereto.

As used herein, the biological system is generally non-linear, and thus clustering is unpredictable, or rather impossible to predict from conventional linear information processing, but the information processed by means of clustering unexpectedly attains improvement in efficiency which is one of the unexpectedly significant effects attained by the claimed invention.

In particularly preferable embodiment, a biological system is a biological organism per se, or alternatively, may be organ, tissue, collection of cells, cells or cellular organelles or the like. Alternatively, in another preferable embodiment, the system may be a cell. Efficient analysis of a biological system, which is a non-linear system, cannot be achieved by technology other than the methods described in detail in the present specification which has been developed by the present inventors. Accordingly, the present invention should be recognized to be firstly achieved by the disclosure of the present inventors.

As used herein, indicators for expressing output used in the present invention may vary depending on a particular system, it should be understood that those skilled in the art would be able to select such indices for appropriately expressing outputs in an arbitrary manner depending on the particular system. Indices for expressing such output which may be used in the present invention, include, for example, those for expressing natural science outputs, those for expressing technical outputs such as those for expressing physical outputs, those for expressing chemical outputs, those for expressing biochemical outputs, those for expressing biological outputs and the like.

In a preferable embodiment, indices used for expressing output used in the present invention include a differentiation state, responses to an external agent, cellular cycle, proliferation state, an apoptosis state, response to an environmental change, an aging state, intracellular interaction, chemostasis, elongation rate, morphology, volume change and the like.

In another embodiment, the indices used for expressing output used in the present invention includes gene expression level, gene transcriptional level, gene post-translational modification level, chemical substance level present inside a cell, intracellular ionic level, cellular volume, biochemical process level, and biophysical process level (for example, including those expressed as biological macromolecule, study of the physical or structural properties of macromolecules, study for elucidation at a molecular level of a variety of biological mechanisms, simulation studies using physical data and computer to model biological mechanisms, and the like).

In a preferable embodiment, the indices used to express output used in the present invention may be selected from the group consisting of gene expression level and gene transcriptional level. More preferably, the indices used in the present invention include gene transcriptional level. Analysis of transcriptional level allows analysis of behaviors inside a cell in a detailed manner.

In a preferable embodiment, the data used in the present invention is data of gene expression level, and the gene expression level is the expression level of fluorescence protein. Gene expression includes transcription and translation. Behavior of “change” of such genes may be observed by means of fluorescence protein. In particular, transcription level may be visualized by means of fluorescence protein with respect to the behavior of the promoter. A method for linking a fluorescence protein to a promoter is concisely described herein and well known in the art.

In one embodiment, the biological database comprises a database of a digital cell.

In a preferable embodiment, the biological database comprises a component constituting the biological system, and the analysis calculates a component constituting the desired analysis target system. Elements constituting a biological system vary depending on the biological system, and in the case of a cell, it includes for example, genes, proteins, lipids and the like, and for example, depending on the expression method of variation, more abstract concept such as size of a cell may also be used.

In another embodiment, the biological database is a cell, and the elements include a gene, the analysis includes the step of inducing a gene characteristic amongst genes constituting the desired target to be analysed.

In one embodiment, the biological database is a cell, and the component constituting the biological system comprise a gene, and the analysis comprises the step of calculating a characteristic gene amongst the genes constituting the target to be analysed. As used herein, the intermolecular interaction of genes may refer to the interaction in a signaling pathway. As used herein “pathway” refers to a pathway per se of signal transduction in a signaling pathway. Regulations may be for example, upregulation or downregulation, or alternatively direct regulation or indirect regulation.

In one embodiment, the biological database, the input information database, and the output information database are provided by a digital cell, and the digital cell is provided by a digital cell database produced by a process of the steps of: a) obtaining a cell parameter specifying a cell of experimental interest; b) obtaining an environment parameter specifying an environment under which the cell specified by the cell parameter is cultured; c) obtaining a stimulus parameter specifying a stimulus to be given to the cell specified by the cell parameter; d) obtaining a stimulus response result showing the response of the cell specified by the cell parameter to the stimulus specified by the stimulus parameter under the environment specified by the environment parameter; e) producing an experimental data for the cell, by correlating the cell parameter, the environment parameter, the stimulus parameter and the stimulus response result; f) optionally repeating steps a) through e) to produce at least one collection of experimental data for the cell, and to provide the at least one collection of experimental data as a digital cell; g) collecting data of the digital cell to produce a database.

In one embodiment, the biological system targeted by the present invention is a cell, and the analysis is conducted by means of change in signs (+/−) of first-order differentiation of time-series data of the output. This may correspond to the increase or decrease of a response to a stimulus.

In one embodiment, the biological system targeted by the present invention is a cell, and the desired analysis target system is a disease related to a cell. Cells related to diseases include cells present in the living body at a diseased state in general, and in particular, cells directly used to diseases (for example, cancer cell, cells which originally produced insulin but have become non-producing, and the like) may be used.

In another embodiment, the biological system targeted by the present invention is a cell, and the desired analytical system is a disease related cell.

In another embodiment, the biological system targeted by the present invention is a cell, and the desired analysis target system is a cell related to a disease, the component comprises a gene, and the analysis comprises the step of selecting a characteristic gene amongst the genes constituting the desired analysis target. Extraction of genes, for example, can be identified by means for analyzing signal transduction pathways. For example, clustering may be used for such analysis.

In a specific embodiment, the biological system targeted by the present invention is a cell, and the desired analysis target system is a disease related cell, the component comprises a gene, and an intermolecular interaction, regulation relationship and pathway thereof, and the analysis comprises the step of selecting a characteristic gene, and the intermolecular interaction, regulation relationship and pathway thereof amongst the genes constituting the desired analysis target.

In another specific embodiment, the biological system targeted by the present invention is a cell, and the response is selected from the group consisting of cell lethality, change in cell morphology, a genetic promoter activity, an enzymatic activity, an ionic amount, an ionic localization, the amount of a biomolecule other than a protein, and the change in localization of a biomolecule other than a protein. As used herein, ions include, for example, metal ions such as calcium ion, potassium ion, sodium ion, and the like, non-metal ions such as chloride ion and the like. In particular, calcium ion is preferable, as it can translocate between intranuclear section and cytoplasm, and thereby can be used as an index for determining activity of G-protein coupled receptor (GPCR). Methods for measuring calcium comprise the steps of introducing FURA-2 (available from DOJINDO or the like) or calcium sensing fluorescence protein or the like into a cell, in order to calculate variation from change in intensity of fluorescence images of a cell.

In another specific embodiment, the biological system targeted by the present invention is a cell, and the cell is selected from the group consisting of a tissue derived normal cell, diseased cell and an established cell line.

In an embodiment, the stimulus used in the present invention is selected from the group consisting of an inhibitor, an antisense oligonucleotide, an RNAi and an antibody.

In another embodiment, clustering comprises one by the Ward method. As used herein, clustering refers to dividing a set of targets for classification into subsets so as to achieve internal cohesion and external isolation. Each subset is called cluster after such division. There are many methods for division, including cases where the entire classification target is included within one cluster (hard or crisp cluster), or those where one cluster simultaneously belongs to a plurality of clusters in a partial manner (soft, or fuzzy cluster).

Clustering methods are generally divided into hierarchical methods such as nearest neighbor method or the like, and partitioning-optimization such as k-means or the like. Hierarchical methods are further divided into divisive and agglomerative.

In agglomerative type, clustering, when data consisting of N targets is given, initial state is firstly produced which has N clusters each including one target. Beginning with the present state, distance D (C1,C2) between clusters are calculated from distance D(x1,x2) between targets x1 and x2 (non-similarity), and thereby consecutively combine two clusters which have the closest distance. Furthermore, such combination is repeated until all the targets are incorporated into one cluster to obtain hierarchical structure. Such hierarchical structure may be expressed by means of dendrogram. Dendrograms refer to binary tree in which each terminal nodes refer to each target and the resultant combined clusters are expressed by means of non-terminal nodes. X-axis of the non-terminal nodes refers to the distance between clusters when combined. Depending on distance function D(C1,C2) regarding clusters C1 and C2, there are different methods as follows:

(1) nearest neighbor method or single linkage method

$$D ( {C}_{1} , {C}_{2} ) = {min}_{{x}_{1} ∈ {C}_{1} , {x}_{2} ∈ {C}_{2}} D ( {x}_{1} , {x}_{2} )$$

(2) furthest neighbor method or complete linkage

$$D ( {C}_{1} , {C}_{2} ) = {max}_{{x}_{1} ∈ {C}_{1} , {x}_{2} ∈ {C}_{2}} D ( {x}_{1} , {x}_{2} )$$

(3) group average method

$$D ( {C}_{1} , {C}_{2} ) = \frac{1}{{n}_{1} {n}_{2}} {\sum }_{{x}_{1} ∈ {C}_{1}} {\sum }_{{x}_{2} ∈ {C}_{2}} D ( {x}_{1} , {x}_{2} )$$

(4) Ward's method

$$D ( {C}_{1} , {C}_{2} ) = E ( {C}_{1} ⋃ {C}_{2} ) - E ( {C}_{1} ) - E ( {C}_{2} ) \\ where \\ E ( {C}_{i} ) = {\sum }_{x ∈ {C}_{i}} {( D ( x , {c}_{i} ) )}^{2} . \qquad$$

Ward's method minimize total sum of square of distances from each target to a centroid of the cluster containing the target. Nearest neighbor method, furthest neighbor method and group average method can be applied when distance D(xi, xj) between any targets already given. When the target is described as a numerical vector, Euclidean distance between vectors is calculated and applied thereto. Detailed description thereof should be referred to Kamishima Toshihiro, “deeta mainingu bun'ya no kurasutaringu shuho (1), kurasuraringu o tsukattemiyo!” (Clustering methods in data mining field (1) - - - Let's use Clustering!”, Jinkochino gakkaishi (The JSAI Journal), vol. 18, no. 1, pp. 59-65 (2003); and Kamishima Toshihiro, “deeta mainingu bun'ya no kurasutaringu shuho (2)—daikibo deeta e no chosen to jigen no noroi no kokufuku” (Clustering methods in data mining field (1) - - - challenging mass data and overcoming cursing of dimensions”, Jinkochino gakkaishi (The JSAI Journal), vol. 18, no. 2, pp. 170-176 (2003).

In a specific analysis embodiment, the clustering is determined by conducting a first-order processing wherein if a variable in the response is within a predetermined range, the variable is determined to be 0, if the variable is greater than the upper limit of the predetermined range, the variable is determined to be 1, and if the variable is lower than the lower limit of the predetermined range, the variable is determined to be −1; performing a second-order processing wherein if the value of the results of the first-order processing per member of each biological system coincide, then the member is determined to be 0, and otherwise the member is determined to be 1; and calculating a Euclidean space distance with respect to the results of the second-order processing. The predetermined range may be within a predetermined range of a change in the response. Such ranges of variation include: for example, +/−100%, 90%, 80%, 70%, 60%, 50%, 40%, 30%, 20%, 10%, 5% and the like.

In an embodiment, the calculation based on the clustering further comprises the step of extracting stimulus and response patterns which are capable of distinguishing a biological system similar to a desired analytical target system, and one different from the desired analytical target system. The present method may further comprise the step of extracting a stimulus capable of specifically distinguishing the desired analytical target system.

In another aspect, the present method may comprise in lieu of step D), the step of calculating a stimulus relating to the combination of a biological system and a response corresponding to the pattern of the biological system and a response relating to the desired stimulus.

In another aspect, the present method may comprise in lieu of step D), the step of calculating a response relating to the combination of a biological system and a stimulus corresponding to the pattern of the biological system and the stimulus relating to the desired stimulus.

As such, the present invention has significance in having found unexpected efficiency in a biological system, a non-linear system, in that similar members may be extrapolated and extracted in an efficient manner with respect to members for which two-dimensions have been determined, based on the two dimension thereof, by applying three-dimensional parameters to the clustering methods.

Accordingly, in another aspect, the present invention provides a system for analyzing a biological system relating to a stimulus response. The subject system comprises: A) means for providing a biological database comprising information relating to a biological system, input information database comprising information relating to a stimulus, and an output information database comprising information relating to a response of the biological system to the stimulus; B) means for extracting a combination of an input data from the input information database and an output data from the output database; C) means for calculating a clustering with respect to each of the input data and the output data; and D) means for calculating the pattern of a stimulus and a response relating to a desired analysis target system to induce a biological system relating to the combination of a stimulus and a response corresponding thereto. These means may be carried out based on the description of the present specification by those skilled in the art as described elsewhere herein with respect to each step of the above-mentioned methods. Most of these methods may be carried out using CPU.

Accordingly, in another aspect, the present invention provides a computer program for implementing a method for analyzing a biological system relating to a stimulus response to a computer. The subject method comprising the steps of: A) providing a biological database comprising information relating to a biological system, input information database comprising information relating to a stimulus, and an output information database comprising information relating to a response of the biological system to the stimulus; B) extracting a combination of an input data from the input information database and an output data from the output database; C) calculating a clustering with respect to each of the input data and the output data; and

D) calculating the pattern of a stimulus and a response relating to a desired analysis target system to induce a biological system relating to the combination of a stimulus and a response corresponding thereto; calculating a stimulus relating to the combination of a biological system and a response corresponding to the pattern of the biological system and a response relating to the desired stimulus; or calculating a response relating to the combination of a biological system and a stimulus corresponding to the pattern of the biological system and the stimulus relating to the desired stimulus. As used herein, the present invention may be carried out based on the description of the present specification by those skilled in the art as described elsewhere herein with respect to each step of the above-mentioned methods. Most of these methods may be carried out using CPU.

In another aspect, the present invention provides a computer-readable medium with a computer program stored thereon for implementing to computer a method for analyzing a biological system relating to a stimulus response. The subject method comprising the steps of: A) providing a biological database comprising information relating to a biological system, input information database comprising information relating to a stimulus, and an output information database comprising information relating to a response of the biological system to the stimulus; B) extracting a combination of an input data from the input information database and an output data from the output database; C) calculating a clustering with respect to each of the input data and the output data; and D) calculating the pattern of a stimulus and a response relating to a desired analysis target system to induce a biological system relating to the combination of a stimulus and a response corresponding thereto; calculating a stimulus relating to the combination of a biological system and a response corresponding to the pattern of the biological system and a response relating to the desired stimulus; or calculating a response relating to the combination of a biological system and a stimulus corresponding to the pattern of the biological system and the stimulus relating to the desired stimulus. As used herein, the present invention may be carried out based on the description of the present specification by those skilled in the art as described elsewhere herein with respect to each step of the above-mentioned methods. Most of these methods may be carried out using CPU.

All patents, published patent applications and publications cited herein are incorporated by reference as if set forth fully herein.

The preferred embodiments of the present invention have been heretofore described for a better understanding of the present invention. Hereinafter, the present invention will be described by way of examples. Examples described below are provided only for illustrative purposes. Accordingly, the scope of the present invention is not limited except as by the appended claims. According to the examples below, it will be understood that those skilled in the art can select cells, supports, biological agents, salts, positively charged substances, negatively charged substances, actin acting substances, and the like, as appropriate, and can make or carry out the present invention.

### EXAMPLES

Hereinafter, the present invention will be described in greater detail by way of examples, though the present invention is not limited to the examples below. Reagents, supports, and the like are commercially available from Sigma (St. Louis, USA), Wako Pure Chemical Industries (Osaka, Japan), Matsunami Glass (Kishiwada, Japan) unless otherwise specified.

### Example 1

### Reagents

Formulations below were prepared in Example 1.

As candidates for an actin acting substance, various extracellular matrix proteins and variants or fragments thereof were prepared in Example 1 as listed below. Fibronectin and the like were commercially available. Fragments and variants were obtained by genetic engineering techniques:

1) fibronectin (SEQ ID NO.: 11);
2) fibronectin 29 kDa fragment;
3) fibronectin 43 kDa fragment;
4) fibronectin 72 kDa fragment;
5) fibronectin variant (SEQ ID NO.: 11, alanine at 152 was substituted with leucine);

### 6) ProNectin F (Sanyo Chemical Industries, Kyoto, Japan);

### 7.) ProNectin L (Sanyo Chemical Industries);

### 8) ProNectin Plus (Sanyo Chemical Industries);

9) laminin (SEQ ID NO.: 6);
10) RGD peptide (tripeptide);
11) RGD-containing 30 kDa peptide;
12) 5 amino acids of laminin (IKVAV, SEQ ID NO.: 28); and
13) gelatin.

Plasmids were prepared as DNA for transfection. Plasmids, pEGFP-N1 and pDsRed2-N1 (both from BD Biosciences, Clontech, CA, USA) were used. In these plasmids, gene expression was under the control of cytomegalovirus (CMV). The plasmid DNA was amplified in E. coli (XL1 blue, Stratgene, TX, USA) and the amplified plasmid DNA was used as a complex partner. The DNA was dissolved in distilled water free from DNase and RNase.

The following transfection reagents were used: Effectene Transfection Reagent (cat. no. 301425, Qiagen, CA), TransFast™ Transfection Reagent (E2431, Promega, WI), Tfx™-20 Reagent (E2391, Promega, WI), SuperFect Transfection Reagent (301305, Qiagen, CA), PolyFect Transfection Reagent (301105, Qiagen, CA), LipofectAMINE 2000 Reagent (11668-019, Invitrogen corporation, CA), JetPEI (×4) conc. (101-30, Polyplus-transfection, France), and ExGen 500 (R0511, Fermentas Inc., MD). These transfection reagents were added to the above-described DNA and actin acting substance in advance or complexes thereof with the DNA were produced in advance.

The obtained solution was used in assays using transfection arrays described below.

### Example 2

### Transfection Array

### Demonstration Using Mesenchymal Stem Cells

In Example 2, an improvement in the transfection efficiency of solid phase was observed. The protocol used in Example 2 will be described below.

(Protocol)

The final concentration of DNA was adjusted to 1 μg/μL. An actin acting substance was preserved as a stock having a concentration of 10 μg/μL in ddH₂O. All dilutions were made using PBS, ddH₂O, or Dulbecco's MEM. A series of dilutions, for example, 0.2 μg/μL, 0.27 μg/μL, 0.4 μg/μL, 0.53 μg/μL, 0.6 μg/μL, 0.8 μg/μL, 1.0 μg/μL, 1.07 μg/μL, 1.33 μg/μL, and the like, were formulated.

Transfection reagents were used in accordance with the instructions provided by each manufacturer.

Plasmid DNA was removed from a glycerol stock and amplified in 100 mL L-amp overnight. Qiaprep Miniprep or Qiagen Plasmid Purification Maxi was used to purify DNA in accordance with a standard protocol provided by the manufacturer.

In Example 2, the following 5 cells were used to confirm an effect: human mesenchymal stem cell (hMSCs, PT-2501, Cambrex BioScience Walkersville, Inc., MD); human embryonic renal cell (HEK293, RCB1637, RIKEN Cell Bank, JPN); NIH3T3-3 cell (RCB0150, RIKEN Cell Bank, JPN); HeLa cell (RCB0007, RIKEN Cell Bank, JPN); and HepG2(RCB1648, RIKEN Cell Bank, JPN). These cells were cultured in DMEM/10% IFS containing L-glut and pen/strep.

(Dilution and DNA Spots)

Transfection reagents and DNA were mixed to form a DNA-transfection reagent complex. The complex formation requires a certain period of time. Therefore, the mixture was spotted onto a solid phase support (e.g., a poly-L-lysine slide) using an arrayer. In Example 2, as a solid phase support, an APS slide, a MAS slide, and an uncoated slide were used as well as a poly-L-lysine slide. These slides are available from Matsunami Glass (Kishiwada, Japan) or the like.

For complex formation and spot fixation, the slides were dried overnight in a vacuum dryer. Drying was performed in the range of 2 hours to 1 week.

Although the actin acting substance might be used during the complex formation, it was also used immediately before spotting in Example 2.

(Formulation of Mixed Solution and Application to Solid Phase Supports)

300 μL of DNA concentrated buffer (EC buffer)+16 μL of an enhancer were mixed in an Eppendorf tube. The mixture was mixed with a Vortex, followed by incubation for 5 minutes. 50 μL of a transfection reagent (Effectene, etc.) was added to the mixture, followed by mixing by pipetting. To apply a transfection reagent, an annular wax barrier was formed around the spots on the slide. 366 μL of the mixture was added to the spot region surrounded by the wax, followed by incubation at room temperature for 10 to 20 minutes. Thereby, the fixation to the support was manually achieved.

(Distribution of Cells)

Next, a protocol for adding cells will be described. Cells were distributed for transfection. The distribution was typically performed by reduced-pressure suction in a hood. A slide was placed on a dish, and the cell containing solution was added to the dish for transfection. The cells were distributed as follows.

The growing cells were distributed to a concentration of 10⁷ cells/25 mL. The cells were plated on a slide in a 100×100×15 mm squared Petri dish or a 100 mm (radius)×15 mm circular dish. Transfection was conducted for about 40 hours. This period of time corresponded to about 2 cell cycles. The slide was treated for immunofluorescence.

(Evaluation of Gene Introduction)

Gene introduction was evaluated by detection using, for example, immunofluorescence, fluorescence microscope examination, laser scanning, radioactive labels, and sensitive films, or emulsion.

When an expressed protein to be visualized is a fluorescent protein, such a protein can be observed with a fluorescence microscope and a photograph thereof can be taken. For large-sized expression arrays, slides may be scanned using a laser scanner for storage of data. If an expressed protein can be detected using fluorescence antibodies, an immunofluorescence protocol can be successively performed. If detection is based on radioactivity, the slide may be adhered as described above, and autoradiography using film or emulsion can be performed to detect radioactivity.

(Laser Scanning and Quantification of Fluorescence Intensity)

To quantify transfection efficiency, the present inventors use a DNA microarray scanner (GeneTAC UC4×4, Genomic Solutions Inc., MI). Total fluorescence intensity (arbitrary unit) was measured, and thereafter, fluorescence intensity per unit surface area was calculated.

### (Cross-Sectional Observation by Confocal Scanning Microscope)

Cells were seeded on tissue culture dishes at a final concentration of 1×10⁵ cells/well and cultured in appropriate medium (Human Mesenchymal Cell Basal Medium (MSCGM BulletKit PT-3001, Cambrex BioScience Walkersville, Inc., MD). After fixation of the cell layer with 4% paraformaldehyde solution, SYTO and Texas Red-X phalloidin (Molecular Probes Inc., OR, USA) was added to the cell layer for observation of nuclei and F-actin. The samples emitting light due to gene products and the stained samples were observed with a confocal laser microscope (LSM510: Carl Zeiss Co., Ltd., pin hole size=Ch1=123 μm, Ch2=108 μm, image interval=0.4) to obtain cross sectional views.

(Results)

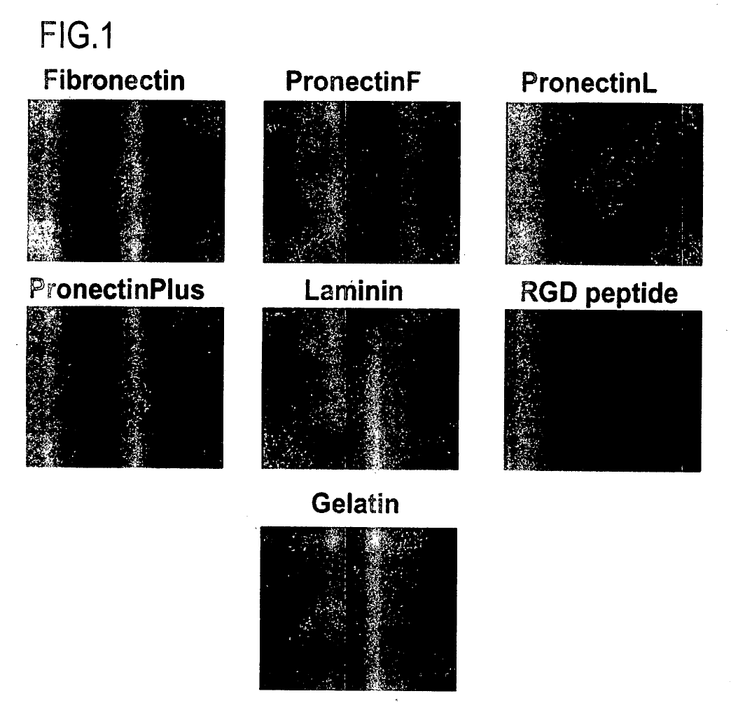

FIG. 1 shows the results of experiments in which various actin acting substances and HEK293 cells were used and gelatin was used as a control.

As can be seen from the results, whereas transfection was not very successful in a system using gelatin, transfection took place to a significant level in systems using fibronectin, ProNectin (ProNectin F, ProNectin L, ProNectin Plus) which is a variant of fibronectin, and laminin. Therefore, it was demonstrated that these molecules significantly increase transfection efficiency. Use of the RGD peptide alone exhibited substantially no effect.

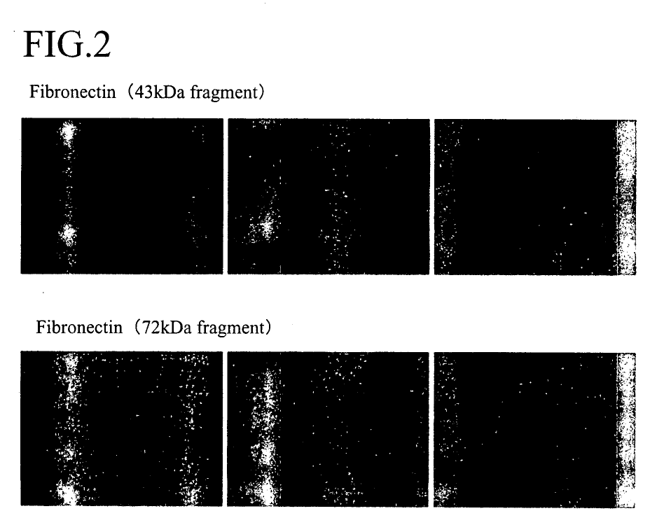

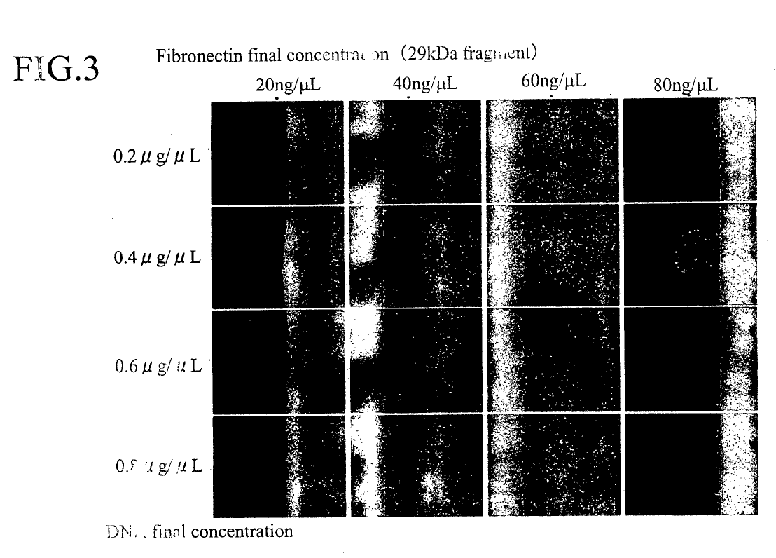

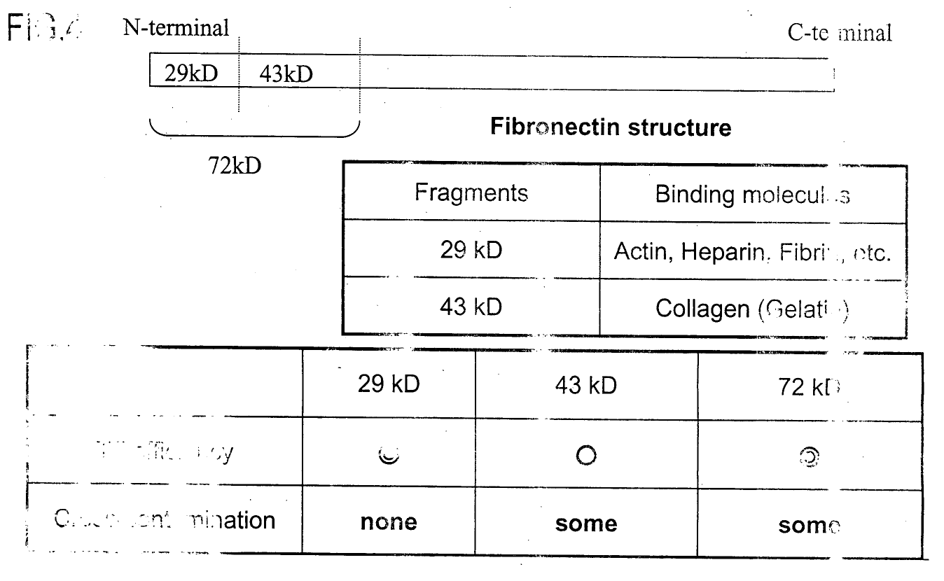

FIGS. 2 and 3 show transfection efficiency using fibronectin fragments. FIG. 4 shows the summary of the results. 29 kDa and 72 kDa fragments exhibited a significant level of transfection activity, while a 43 kDa fragment had a lower activity. Therefore, it was suggested that an amino acid sequence contained in the 29 kDa fragment played a role in the increase in transfection efficiency. Substantially no contamination was found in the case of the 29 kDa fragment, while contamination was observed in the case of the other two fragments (43 kDa and 72 kDa). Therefore, only the 29 kDa domain may be preferably used as an actin-acting substance. When the RGD peptide was used alone, the increase in transfection efficiency was not exhibited, demonstrating that the activity resulted from the 29-kDa peptide. Such a system with additional 6 amino acids of laminin (higher molecular weight) exhibited transfection activity. Therefore, these peptide sequences may also play an important role in the activity to increase transfection efficiency, without limitation. In such a case, a molecular weight of at least 5 kDa, preferably at least 10 kDa, and more preferably at least 15 kDa may be required for an increase in transfection efficiency.

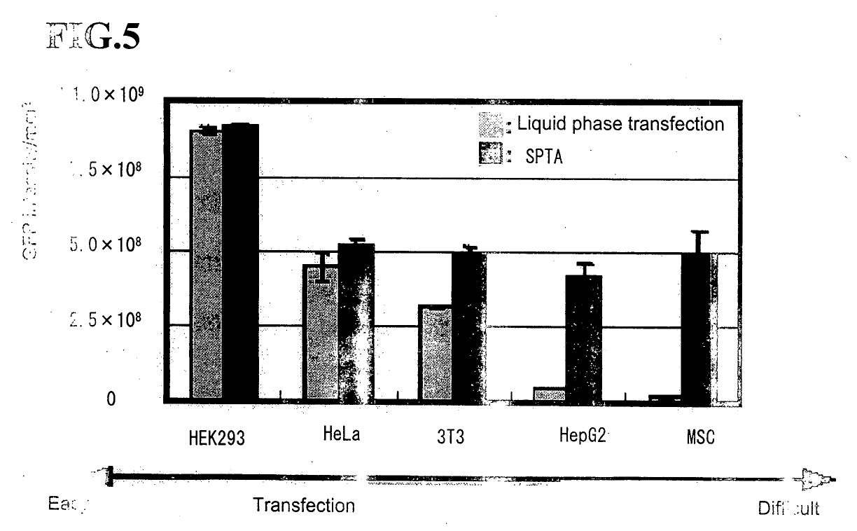

Next, FIG. 5 shows the result of studies on transfection efficiency of cells. In FIG. 5, HEK293 cells, HeLa cells, and 3T3 cells, which are known to be transfectable, and HepG2 cells and mesenchymal stem cells (MSC) which are conventionally believed to be substantially impossible to transfect, were used to show the effect of the transfection method of the present invention. The vertical axis represents the intensity of GFP.

In FIG. 5, the transfection method of the present invention using a solid phase support was compared to a conventional liquid phase transfection method. The conventional liquid phase transfection method was conducted in accordance with a protocol recommended by the kit manufacturer.

As can be seen from FIG. 5, transfection efficiency comparable to HeLa and 3T3 was achieved in HepG2 cells and mesenchymal stem cells (MSC) which are conventionally believed to be substantially impossible to transfect, as well as HEK293 cells, HeLa cells, and 3T3 cells, as a positive control. Such an effect was not achieved by conventional transfection systems. The present invention was the first to provide a system which can increase transfection efficiency and can provide practicable transfection for substantially all cells. By using solid phase conditions, cross contamination was significantly reduced. Therefore, it was demonstrated that the present invention using a solid phase support is appropriate for the production of an integrated bioarray.

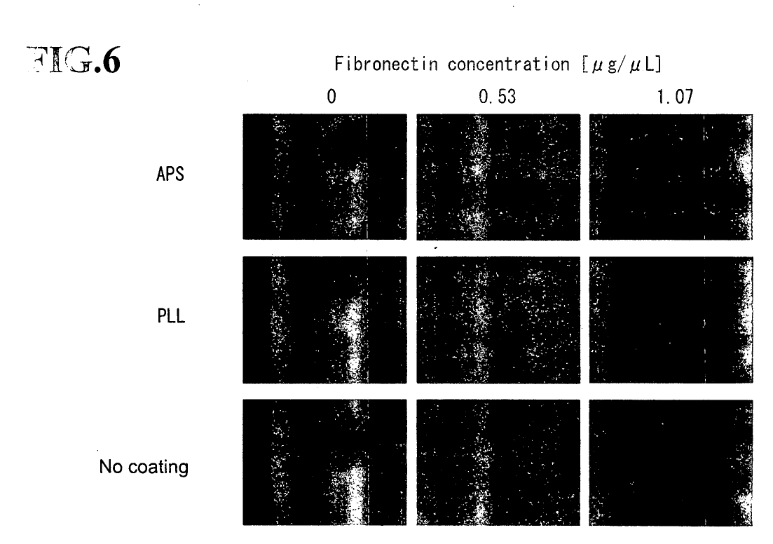

Next, FIG. 6 shows the results of transfection when various plates were used. As shown in FIG. 6, contamination was reduced when coating was provided whereas transfection efficiency was increased when coating was not provided.

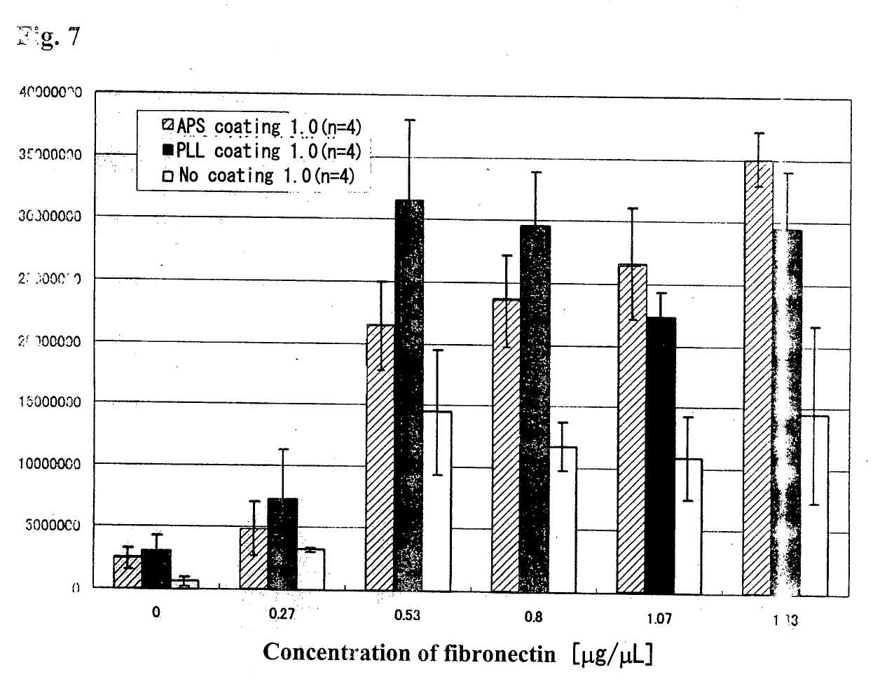

Next, FIG. 7 shows the results of transfection with fibronectin concentrations of 0, 0.27, 0.53, 0.8, 1.07, and 1.33 (μg/μL for each). In FIG. 7, slides coated with PLL (poly-L-lysine) and APS. Uncoated slides are shown.

As shown in FIG. 7, transfection efficiency was increased with an increase in fibronectin concentration. Note that in the case of PLL coating and the absence of coating, the transfection efficiency reached a plateau at a fibronectin concentration of more than 0.53 μg/μL. In the case of APS, it was found that the effect was further increased at a fibronectin concentration of more than of 1.07 μg/μL.

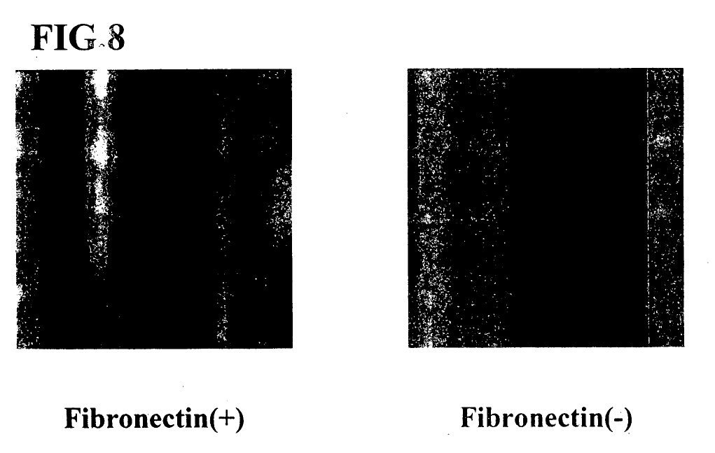

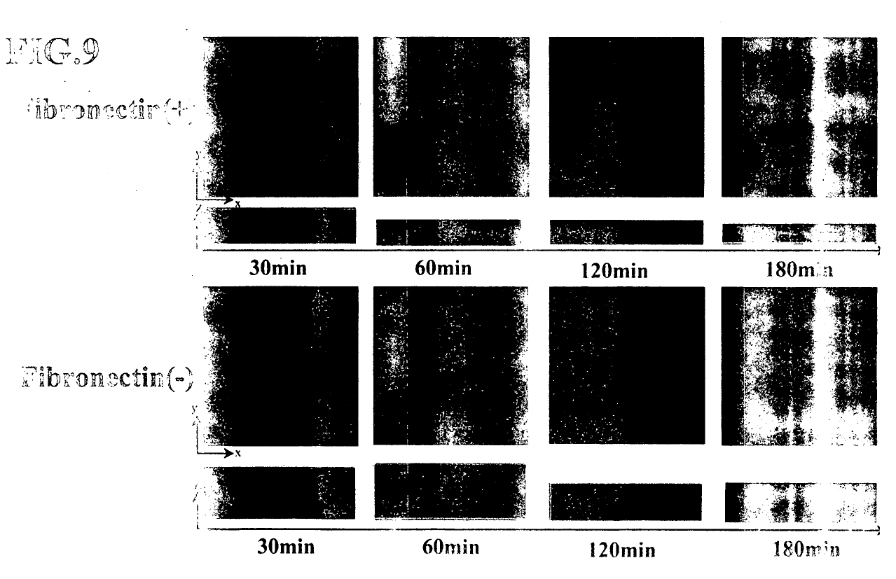

Next, FIG. 8 shows photographs indicating cell adhesion profiles in the presence or absence of fibronectin. FIG. 9 shows cross-sectional photographs. The shapes of adherent cells were shown to be significantly different (FIG. 8). The full extension of cells was found during the initial 3 hours of culture in the presence of fibronectin, while extension was limited in the absence of fibronectin (FIG. 9). Considering the behavior of filaments (FIG. 9) and the results of the time-lapse observation, it was considered that an actin-acting substance, such as fibronectin, attached to a solid phase support has an influence on the shape and orientation of actin filaments, and that the efficiency of introduction of a substance into a cell, such as transfection efficiency or the like, is increased. Specifically, actin filaments were shown to quickly change their location in the presence of fibronectin, and to disappear from the cytoplasmic space within the nucleus as the cell extends. It is considered that actin depletion in the perinuclear space, which is induced by an actin acting substance, such as fibronectin, allows the transport of a target substance, such as DNA or the like, into cells or nuclei. Though not wishing to be bound by any theory, the reason is considered to be that the cytoplasm viscosity is reduced and that positively charged DNA particles are prevented from being trapped by negatively charged actin filaments. Additionally, it is considered that the surface area of the nucleus is significantly increased in the presence of fibronectin (FIG. 10), possibly facilitating the transfer of a target substance, such as DNA or the like, into the nucleus.

### Example 3

### Application to Bioarrays

Next, larger-scale experiments were conducted to determine whether or not the above-described effect was demonstrated when arrays were used.

### Experimental Protocols

(Cell Sources, Culture Media, and Culture Conditions)

In this example, five different cell lines were used: human mesenchymal stem cells (hMSCs, PT-2501, Cambrex BioScience Walkersville, Inc., MD), human embryonic kidney cell HEK293 (RCB1637, RIKEN Cell Bank, JPN), NIH3T3-3 (RCB0150, RIKEN Cell Bank, JPN), HeLa (RCB0007, RIKEN Cell Bank, JPN), and HepG2 (RCB1648, RIKEN Cell Bank, JPN). In the case of human MSCS, cells were maintained in commercialized Human Mesenchymal Cell Basal Medium (MSCGM BulletKit PT-3001, Cambrex BioScience Walkersville, Inc., MD). In case of HEK293, NIH3T3-3, HeLa and HepG2, cells were maintained in Dulbecco's Modified Eagle's Medium (DMEM, high glucose 4.5 g/L with L-Glutamine and sodium pyruvate; 14246-25, Nakalai Tesque, JPN) with 10% fetal bovine serum (FBS, 29-167-54, Lot No. 2025F, Dainippon Pharmaceutical CO., LTD., JPN). All cells were cultivated in a controlled incubator at 37° C. in 5% CO₂. In experiments involving hMSCs, we used hMSCs of less than five passages, in order to avoid phenotypic changes.

(Plasmids and Transfection Reagents)

To evaluate the efficiency of transfection, the pEGFP-N1 and pDsRed2-N1 vectors (cat. no. 6085-1, 6973-1, BD Biosciences Clontech, CA) were used. Expression of both genes was under the control of cytomegalovirus (CMV) promoter. Cells were transfected with EGFP or DsRed2, respectively. Plasmid DNAs were amplified using Escherichia coli, XL1-blue strain (200249, Stratagene, TX), and purified by EndoFree Plasmid Kit (EndoFree Plasmid Maxi Kit 12362, QIAGEN, CA). In all cases, plasmid DNA was dissolved in DNase and RNase free water. Transfection reagents were obtained as below: Effectene Transfection Reagent (cat. no. 301425, Qiagen, CA), TransFast™ Transfection Reagent (E2431, Promega, WI), Tfx™-20 Reagent (E2391, Promega, WI), SuperFect Transfection Reagent (301305, Qiagen, CA), PolyFect Transfection Reagent (301105, Qiagen, CA), LipofectAMINE 2000 Reagent (11668-019, Invitrogen corporation, CA), JetPEI (×4) conc. (101-30, Polyplus-transfection, France), and ExGen 500 (R0511, Fermentas Inc., MD).

(Solid-Phase Transfection Array (SPTA) Production)

The detail of protocols for ‘reverse transfection’ was described in the web site, ‘Reverse Transfection Homepage’ (http://staffa.wi.mit.edu/sabatini_public/reverse_transfect ion.htm) or J. Ziauddin, D. M. Sabatini, Nature, 411, 2001, 107; and R. W. Zu, S. N. Bailey, D. M. Sabatini, Trends in Cell Biology, Vol. 12, No. 10, 485. In our solid phase transfection (SPTA method), three types of glass slides were studied (silanized glass slides; APS slides, and poly-L-lysine coated glass slides; PLL slides, and MAS coated slides; Matsunami Glass, JPN) with a 48 square pattern (3 mm×3 mm) separated by a hydrophobic fluoride resin coating.

(Plasmid DNA Printing Solution Preparation)

Two different ways to produce a SPTA were developed. The main differences reside in the preparation of the plasmid DNA printing solution.

(Method A)

In the case of using Effectene Transfection Reagent, the printing solution contained plasmid DNA and cell adhesion molecules (bovine plasma fibronectin (cat. no. 16042-41, Nakalai Tesque, JPN), dissolved in ultra-pure water at a concentration of 4 mg/mL). The above solution was applied on the surface of the slide using an inkjet printer (synQUAD™, Cartesian Technologies, Inc., CA) or manually, using a 0.5 to 10 μL tip. This printed slide was dried up over 15 minutes at room temperature in a safety-cabinet. Before transfection, total Effectene reagent was gently poured on the DNA-printed glass slide and incubated for 15 minutes at room temperature. The excess Effectene solution was removed from the glass slide, using a vacuum aspirator and dried up at room temperature for 15 minutes in a safety-cabinet. The DNA-printed glass slide obtained was set in the bottom of a 100-mm culture dish and approximately 25 mL of cell suspension (2 to 4×10⁴ cells/mL) was gently poured into the dish. Then, the dish was transferred to the incubator at 37° C. in 5% CO₂ and incubated for 2 or 3 days.

(Method B)

In case of other transfection reagents (TransFast™, Tfx™-20, SuperFect, PolyFect, LipofectAMINE 2000, JetPEI (×4) conc., or ExGen), plasmid DNA, fibronectin, and the transfection reagent were mixed homogeneously in a 1.5-mL micro-tube according to the ratios indicated in the manufacturer's instructions and incubated at room temperature for 15 minutes before printing on a chip. The printing solution was applied onto the surface of the glass-slide using an inkjet printer or a 0.5- to 10-μL tip. The printed glass-slide was completely dried up at room temperature over 10 minutes in a safety-cabinet. The printed glass-slide was placed in the bottom of a 100-mm culture dish and approximately 3 mL of cell suspension (2 to 4×10⁴ cells/mL) was added and incubated at room temperature over 15 minutes in a safety-cabinet. After incubation, fresh medium was poured gently into the dish. Then, the dish was transferred to an incubator at 37° C. in 5% CO₂ and incubated for 2 to 3 days. After incubation, using fluorescence microscopy (IX-71, Olympus PROMARKETING, INC., JPN), transfectants were observed, based on their expression of enhanced fluorescent proteins (EFP, EGFP and DsRed2). Phase contrast images were taken with the same microscope. In both protocols, cells were fixed by using a paraformaldehyde (PFA) fixation method (4% PFA in PBS, treatment time was 10 minutes at room temperature).

(Laser Scanning and Fluorescence Intensity Quantification)

In order to quantify the transfection efficiency, we used a DNA microarray scanner (GeneTAC UC4×4, Genomic Solutions Inc., MI). The total fluorescence intensity (arbitrary units) was measured, and thereafter, the fluorescence intensity per surface area was calculated.

(Results)

(Fibronectin-Supported Localized Transfection)

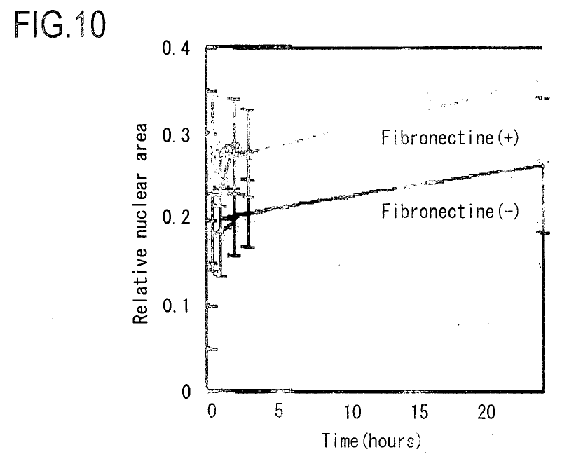

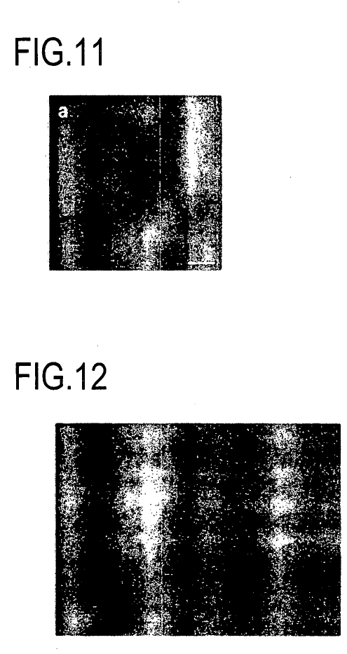

A transfection array chip was constructed as shown in FIG. 11. The transfection array chip was constructed by microprinting a cell cultivation medium solution containing fibronectin and DNA/transfection reagent onto a poly L lysine (PLL) coated glass slide.

Various cells were used for this example. The cells were cultivated under typical cell culture conditions. As they adhered to the glass slide, the cells efficiently incorporated and expressed the genes corresponding to the DNA printed at a given position on the array. As compared to conventional transfection methods (e.g., cationic lipid or cationic polymer-mediated transfection), the efficiency of transfection using the method of the present invention was high in all the cells tested. Importantly, it was found that tissue stem cells, such as HepG2 and hMSC, which were conventionally believed to resist transfection, were efficiently transfected. hMSC was transfected with an efficiency 40 or more times higher than that of conventional techniques. In addition, high spatial localization, which is required for high-density arrays, was achieved (low cross contamination between adjacent spots on the array). This was confirmed by production of a checkered pattern array of EGFP and Ds-Red. hMSC cultivated on this array expressed the corresponding fluorescent proteins with virtually total space resolution. The result is shown in FIG. 12. As shown in FIG. 12, it was found that there was little cross contamination. Based on the study of the role of the individual components of the printed mixture, transfection efficiency can be optimized.

(Solid-Phase Transfection Array of Human Mesenchymal Stem Cells)

The capacity of human Mesenchymal Stem Cells (hMSC) to differentiate into various kinds of cells is particularly intriguing in studies which target tissue regeneration and renewal. In particular, the genetic analysis of transformation of these cells has attracted attention with expectation of understanding the factor controlling the pluripotency of hMSC. In conventional hMSC studies, it is not possible to perform transfection with desired genetic materials.

(Solid-Phase Transfection Array of Human Mesenchymal Stem Cells)

The capacity of human Mesenchymal Stem Cells (hMSC) to differentiate into various kinds of cells is particularly intriguing for studies which target tissue regeneration and renewal. In particular, the genetic analysis of transformation of these cells has attracted attention with the expectation to understand the factor that controls the pluripotency of hMSC. In conventional hMSC studies, it is not possible to perform transfection with desired genetic materials.

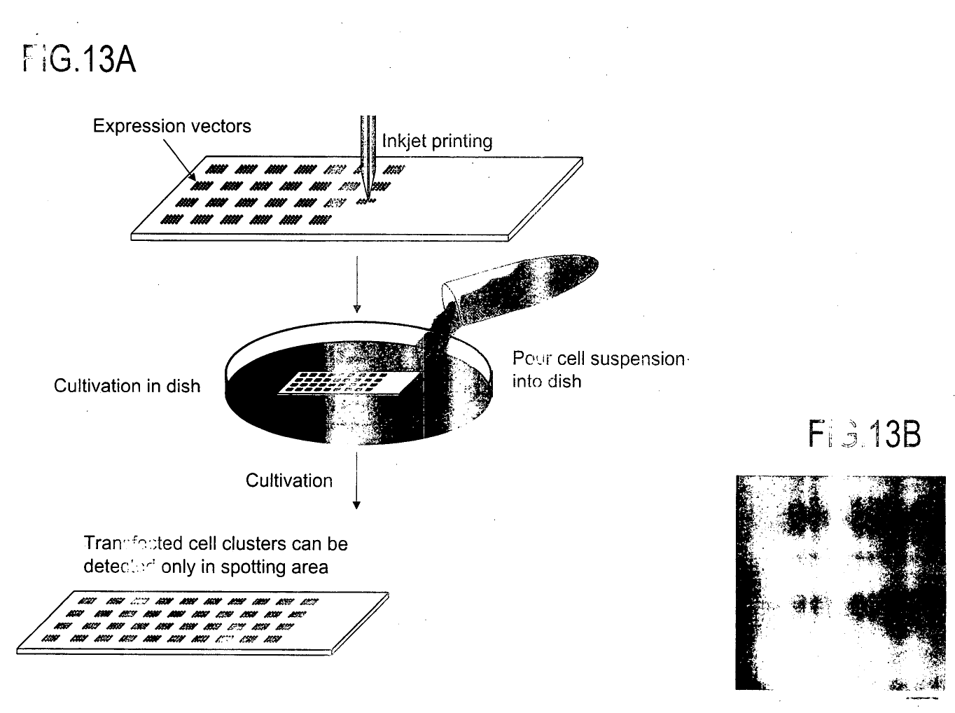

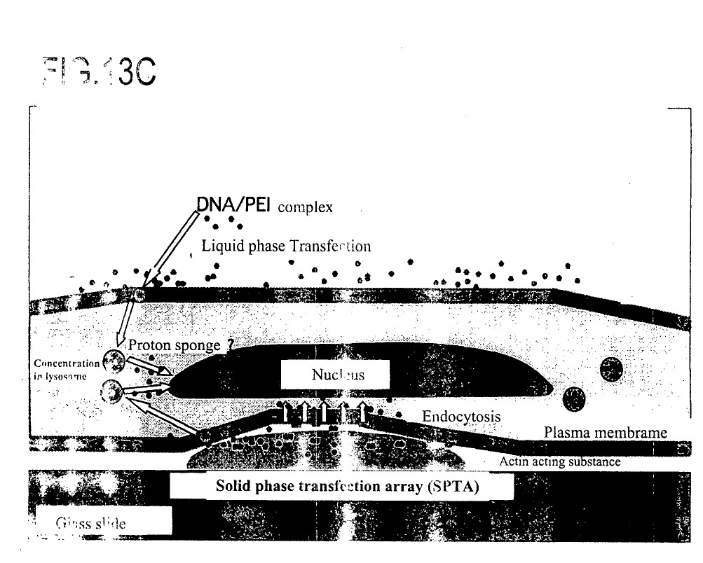

To achieve this, conventional methods include either a viral vector technique or electroporation. The present inventors developed a complex-salt system, which could be used to achieve solid phase transfection which makes it possible to obtain high transfection efficiency to various cell lines (including hMSC) and special localization in high-density arrays. An outline of solid phase transfection is shown in FIG. 13A.

It was demonstrated that solid phase transfection can be used to achieve a “transfection patch” capable of being used for in vivo gene delivery and a solid phase transfection array (SPTA) for high-throughput genetic function research on hMSC.

Although a number of standard techniques are available for transfecting mammalian cells, it is known that it is inconvenient and difficult to introduce genetic material into hMSC as compared with cell lines, such as HEK293, HeLa, and the like. Conventional viral vector delivery and electroporation techniques are each important. However, these techniques have the following inconveniences: potential toxicity (for the virus technique); difficulty in high-throughput analysis at the genomic scale; and limited applications in in vivo studies (for electroporation).

The present inventors developed a phase support system that can be easily fixed to a solid phase support and has sustained release capability and cell affinity, whereby most of the above-described drawbacks could be overcome.

An example of the results of the above-described experiment is shown in FIG. 13B. The present inventors used our microprinting technique to fix a mixture of a selected genetic material, a transfection reagent, an appropriate cell adhesion molecule, and a salt onto a solid support. By culturing cells on a support having such a mixture fixed thereonto, the gene contained in the mixture was allowed to be taken in by the cultured cells. As a result, it became possible to allow support-adherent cells to take in DNA spatially separated therefrom (FIG. 13B).

As a result of this example, several important effects were achieved: high transfection efficiency (thereby making it possible to study a group of cells having a statistically significant scale); low cross contamination between regions having different DNA molecules (thereby making it possible to study the effects of different genes separately); the extended survival of transfected cells; high-throughput, compatible and simple detecting procedure. SPTA having these features serves as an appropriate basis for further studies.

To achieve the above-described objects, the present inventors studied five different cell lines (HEK293, HeLa, NIH3T3, HepG2 and HMSC) as described above with both our methodology (transfection in a solid phase system)(see FIGS. 13A and 13C) and conventional liquid-phase transfection under a series of transfection conditions. Cross contamination was evaluated for both systems as follows. In the case of SPTA, we printed DNA's encoding a red fluorescent protein (RFP) and a green fluorescent protein (GFP) on glass supports in a checked pattern. In the case of experiments including conventional liquid phase transfection (where cells to be transfected cannot be spatially separated from each other spontaneously), a DNA encoding GFP was used. Several transfection reagents were evaluated: four liquid transfection reagents (Effectene, TransFast™, Tfx™-20, LipofectAMINE 2000), two polyamine (SuperFect, PolyFect), and two polyimine (JetPEI (×4) and ExGen 500).

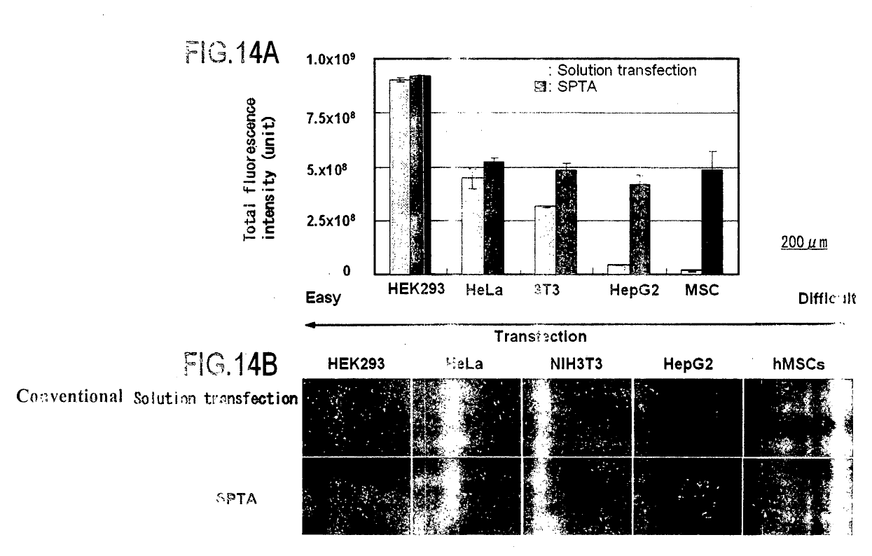

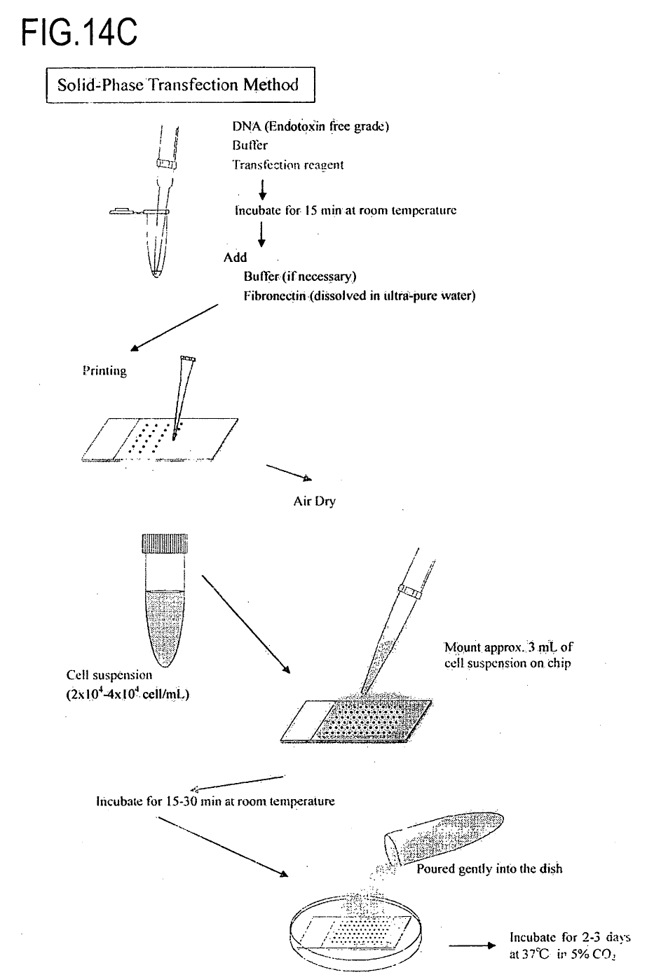

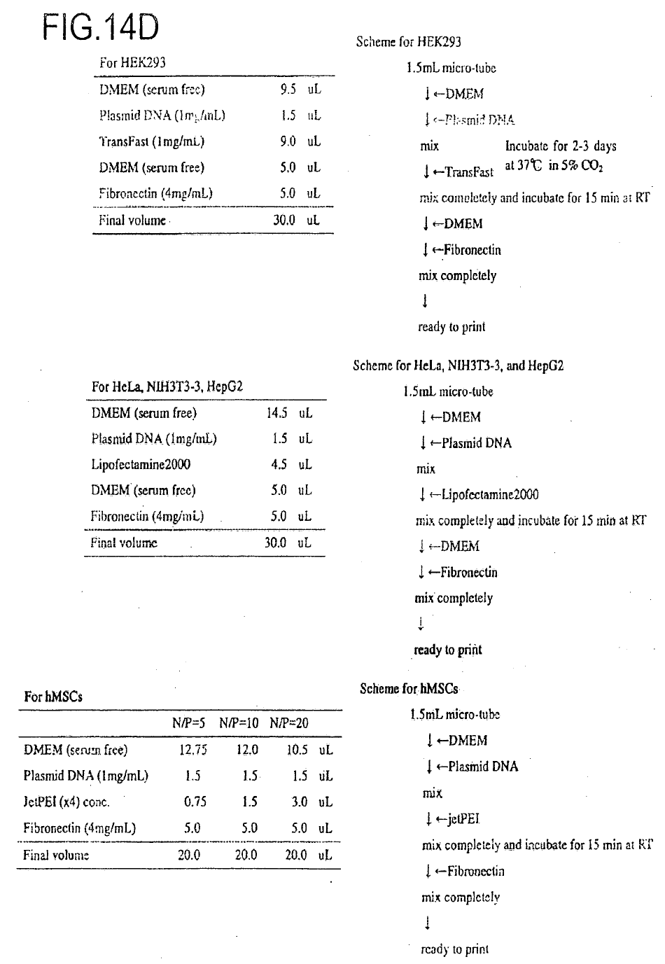

Transfection efficiency: transfection efficiency was determined as total fluorescence intensity per unit area (FIG. 14A and FIG. 14B (images)). The optimal results for liquid phase transfection were obtained using different transfection reagents (see FIGS. 14C to 14D). Next, these efficient transfection reagents were used to optimize a solid phase protocol. Several tendencies were observed. For cell lines which are readily transfectable (e.g., HEK293, HeLa, NIH3T3, etc.), the transfection efficiency observed in the solid phase protocol was slightly superior to, but essentially similar to, that of the standard liquid phase protocol (FIG. 14A to 14D).

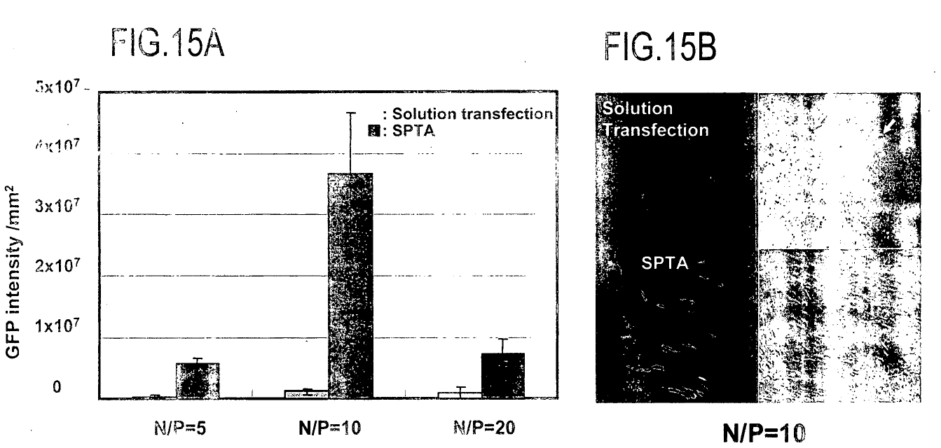

However, for cells known to be difficult to transfect (e.g., hMSC, HepG2, etc.), we observed that transfection efficiency was increased up to 40 fold while retaining the features of the cells under conditions optimized from the SPTA methodology (see the above-described protocol and FIGS. 14C and 14D). In the case of hMSC (FIGS. 15A and 15B), the best conditions included the use of a polyethylene imine (PEI) transfection reagent. As expected, important factors for achieving high transfection efficiency are the charge balance (N/P ratio) between the number of nitrogen atoms (N) in the polymer and the number of phosphate residues (P) in plasmid DNA and DNA concentration. Generally, increases in the N/P ratio and the concentration lead to an increase in transfection efficiency. We also observed a significant reduction in the survival rate of hMSC cells in liquid phase transfection experiments when both the DNA concentration and the N/P ratio were high. Because of these two opposing factors, the liquid phase transfection of hMSC had a relatively low cell survival rate (N/P ratio>10). In the case of the SPTA protocol, however, a considerably high N/P ratio (fixed to the solid support) and DNA concentration were tolerable (probably attributed to the effect of the solid support on cell membrane stability) while the cell survival rate and the cellular state were not significantly affected. Therefore, this is probably responsible for the dramatic improvement in transfection efficiency. It was found that the N/P ratio of 10 was optimal for SPTA, and a sufficient transfection level was provided while minimizing-cytotoxcity. Another reason for the increase in transfection efficiency observed in the case of the SPTA protocol is that a high local ratio of the DNA concentration to the transfection reagent concentration was achieved (this leads to cell death in liquid phase transfection experiments).

A coating agent used is crucial for the achievement of high transfection efficiency on chips. It was found that when a glass chip is used, PLL provided best results both for transfection efficiency and cross contamination (described below). When fibronectin coating was not used, few transfectants were observed (all the other experimental conditions remained unchanged). Although not completely established, fibronectin probably plays a role in accelerating cell adhesion process (data not shown), and thus, limiting the time which permits the diffusion of DNA released from the surface.

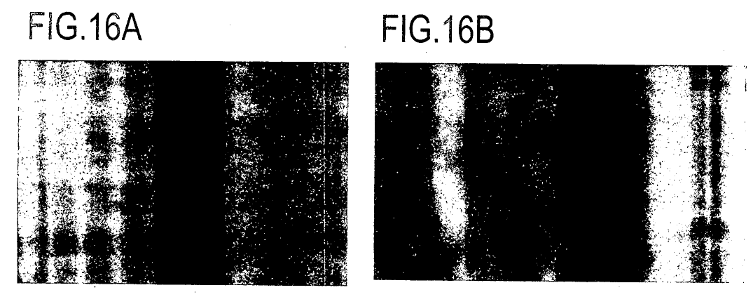

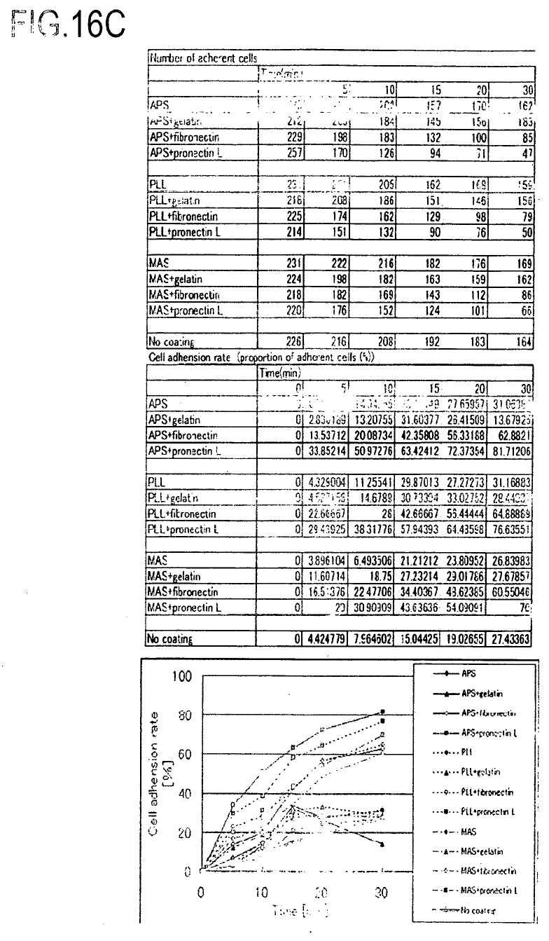

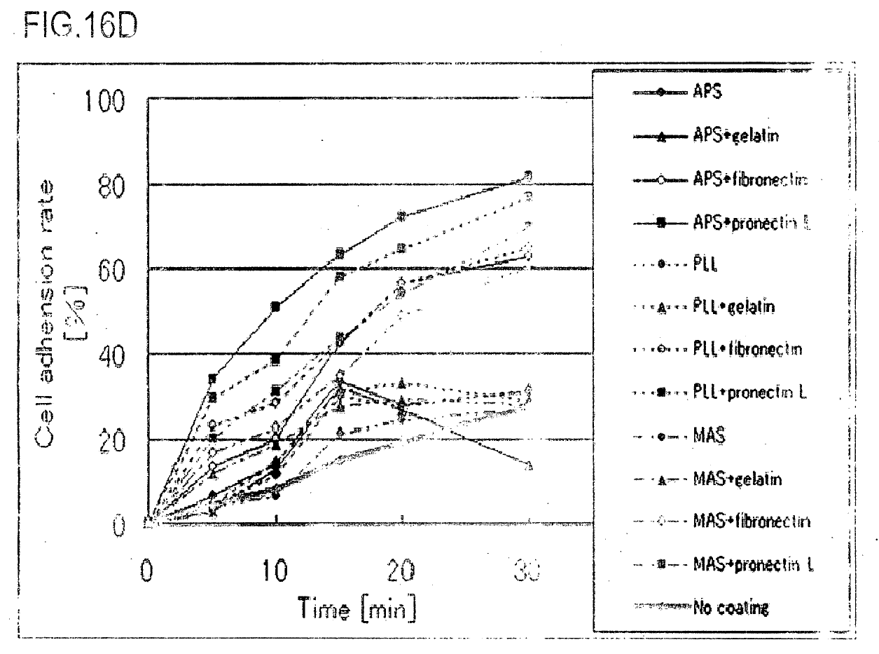

Low cross contamination: apart from the higher transfection efficiency observed in the SPTA protocol, an important advantage of the technique of the present invention is to achieve an array of separated cells, in which selected genes are expressed in the separate positions. The present inventors printed JetPEI (see the “Experimental protocols” section) and two different reporter genes (RFP and GFP) mixed with fibronectin on glass surface coated with fibronectin. The resultant transfection chip was subjected to appropriate cell culture. Expressed GFP and RFP were localized in regions, in which corresponding cDNA had been spotted, under experimental conditions which had been found to be best. Substantially no cross contamination was observed (FIGS. 16A to 16D). In the absence of fibronectin or PLL, however, cross contamination which hinders solid phase transfection was observed, and the transfection efficiency was significantly lower (see FIG. 6). This result demonstrated the hypothesis that the relative proportion of plasmid DNA, released from the cell adhesion and the support surface, is a factor important for high transfection efficiency and high cross contamination.

Another cause of cross contamination may be the mobility of transfected cells on a solid support. The present inventors measured both the rate of cell adhesion (FIG. 16C) and the diffusion rate of plasmid DNA on several supports. As a result, substantially no DNA diffusion occurred under optimum conditions. However, a considerably amount of plasmid DNA were diffused under high cross contamination conditions until cell adhesion was completed, so that plasmid DNA was depleted from the solid phase surface.

This established technique is of particular importance in the context of cost-effective high-throughput gene function screening. Indeed, the small amounts of transfection reagent and DNA required, as well as the possible automatization of the entire process (from plasmid isolation to detection) increase the utility of the above presented method.

In conclusion, the present invention successfully realized an hMSC transfection array in a system using complex-salt. With this technique, it will be possible to achieve high-throughput studies using the solid phase transfection, such as the elucidation of the genetic mechanism for differentiation of pluripotent stem cells. The detailed mechanism of the solid phase transfection as well as methodologies for the use of this technology for high throughput, real time gene expression monitoring can be applied for various purposes.

### Example 4

### Mathematical Analysis

Next, time-lapse profiles were produced based on data obtained using the techniques described in Examples 2 and 3.

(Induction of Differentiation)

Each reporter was fixed to a solid phase support and cultured in undifferentiated mesenchymal stem cell maintenance medium (MSCGM, PT-3001, PT-3238, PT-4105, Cambrex, BioWhittaker, USA) for two days. Thereafter, the medium was replaced with differentiation inducing medium (hMSC Differentiation, PT-3002, PT-4120, Cambrex, BioWhittaker, USA). The response profile of each reporter was measured.

(Mathematical Analysis Technique)

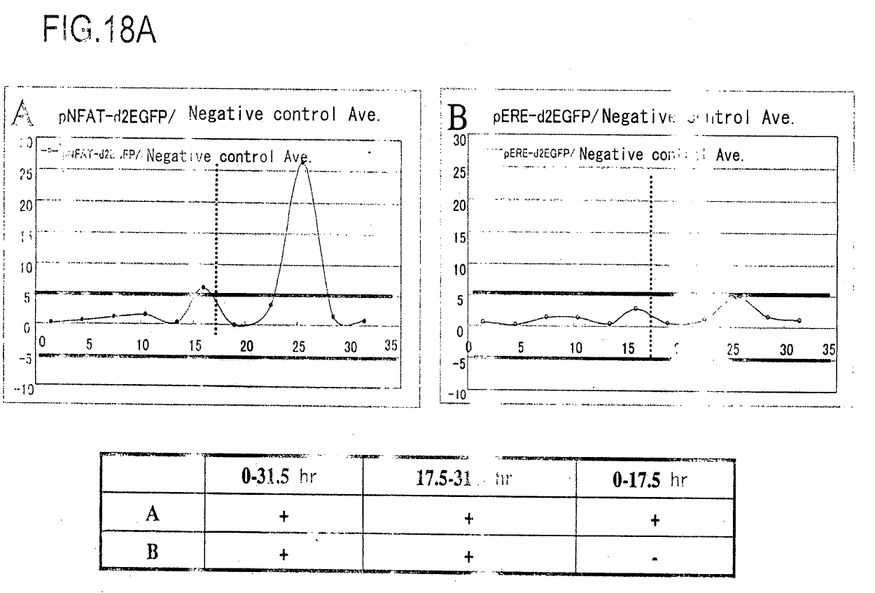

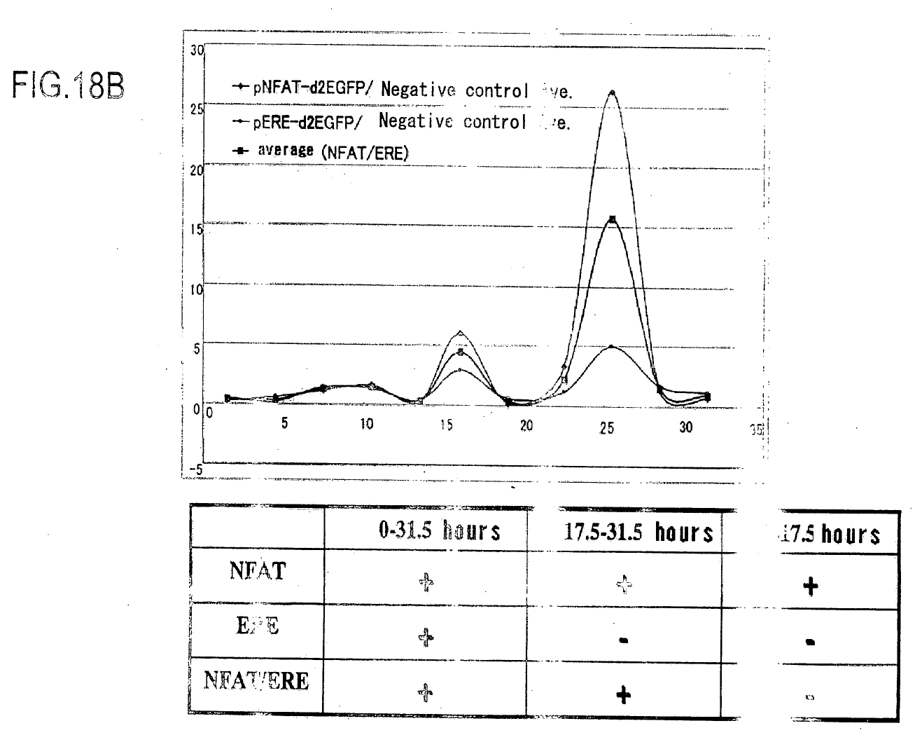

A mathematical analysis technique used herein is shown in FIGS. 18A and 18B (18-1 to 18-2).

(Transcription Factors Used Herein)

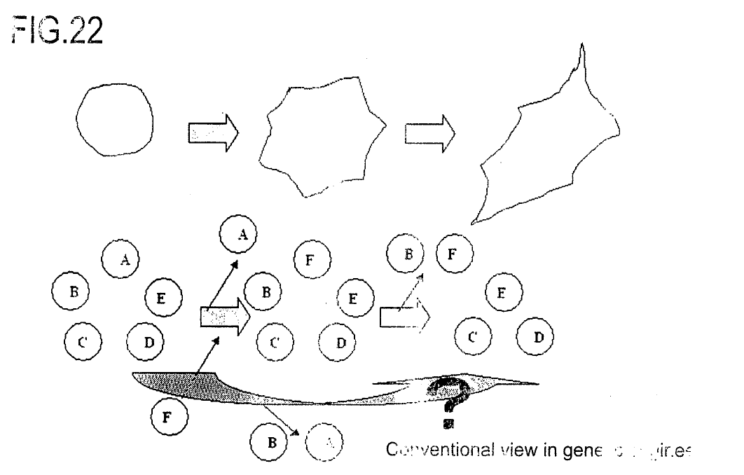

As shown in FIGS. 19 and 24, plasmids (commercially available from Clontech), in which 17 transcription factors (ISRE, RARE, STAT3, GAS, NFAT, MIC, AP1, SRE, GRE, CRE, NFκB, ERE, TRE, E2F, Rb, p53) were operably linked to GFP, were used to observe the differentiation of mesenchymal stem cells into osteoblasts. The resultant time-lapse profiles are shown in FIG. 19. Reporters for the transcription factors were constructed as shown in FIG. 23.

An assay was conducted using the transcription factor reporters under control conditions (cells, supplement factors, culture conditions, etc.) published by Clontech.

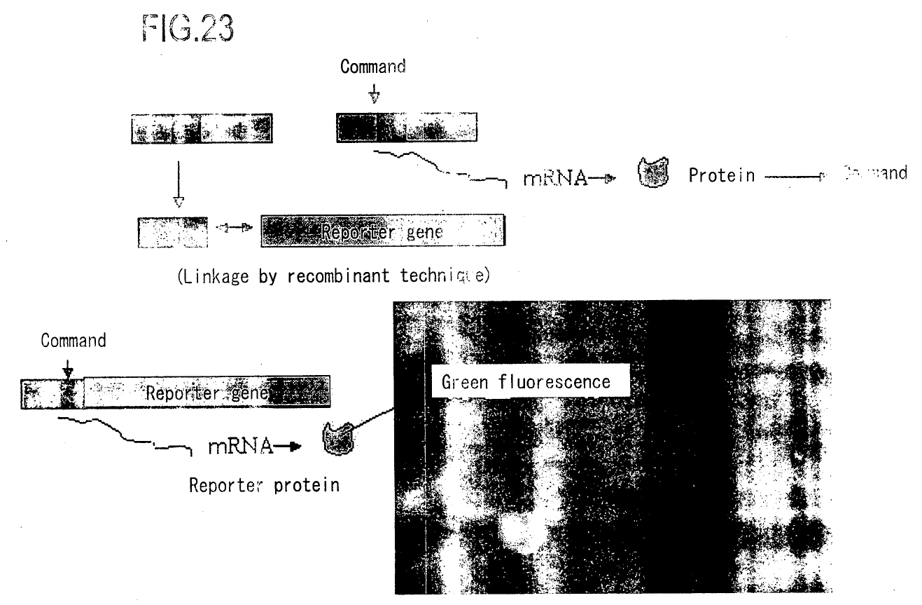

The results are shown in FIG. 25. It was demonstrated that when compared only to DNA in this manner, most of the transcription factors were induced when inducing agents were added.

Next, the activity of the transcription factors was measured over time in the course of bone differentiation induction. In this case, time-lapse profiles, which were obtained in the induction of differentiation under the above-described conditions, were compared with each other. The time-lapse profiles were obtained as follows. Each reporter gene was introduced into mesenchymal stem cells by a solid phase transfection method. The cells were cultured in undifferentiated state maintenance medium for two days. Thereafter, the medium was replaced with osteoblast differentiation medium. This time point was referred to as osteoblast differentiation start time. Supplement factors were added at concentrations recommended for the osteoblast differentiation medium. The other culture conditions were in accordance with Cambrex's instructions.

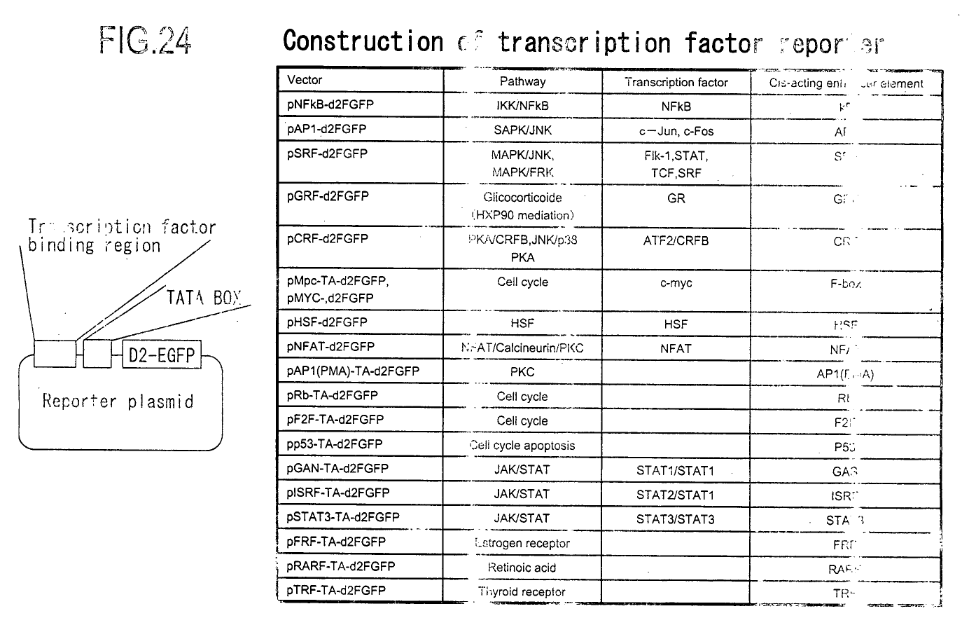

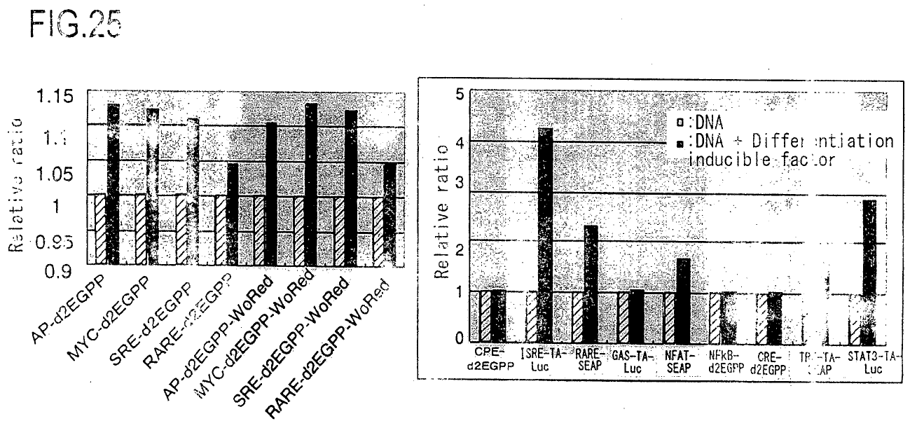

The results are shown in FIG. 26. The profile pattern on the left of FIG. 26 was obtained 10 hours to 30 hours after replacement of the medium. The profile pattern on the right of FIG. 26 was obtained 5 to 6 days after replacement of the medium. Thus, it was demonstrated that the pattern significantly changed over time. The profiles phases were calculated using a formula shown in FIG. 27 and the results were summarized in a table to the right of FIG. 27. As shown, the inversion of the phase of the profile was deeply associated with differentiation for ISRE, RARE, STAT3, GRE, CRE, TRE, E2F, and p53. Therefore, it was demonstrated that by examining the phase, changes in process, i.e., the occurrence of transcription control, could be detected.

(Arbitrary Combination of Reporters)

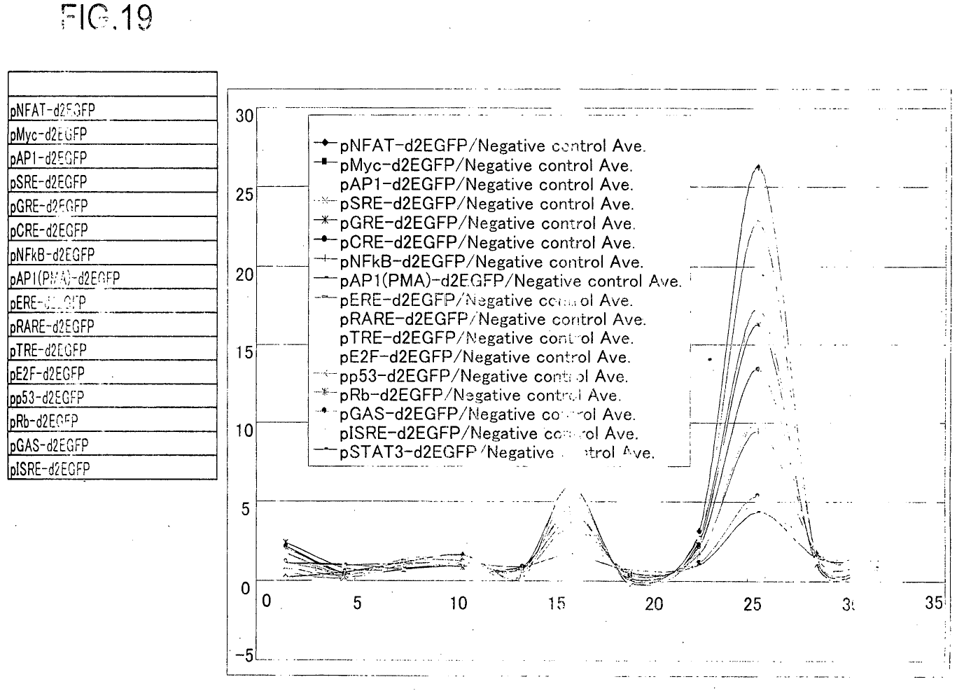

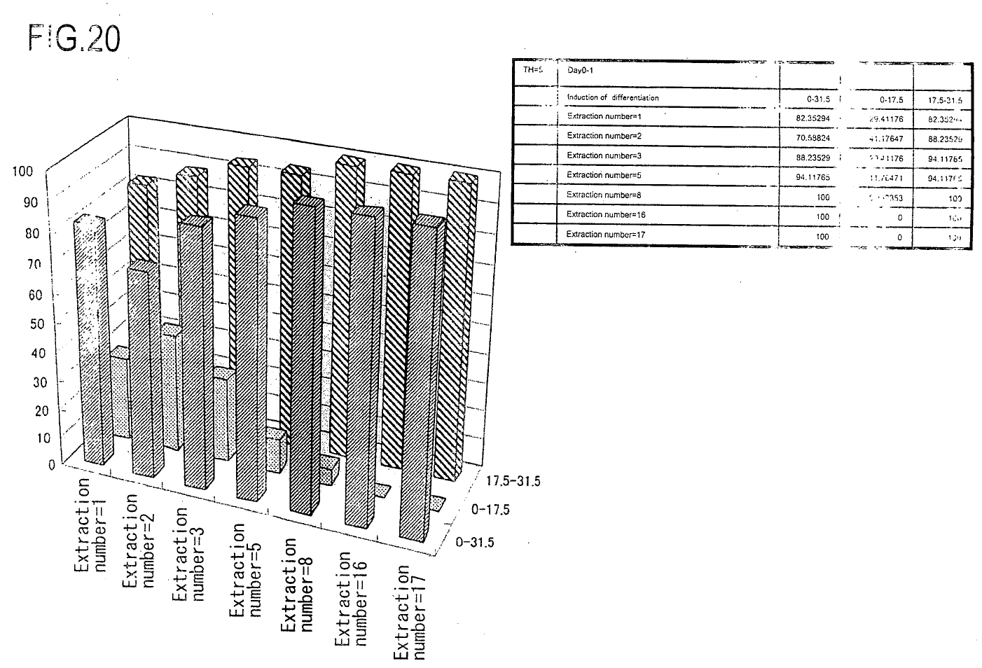

Next, it was demonstrated that differentiation could be identified using an arbitrary combination of promoters for which data was extracted at the initial stage of induction of differentiation. Briefly, the analysis was conducted as shown in FIG. 20.

The results are shown in FIG. 20. This analysis revealed that although differentiation could not be detected at its very initial stage (potentially due to noise), but could be confirmed about 15 hours after induction of differentiation. In this example, when data was extracted for 8 or more promoters, differentiation could be detected at a detection rate of 100%. When data was extracted for 3 promoters, differentiation could be detected at a detection rate of more than 90%. When data was extracted for two promoters, differentiation could be detected at a detection rate of 88%. When data was extracted for one promoter, differentiation could be detected at a detection rate of 82%. Thus, it was revealed that one, two or at least three promoters are sufficient for the determination or identification of cell states.

(Maintenance of Undifferentiated State)

Next, the maintenance of undifferentiated state was analyzed using an arbitrary combination of transcription control sequences for which data was extracted. Analysis was conducted as described in FIG. 20.

The results are shown in FIG. 21. As it is largely different from the results of induction of differentiation, by comparing the profiles of the transcription control sequences with one another, it could be determined whether or not stem cells were induced toward differentiation or remained undifferentiated. Such a determination could be achieved using at least one transcription control sequence. The determination of the state of cells using such a small number of transcription control sequences cannot be achieved by conventional techniques. It can be said that the present invention achieved an excellent effect.

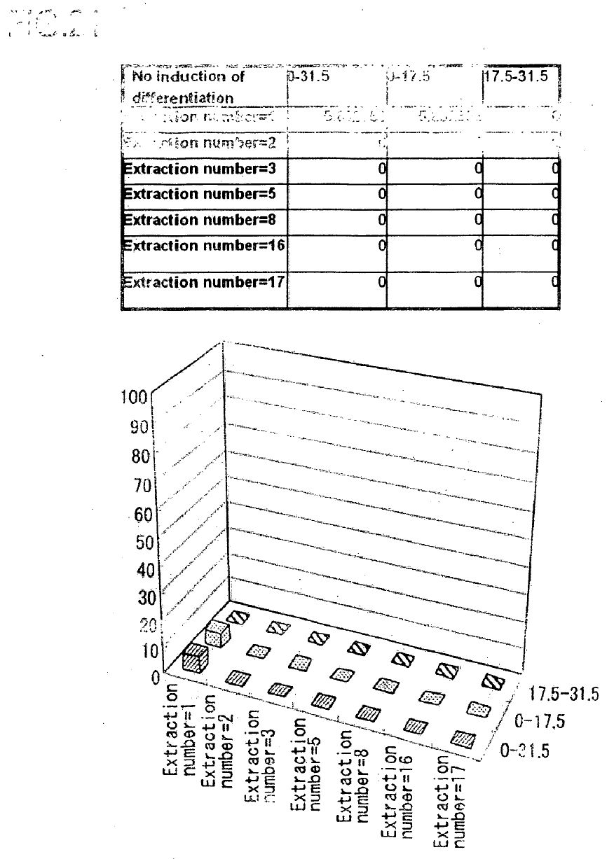

By analyzing a cellular process in such a fashion, the formation of cellular functions can be described as a cocktail party process as shown in FIG. 22. With such a process description, the present invention made it possible to analyze procession of response to drugs and procession of induction of differentiation.

### Example 5

### Anticancer Agent

In this example, cisplatin was used as an exemplary anticancer agent and mixed into medium exposed cells. The concentration of the anticancer agent was selected as appropriate, such as 1 μM, 5 μM, 10 μM, and the like, to observe the reaction of the cells. Cisplatin was applied to cells resistant or sensitive to the anticancer agent. Time-lapse observation was conducted to produce profiles as in the above-described examples. As a result, it was revealed that time-lapse profiles varied depending on the difference in cisplatin concentration and resistance/sensitivity.

### Example 6

### RNAi

The present Example demonstrated that it was possible to obtain a profile relating to gene knockdown effect using an immobilized cell as described in Example 1, RNAi was used as a biological agent. The following was used as RNAi for experimentation. Gene expression inhibition methods using ribozymes, siRNA and the like allow the obtention of a response reaction profile in a cell wherein the gene expression is inhibited.

RNAi: those sequences are available at the URL: http://www.nippongene.jp/pages/products/sirna/review/ were used (for example, Control siRNA duplex).

RNAi Transfection

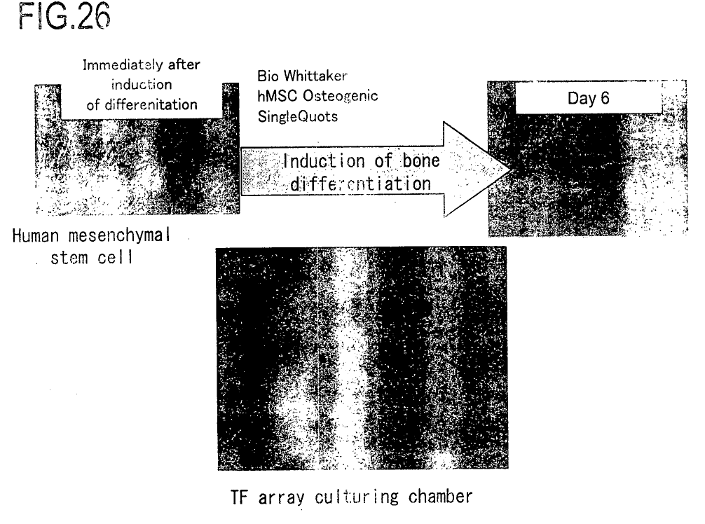

First, it was confirmed whether the siRNA could achieves knockdown effects. Synthesis of siRNA 5′-AAGCAGCAGGACUUCUUCAAG-3′ (SEQ ID NO: 2) corresponding to EGFP was performed to prepare assay substrate as described herein above in the Examples. The preparation of array substrate using the siRNA instead of nucleic acid molecules including promoter sequences was performed. Effective inhibition of expression of the target gene by transfection using these array substrates was then confirmed. The protocols thereof are presented in FIG. 28.

(Results)

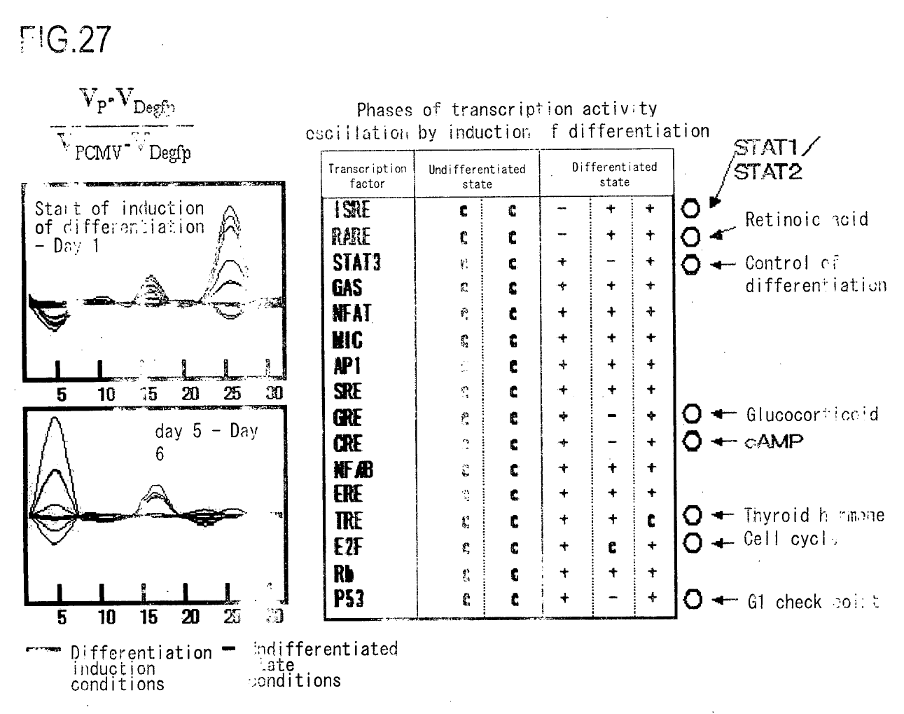

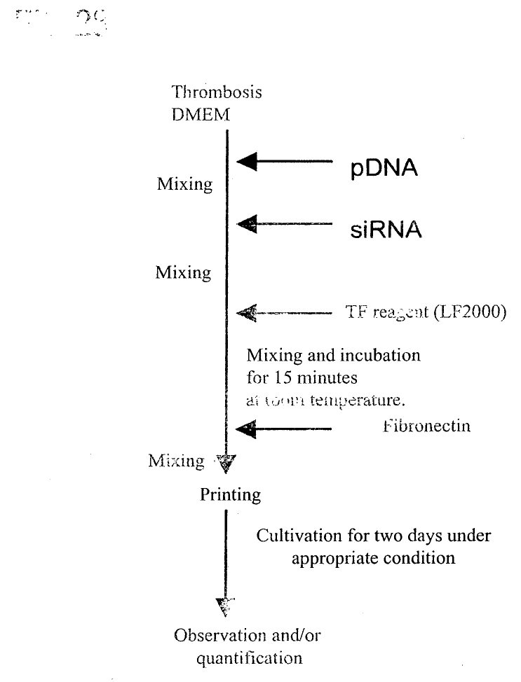

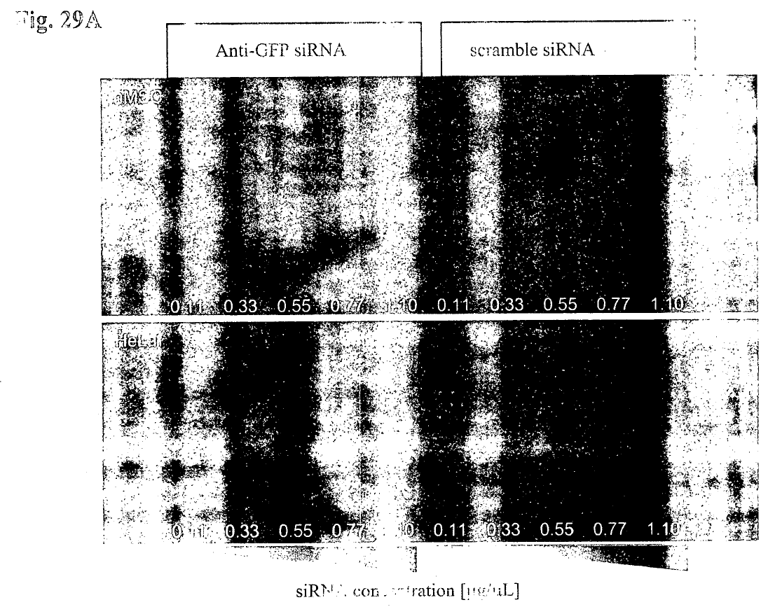

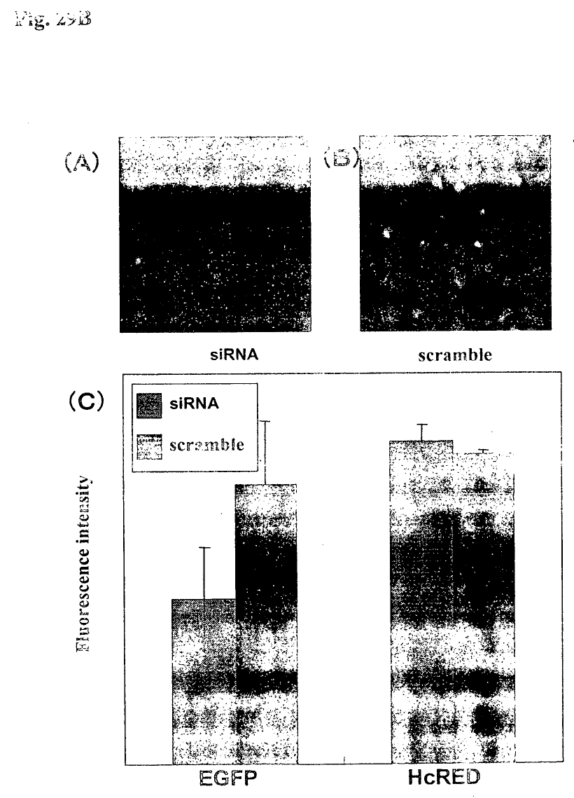

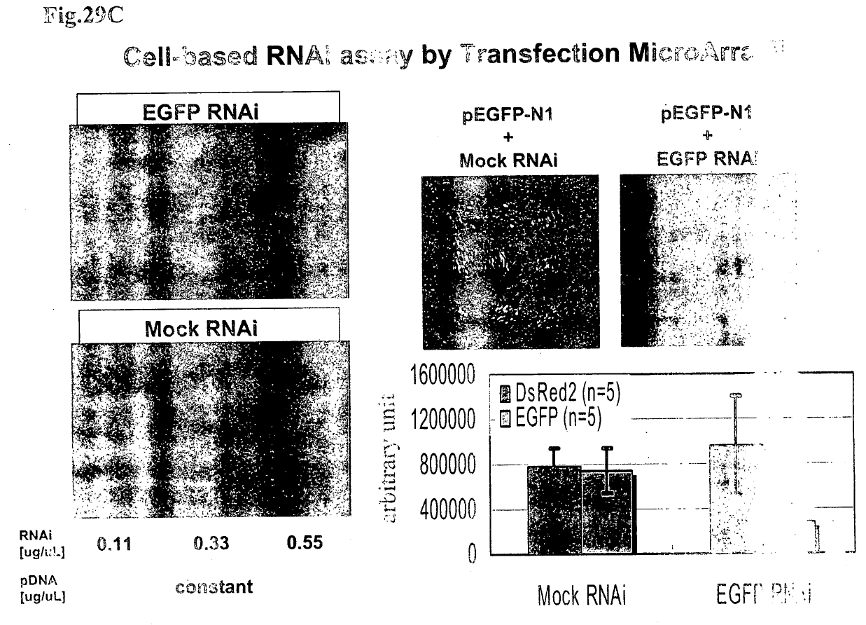

FIG. 29A shows the effects of target gene inhibition by siRNA. Expression of target gene has actually been inhibited. The results using this gel may be stored as a profile in any data format.

Next, results of siRNA are stored as a profile data (image data of TIFF format having resolution level of 5 μm/pixel or less). As such, the results of siRNA may be stored as a profile data. Such a format is not limited to those specifically presented in this Example, but those skilled in the art may employ any type of formats.

(FIG. 9: Applications Using siRNA of Transfection Microarray of PC12 Cells on a Collagen IV Coated Chip)

Next, the present Example depicts a gene expression inhibition experiment using siRNA. The present Example evaluated whether or not the present invention is effective by observing whether or not siRNAs against EGFP can specifically inhibit the expression of the EGFP as an indicator.

Using the conditions described in Example 7, transfection of PC12 was conducted on an array coated with collagen IV. In lieu of the gene used in Example 7, the following conditions were used:

0.75 ng of an expression vector (pEGFP-N1), HcRed (available from BD Clontech) were each spotted on a single spot of the array. Thereafter, 16.5 ng of siRNA (available from Dharmacon, target sequence: 5′-GGC TAC GTC CAG GAG CGC ACC-3′ (SEQ ID NO:47)=a) or scrambled siRNA (available from Dharmacon. target sequence: 5′-gCg CgC TTT gTA ggA TTC g-3′ (SEQ ID NO: 48)=b) were also spotted.

FIG. 29B shows the results. As shown in FIG. 29 B(A), in the case of PC12 cells coexpressing EGFP vector and anti-EGFP siRNA, it was observed that only HcRed was colored, while green signal deriving from pEGFP-N1 was inhibited. On the other hand, as shown in FIG. 29 B(B), in the case of scrambled siRNA, green fluorescence was observed and thus it was confirmed that the effects seen in FIG. 29 B(A) are the result of RNAi. Relative intensities of the fluorescence in FIGS. 29B(A) and 29B(B) are shown in FIG. 29B(C). y-axis is shown with relative luminance. It can be seen that the effect by EGFP is completely inhibited.

FIG. 29C shows results and graph summarizing the above. The left panel shows a photograph comparing an EGFP RNAi and a scrabbled (Mock) RNAi. As shown in the figure, the use of RNAi of EGFP showed inhibitory effect, whereas the use of scrambled RNAi did not show such inhibitory effect. Right panel shows the same together with DsRed2. Experimental conditions were similar to the Examples above. Red (signal derived from DsRed) and green (signal derived from EGFP) were presented in proportion to the effects of RNAi.

FIG. 29D shows an illustrative drawing of a chip using RNAi reporter. When using RNAi as an input signal, and introducing a nucleic acid encoding both a gene product capable of signaling such as EGF and the like and a gene of interest (including a promoter) as an output, observation of the signaling as the output allows one to produce cellular information.

FIG. 29E shows an exemplary experiments using a variety of reporters (pAP1-EGFP, pAP1(PMA)-EGFP, PCRE-EGFP, pE2F-EGFP, pERE-EGFP, pGAS-EGFP, PGRE-EGFP, pHSE-EGFP, pISRE-EGFP, pMyc-EGFP, pNFAT-EGFP, pNFkB-EGFP, pRARE-EGFP, pRb-EGFP, pSTST3-EGFP, pSRE-EGFP, PTRE-EGFP, pp 53-EGFP, pCREB-sensor, pIkB-sensor, pp 53-sensor, pCasapase3-sensor; cis-element sequence was commercially available from Clontech; these are plasmid vectors produced by recombing a fluorescent protein gene). As such, the system of the present invention will function regardless of the reporter types used.

### Example 8

### Regulation of Gene Expression Using Tetracycline-Dependent Promoter

As described in the Examples 1-3, it was demonstrated that a tetracycline-dependent promoter can be used to produce a profile showing how gene expression is regulated. The sequences described below were used.

As the tetracycline-dependent promoter (and its gene vector construct), pTet-Off and pTet-On vectors (BD Biosciences) were used (see http://www.clontech.com/techinfo/vectors/cattet.shtml). As a vector, pTRE-d2EGFP was used (see http://www.clontech.com/techinfo/vectors/vectorsT-Z/pTRE-d2EGFP.shtml).

(Protocol)

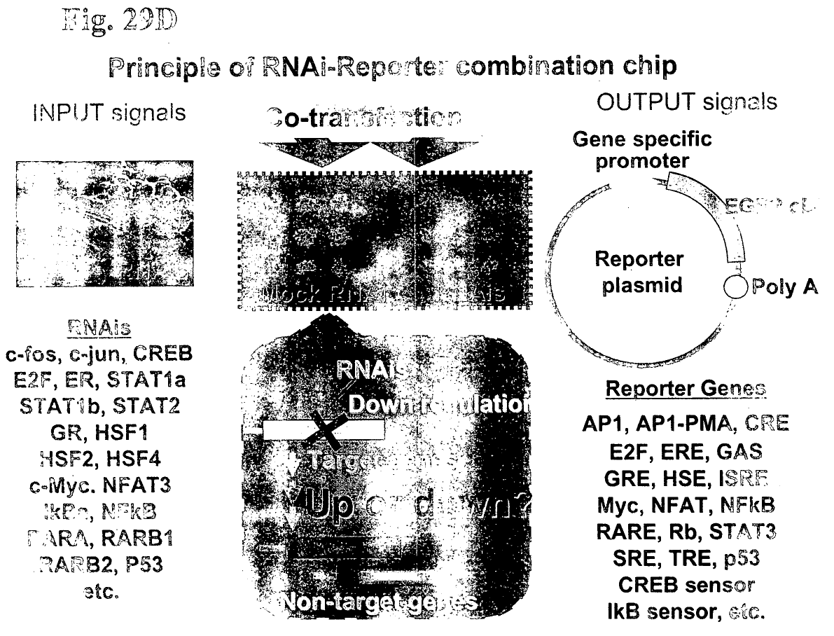

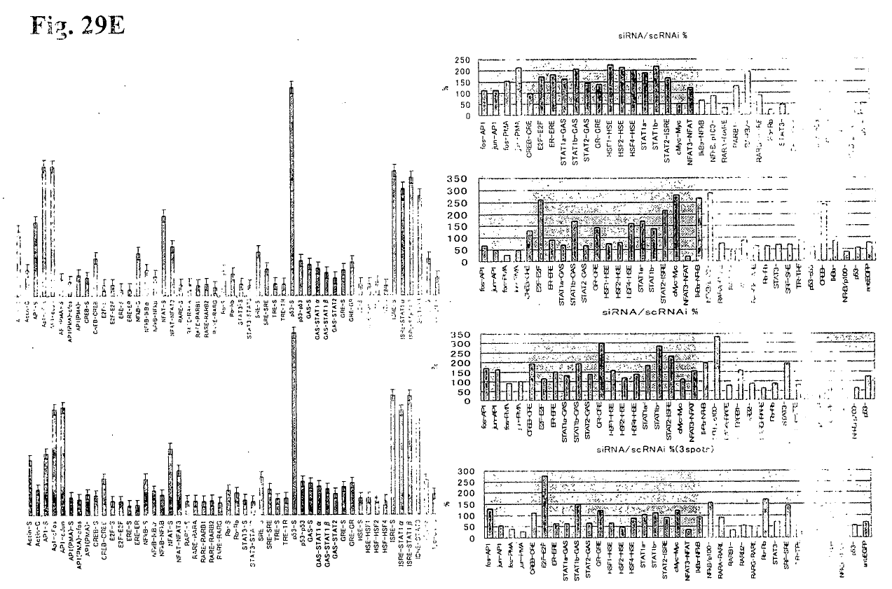

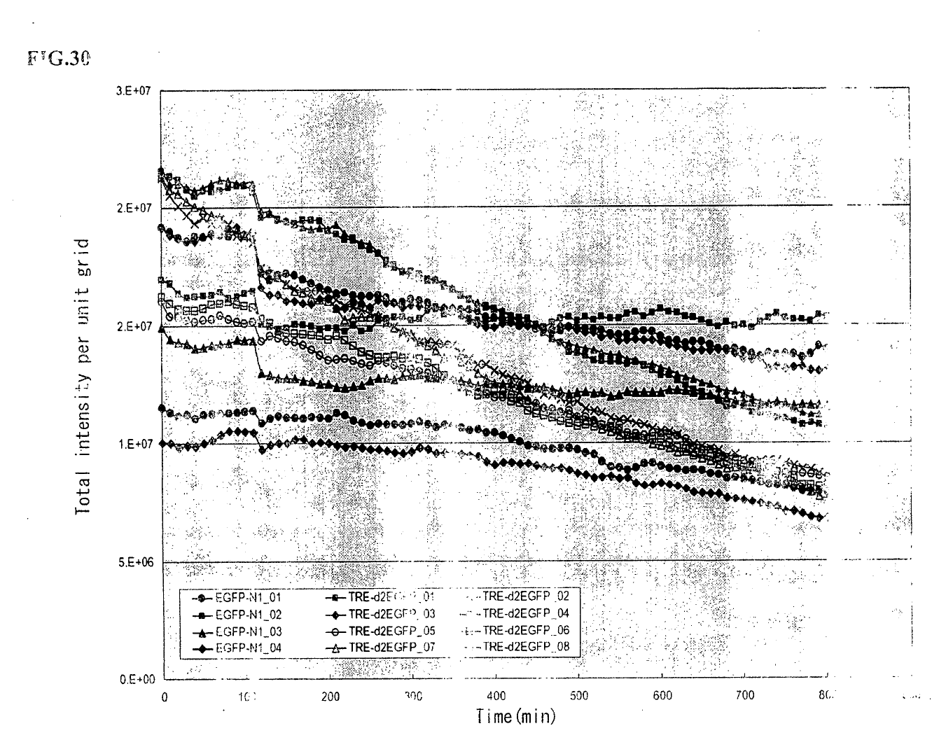

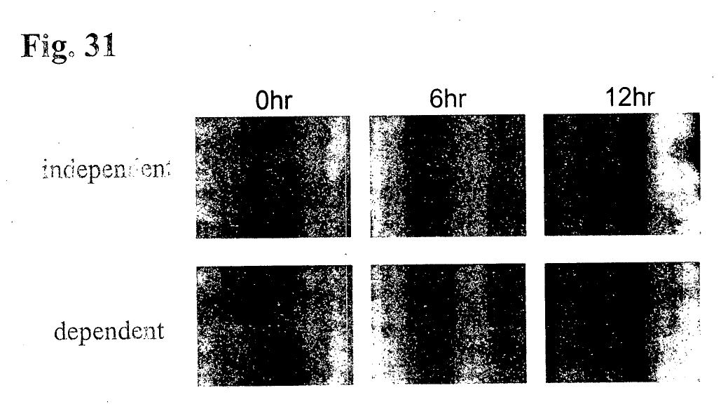

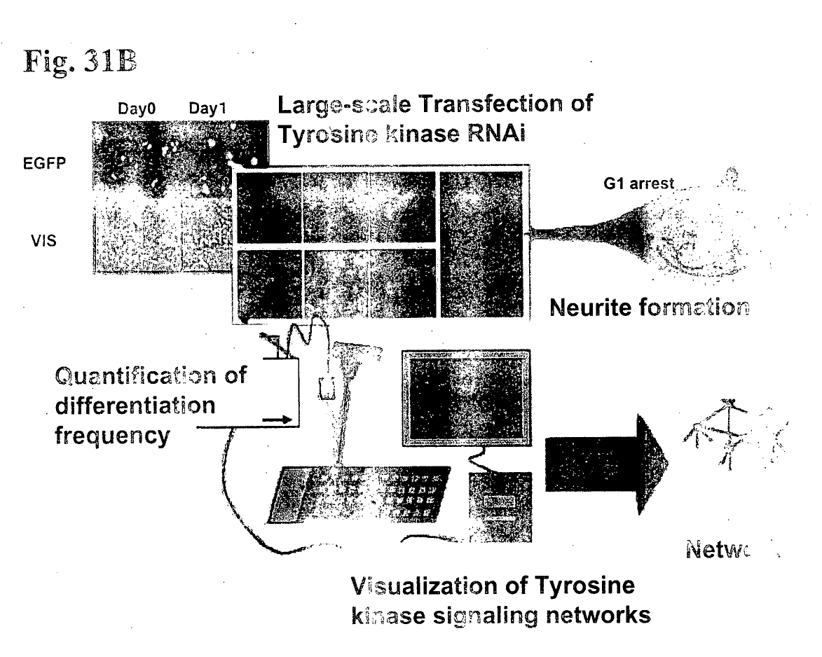

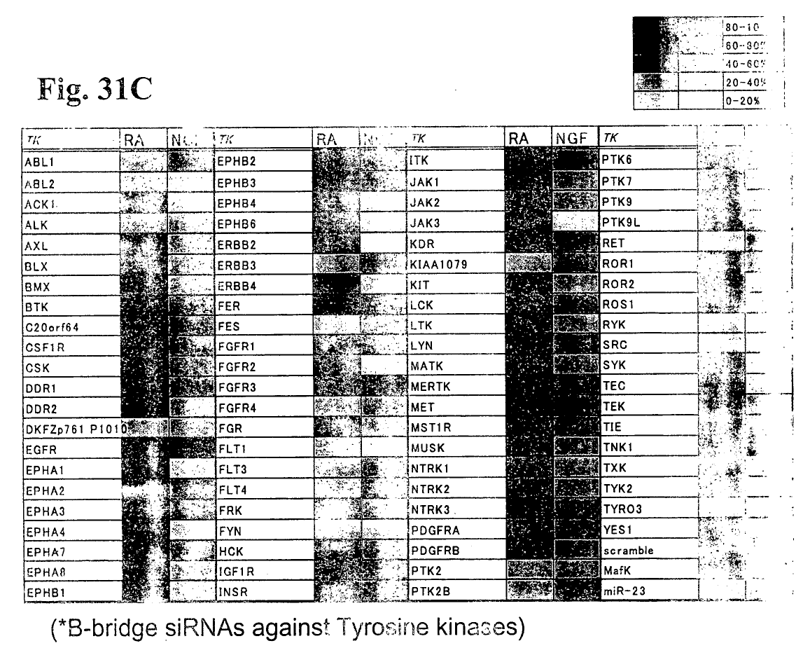

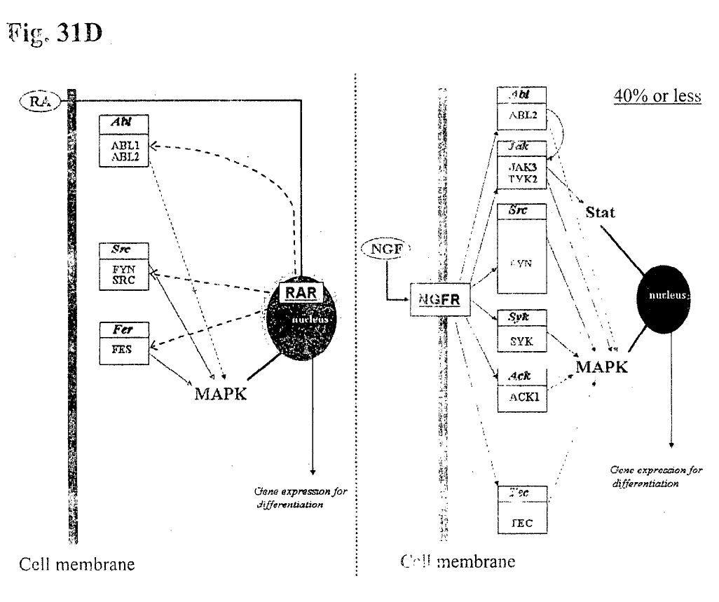

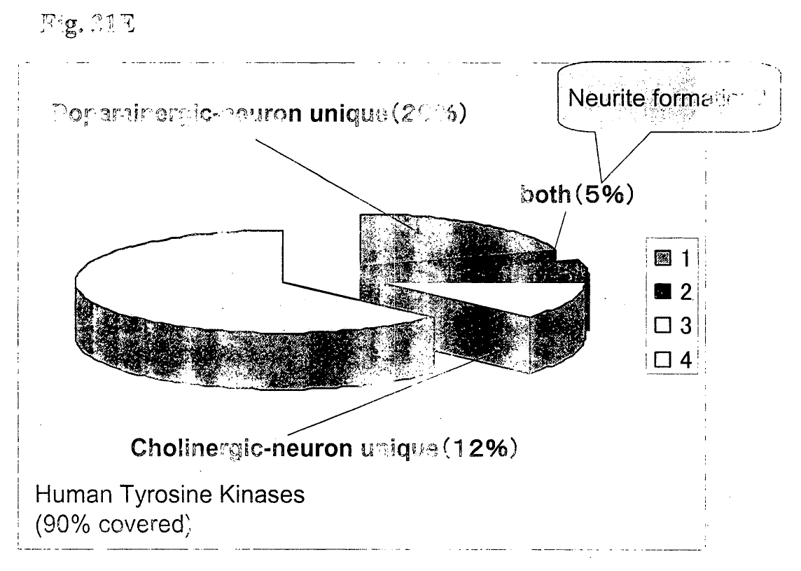

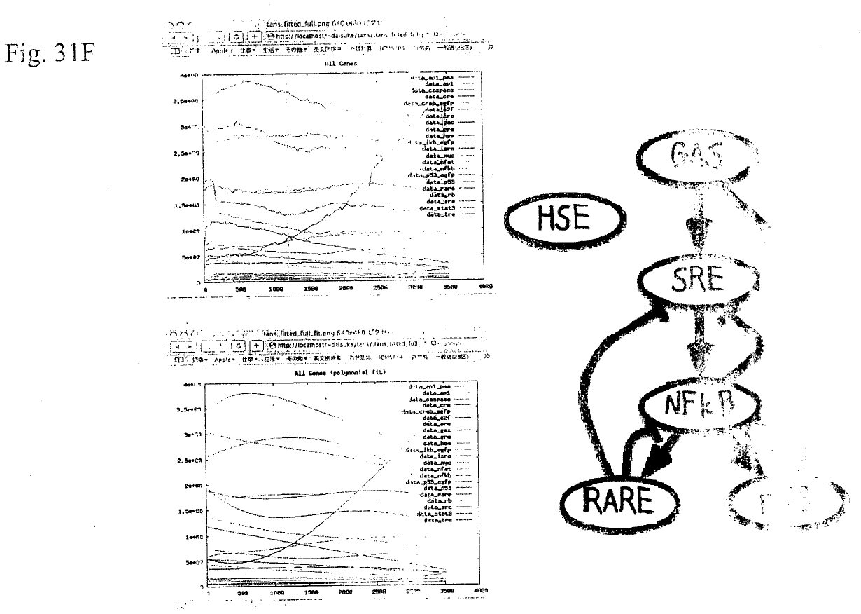

pTet-Off and pTet-On (SEQ ID NOS.: 26 and 27, respectively) were printed onto array substrates. Real time measurement was performed on the array substrates to determine whether or not tetracycline regulates gene expression. The results are shown in FIG. 30. As shown in FIG. 30, a change in gene expression was detected only for the tetracycline-dependent promoter. FIG. 31 is a photograph showing the actual states of expression for the tetracycline-dependent promoter and the tetracycline-independent promoter. As shown, the difference between these two states is measurable by the naked eye.

(Measurement of Profile Data)

Images were taken in real time. Changes in intensity per cell or area were plotted on a graph. The resultant data may be subjected to linear transformation, such as noise reduction, and then multivariate analysis, signal processing, or the like, to obtain profile data. The resultant data is compared between phenomena or cells, thereby making it possible to obtain response or identity specific to cells.

### Example 9

### Gene Expression

Next, nucleic acid molecules encoding structural genes were used to produce cellular profiles. In this example, an olfactory receptor 17 (SEQ ID NOS: 13, 14) was used as a structural gene. The protocol used in Examples 1-3 was used.

As a result, as with promoters, it was demonstrated that cellular profiles could be produced by measuring gene production or the like.

### Example 10

### Apoptotic Signals

Next, it was investigated that cellular profiles could be produced by monitoring the activation of caspase 3 present within cells. Transfection and array preparation were performed as in the above-described examples.

pCaspase3-Sensor Vector (BD Biosciences Clontech, 1020 East Meadow Circle, Palo Alto, Calif. 94303; cat. No. 8185-1) was used to monitor an apoptotic signal from caspase 3.

As a result, as with promoters, it was demonstrated that cellular profiles could be produced by measuring apoptotic signals or the like.

### Example 11

### Stress Signal

Next, it was investigated whether cellular profiles concerning stress signals from JNK, ERK, p38 or the like could be produced using transcription factor reporters. Transfection and array preparation were performed as in the above-described examples.

pAP1-EGFP, pCRE-EGFP, and pSRE-EGFP available from BD Bioscience Clontech were used to monitor stress signals from JNK, ERK, and p38.

As a result, as in the above-described examples, it was demonstrated that cellular profiles could be produced by measuring stress signals.

### Example 12

### Localization of Molecules

Next, it was demonstrated that a gene of interest could be fused with a fluorescent protein so that the expression profile of the gene and the localization within cells of the gene could be visualized.

GFP, RFP, CFP and BFP, were used as fluorescent proteins and cloned KIAA cDNA libraries or the like were used as genes of interest to produce gene constructs. These materials are specifically described below:

cloned KIAA cDNA (KIAA=Kazusa DNA Research Institute, Kazusa, Chiba, Japan); and

cDNA libraries commercially available from Invitrogen.

Transfection and array preparation were performed as in the above-described examples.

The expression of cloned KIAA, KIAA1474, was monitored to produce an expression profile and to investigate the localization of the expression.

As a result, as in the above-described examples, it was demonstrated that intentionally constructed gene constructs could be used to produce cellular profiles to target specific characteristics.

### Example 13

### Changes in Cellular Morphology

Next, it was demonstrated that cellular profiles concerning cellular morphology could be produced by expressing or knocking out genes or adding substances (glycerophosphate as a chemical substance and dexamethasone as a cytokine). Cellular morphology, such as multinucleated cells, cellular outgrowth, outgrowth projections, and the like, was measured and analyzed as three-dimensional data.

The specific sequences of the introduced nucleic acid molecules are described below:

Cloned KIAA (supra); and

RNAi for transcription factors (CBFA-1, AP1).

Transfection and array preparation were performed as in the above-described examples.

Mesenchymal stem cells as used in the above-described examples were used to monitor the morphology of cells which were induced to be differentiated into osteoblasts.

As a result, as in the above-described examples, it was demonstrated that intentionally constructed gene constructs could be used to produce cellular profiles to target specific characteristics.

### Example 14

### Intermolecular Interaction

Next, it was demonstrated that cellular profiles could be produced by using a technique such as a two-hybrid system, FRET, BRET, or the like.

The specific sequences of the introduced nucleic acid molecules are described below:

olfactory receptors (SEQ ID NOS: 13 to 38); and

G proteins (SEQ ID NOS: 39 to 44).

Transfection and array preparation were performed as in the above-described examples.

The dissociation of the olfactory receptor and the G protein was monitored through induction of a smelling substance, which was captured as changes in fluorescent wavelength. In this manner, cells were monitored.

The two-hybrid system, FRET, and BRET were specifically performed as follows.

The two-hybrid system was available from Clontech (http://www.clontech.co.jp/product/catalog/007003006.shtml). FRET and BRET were performed using devices available from Berthold Japan.

As a result, as in the above-described examples, it was demonstrated that intentionally constructed gene constructs could be used in a two-hybrid system, FRET, BRET, or the like to produce cellular profiles.

### Example 15

### Receptor-Ligand

Next, it was demonstrated that cellular profile can be produced by employing interaction between a receptor and its ligand as an indicator. It is useful for cellular network formation to obtain interactive information between receptor protein present in the cell membrane or nuclear membrane or the like and a ligand thereto.

In the present Example, the following was prepared:

(Cell Adhesion Molecules)

A variety of extracellular matrix protein and variants and fragments thereof were prepared as candidates for cell adhesion molecules. What was prepared in the present Example is as follows. Cell adhesion molecules were commercially available.

### 1) ProNectin F (Sanyo Chemical Industries, Kyoto, Japan);

### 2) ProNectin L (Sanyo Chemical Industries);

### 3) ProNectin Plus (Sanyo Chemical Industries);

4) fibronectin (SEQ ID NO.: 2);
5) gelatin.

Plasmids were prepared as DNA for transfection. Plasmids, pEGFP-N1 and pDsRed2-N1 (both from BD Biosciences, Clontech, CA, USA) were used. In these plasmids, gene expression was under the control of cytomegalovirus (CMV). The plasmid DNA was amplified in E. coli (XL1 blue, Stratgene, TX, USA) and the amplified plasmid DNA was used as a complex partner. The DNA was dissolved in distilled water free from DNase and RNase.

The following transfection reagents were used: Effectene Transfection Reagent (cat. no. 301425, Qiagen, CA), TransFast™ Transfection Reagent (E2431, Promega, WI), Tfx™-20 Reagent (E2391, Promega, WI), SuperFect Transfection Reagent (301305, Qiagen, CA), PolyFect Transfection Reagent (301105, Qiagen, CA), LipofectAMINE 2000 Reagent (11668-019, Invitrogen corporation, CA), JetPEI (×4) conc. (101-30, Polyplus-transfection, France), and ExGen 500 (R0511, Fermentas Inc., MD). These transfection reagents were added to the above-described DNA and actin acting substance in advance or complexes thereof with the DNA were produced in advance.

The thus-obtained solution was used in assays using transfection arrays described below. Next, transfection effects on a solid phage were observed. The protocols therefor are described below:

(Protocol)

The final concentration of DNA was adjusted to 1 μg/μL. A cell adhesion molecule was preserved as a stock having a concentration of 10 μg/μL in ddH₂O. All dilutions were made using PBS, ddH₂O, or Dulbecco's MEM. A series of dilutions, for example, 0.2 μg/μL, 0.27 μg/μL, 0.4 μg/μL, 0.53 μg/μL, 0.6 μg/μL, 0.8 μg/μL, 1.0 μg/μL, 1.07 μg/μL, 1.33 μg/μL, and the like, was prepared.

Transfection reagents were used in accordance with instructions provided by each manufacturer.

Plasmid DNA was removed from a glycerol stock and amplified in 100 mL L-amp overnight. Qiaprep Miniprep or Qiagen Plasmid Purification Maxi was used to purify DNA in accordance with a standard protocol provided by the manufacturer.

In the present Example, the following five cells were used to confirm an effect: human mesenchymal stem cell (hMSCs, PT-2501, Cambrex BioScience Walkersville, Inc., MD); human embryonic renal cell (HEK293, RCB1637, RIKEN Cell Bank, JPN); NIH3T3-3 cell (RCB0150, RIKEN Cell Bank, JPN); HeLa cell (RCB0007, RIKEN Cell Bank, JPN); and HepG2(RCB1648, RIKEN Cell Bank, JPN). These cells were cultured in DMEM/10% IFS containing L-glut and pen/strep.

(Dilution and DNA Spots)

Transfection reagents and DNA were mixed to form a DNA-transfection reagent complex. The complex formation requires a certain period of time. Therefore, the mixture was spotted onto a solid phase support (e.g., a poly-L-lysine slide) using an arrayer. In the present Example, as a solid phase support, an APS slide, a MAS slide, and an uncoated slide were used as well as a poly-L-lysine slide. These slides are available from Matsunami Glass (Kishiwada, Japan) or the like.

For complex formation and spot fixation, the slides were dried overnight in a vacuum dryer. Drying was performed in the range of 2 hours to 1 week.

Although cell adhesion molecules might be used during the complex formation, it was also used immediately before spotting in the present Example.

(Formulation of Mixed Solution and Application to Solid Phase Supports)

300 μL of DNA concentrated buffer (EC buffer)+16 μL of an enhancer were mixed in an Eppendorf tube. The mixture was mixed with a Vortex, followed by incubation for 5 minutes. 50 μL of a transfection reagent (Effectene, etc.) was added to the mixture, followed by mixing by pipetting. To apply a transfection reagent, an annular wax barrier was formed around the spots on the slide. 366 μL of the mixture was added to the spot region surrounded by the wax, followed by incubation at room temperature for 10 to 20 minutes. Thereby, the fixation to the support was manually achieved.

(Distribution of Cells)

Next, a protocol for adding cells will be described. Cells were distributed for transfection. The distribution was typically performed by reduced-pressure suction in a hood. A slide was placed on a dish, and a solution containing cells was added to the dish for transfection. The cells were distributed as follows.

The growing cells were distributed to a concentration of 10⁷ cells/25 mL. The cells were plated on the slide in a 100×100×15 mm squared Petri dish or a 100 mm (radius)×15 mm circular dish. Transfection was conducted for about 40 hours. This period of time corresponded to about 2 cell cycles. The slide was treated for immunofluorescence.

(Evaluation of Gene Introduction)

Gene introduction was evaluated by detection using, for example, immunofluorescence, fluorescence microscope examination, laser scanning, radioactive labels, and sensitive films, or emulsion.

When an expressed protein to be visualized is a fluorescent protein, such a protein can be observed with a fluorescence microscope and a photograph thereof can be taken. For large-sized expression arrays, slides may be scanned using a laser scanner for data storage. If an expressed protein can be detected using specific fluorescence in the case of calcium, a protocol specific for detection of a specific fluorescence can be successively performed for signal detection. If an expressed protein can be detected using fluorescence antibodies, an immunofluorescence protocol can be successively performed.

(Laser scanning and Quantification of Fluorescence Intensity)

To quantify transfection efficiency, the present inventors use a DNA microarray scanner (GeneTAC UC4×4, Genomic Solutions Inc., MI). Total fluorescence intensity (arbitrary unit) was measured, and thereafter, fluorescence intensity per unit surface area was calculated.

(Cross-Sectional Observation by Confocal Scanning Microscope)

Cells were seeded on tissue culture dishes at a final concentration of 1×10⁵ cells/well and cultured in appropriate medium (Human Mesenchymal Cell Basal Medium (MSCGM BulletKit PT-3001, Cambrex BioScience Walkersville, Inc., MD). After fixation of the cell layer with 4% paraformaldehyde solution, SYTO and Texas Red-X phalloidin (Molecular Probes Inc., OR, USA) was added to the cell layer for observation of nuclei and F-actin. The samples emitting light due to gene products and the stained samples were observed with a confocal laser microscope (LSM510: Carl Zeiss Co., Ltd., pin hole size=Ch1=123 μm, Ch2=108 μm, image interval=0.4) to obtain cross sectional views.

Next, the Example, to which the present invention is applied to, is described wherein an olfactory receptor is set as a typical example of a chemical substance receptor. When a preliminary example was implemented, it was proved that transfection arrays can also be used in an olfactory receptor

The olfactory receptor expression vector group was spotted for every receptor types on a cover glass, which was made like an array, was secured with screws and the like in a chamber for signal measurement, and cells having almost homogeneous nature, were cultured thereon. Regarding the signal measurement chamber, sample gas was introduced in a known structure (Proc. Natl. Acad. Sci. USA, 96 (1999): 4040-4045 and the like). Other devised chambers are also intended. During response measurement, culture medium was flowed at a constant speed. Culture was supplied to the chamber for measurement from the opening of a culture medium supplying tube, and a sample gas supplying tube was secured at the position preferably near the liquid level, which is the upper portion of an interval whose boundary is delimited by reaching a wall which prevents approach of culture over a cover glass for a ceiling of the measurement member, so that sample gas can be supplied to culture medium flowing across the interval. This sample gas supplying tube was preferably made of materials to which lipophilic odor substances such as Teflon and peak, and dust are not readily adsorbed. The higher effect was obtained in the situation wherein, at the time other than introducing sample gas, sample gas remaining in a tube was removed, and to preferably keep the interior clean (although not necessary), the tube (preferably with a broad opening) could be washed with odorless air by setting a three-way valve in the mid course, or by setting a check valve at a joint of an odorless air supplying tube. The example could also be implemented in the situation wherein, at a time other than introducing sample gas from outside for an appropriate time such as 0.5-4 seconds, odorless air was introduced at mid course from a sample gas supplying tube near the opening for collecting gas from outside, the interior of the tube was washed therewith, and at the same time, odorless gas was supplied to the culture medium as sample gas to promote the removal of remaining gas in a measurement chamber. A supporting base for the upper-glass cover slip is made of water repellent opaque plastic such as Teflon. A width of flow channel, where culture medium flows, is about 2-fold of a width of an array, and the array is disposed in the center of the flow channel. Regarding a culture medium supplying tube and an overflow culture medium sucking tube, a part of several millimeters from the opening at the side of the measurement chamber is made using materials, which has high hydrophilicity and is difficult to deform, such as stainless steel. The upper portion of the supporting base the upper glass cover-slip where culture medium flows, from the openings of both tubes to an array, was coated, or covered with a pieces of lens paper and the like in order to provide sufficient hydrophilicity. Negative pressure for suction was adjusted at the grade such that measurements were not affected by vibration from sound generated by aspiration culture.

Generally, response measurement could be implemented 2 days after the introduction of the gene by the expression vector. Since an upper glass cover-slip was required only at the time of measurement, it was not required to install it during culture until the gene was expressed. Therefore, the Example could be implemented, adding an upper glass cover slip which is integrated with a wall which prevents leakage of culture medium, and a supporting base for the upper glass cover slip, to a chamber for measurement, when setting a chamber for measurement of change in fluorescence measured by an apparatus after gene expression. The Example could also be implemented in the situation wherein culture medium was exchanged without using a culture medium supply tube and an overflow culture sucking tube during culture until the gene was expressed. An amount of about 10 ml of culture medium was supplied and exchanged at the frequency of about 1 time per several hours per day, during the time of tissue culture.

Size of odor response could be optically measured using a two-dimensional image sensor such as a sensitive video camera, with a calcium ion sensitive fluorescent dye fura-2 and the like absorbed into the cell. Measurement interval preferably has time resolution which can evaluate time constants of build-up and recovery of response of about ⅓-1 second. However, for average response time curve or its theoretical formula, actual change was estimated from measurement results at 5 points with 5-second-interval of 5, 10, 15, 20, and 25 seconds after stimulation. The obtained estimates of time constant of response starting time, response build-up time, and response recovery time was set as an index, and evaluation could be made as to whether a signal was induced by odor, or generated by spontaneous activity of a cell or other abnormalities.

In this Example, response of an expressed olfactory receptor in neurons was studied by measuring the change of fluorescence intensity of a calcium sensitive fluorescent dye. A decrease in fluorescence intensity (downward change) corresponds to an olfactory receptor response. Odor molecules were added to culture medium at the concentration indicated above as a stimulation source, and administered to a cell during the time indicated by the bar (4 or 2 seconds). As understood from this example, cells that were simultaneously stimulated have high intercommunity in time response characteristics, response threshold concentration corresponding to different stimulation per cell, and relative value of response amplitude. However, cells stimulated at different times show some differences. These results show that the highest measurement reliability can be obtained by measuring odor response using a sensor arrayed to a size that allows a homogeneous administration of sample gas, providing the same adjustment conditions.

As such, it was understood that odor-receptor-ligand (odor substance) can also be used to obtain a cellular profile.

### Example 16

### Application to Neuron Differentiation

Next, experiments similar to those of Example 14 have been conducted with neurons to analyze the effects of tyrosine kinase RNAi using transfection microarray. The exemplified drawings are shown in FIG. 31B.

As shown in FIG. 31B, network analysis can be conducted by taking photographs of signal represented by a reporter and collecting information thereon.

FIG. 31C shows responses of retinoic acid (RA) and nerve growth factor (NGF) by a variety of tyrosine kinases. Inhibition % by siRNA is shown.

FIG. 31D depicts an exemplary drawing of signal transduction pathway obtained as a result of analysis.

FIG. 31E shows results obtained by the above-mentioned analysis. Classification has been made regardless of dopaminergic neurons, cholinergic neuron, both, or neither of both. It can be analyzed that those relating to both have high probability of relating to nerve projection formation.

FIG. 31F depicts an example of real-time monitoring of transcription regulation of apoptosis in a HeLa cell. The left handed panel shows the result over time, and the right handed panel shows the result of a signaling pathway based on the analysis thereof.

### Example 17

### Data Production

Data produced in Examples 5-16 can be analyzed using a mathematical analysis with an appropriate modification as described in Example 4. Such data have been demonstrated to present a variety of formats.

### Example 17

### Production of a Digital Cell

Data produced in Examples 5-16 and additional data produced using the protocols described therein were used to produce a digital cell. In order to produce digital cells, parameters for data produced in these Examples have been extracted, and medium, pH, temperature, CO₂ concentration, and the like have been used as environment parameters. Database production may be performed using, for example, spreadsheet software such as Excel™ available from Microsoft, or database software such as Access™ also available from Microsoft. Next, as cell parameters, a database including cell species such as those used in Examples 5-16 can be used. A variety of stimulus parameters such as a variety of chemical stimuli (for example, including a variety of growth factors or cytokines such as HGF, FGF, PDGF, VEGF, CSF and the like) can be inputted to produce cell dynamics data, measurement data of reporters such as fluorescence intensity and the like. As such, a database constituting digital cell can be produced. Such examples are shown in FIGS. 33A and 33B.

### Example 18

### Use of Digital Cells: in Silico Live Experiments

The digital cells produced in Example 17 were used to conduct experiments on a computer. In the present Example, a mesenchymal stem cell was used to study which agents are differentiation agents. In the case of FIG. 33A, cell A was selected as cell (for example, mesenchymal stem cell or the like). Further, DMEM was selected as a medium, pH 7.4 is selected as the pH, 37 degree Celsius was selected as the temperature, and 5% was selected as the CO₂ concentration. Moreover, a variety of chemical stimuli such as growth factors or cytokines such as HGF, FGF, PDGF, VEGF, and CSF were selected. With respect to such a variety of chemical stimuli, concentrations were also appropriately selected, such as 1 nM to 1 mM. Combinations of these two or three thereof were also selected as a variety of chemical stimuli. Depending on these combinations and concentrations, data regarding responses with respect to how a mesenchymal stem cell responds was outputted. As an output, cell dynamic was included. From such cell dynamic, it was confirmed that the mesenchymal stem cell is differentiated (e.g. to bone marrow or adipocyte or the like) or not. If morphology was not sufficient, a combination between transcriptional factors and EGF as reporters was used to output further measurement data. As such, it can be confirmed whether or not a mesenchymal stem cell is specifically differentiated. By using the present method, one can specify a chemical stimulus which induces differentiation to a specific differentiated cell.

### Example 19

### Use of Digital Cells

### Education by in Silico Live Experiments

In silico live experiments described in Example 18 were conducted during school education. In this example, the experimental theme as described above was given to a student. The student selected a variety of parameters from a database of a given digital cells. The student composed his/her own research based on the data selected. The student submitted the composed research results as assignment/report. As such, education to a student can be conducted without using a live experimental system.

### Example 20

### Provision of a Digital Cell as Service

A database of the digital cell may be provided as an external service. Databases produced in Example 18 may use the embodiment described in FIG. 35. As such, the configuration of computer system 3501 providing a service reproducing experimental results from actual cell using the digital cells is shown. Computer system 3501 comprises service requester 3510 requesting services desired by a user, and service provider 3520 providing a determined service in response to the request. Users such as research institutes, educational organizations or institutions request desired services. Service provider 3520 providing commercial service provides appropriate data to the research institutes, educational-organizations or institutions upon request. For the purpose of school education, for example, a particular data base only directed to a particular cell or parameters or the like may be used as a service target.

As such, it is demonstrated that the digital cell of the present invention can be used to provide services.

### Example 21

### Practice of Cocktail Genome Project

As depicted in FIG. 47, the above mentioned technology of the present invention is used to practice cocktail genome project. High throughput systems are constructed using the transfection microarray of the present invention. Such a system may be carried out based on the above-described Examples. This allows analyses of 10⁶ to 10⁸ cells or more by means of the present invention. Cost for such an analysis may be 0.001 USD per assay. As used herein, for example, RNAi cocktails as used in the above-described Examples may also be used. Functional cocktails may also be produced by RNAi. This allows investigation of a variety of functions such as proliferation, differentiation, death and the like. Data obtained through such experiments may be feedbacked, and may also be used as reference for further analyses. The present invention may be used for conducting repetition of such cycles in a short period of time. Designing experiments based on such cellular informatics have not been carried out to date. The present invention allows designing experiments based on such cellular informatics, and can be applied to drug development such as anti-cancer drugs, and regenerative medicine and the like.

### Example 22

### Realization of Cellular Based Experimental System with Network Assistance)

As depicted in FIG. 48, the above-mentioned technology of the present invention is used to construct a cellular system analysis apparatus. This may be used by researchers, pharmaceutical companies, hospitals and university education organizations and the like.

Experiments and information presentation using the analytical apparatus of cell system of the present invention may be provided by an independent data production company for cell based data, and clients therefore include staffs conducting science and technology research, and pharmaceutical development at pharmaceutical companies, diagnostics at hospitals, school education organizations and the like. Accordingly, it is understood that the system of the present invention can be used not only for research purpose but also can be applied to a variety of fields and aspects.

### Example 23

### Examples of Cell Network Analysis

As depicted in FIG. 42, systems for analyzing of cell network using the technology is constructed.

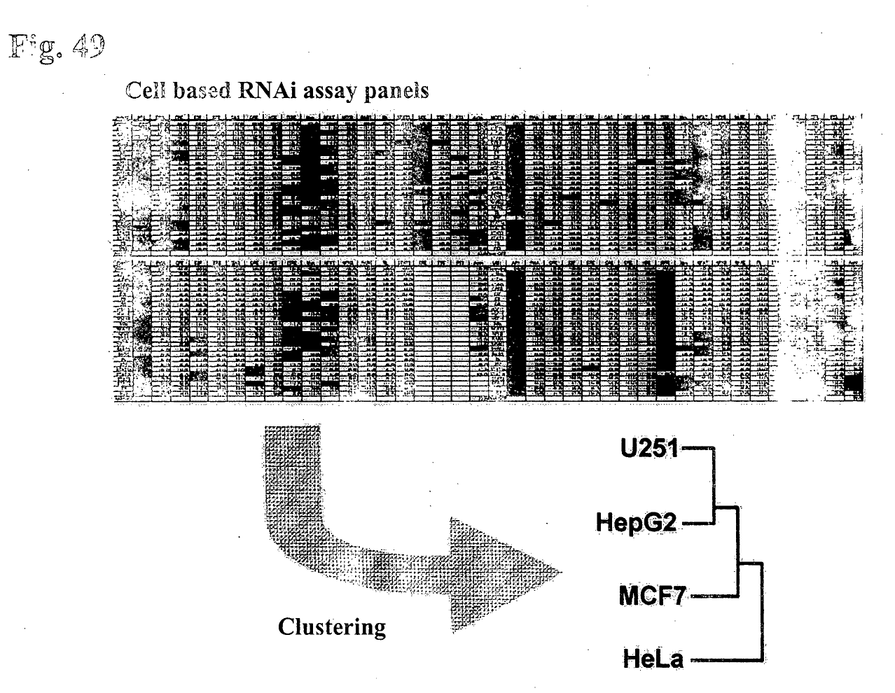

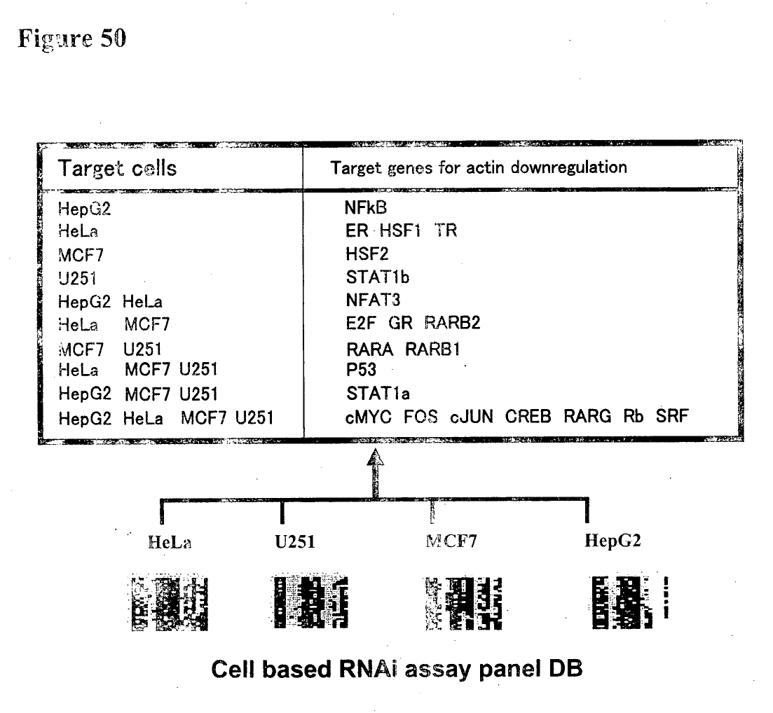

Experiments as illustrated by means of results of RNAi (see FIG. 29E), which were analyzed in EXAMPLE 6, were conducted on four types of cells such as U251, HepG2, MCF7 and HeLa cells. The results are shown in FIG. 49.

FIG. 49 depicts variation in transcription level by siRNA or scramble RNA against transcriptional factors set forth in the left panel for respective cell, wherein the variation is shown in the upper panel. When using scramble RNAs, the value is considered to be 100% for respective case. Transcriptional factors significantly activated are shown in read, and those significantly suppressed are shown in blue.

Based on the present correlation, cells are clustered. Optionally, clustering is conducted as described in Japanese Patent Application NO. 2004-24923.

Based on the subject clustering, cellular specificity targeting siRNA was designed. An example is depicted in FIG. 50. Tables shown in the upper panel of FIG. 50 depicts target cells, and target genes for actin downregulation are shown in the right column. This was constructed based on cell-based RNAi assay panel database as shown in the lower panel.

This operation may be provided using service requester and service provider.

### Example 24

### Cellular Network Analysis Using a Known Database

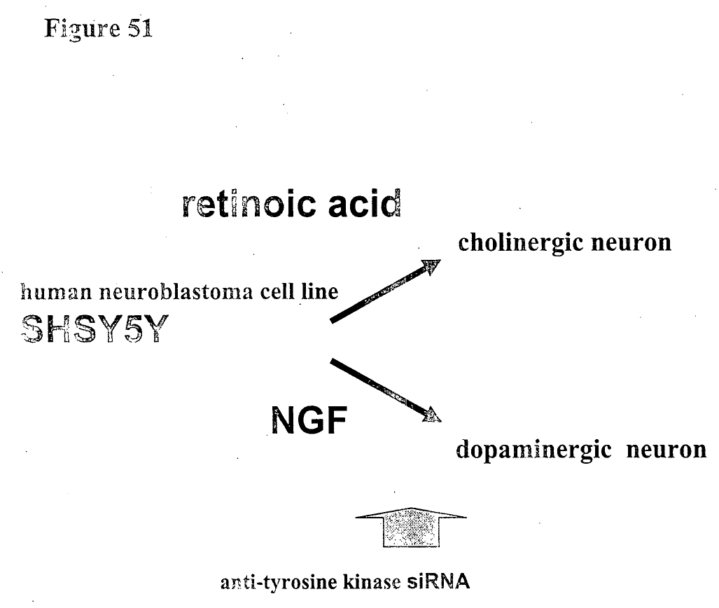

Next, known databases were used to analyze network in the neuron differentiation pathway by means of tyrosine kinase in a cell. An example thereof is depicted in FIG. 51. For example, responses of SHSY5Y, which are human neuroblastoma cell line, to retinoic acid (RA) and nerve growth factor (NGF) were analyzed in combination with known pathway database. The analyses allow gross classification of tyrosine kinases into cholinergic and dopaminergic. Pathways used for such analyses included KEGG, Signaling Gateway, Cell signaling databases signaling pathway database and CNSDB.

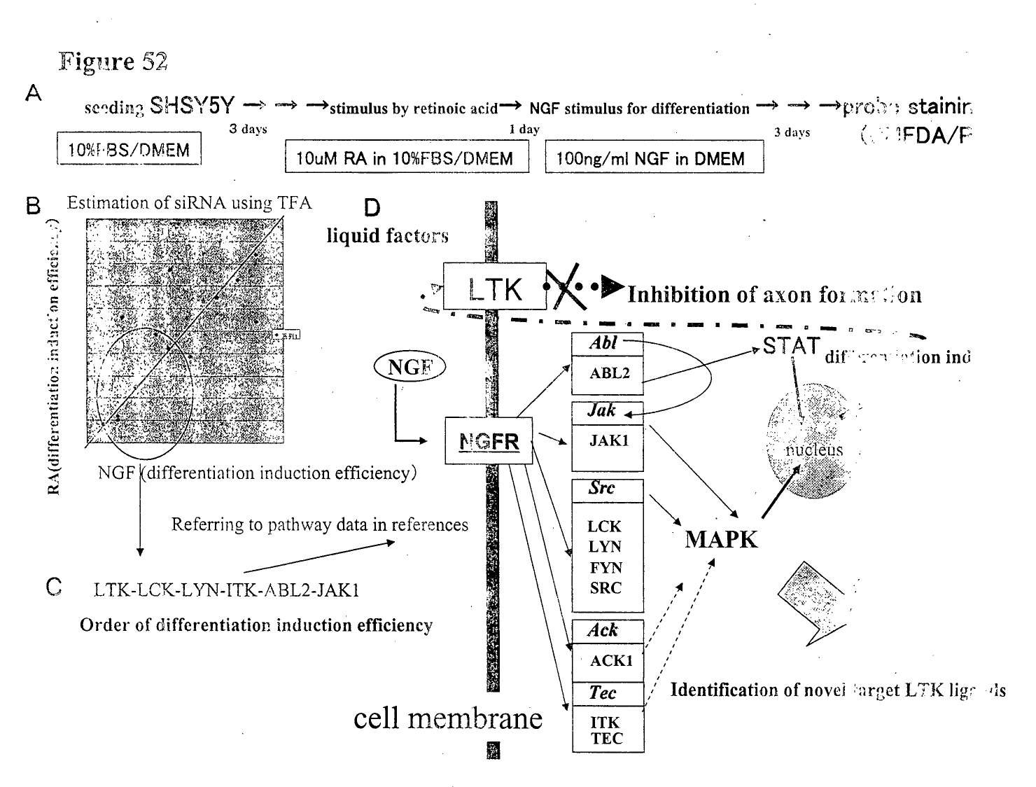

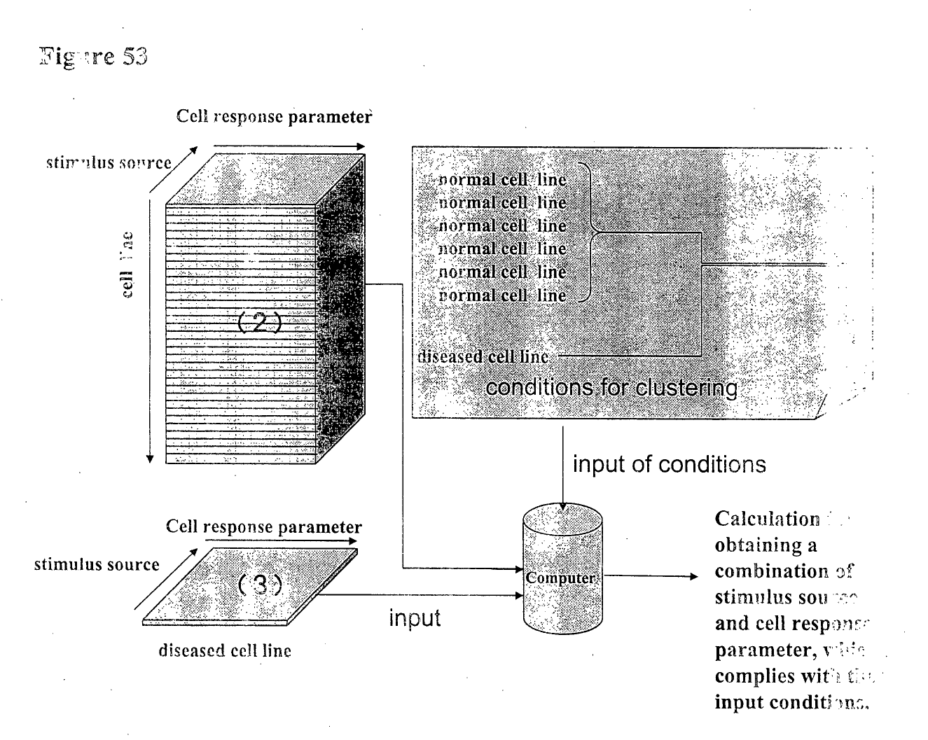

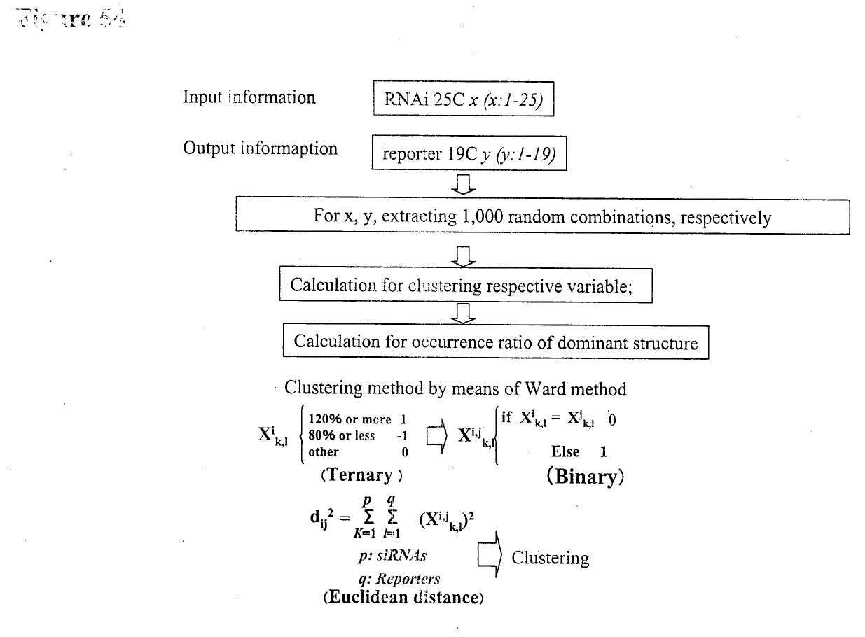

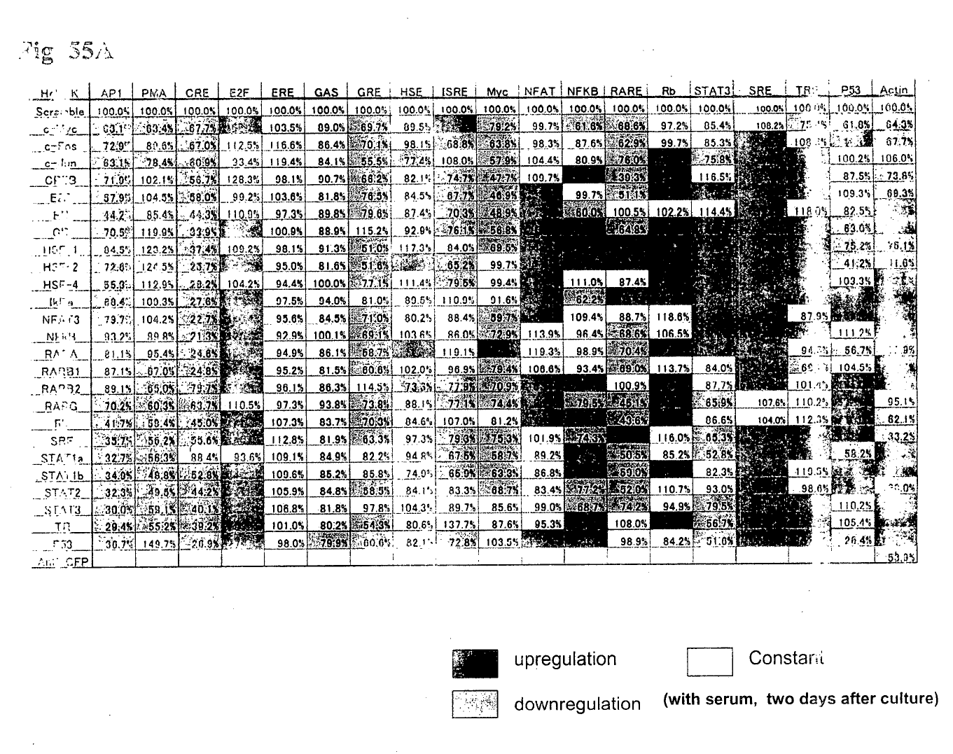

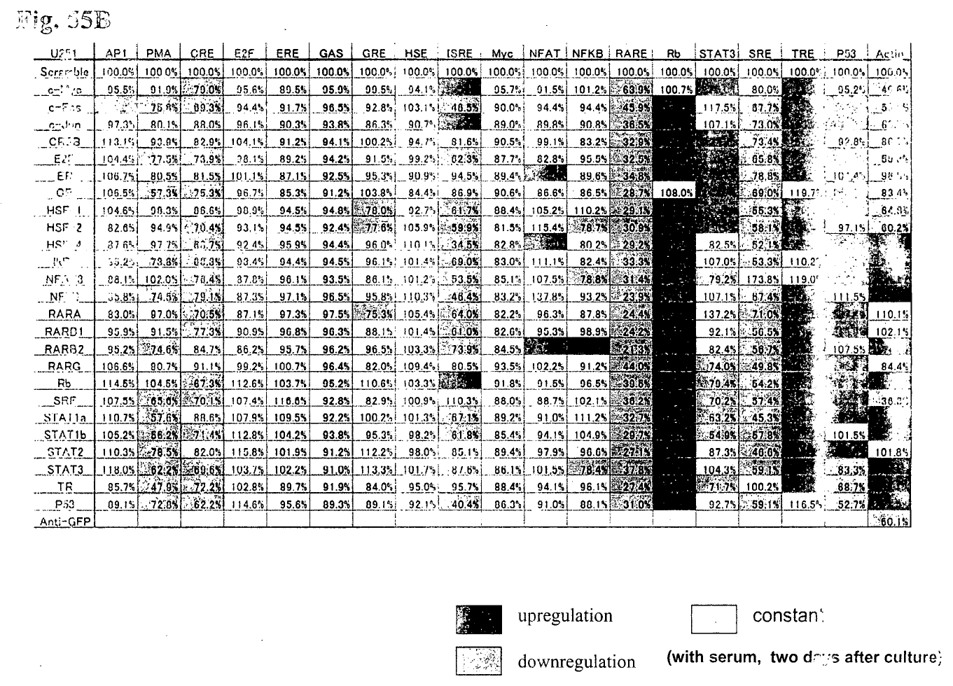

Interrelationship between NGF signal analysis results relating to the receptor and known pathway database was analyzed to obtain a list of order along the relativity thereof. This order list is analyzed for NGF function using SHSY5Y cell as depicted in FIG. 52A using a transfection array. The result is shown in FIG. 52B. In FIG. 52B, differentiation induction efficiency of RA and that of NGF were plotted. This correlation was analyzed and those having the highest inhibition efficiency of differentiation induction were outputted. The results are shown in FIG. 52C. A correlation with the referred orders of pathway data from the literature as mentioned above is illustrated in FIG. 52D.

As is seen from FIG. 52, it is suggested that rather than NGF receptor, which was conventionally believed to be responsible for major signaling of NGF, leukemia tyrosine kinase is responsible for axon formation inhibition. It was believed that NGF receptor has an high relevancy for MAPK as a signal transduction pathway with respect to formation of signal transduction network (for example, FIG. 31D). However, based on the analyzed results, the pathway relating to LTK (leukemia tyrosine kinase) turned out to have no direct relevance with NGF receptor for a role in signal transduction network as an autocrine manner. As such, the present invention allows clarification of networks which could never be understood by means of methods by directly using analysis from experimental results as in conventional methods. Based on such results, LTK may be used as a target for a neuron differentiation regulation factor. In order to use LTK as a drug target relating to neuronal differentiation, for example, database relating to LTK, compounds database relating to drug targets, interaction database (for example, ExPASy, GPCRDB, NCBI database, PROW, PDB, SwissProt, PIR), intermolecular interaction network database such as OMIM, KEGG, NCBI database, Path Calling database, database of compounds and chemical reactions such as LIGAND, AAindex can be employed to realize designing and screening of neuron differentiation regulation factors using network analysis and digital cell technology according to the present invention.

As such, the identification of novel targets as LTK ligands is an important information relating to the design of axon formation inhibitors, which were identified for the first time by the present invention.

### Example 25

### Analysis Service for Cell Specific Target Genes

With respect to a number of diseases such as cancer, it is important to search for target for a drug having apoptosis inducing effects in a tissue specific manner or blocking proliferation or the like, which are causes of the disease, and thus there are business sectors such as order-made search services and the like therefore.

In order to generally make experimental designs according to the purpose of such an exhaustive analysis of genes and the like, the methods are provided by means of out-sourcing services at a cost.

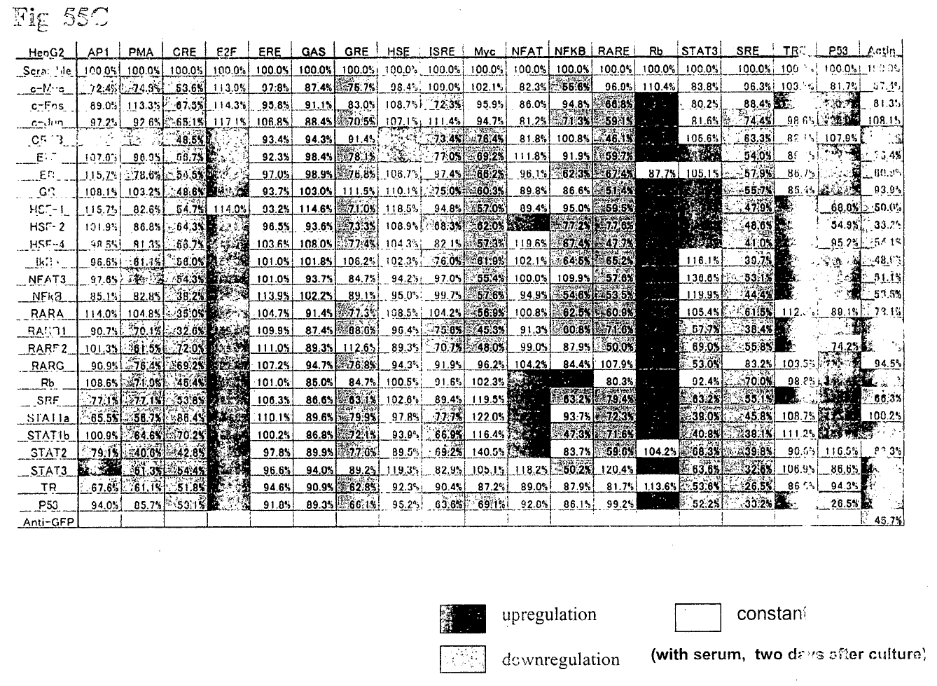

On the other hand, according to the flow chart analysis (1) used in the system provided by the present invention, digital cell database (2) and digital cell data (3) of disease related cells are compared to allow identification of combinations (4) of necessary genes in order to differentiate disease related cells (FIG. 53). Biological relationships (for example, intermolecular interaction, regulation relationship, pathway and the like) between genes included in the combination of genes (4) can be used for targeting genes at a lower cost and in a more rapid manner than the conventional exhaustive search. Data of (2) and (3) were obtained through cell-assay experiments.

(1) Flow chart analysis of target gene: As a stimulus source, substances inhibiting a particular gene function (for example, siRNA and the like) which are typically used in the art in the present Example was used. As cell response parameter, cell death rate, cell morphology variation, variation in intracellular structure size, gene promoter activity, enzymatic activity, variation in protein localization and the like was used. As cell types, normal cells from a variety of tissues, diseased cell, cell-lines and the like were used. Using a computer, a program was carried out for conducting search of combination of necessary parameters for classifying database (2) and data (3) so as to be applicable to conditional clusters.

As such, the present invention can be used to calculate a variety of parameters.

### Example 26

### Analysis Using Clustering

The present Example is described using specific examples.

Nineteen plasmid vectors for reporting transcriptional factor activities via fluorescence were used to construct cell variation database observed when siRNA to twenty five target candidate gene was introduced to seventy six cells, which were obtained by introducing the nineteen plasmid vectors to four cell lines, namely, HeLa cell (derived from cervix uteri cancer), HepG2 cell (derived from hepatic cancer), MCF7 cell (derived from breast cancer), U251 cell (derived from nerve cancer), respectively. The database is thus constituted from 1900 types of cell response data.

SiRNA which gives alternative effect to actin gene expression of a particular cell group (5) amongst cells included in the database were searched using the following data processing methods (6) to obtain results (7):

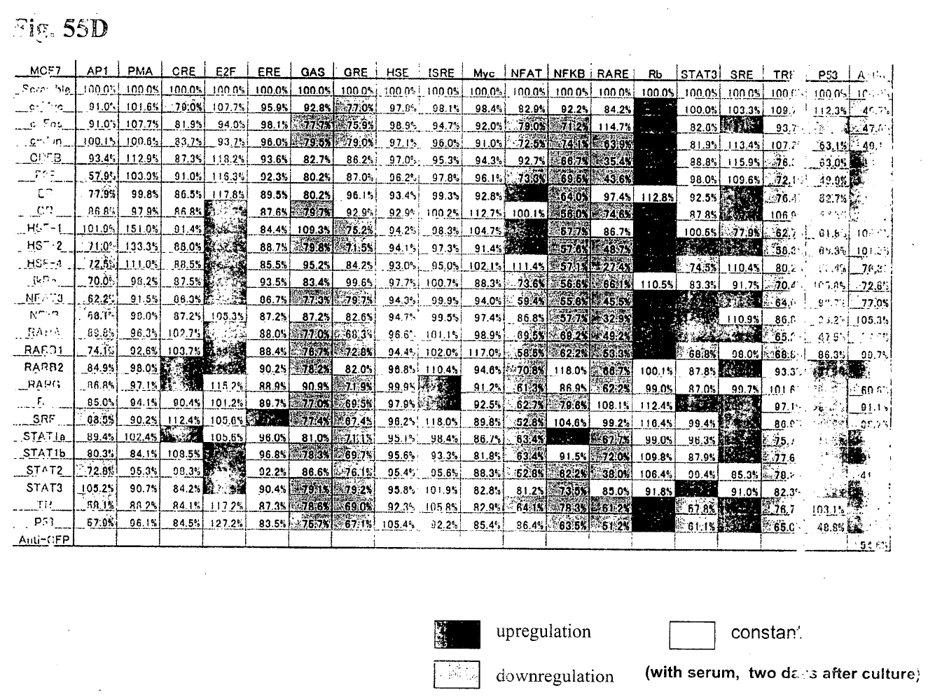

Clustering applying Ward's method was carried out to process cell response data. The scheme therefore is depicted in FIG. 54. The results are shown in FIG. 55. FIG. 55 depicts an average value of four experiments per data with respect to response data of a cellular event reporter to siRNA, which was obtained by means of processing according to the present invention. In the experiments, upregulation and downregulation were determined whether a 20% increase or decrease compared to the standard (before change) was observed.

Correlation of interaction based on the calculation of results depicted in FIG. 55 is shown in the following table. The present table shows results in which clustering using Ward's method was applied and correlation was provided to each of actin expression suppressing RNAi with target cell based on the results obtained by cell response data processing.

TABLE 1
Target cell group vs. groups of siRNA giving selective effects

| Target Cells | | | | Actin Expression Suppressing RNAi |
|---|---|---|---|---|
| HepG2 | | | | NFκB |
| HeLa | | | | ER HSF1 TR |
| MCF7 | | | | HSF2 |
| U251 | | | | STAT1b |
| HepG2 | HeLa | | | NFAT3 |
| HeLa | MCF7 | | | E2F GR RARB2 |
| MCF7 | U251 | | | RARA RARB1 |
| HeLa | MCF7 | U251 | | P53 |
| HepG2 | MCF7 | U251 | | STAT1a |
| HepG2 | HeLa | MCF7 | U251 | cMYC cFOS cJUN CREB RARG |
| | | | | Rb SRF |

Although certain preferred embodiments have been described herein, it is not intended that such embodiments be construed as limitations on the scope of the invention except as set forth in the appended claims. Various other modifications and equivalents will be apparent to and can be readily made by those skilled in the art, after reading the description herein, without departing from the scope and spirit of this invention. All patents, published patent applications and publications cited herein are incorporated by reference as if set forth fully herein.

### INDUSTRIAL APPLICABILITY

The present invention allows the determination of a cell state by observing significantly less factors. This determination allows application to diagnosis, prevention, therapy, and the like, and the scope of applications expanded not only to medicine but also to a variety of fields such as food industry, cosmetics, agriculture, environmental industries and the like. As live experiments can be reproduced on a computer, education and research in the field of biotechnology can be conducted on such a computer, which is industrially applicable. Furthermore, the present invention applies clustering in a reverse manner as conventionally used, to allow analysis of biological systems, which are non-linear, in an efficient manner with respect to responses and stimuli. Thus, there was observed a significant increase in the analysis accuracy thereof. This should be recognized to be useful in particular for drug discovery, since accurate cellular information can be obtained.

1.-81. (canceled)

82. A method for producing a digital cell database, comprising the steps of:
a) obtaining a cell parameter specifying a cell of experimental interest;
b) obtaining an environment parameter specifying the environment under which the cell specified by the cell parameter is cultured;
c) obtaining a stimulus parameter specifying the stimulus to be given to the cell specified by the cell parameter;
d) obtaining a stimulus response result showing the response of the cell specified by the cell parameter to the stimulus specified by the stimulus parameter under the environment specified by the environment parameter;
e) producing an experimental data for the cell, by correlating the cell parameter, the environment parameter, the stimulus parameter and the stimulus response result;
f) optionally repeating steps a) through e) to produce at least one collection of experimental data for the cell, and to provide at least one collection of experimental data as a digital cell;
g) collecting the data of the digital cell to form a database.

83. A method according to claim 82, wherein the data relating to the cell is obtained by a method for producing profile data relating to a cell in a consistent environment, the method comprising the steps of:
a) locating a plurality of cells to a support which is capable of maintaining the cells in a consistent environment; and
b) monitoring a biological agent or a collection thereof on or in the cell to produce the profile data for the cell.

84. A method according to claim 82, wherein the environment parameters comprise a parameter indicating culture medium in which the cell is cultured, and a parameter showing the conditions of the culture medium.

85. A method according to claim 82, wherein the stimulus parameters comprise a parameter showing a reporter and a parameter showing a chemical stimulus.

86. A method according to claim 82, wherein said stimulus response result comprises the profile data for the cell obtained by monitoring a biological agent or a collection thereof on or in the cell over time.

87. A method according to claim 83, wherein the digital cell database is adapted to the format of a known database selected from the group consisting of KEGG, EMBL, GenBank and AfCS.

88. A database produced by the method according to claim 83.

89. A database according to claim 88, wherein the database has a data structure selected from the group consisting of those which have a continuous monitoring data of gene expression, and data of a cell caused in an identical chip obtained in a simultaneous and parallel manner.

90. An apparatus for producing a digital cell database, comprising:
a) means for obtaining a cell parameter specifying a cell of experimental interest;
b) means for obtaining an environment parameter specifying the environment under which the cell specified by the cell parameter is cultured;
c) means for obtaining a stimulus parameter specifying a stimulus to be given to the cell specified by the cell parameter;
d) means for obtaining a stimulus response result showing the response of the cell specified by the cell parameter to the stimulus specified by the stimulus parameter under the environment specified by the environment parameter;
e) means for producing an experimental data for the cell, by correlating the cell parameter, the environment parameter, the stimulus parameter and the stimulus response result;
f) means for providing at least one collection of experimental data as a digital cell, by optionally repeating steps performed by steps conducted by the means a) through
e) to produce at least one collection of experimental data for the cell; and
g) means for collecting data to form the digital cell database.
